(19) United States
(12) Patent Application Publication
(10) Pub. No.: US 2016/0376003 A1
(43) Pub. Date: Dec. 29, 2016

(54) Aircraft

(71) Applicant: Yuri Feldman, Haifa (IL)

(72) Inventor: Yuri Feldman, Haifa (IL)

(21) Appl. No.: 14/751,180

(22) Filed: Jun. 26, 2015

(51) Int. Cl. B64C 39/00; B64C 29/00; B64C 13/08; B64C 13/14; G06F 17/10; B64D 43/00; G05D 1/10; G01P 13/02; G06F 17/50; B64C 27/32; B64C 13/34

(52) U.S. Cl. CPC B64C 39/005; B64C 27/32; B64C 29/0008; B64C 13/08; B64C 13/14; B64C 13/34; B64D 43/00; G05D 1/102; G01P 13/025; G06F 17/5009; G06F 17/10

(57) ABSTRACT

Conception introduced for performing powered flight of aircraft by performing work against gravity force, using gliding wing as steady support, namely “flying elevator” conception, and aircraft developed, based on cyclorotor scheme with elaborated steering solution, continuing in flexible handling and control. Said aircraft correctly and optimally implements said conception after presented detailed modeling, simulation and analyzing, having ability for flight with exceptionally high propulsion efficiency, moderate lift to drag ratio and short takeoff and landing. Additionally, it has ability for recuperative descent and deceleration, utilizing direct driving from high torque electrical engines, which can optionally hybridized with combustion engine, and covers speed range up to limits of subsonic flight.

### FIELD OF THE INVENTION

The presented invention generally relates to short takeoff and landing aircraft. In particular the present invention relates to such aircraft, which used pair of rotors from parallel oriented rotated wings for obtain overall aerodynamic force with desired components in vertical and horizontal directions enough to accomplish entire flight, in place of pair of stationary wings and separate propulsors. The invention also relates to steering those wings on rotors and handling entire aircraft.

### BACKGROUND OF THE INVENTION

Contemporary aviation has in its history remarkable time when first aircraft for powered flight was invented. Looking only from point of view of powering, this invention can be considered as application of rotated wings actuator, known as propeller, to non-powered glider. Prior this time propeller was well known for using for marine applications and its successful adaptation to air applications opened the airplane era and defined a general point of view on any kind of aircraft. Cornerstone of this general point of view is considering of neediness of some kind powered propulsion for any kind of powered flight. And for characterize ability or performance of such propulsion a coefficient of propulsion efficiency used. This coefficient was knowing prior the time as part of momentum theory of actuators, which was successfully applied to marine application and developed by W. J. M. Rankine, A, G. Greenhill and R. E. Froude. And so propeller of airplane isn't exclusion from it. Other performance characteristic of airplane was well known from time of non-powered flights as glide ratio. Also it referenced by its equal counterpart as lift to drag ratio and widely used upon referencing performance of contemporary airplanes and gliders. And total performance of an aircraft can be considered by product of both mentioned coefficients. Progress in having high performance airplane still is today neediness, but the progress saturated after long way of airplanes optimization. One of last segments of such optimization was migrating to use of turbofan engines in park of contemporary airplanes, which have significant advantage over used before turbojet engines. This advantage permitted by having higher propulsion efficiency in full accordance with momentum theory of actuators. Nevertheless, propulsion efficiency of turbofan in time of cruise is only about 50 percents, since its fan stage only particularly participates in overall propulsion.

Other kinds of aircrafts were considered also, but only few of them succeeded in practical use. One of them is helicopter, which propulsion efficiency in time of cruise more than 90 percents, but its lift to drag ratio is too low for having concurrency with airplane. Autogiro also has too low lift to drag ratio and uses separate propeller for propulsion, so its propulsion efficiency is below 80 percents. Nevertheless, it still used for flights.

Ornithopters also were under development. They have big advantage in performance, permitting have propulsion efficiency more than 95 percents and high lift to drag ratio, but they have big drawback: oscillation from flapping wings inevitable propagated to fuselage, so flight cannot be comfortable for humans. Also they need transmissions with very high-applied forces, especially for big scale aircrafts. Nevertheless, this kind of “aircraft” successfully used by birds.

Aircrafts with parallel movement of wings over circular pathway are known as cyclorotor aircrafts. They were under development long time from beginning of twenty century, but still not succeeded for human flight. Currently they used only for low scale models, without great advantage over low scale helicopter models. Nevertheless, cyclorotor actuators itself succeeded in marine applications. Non-succeeding of cyclorotors for aircraft was mainly caused by wrong understand of their abilities upon transmitting elements of theory and practice from development of airplanes and helicopters to their development. Main principal point in this misunderstanding is particular kind of relation between powering and propulsion for airplane. Cyclorotors can also operate for this particular case, but they cannot leverage they potential by this way. Nevertheless, this mode of operation permits abilities for using short runway, which are also known as Short Takeoff and Landing operations (STOL).

Presented invention originated from some conception of inventor, which explained in detailed description of the application, and from which generalized relation between powering and propulsion follows. And developing of presented invention follows from correct understanding of application of this generalized relation on cyclorotor aircraft and from correct implementation of mentioned conception to aircraft with high propulsion efficiency, moderate glide ratio and abilities for STOL operations.

### SUMMARY OF THE INVENTION

The present invention provides an aircraft with high propulsion efficiency, moderate high gliding efficiency, abilities perform short takeoff and landing (STOL) and having cruise speed up to subsonic limit. Also other aspect of the invention presented in the aircraft is using high torque electrical engines for power flight of actuators of the aircraft with ability of recuperation energy with high efficiency under descent, deceleration or both of the aircraft.

The aircraft based on improved variant of cyclorotor aircraft, where improvements included using improved steering mechanics for articulation wings of the rotor and using intermediate support rings for increase aspect ratio of aircraft. As aspect of the invention improving of steering mechanics performed by using displaceable four-gears scheme with set of grove followers with common grove and central gear instead of displaceable three-gears scheme with multiple radial connected links. The improvement enables using high number of wings per rotor, enough for having low level of remained vibrations for comforted flight. Also additional aspect of the invention is method for decreasing those vibrations by application specific patterns of electric current on coils of engine through engine controller.

Core value of the invention is presented in the application by disclosing correct attitude of understanding of operation of generic cyclorotor aircraft, by narrowing to use it as best variant of implementation of an abstract scheme with ideal powering. This abstract scheme referenced in the application as “flying elevator” conception for performing powered flight of aircraft by performing work against gravity force, using gliding wing as steady support. It presented there with detail analyze, including flight simulation result for other variants of implementation of the conception. Also preferred embodiment of the invention was undergo detailed prediction analyze through flight simulation before its presentation. The details of the multi-tier flight simulation presented also as aspects of the invention.

Also other aspect of the invention is handling of the aircraft. The handling presented there in two levels. The first is low level three components vector, where those components are introduced in detailed description as Pitch, Gain and Skew per each rotor of both sides of the aircraft, which referenced as PGS-state or simple PGS. The rotor possess additional mechanics for decompose the PGS vector on components independently. The additional mechanics is also separated aspect of the invention. Other aspect of the invention is set of control and indication trimmers connected to output shafts of the decomposing mechanics. Those trimmers permit control each component with high precision over high dynamic range, which performed by using up to three rotated coaxial scales simultaneously. Each of the trimmers can be handled electromechanically by servo or manually in case of unattended electricity outage. The second handling level is two components biangular set with Skew as additional option. The values of those set are meaningful angles of attack of some points of wings occurrence of the presented rotor, which placed in some relation with direction of the Skew line. For pilot, exact meaning of those points can be irrelevant, but values of those set are significant. In comparison with conventional airplane they can be correspond to position of elevator and position of flaps. Also they can have meaning of elevator and ailerons for turning operations. And next aspect of the invention there is architecture of software, which acts together with flight computer for match servo of trimmers to actual winding speed of rotor and aircraft for having cinematically correct angles of attack in specific points, using values from second handling level. Those cinematic angles of attack differed from actual angles of attack on some values induced by wing interference and inflow, but it is irrelevant for pilot, since they fixed for particular aerodynamic speed and speed of rotor for known flight operation. The application presented broad set of handling parameters for presented aircraft for many typical operation of entire flight. And that can be repeated for any other particular implementation using presented simulation scheme.

Other aspect of the invention is redundancy of powering and steering of rotor. The aircraft possess abilities to perform turning operations with same speed of rotors on each side. In many cases it is coordinated turn, but it also can perform flat turn before finalizing of landing sequence. So next aspect of presented invention prescribes connect shafts of both rotors together. So aircraft can fly on one engine in case if other engine or its controller has electricity malfunction. Also those benefits applied on each rotor shaft locking mechanism used in case of gliding or some serious problem. Steering of rotor possess redundancy from said multiple levels of handling, which have different impact from different levels of malfunction.

Other aspect of presented invention is system for providing steady reference base for rotor steering operations. It referenced as stream following system: the system permits having fuselage oriented in direction of airstream. The system consists from stabilators managed electromechanically, controller, pair of pressure sensors and special Stream Deviation Tube (SDT), which introduced in detailed description as separate aspect of presented invention. The system normally functioned by negative feedback through controller with option of computer management. But it can be handled manually in case of electricity outage by using separated trimmer and pneumatic Stream Deviation Indicator (SDI).

Additional aspects of presented invention are construction of fuselage for cooling engines and providing simple setup for engines and rotors. Also power gear excluded from design of the preferred embodiment since high rotor shaft moment prescribes using high-pressure oil system for the gear. Using high torque electrical engine instead it resolves the problem, where the engine has big diameter and small thickness. Next additional aspect of presented invention is placing accumulators along each side of fuselage space near rotors on shifted racks, which permits compensate load variation and also keep central space of fuselage relatively free. Other additional aspect of presented invention is option of combustion engine coupled with generator placed after rotors, which utilized warm cooling air from rotor's engines for combustion fuel with additional intake and has exhaust along trailing edge of fuselage.

These as well as other features of presented invention will be better appreciated by reference to the following detailed descriptions and drawings.

### BRIEF DESCRIPTION OF THE DRAWINGS

FIG. 1 is a diagram of explanation of the “flying elevator” conception;

FIG. 2A is an elevation view of the “flying elevator” configuration kind of “Wired wings” with one wired wing;

FIG. 2B is an elevation view of the “flying elevator” configuration kind of “Wired wings” with two equal wired wings;

FIG. 2C is an elevation view of the “flying elevator” configuration kind of “Wired wings” with two queued wired wings;

FIG. 2D is an elevation view of the “flying elevator” configuration kind of “Wired wings” with glider connected to one wired wing;

FIG. 3 is a perspective view of central node of intermediate wired wing of queued configuration;

FIG. 4 is a diagram of common constrains used in wired wings simulations;

FIGS. 5A, 5B, 5C and 5D are resulted flight profiles and plots of handling and acceleration values from flight dynamics simulations for “wired wings” configurations of FIGS. 2A, 2B, 2C and 2D respectively;

FIG. 6 is a side elevation view of “conveyered wings” configuration of “flying elevator” aircraft;

FIG. 7 is a side elevation view of cyclorotor configuration of “flying elevator” aircraft;

FIG. 8 is a diagram of explanation of PGS state for considered aircraft;

FIG. 9 is a cinematic and clearance scheme of presented rotor in neutral gain wings steering articulation;

FIG. 10 is a cinematic and clearance scheme of presented rotor in high negative gain wings steering articulation;

FIG. 11 is a cinematic and clearance scheme of presented rotor in high positive gain wings steering articulation;

FIG. 12 is an overall geometric chart for explanation four gears pitch steering scheme;

FIG. 13 is a detailed geometric chart for deducing relation for pitch steering angle in four gears steering scheme;

FIG. 14 is a formulae-deducing chart for pitch steering angle;

FIG. 15 is a data flow and definition chart for end use application of formulae for pitch steering angle;

FIG. 16 is a plot of pitch deviation distribution over entire wings positions of rotor for width set of radial offsets of central gear for normal assembling;

FIG. 17 is a plot of pitch deviation distribution over entire wings positions of rotor for width set of radial offsets of central gear for inverted assembling;

FIGS. 18A and 18B are comparative charts of assembling of four gears scheme for normal and inverted variants respectively;

FIG. 19 is a plot of pitch deviation in main and opposite positions dependently from radial offset of central gear for inverted assembling;

FIG. 20 is a plot of angular gain changing dependently from radial offset of central gear and from linear normalized gain for inverted assembling;

FIG. 21 is a diagram of explanation of biangular handling of aircraft with presented rotor in relation to airflow conditions;

FIG. 22 is a plot of distributions angles of attack, pitches and intermediate angles over entire wing positions of rotor and explanation relation between biangular handling and PGS state;

FIG. 23 is a plot of distribution pitches over entire wing positions of rotor relative to biangular pitch handling distribution in operational mode when airflow conditions ignored;

FIG. 24A is a diagram of relations of biangular values, PGS, wings articulation, thrust and airflow condition in “propelling” mode of operation of rotor in case of horizontal propelling upon runway acceleration;

FIG. 24B is a diagram of relations of biangular values, PGS, wings articulation, thrust and airflow condition in “propelling” mode of operation of rotor in case of try of vertical takeoff;

FIGS. 25A, 25B, 25C and 25D are exemplary plots of airfoil section coefficients and aggregations in entire 360° range of angles of attack used in flight dynamics simulation for CL, CD, CFx and CFy respectively;

FIG. 26 is an explanation chart for definition components of trust specific area relative to aircraft geometry;

FIG. 27 is an explanation chart for definition inflow and trust specific angle in relation to airflow conditions;

FIG. 28 is a data flow and definition chart for calculation trust specific area and inflow;

FIG. 29 is an explanation chart for definition terms used in calculation airflow interference in relation of superposition of foreign wings vorticity to segment of current wing;

FIG. 30 is an explanation chart for formulae used for consolidation interference induced speed vector over entire wing;

FIG. 31 is an explanation chart for formulae used for approximation center of vorticity of wing dependently from angle of attack;

FIG. 32 is an explanation chart with deducing formulas for calculation vorticity induced speed vector from sourced wing to particular linear segment of destined wing and to entire destined wing;

FIG. 33 is a data flow and definition chart for calculation state of interference corrected airflow of entire rotor;

FIG. 34 is an overall data flow chart for state machine used for flight dynamics simulation of aircraft with presented rotor;

FIG. 35 is a data definition chart for particular components of aircraft entire state;

FIG. 36A is a data flow chart for updating altitude conditions;

FIG. 36B is a data flow chart for updating predicted state;

FIG. 36C is a data flow chart for updating airflow state;

FIG. 36D is a data flow chart for updating winding state;

FIG. 36E is a data flow chart for first part of updating dynamic state;

FIG. 36F is a data flow chart for remained part of updating dynamic state;

FIG. 36G is a data flow chart for updating cinematic state;

FIG. 36H is a data flow chart for updating power state;

FIG. 36I is a data flow chart for updating rotor's phase;

FIG. 36J is a data flow chart for first part of updating report state;

FIG. 36K is a data flow chart for remained part of updating report state;

FIG. 37 is a data definition chart for constrains used in the simulation;

FIG. 38 is a chart of Rotor State Indicator (RSI) with explanation its elements used in reporting of result of the simulation;

FIG. 39 is a data definition chart of designation components of flags of handling state used in reporting of result of the simulation;

FIG. 40A is a chart, reporting result of the simulation for flight operation: “Beginning acceleration on runway”;

FIG. 40B is a chart, reporting result of the simulation for flight operation: “Before takeoff”;

FIG. 40C is a chart, reporting result of the simulation for flight operation: “After takeoff at 0.5 meters”;

FIG. 40D is a chart, reporting result of the simulation for flight operation: “Getting initial altitude and speed at 12 meters”;

FIG. 40E is a chart, reporting result of the simulation for flight operation: “Getting cruise speed in ascent at 75 meters”;

FIG. 40F is a chart, reporting result of the simulation for flight operation: “Ascending to cruise altitude at 400 meters”;

FIG. 40G is a chart, reporting result of the simulation for flight operation: “Ascending to cruise altitude at 3900 meters”;

FIG. 40H is a chart, reporting result of the simulation for flight operation: “Cruise at altitude 4016 meters”;

FIG. 40I is a chart, reporting result of the simulation for flight operation: “Gliding at altitude 3700 meters”;

FIG. 40J is a chart, reporting result of the simulation for flight operation: “Recuperative descent at altitude 600 meters”;

FIG. 40K is a chart, reporting result of the simulation for flight operation: “Approaching at altitude 202 meters”;

FIG. 40L is a chart, reporting result of the simulation for flight operation: “Enter in descent for landing at 165 meters”;

FIG. 40M is a chart, reporting result of the simulation for flight operation: “Dropping speed at altitude 82 meters”;

FIG. 40N is a chart, reporting result of the simulation for flight operation: “Dropping speed at altitude 30 meters”;

FIG. 40O is a chart, reporting result of the simulation for flight operation: “Dropping speed at altitude 20 meters”;

FIG. 40P is a chart, reporting result of the simulation for flight operation: “Dropping speed and descent at altitude 6 meters”;

FIG. 40Q is a chart, reporting result of the simulation for flight operation: “Dropping speed and descent at altitude 2 meters”;

FIG. 40R is a chart, reporting result of the simulation for flight operation: “Before touchdown at altitude 0.2 meters”;

FIG. 40S is a chart, reporting result of the simulation for flight operation: “Touchdown”;

FIG. 40T is a chart, reporting result of the simulation for flight operation: “Begin aerial braking on runway”;

FIG. 40U is a chart, reporting result of the simulation for flight operation: “Continue aerial braking on runway”;

FIG. 40V is a chart, reporting result of the simulation for flight operation: “Finalizing aerial braking on runway”;

FIG. 41A is a plot of result of simulation for cruise flight operation illustrating deviation of components of normalized acceleration and external moment ratio versus minor phase of rotor;

FIG. 41B is a plot of result of simulation for cruise flight operation illustrating deviation of internal moment ratio and normalized winding speed versus minor phase of rotor;

FIG. 42 is a chart of tabular result of aircraft turning analyze based on the simulation data for different flight operations;

FIG. 43 is a perspective view of preferred embodiment of aircraft in accordance with the present invention;

FIG. 44 is a fragmentary cross-sectional view taken along the line 44-44 of FIG. 43 in the direction indicated generally and broken on parts with placement map and overall low scale imaging diagram;

FIG. 44A is upper left part of the cross-sectional view from FIG. 44;

FIG. 44B is central left part of the cross-sectional view from FIG. 44;

FIG. 44C is bottom left part of the cross-sectional view from FIG. 44;

FIG. 44D is upper right part of the cross-sectional view from FIG. 44;

FIG. 44E is central right part of the cross-sectional view from FIG. 44;

FIG. 44F is bottom right part of the cross-sectional view from FIG. 44;

FIG. 45 is outer side plan view of earring assembly;

FIG. 46 is a elevation view of earring assembly shown from direction of left side of FIG. 45;

FIG. 47 is a longitudinally-sectional view taken along the line 47-47 of FIG. 45 in the direction indicated generally;

FIG. 48 is a fragmentary plan view of extracted rotor taken from mating side and broken on parts with placement map and overall low scale imaging diagram of entire rotor;

FIG. 48A is upper part of view from FIG. 48;

FIG. 48B is bottom part of view from FIG. 48;

FIG. 49 is a fragmentary radial-sectional view taken along the line 49-49 of FIG. 48A in the direction indicated generally;

FIG. 50 is a fragmentary cross-sectional view taken along the line 50-50 of FIG. 48A in the direction indicated generally;

FIG. 51 is a fragmentary cross-sectional view taken along the line 51-52 of FIG. 48A in the direction indicated generally;

FIG. 52 is a fragmentary cross-sectional view taken along the line 52-52 of FIG. 48A in the direction indicated generally;

FIG. 53 is a fragmentary cross-sectional view taken along the line 53-53 of FIG. 48A in the direction indicated generally;

FIG. 54 is a fragmentary cross-sectional view taken along the line 54-54 of FIG. 43 in the direction indicated generally;

FIG. 55 is a fragmentary plan view shown from direction of ring's side of FIG. 54 and oriented similar as on FIG. 43;

FIG. 56 is a fragmentary longitudinally-sectional view taken along the line 56-56 of FIG. 43 in the direction indicated generally;

FIG. 57 is a partial view of FIG. 56 from magnification circle labeled with number 57;

FIG. 58 is a partial view of FIG. 56 from magnification circle labeled with number 58;

FIG. 59 is a fragmentary longitudinally-sectional view taken in same orientation and direction as for FIG. 56 and showing tail compartment of stabilator steering transmission;

FIG. 60 is a cut-away fragmentary cross-sectional view taken along the line 60-60 of FIG. 56 in the direction indicated generally and showing only aircraft steering transmission connected to cockpit;

FIG. 61 is toward flight direction elevation view of cockpit with fragmentary included connected transmission and can be considered as continuation of FIG. 60;

FIG. 62 is upper plan view of joystick pad of cockpit;

FIG. 63 is a composed plan view of scales of all kinds of trimmers;

FIG. 64 is a plan view of scale of Stream Deviation Indicator (SDI);

FIG. 65A is a placement plan view of left PGS trimmer block taken from face side direction;

FIGS. 65B, 65C and 65D are placement plan views of WST-trimmer, SP-trimmer and L-trimmer respectively taken from face side direction;

FIG. 66 is a cross-sectional view of P-trimmer with transmission taken along the line 66-66 of FIG. 65A in the direction indicated generally;

FIG. 67 is a fragmentary cross-sectional view of S-trimmer without transmission taken along the line 67-67 of FIG. 65A in the direction indicated generally;

FIG. 68 is a fragmentary cross-sectional view of G-trimmer without transmission taken along the line 68-68 of FIG. 65A in the direction indicated generally;

FIG. 69 is a fragmentary cross-sectional view of WST-trimmer without encoder transmission taken along the line 69-69 of FIG. 65B in the direction indicated generally;

FIG. 70 is a fragmentary cross-sectional view of SP-trimmer without transmission taken along the line 70-70 of FIG. 65C in the direction indicated generally;

FIG. 71 is a fragmentary cross-sectional view of L-trimmer without transmission taken along the line 71-71 of FIG. 65D in the direction indicated generally;

FIG. 72 is a forward elevation view of Stream Deviation Tube (SDT);

FIG. 73 is a fragmentary longitudinally-sectional view of SDT taken along the line 73-73 of FIG. 72 in the direction indicated generally;

FIG. 74 is a cross-sectional view of SDT taken along the line 74-74 of FIG. 73 in the direction indicated generally;

FIG. 75 is a cross-sectional view of SDT taken along the line 75-75 of FIG. 73 in the direction indicated generally;

FIG. 76 is a functional block-diagram of in-fly management of the presented aircraft;

FIG. 77 is a fragmentary cross-sectional view of optional intermediate ring taken in direction and orientation similar as for end ring on FIG. 54;

FIGS. 78A and 78B are fragmentary perspective view of winglets installed on rotor for straight and forward swept variants respectively;

FIG. 79 is a fragmentary plan view of base part of extracted wing based on symmetrical airfoil accommodated to use in the presented aircraft taken in direction perpendicular to chord of the wing;

FIG. 80 is a fragmentary cut-away view of placement of combustion engine accommodated to use in the presented aircraft with relation to all power and cooling components.

### DETAILED DESCRIPTION

Prior to describing details of preferred embodiment, a discussion is provided of related matter for having correct attitude of understanding functionality of some kind of aircrafts, to which the preferred embodiment belongs.

Corner aspects of the invention were originated from following thought experiment, which I imagined in one day.

Consider an elevator (or lift), which going up on some wire, which winding in elevator's own drum by power of its own engine. And now consider also: other end of the wire is fixedly connected to some wing or lightweight glider, which is gliding down. Also consider horizontal components of speed of both: elevator and glider are equal, and also the movement of both is without of acceleration. Additionally consider: let aerodynamic drags of the elevator and of the wire itself are negligible. So this system will be in the presented movement until exists free length of the wire. But let stay away now from the problem of limited time of the movement and look on instant characteristics of the system.

We can simple find the system possess a some center of gravity (CG), which moves forward with same horizontal speed as both components of the system and will move up in case of the elevator going up with speed higher than glider gliding down. And so potential energy of entire system will be increased due a work performed by engine of elevator. Now the system can be considered, from point of view the increasing energy, like as some aircraft in ascent, where powering is on 100 percents mechanical. But this assuming can be not OK sound for some people acquainted with realm of aircrafts. Indeed, we know a powered aircraft should have a something for propulsion its forward, like propeller, turbojet engine or rotor of helicopter articulated to forward flight. On other side it wouldn't such surprisingly sound for people more acquainted with aspects of non-powered flight, for example for people having experience in gliding, hang gliding or paragliding. They know: any non-powered glider propelled forward by gravity force due spending energy from decreasing its altitude. More than, they have experience of ascent in raised air of dynamical or thermal nature. The raised air acts as the elevator in considered thought experiment in pure mechanical manner. And when the glider going up in the raised air, it still continue gliding down relative the air itself under propulsion force of gravity, having some gliding angle. Also such people know how to switch direction of the propulsion force for deceleration the glider upon landing.

So considered system possess some equivalence with glider placed into raised air, and power of elevator acts there as power of the raised air. And now we can find: the system possesses powered lift instead of powered propulsion of an airplane. And propulsion gravitic component of the system is powered by increasing altitude of CG from the lift powering. Also now we can find: a correct particular implementation of the “flying elevator” abstract conception will have great advantage over conventional airplane. It is very high propulsion efficiency, since the powered propulsion will be excluded from its scope as much as possible with related loss of power on it.

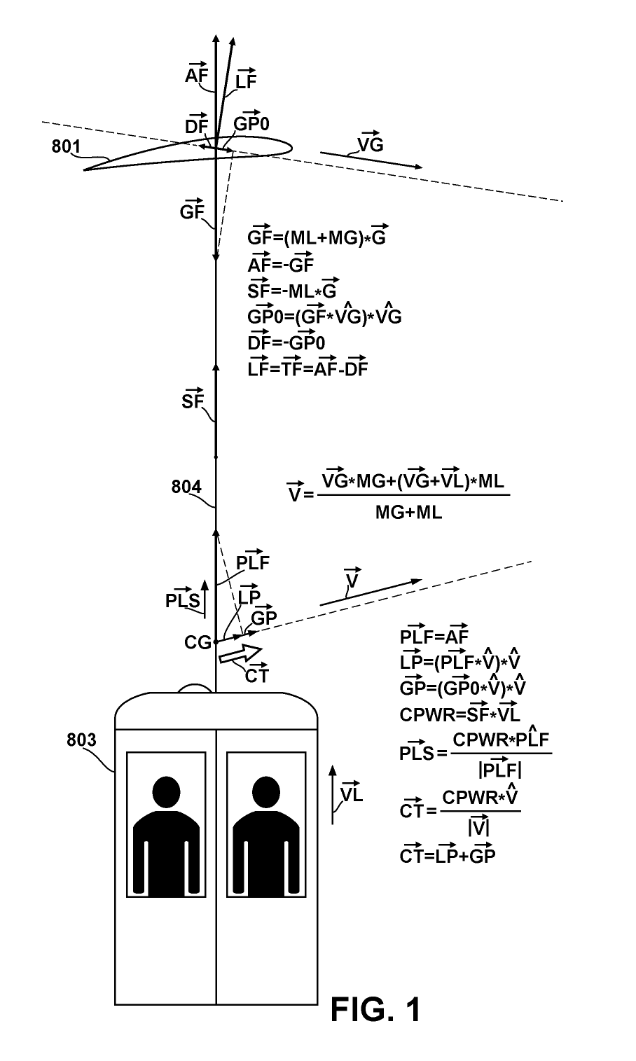

Now before go forward, lets look on FIG. 1, which explains the conception in details. There and in other places I use arrow sign for designate a vector. Also I use the “̂” sign for designate a normalized vector or vector of unitary length, which dot products with some other vector is simple a projection scale a one vector on direction of other.

There we can see glider 801 connected by wire 804 with elevator 803. The glider has speed vector VG and undergo gravity force GF, which value formulated in first upper equation, where vector G is gravitic acceleration and masses of elevator and glider referenced as ML and MG respectively. The gravity force is full compensated by full aerodynamic force AF, as it formulated by second upper equation. The third equation presents strain force of wire SF, which is opposed to gravity force of elevator only. The aerodynamic force can be decomposed to two components: a component perpendicular to airflow direction LF, which is lifting force and component in direction opposed to source of airflow DF, which is drag force. The gravity force GF has a projection on gliding direction GPO, which value formulated in fourth upper equation.

The GPO force exactly compensates the drag force DF and so it acts as propulsion force, which is formulated in fifth equation. I will reference the GPO force as primary gravitic propulsion force. Sixth upper equation represents other side of using lifting force LF as thrust force TF, which is useable in realm of helicopter aircraft and also in some explanations of presented invention. And the equation presents a simple way to calculate it by subtracting drag force from full aerodynamic force vectorially.

Full speed of elevator is simple algebraic vectorial sum of gliding VG vector and winding lifting speed vector VL. CG point on wire represents the center of gravity of entire system itself. The point has its own speed vector V, which value formulated by weighting equation on center of the diagram. In current example the CG point placed on the wire, but in more complex cases it can be placed simple in space. And so it isn't attributed to some element of system, it attributed to entire system. The CG point possesses mass of entire system, so balance of AF force and GF force can be considered there also. But the AF force referenced there by other name as power lifting force PLF, which mean the CG point is subject of some lifting. It is reflected in first equation of bottom group. We will encounter duality actuation of lifting force PLF, by projection it on vector V. It brings lift propulsion LP, which represented in second equation. Also projection of primary gravitic propulsion GPO on the vector V brings entire gravitic propulsion GP, which represented in third bottom equation. Fourth equation represents consumed power as dot product of strain force on elevator winding speed. Having the power we can calculate two vectors. The first is power lifting speed PLS, which represented in fifth equation. And second is consumed thrust CT, which represented in sixth equation. Also we can see sum of both kinds of propulsion is equal to consumed thrust, which is represented in seventh equation. These PLS and CT represent duality of powering the system. By first we can say as lift powering and by second we can say as thrust or propulsion powering. But we should understand they connected by common power value, which is scalar quantity, and so it isn't represents particular force doing the work. There is simple exchange of power between elevator and gravity field by increasing or compensating altitude of CG.

Let look now for particular case, when CG has only horizontal motion. It will be correspond to aircraft on cruise. We can simple see LP for the case is equal to zero. And system goes forward only by gravitic propulsion GP, but power for this propulsion provided by elevator. For the case absolute propulsion efficiency will be defined by loss of moment through downwash of glider. But the loss already included in balance of drag as inductive drag. So propulsion efficiency relative to non-powered wing will be equal to 100 percents.

Now let look for case when the elevator doesn't work. It will be simple gliding. We can simple see LP will be exactly compensated by GP and so CT will be equal to zero in full accordance with non-powered flight.

Also there exist other interested variant of applying the “flying elevator” conception: now to analyze induced drag itself upon gliding. From lifting line theory known the induced drag created by vortex connected with wings of finite span. It is known as “horseshoe” vortex. The vortex created some complex induced deviation of base flow. This component on near infinity in downstream direction has vertical direction and known as downwash. Also this component in vicinity of wing itself is known as inwash or inflow. That inflow also points down in counter-direction of lift but is two times small than downwash. Since the component represents a loss, it mapped for practical use to those induced drag by reposition of actual aerodynamic force to reference frame of non-disturbed stream in far infinity. But on other side it can be considered as kind of permanent sinking air. This sinking air can be considered as negative powering, where potential energy going back to power source. But power source there is gravity field itself, which provided propulsion for compensate airfoil section drag. But powering the “horseshoe” vortex also needs energy. And so we can see gravitic power there split on two ways. The first is simple compensation of airfoil section drag, such as profile drag. And second is powering the “horseshoe” vortex, which performs self servicing for the powering by placing the glider inside of sinking air of the inflow. It looks interested, but what useful thing we can extract from it? It is horizontal acceleration. The horizontal acceleration of glider will be powered only by first component of the gravitic propulsion, since the “horseshoe” vortex steal the second for its own servicing. For using this feature we should consider a gliding the glider inside its own inflow. For this gliding exists correspondent gliding angle. I will reference it as local gliding angle (LGA) of glider. Now consider we have some implementation of the “flying elevator” conception in some aircraft. We can decompose particular flight of the aircraft to “glider” component and “lift” component. Let name the “glider” component as embedded virtual glider or simple virtual glider. So said LGA can be obtained from the virtual glider. Knowing of it is useable for understanding when the aircraft will accelerate or decelerate for any particular flight operation. Real glider cannot change its LGA instantly for correct its acceleration, since its changing linked to changing flight path by entire mass of glider. But the virtual glider can do it upon simple changing articulation of its actuator.

Other interested thing, which can provide the conception is ability for recuperation energy with same level of efficiency as spending it for flight. For it we need only switch direction of the winding lift speed and the aircraft will enter in recuperative descent. More than, the “glider” can simple exchange exceptional speed on additional altitude and that altitude can be winded back for gaining energy. Doing both those actions simultaneously we can perform recuperative deceleration too.

Now let look how the “flying elevator” conception applies on known types of aircraft. Let look on airplane on cruise flight. The airplane will have zero flight path angle due the cruise operation. And so projection of gravity force on drag direction is also zero, which disables actuation of gravitic propulsion. The airplane compensates the drag using separated actuator such as propeller, turbojet or turbofan engine. The separated actuator has significantly low thrust specific area than wings of the airplane. From the lifting line theory known the thrust specific area of wings itself, which created the downwash, is almost equal to area of circle which diameter based on wingspan. The separated actuator of airplane has high outflow speed, which limits its propulsion efficiency. The efficiency for propeller practically lay in range 0.5-0.8. Also propellers perform badly for speed near of subsonic. Turbojet engines perform well for subsonic speed, but their propulsion efficiency lay in range 0.2-0.3. Turbofan engines on subsonic flight have propulsion efficiency of fan itself about 0.7, for nozzle only about 0.25 and overall about 0.5. But the low nozzle efficiency particularly compensated by high thermal efficiency of the nozzle stage itself, which is about 0.65. So overall efficiency relative to fuel energy is about 0.37. Now we can see, having the propulsion efficiency near to 100 percents can elevate the overall efficiency up to 0.4-0.45.

Next we can analyze the autogiro aircraft. Projection of gravity force on blades of its rotor is not zero, which is used for actuation its rotor. But nevertheless, when the autogiro is on cruise, it performs as wing of airplane, having overall zero-action of gravity force, because separated additional actuator also used there for propulsion.

Now let look on helicopter on cruise flight. There is different picture. Its rotor actuated on such manner that blades are in flapping motion over entire turn. Their wingtips laid in common surface inclined on some angle toward direction of flight. So part of entire thrust is horizontal and performs horizontal propulsion. But we can see difference in gliding blades on different phases of rotation. A wing begins gliding down toward direction of flight. It undergoes gravitic propulsion with increased magnitude of aerodynamic force. And helicopter itself going up like elevator, powered by rotors' engine. After it direction switched and wing is flaring up with decreased magnitude of aerodynamic force. And helicopter going down like elevator returning some power back to rotor. Difference in powering on both considered phases based on vertical component of rotor's thrust can be considered as lifting with PLS compensating sink rate of embedded glider upon gravitic propulsion. Also for duality representation we can consider horizontal component of entire thrust as consumed trust CT. And core feature of helicopter, which permits it, is common actuation area for those actions, due using common actuator. So helicopter is kind of aircraft, which can be referenced as self-actuating aircraft (SAA), because it not need separated actuator for propulsion. It used for it the same actuator as for providing sustaining forces. And so propulsion feature of such aircraft has big thrust specific area, low outflow and high propulsion efficiency.

Now we can see helicopter is example of SAA aircraft, which reflects the “flying elevator” conception in its operation. But helicopter isn't optimal implementation of the conception, because it was designed for different target. It was designed for vertical flight in first order and for horizontal in second. But the conception itself was formulated for design aircraft with ideal propulsion for cruise flight. And particular drawback of helicopter in implementation the conception is pure gliding ability of its rotor.

After understanding of existence of SAA aircraft we can look for other examples of this kind. I suppose it can be understand, birds' flight is example of this kind. Indeed birds have only one actuator for both sustain and propulsion actions: their wings. Also some birds can reach very high speed in horizontal flight. It is gravitic propulsion of simple glider, which permits it. Never they can reach it only by flapping their wings in weightlessness environment. They used the flapping mainly for lift thyself, compensating glide-sinking rate. There were attempts for build ornithopters, which mimic this bird's flight. But I suppose the trend isn't correct. The bird's flight has a big drawback from point of view of people. It is high level of oscillated acceleration, mainly in vertical direction. Birds well accustomed for it, but it would variant of uncomfortable flight for people.

So now is time to find correct implementation of the “flying elevator” conception. After formulating the conception I tried to implement it on straightforward manner: as some system of wired wings connected to common fuselage with winding abilities of those wires. I reference it as “wired wings” configurations. I considered four following variants of this kind.

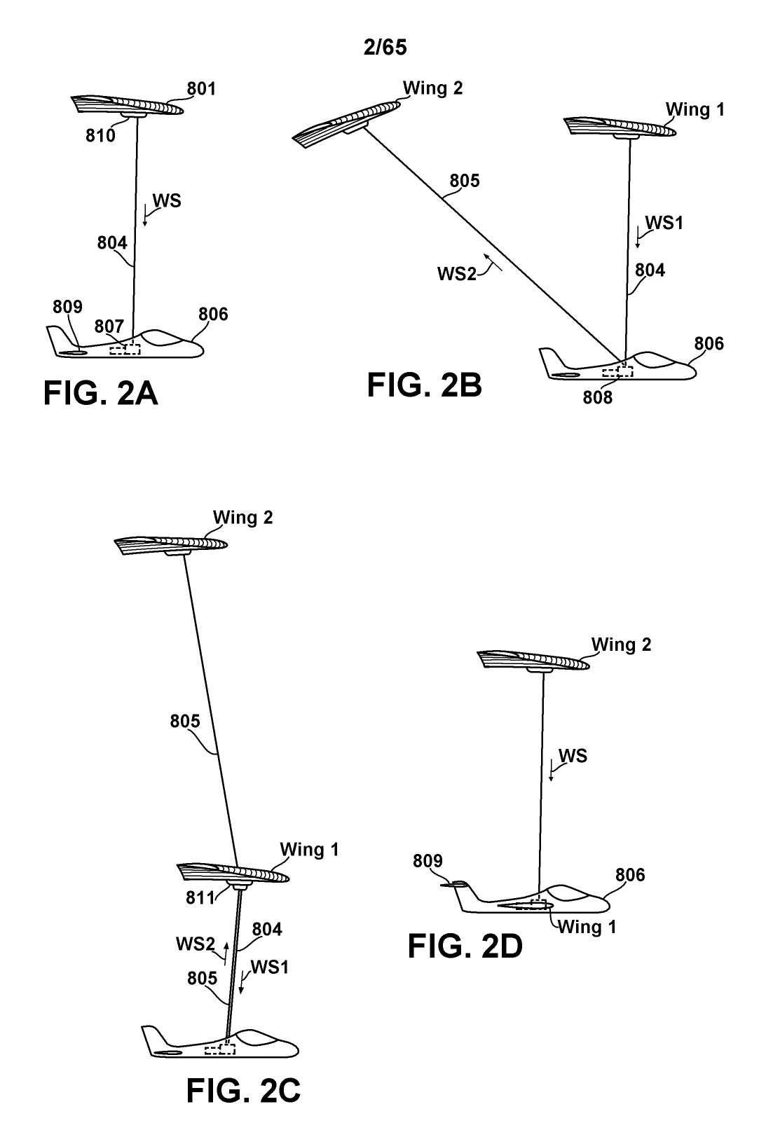

FIG. 2A represents simplest variant with only one wing 801 connected by wire 804 to fuselage 806. The fuselage has powered winding system 807, which placed inside near CG of fuselage. The system also has locking abilities, when it motionless. Also fuselage has a stabilizer 809, which permits tune its attitude upon flight. Wing 801 designed with elements providing longitudinal and transverse stability, like wing of hang glider and has a central node 810, where the wire 804 connected, with ability move the connection point in longitudinal and transverse direction under remote control handling commands from pilot.

FIG. 2B represents variant with two wings equal to wing described for FIG. 2A connected by wires 804 and 805 to common fuselage 806 which differed from fuselage on FIG. 2A by having set of two winding systems 808 instead of one. Here, wings referenced as Wing 1 and Wing 2 with winding speeds WS1 and WS2 respectively. In the configuration exists a problem of transition one wing near of vicinity of wire of other. This avoidance is too tricky for handling. So it practically disables use of this aircraft. Nevertheless, the configuration is useable for flight simulation analyze.

FIG. 2C represents variant where the neighbor wire avoidance problem of variant from FIG. 2B resolved by placing one wing over other permanently and wire 805 from upper Wing 2 is going trough pulley of enhanced central node 811 of lower Wing 1.

FIG. 2D represents variant like as for FIG. 2A, but fuselage 806 has its own Wing 1 pivotally connected to fuselage and upper wing referenced as Wing 2. So fuselage here becomes glider. Also stabilizer 809 here moved up on tail from proximity of main wing. Also the main wing here pictured as kind of symmetric airfoil for decrease its steering moment, although I used for simulation non-symmetric airfoil. Also here can be used standard glider scheme with fixed main wing and stabilizer with elevator surface.

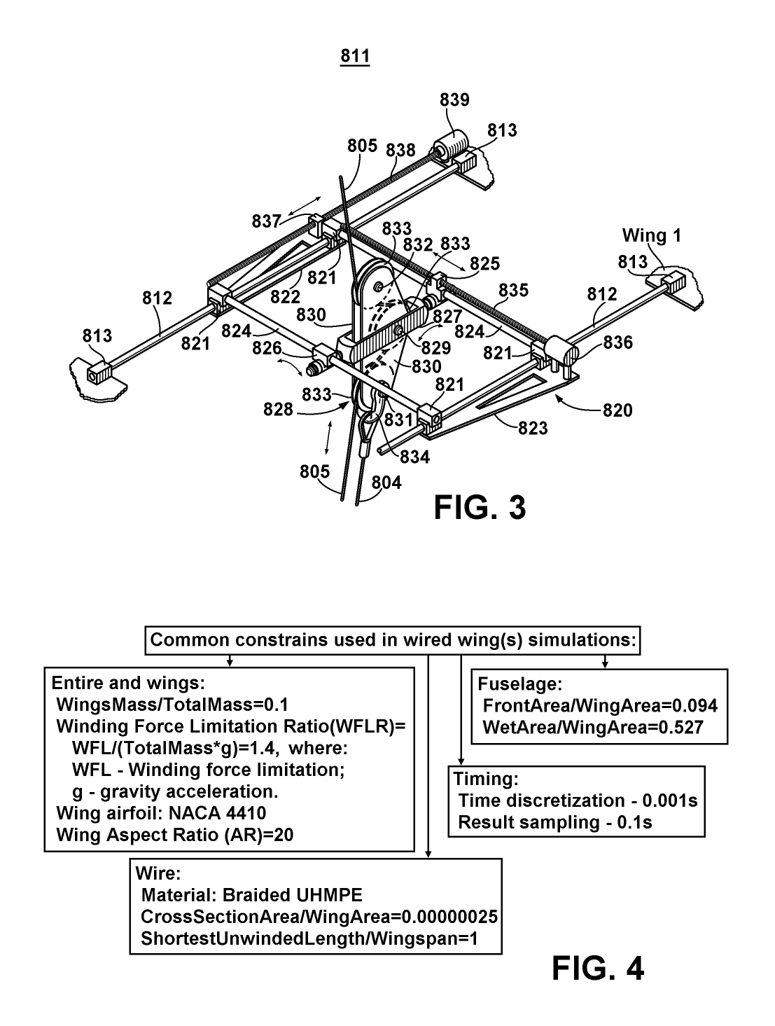

Variant of implementation of central node 811 represented on FIG. 3. The node consists from two longitudinal rods 812 fixed on Wing 1 in their ends by clamped supports 813. Caret 820 can be moved on rods 812 in longitudinal direction interfacing with those rods by pair of slipping supports 821 per each rod. Each pair of slipping supports 821 connected to side base 822 on left side and 823 on right side. Each slipping support 821 has cross oriented hole for clamping ends of rods 824 on forward and rearward sides of caret 820. Forward and rearward rod 824 carry slipping supports 825 and 826 respectively. Those supports have elements, which permit pivotally connect them to common frame 827, oriented perpendicular to direction of rods 824. Also elements of those pivotal connections perform constraining of fixed distance between supports 825 and 826 equal to distance between each support 821 on each side of caret 820. The frame 827 carry a pulley assembly 828 pivotally placed inside of the frame on shaft 829. The pulley assembly 828 consists with pair of equal cheeks 830 connected with shafts 831, 829 and 832 with pulleys 833 on those shafts and between cheeks 830. Placement of shaft 831 and 832 is symmetric relative shaft 829 with common offset to rearward direction. Bottom shaft 831 also pivotally carries earring 834 outside of cheeks 830. The earring 834 connected with end of wire 804. Wire 805 enters in the pulley assembly 828 rearward from wire 805 and over upper side of lower pulley 833. After it the wire 805 follows over forward side of central pulley 833 and exits out and up over lower side of upper pulley 833. Forward slipping support 825 has a continuation with threaded hole on its upper side. Transverse screw 835 goes trough the hole along forward rode 824 from servo 836 placed on right side base 823. The servo 836 provides movement of slipping supports 825 and 826 with frame 827. Wall segment 837 with threaded hole placed on left side base 822. Longitudinal screw 838 goes trough the hole along left rode 812 from servo 839 placed near of forward left clamped support 813. The servo 839 provides movement of caret 820. The implementation provides zero-moment footprint on entire Wing 1 from wires, since its cinematic scheme have a two-axial gimbal in center. Also central nodes 810 implemented as simplified variant of node 811: without pulleys.

All four variants of “wired wings” configuration were tested on a flight dynamics simulation program. I used angles of attack (AoA) of wings and winding speed as input handling parameters. Also I approximated the simulation to reality as much as possible, by including strain dynamics of wires thyself and also aerodynamic drag of wires and fuselage. The self-explaining diagram on FIG. 4 represents “wired wings” simulation constrains grouped by their modalities. I tried to find optimal handling parameters for each variant of aircraft.

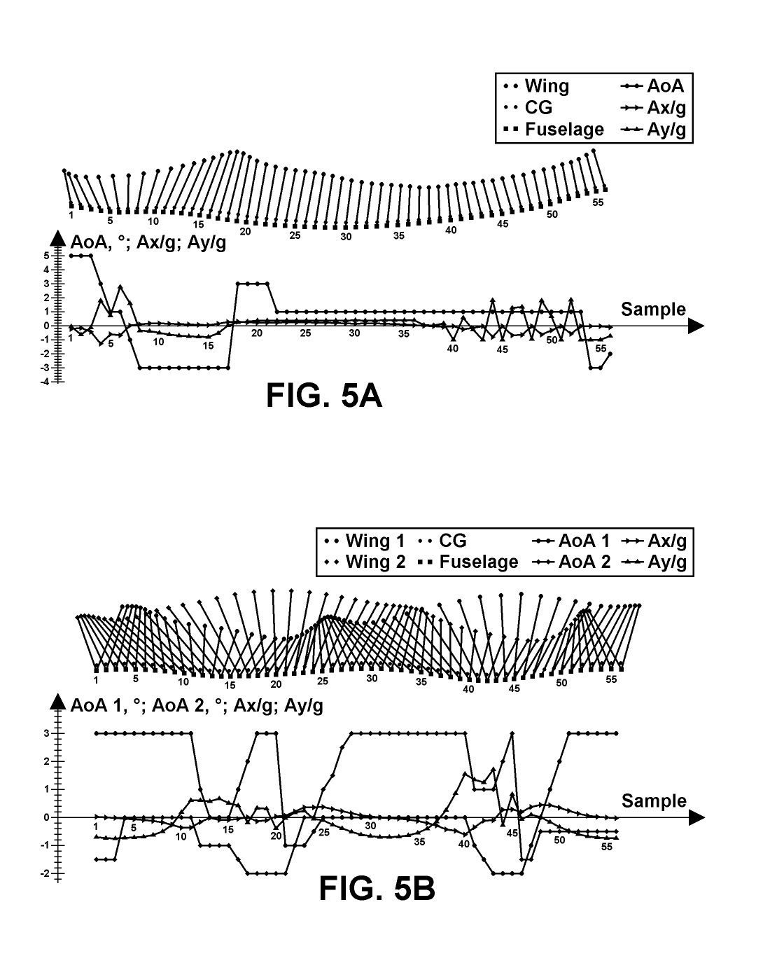

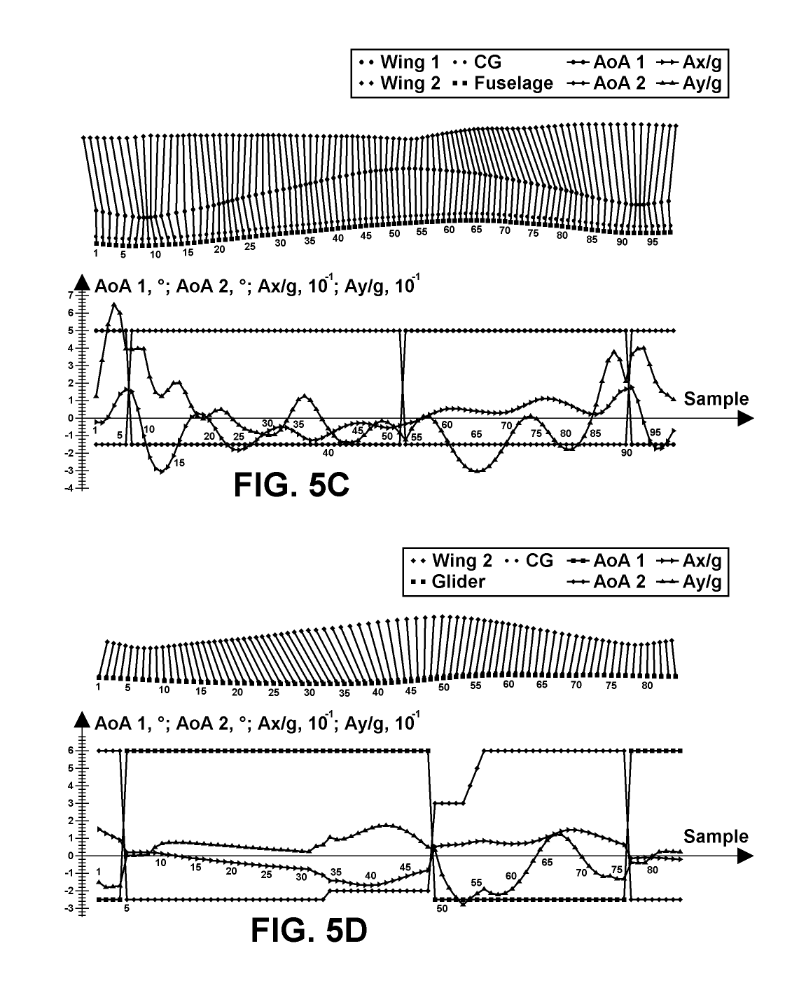

I prepared result of those simulations in form of composed charts, where upper side is flight profile of each component of aircraft, including wires, which keep connectivity of the data. Also there is labeling of numbers of resulted samples one per five. Bottom part is plot composed from handling AoA of related wings and components of acceleration of fuselage, which is normalized on gravity acceleration. Also horizontal axis of the plot is simple number of sample, corresponded to number on flight profiles. Also I placed labels of the sampling in appropriate places instead of the axis itself. Also keep in mind zero lifting AoA for used airfoil is about −4°. Result of entire simulation represented on four components of FIG. 5.

FIG. 5A represents result for one wired wing connected to fuselage. This configuration has some similarity with bird's flight. There exists only one possibility for recovering altitude of wing, because the wing only one. It is partially weightlessness on short time. But bird has advantage in that operation, because its wings aren't wired. So for keep the aircraft in horizontal flight only, I need use high magnitude of winding speed. So vertical acceleration changed from 3 g, when fuselage going up with increased AoA, to −1 g, when fuselage going down with decreased AoA. Horizontal acceleration changed from 0.3 g to −1.4 g. Let look on sample 18, where begins positive powering phase when fuselage has significant sink after particular fall. Wing placed significantly more forward than fuselage, so accelerating force inclined, inducing inertial force. Horizontal component of the inertial force inclines normal gravitic vertical, so it becomes inertial vertical. Fuselage begins accelerate in both directions. Also low flying wing promptly reaches speed of fuselage upon gravitic acceleration and they continue moving together, keeping inclination up to sample 35. Now fuselage has significant positive vertical speed and increased horizontal speed. At sample 39 the phase finished, wing and fuselage in almost vertical relation, but I don't switch to negative powering phase. I locked the wire and wait when vertical speed of fuselage will be maximal. Upon the intermediated phase wing accelerates and undergo pendulum oscillations with short period, which reflected in oscillations of acceleration. On sample 53 begins recovery phase. In the time speed of fuselage decreased. Previous recovery phase begins on sample 7. AoA decreased to −1° and to −3° on next sample. Before it wing was in strong acceleration due high inclined flight path and reaches high speed. The high speed induced high aerodynamic force, reflected in mentioned vertical acceleration of 3 g, which was possible since wire was looked. Remember, there is slipping constrain in 1.4 g without locking. In recovery phase wing continue moving forward and up, winding out the wire. Its flight path angle switched to positive direction and gravity force begins decelerate it. Speed of wing significantly dropped, and so aerodynamic force. Fuselage enters in almost weightlessness and begins increase its sink until of end of this phase. So it isn't a comfortable flight. Also it is too dangerous.

FIG. 5B represents result for two equal wings connected to fuselage. It permits less level of oscillations of acceleration, below 2 g for vertical component and 0.5 g for horizontal with both signs. Positive phase of one wing overlapped by recovery phase of other. But this overlapping induced mutual dependence in phases. This dependence leads to higher resonance of long-periodic pendulum oscillations of fuselage and wings. So amplitude of speed-oscillation for wings is very high, because mass of wings is low. It leads to periodical occurrences of very low speeds of wings, when wing almost cannot support its own weight. It is very dangerous, since wire begins forceless in end of recovery phase.

FIG. 5C represents result for aircraft with two wired wings on separated levels. The aircraft performs a bit better than need for cruise flight. The Wing 1 through pulley of central node applies additional constrains on horizontal position of upper wing and vice versa. So amplitude of horizontal oscillations of wings reduced significantly. There I succeeded in simple handling of the aircraft. Each wing has AoA of 5° until fuselage going up toward it. And in this time opposite wing has AoA −1.5°, when it flaring up, winding its wire out. Nevertheless, this regular pattern of handling isn't symmetrical. Phase with upper wing providing sustain is longer then phase with its recovering. Vertical acceleration reduced there to range between −0.3 g and 0.65 g, and horizontal acceleration to range between −0.3 g and 0.15 g. Also those accelerations have pattern of decremented oscillations replenished after each transition between handling phases. I use here low winding speed, so phases are long, permitting see details of those oscillations. Nevertheless, the system has drawback: the winding speed I use is maximal. Additional increasing of the winding speed leads to switching to mode of highly increased and irregular fluctuations with significantly loss of altitude and increasing of rotational energy of entire system, i.e. high entropy behavior. So gaining cruise altitude for the variant is still problematic.

FIG. 5D represents result for glider with additional wired wing. The aircraft performs a just enough for cruise flight. Pattern of handling is also regular like for FIG. 5C, but there exist prolonged intermediate state for both main and recovery AoAs of wired wing only. The system has prolonged recovery phase, when glider mainly sustained by its own wing with AoA of 6° and wired wing flaring up with AoA from −2.5° to −2°. After it there is shorted lifting phase, when wing of glider is idle with AoA of −2.5° and wired wing sustains the glider with AoA from 3° to 6°. Vertical acceleration lays here in range between −0.28 g and 0.18 g, and horizontal acceleration in range between −0.17 g and 0.15 g. Although winding speed used there is higher then for previous variant, short powering phase doesn't permit gain cruise altitude at all.

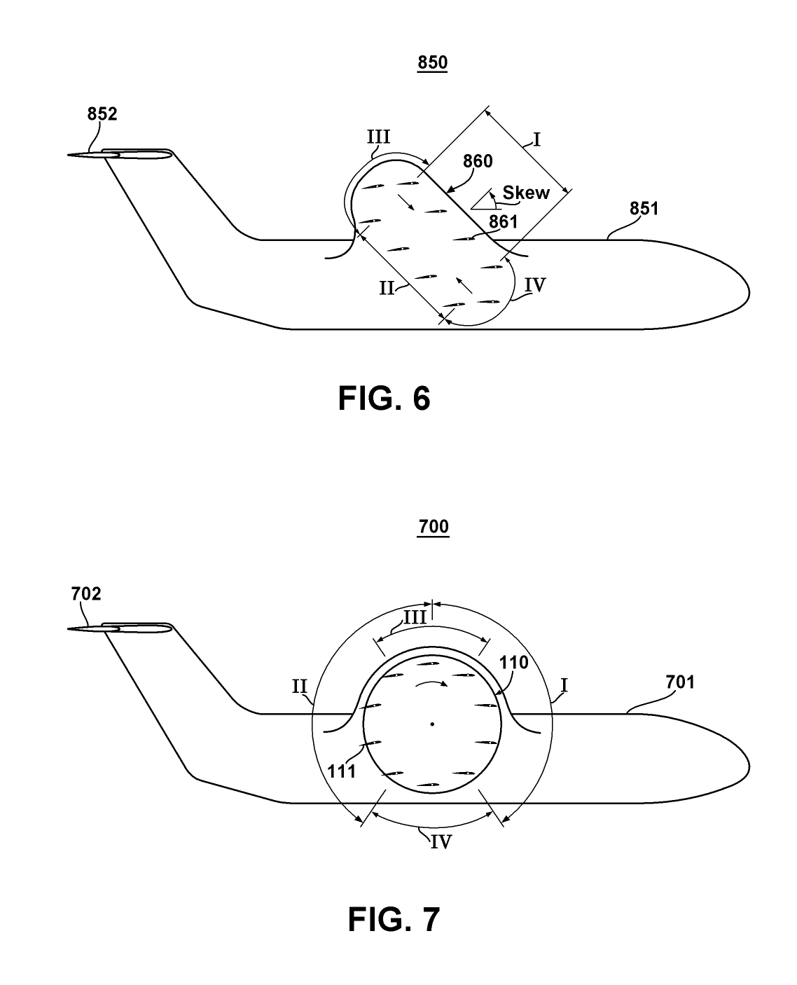

So finally, wired wing configurations permit having only aircraft with ability of perform cruise flight, low ability of gaining cruise altitude and zero ability perform runway operations for takeoff. Those limitations follow from constrain of self-sustaining abilities of wired wings itself and lack of control their angular kinetic energy relative of center of gravity of entire aircraft. So for implementation the “flying elevator” conception need an aircraft with wings of full controlled movement and steering. Ideally wings of such aircraft should be in some conveyer movement with some winding speed over their pivots, which path has a segment where lift powering performed and other segment, where performed simple return back to upper position with low level of aerodynamic force. So I designed a variant of such “conveyered” configuration, which represented on FIG. 6.

There aircraft 850 pictured in cruise flight and used a standard fuselage 851 with upper tail stabilator 852, used for compensate variation of moment of both sides “conveyered” actuators 860 under broad range of flight operations. The pathway of wings 861 on the actuator is rectangle with rounded corners, which inclined back on Skew angle from its vertical position. Those inclining used for distribute load of lifting wings along of fuselage direction, decrease overall height of the aircraft and driving force of entire actuator along its pathway. The pathway of actuator has a segment “I”, where lift powering performed, a segment “II”, where performed recovering altitude of wings, segment “III”, where performed transition from recovering to powering and segment “IV”, where performed transition from powering to recovering. Also due duality representation of power lifting segment “I” can be considered as be in propulsion powering. And also same possibility exists for segment “II”, when its wings have negative load. Such negative load wasn't being possible in “wired wings” configuration, but it is possible now for the aircraft. I supposed number of wings per actuator pictured there is near to optimal, since having lower number can lead to high level of vibration and having higher number leads to too weak wings. Also I suppose wing separation pictured there is near to optimal too, for having enough compact actuator with enough low level of wing interference.

Although from operational point of view this aircraft looks perfect, it has a significant drawback. It is almost impossible to implement. The main challenge for it is resolving a problem of having pictured motion of wings with their simultaneous rigidness with unsupported opposite ends under their big length for desired high aspect ratio. Indeed, the aircraft should have high aspect ratio of wings (AR) to be enough efficient. But its wings should be enough rigid for withstand high load on segment “I” and high level of centrifugal forces on segments “III” and “IV”. Best method to obtain enough rigidness is: bring wings in neighborhood support on their free ends. Do it for circular path is simple resolved by ring. But it isn't work there. So one way to resolve it is using wings between two fuselages, which has a great number of disadvantages, such as having additional transverse elements for frame rigidness. I don't exclude one day the problem will be resolved, but currently I don't have multi-tiered correct solution for it.

So remained way for correctly implement the “flying elevator” conception in aircraft is: using circular actuator. Exemplary variant of this kind aircraft represented on FIG. 7. The aircraft 700 has same fuselage 701 as for aircraft before and now stabilator 702 used for compensate variation of moment implied by circular actuator of the aircraft, which I reference as rotor 110. The rotor has same number of wings 111 as for previous aircraft and same wings separation. Now specific segments of wings pathway have an overlapped placement, since lifting ability of wing has some variance over forward side of the pathway and so related equivalent propulsion abilities of negative loaded wings on rear side of the pathway. Also mentioned ring, which provides rigidness to the rotor isn't shown there, for having wings 111 non-obscured on the view.

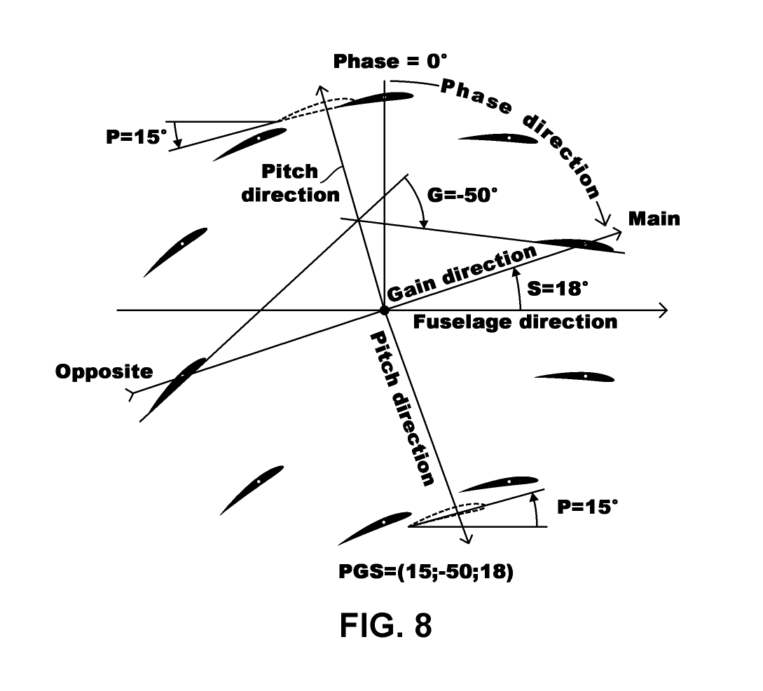

Next step for implement target aircraft is resolving problem of steering wings on rotor. But before do it will be useful to define some system for reference particular state of those steering. So I did and reference it as PGS state or simple PGS. Explanation of the PGS definition represented as diagram on FIG. 8.

The diagram images wings of rotor in some particular state of steering. Main idea of it is: the state is simple cinematic characteristics, which is irrelevant to current airflow condition. And so it can be considered as low level of handling the aircraft. It can be not friendly for pilot use, but it targeted at first only for having exact reference. Straightforward way for it is: having number of pitches equal to number of wings. From simulation examples before we know: aircraft can be handled by switching AoA from lifting value to recovery value and vice versa. But the AoA is a characteristic of airflow condition, which will be out of scope of desired state. Nevertheless, consider the desired state of pitches can have some symmetry correspondent to symmetrical state of AoAs with some functional mapping between both. So if state of AoAs can be characterized with two values in two opposed points and intermediate values between their, also state of pitches can be characterized on same manner, where intermediate states will be reflected by some function, which will be depend from particular implementation of the steering itself and stay out of scope of referencing for state of pitches. In such case the referenced state decreased only to three parameters, where two of them will be related to two values in opposite points and third parameter will point on exact direction where placed those two opposite points.

Additional idea there: let the system will possess of some kind of neutrality in some particular cases. And it exists indeed, when pitches of all wings are equal to some value. Let use the value as first parameter of referenced system and name it as “Pitch” with referencing by first letter “P”. Next parameter will be characterize level of violation of this neutrality, which is logically connected to difference of pitches of wings in two specific opposite points. Let reference one point “main” and other “opposite”, were the word “main” selected for reflecting its impact on much operations for lifting. And the parameter will be equal to difference in pitches between “main” and “opposite”. And so it is second parameter, which has name “Gain” and referenced by second letter “G”. Finally, remained third parameter will be simple angular direction of the “main” point. I named the third parameter as “Skew” and reference it by third letter “S”. The name I selected because there exist logical connection with “Skew” angle for aircraft on FIG. 6 and the aircraft also can utilize the referencing to PGS state, although its Skew is fixed.

Now on the diagram we can see all referenced elements. There are two Pitch directions, where wings possess neutrality with particular “P” value. There is Gain direction, i.e. Skew with value “S”, where can be measured second parameter “G”. And finally at bottom represented example of the reference as three component vector: PGS=(15;−50;18). Here values mean in degrees. Also it can be written as)(15°;−50°;18°. Additionally the diagram referenced to “Phase” parameter definition for particular wing, which is out of scope of the PGS state but used for recovering actual pitch for particular wing upon substitution entire PGS state and the Phase to some routine, which calculated actual pitch using of particular implementation of steering functionality.

Wings on rotor in selected configuration are in cycloidal motion under movement of aircraft. And so this kind of aircraft referenced as cyclorotor aircraft. History of cyclorotor aircraft has a long trend from beginning of twenty century. The trend began simultaneously with trend of helicopters. Finally the trend of cyclorotors wasn't fruitful instead of trend of helicopters. I suppose, wrong understanding of possibilities of the cyclorotor aircraft mainly caused it. In many cases there were intentions to build cyclorotor aircraft with ability of vertical flight. Adherents of this kind of aircraft were lured by advantage in motion of wings in cyclorotor relative to motion of wings in helicopter. Indeed, wings in cyclorotor moved in parallel manner with same speed over its entire length, instead of wings of helicopter, which have low speed near center of rotor. But this advantage isn't a main factor for vertical flight. Prior end of nineteen century was developed moment theory of actuators, which imply area of actuator is main factor for efficiency under desired thrust. Low area of actuator under fixed thrust induced very high inflow, which altered base flow creating a high drag. Only increasing rotation speed of actuator, which can increase efficiency a bit, can decrease the drag. But nevertheless it cannot alter inflow at all and so outflow. This outflow is non-overcoming limitation for entire thrust or propulsion efficiency of any kind of actuator. Also gliding wing can be considered as actuator with downwash as outflow. The thrust specific area of typical cyclorotor aircraft is significantly lower than thrust specific area of helicopter of same scale. Cyclorotor should have its rotation speed much higher, than for case of low inflow. And so it encounters a number disadvantages on this way. Main disadvantage there relative to helicopter is direction of centripetal forces. They always have radial direction, which is direction of weakness for wings of cyclorotor and direction of strongness for wings of helicopter. Other disadvantage is induced by first: centripetal forces on helicopter induce additional rigidness for its wings for applied aerodynamic forces. It acts as some multiplicative coefficient. But for cyclorotor aircraft this feature acts as oscillated superposition of two forces: centripetal and aerodynamic. Finally, cyclorotor aircraft never can be on same level of efficiency for vertical flight as helicopter. More than, simple build this kind aircraft of full-scale size with any efficiency is a great challenge also using contemporary advanced materials. The wrong intention also was reflected in naming of those aircraft. They until now referenced as cycloidal propellers and the trend still continue.

Also I suppose, there was an additional factor, which can prohibit building of cyclorotors for horizontal flight. It is high value of rotation moment upon powering of the rotor. It follows from the “flying elevator” conception. The cyclorotor can be considered as drum of elevator upon winding wire. And force on pivot of wing will be equal to force on the wire in case the wing is in forward position and only it provides sustain. In real case there are four wings, which provide 90 percents of sustain on forward side. So the total force in pivots' radial position will be about of half of entire weight of aircraft. And moment of rotor can be represented as ratio of such force to entire weight of aircraft. I reference it as particular case of Moment Ratio (MR), when internal aerodynamic moments of wings discarded. Also this particular case can be referenced as External Moment Ratio (EMR). And so that EMR can be too high for powering the aircraft. Indeed, also on helicopter exists the problem. Helicopter used spoor gear with pinion for cope the moment. Also it used a high-pressure oil pump for decrease wearing action in this kind of transmission. I resolve the problem in presented invention by other way: I don't use power transmission at all. Instead it, I use electrical engine with high torque, permitted by its high area of magnetic air-gap. And this electrical engine directly connected to rotor's shaft.

Nevertheless, some people tried to adapt cyclorotor for horizontal flight. They related boundary between two kinds of flight by pair of operation modes of the rotor. Those two kind of flight mainly differed by kind of cycloid, which their wings follow. Rotor, operated as propeller with low airspeed, has low advance ratio relative to air on infinity, which is known as True Aerodynamic Speed (TAS) and significantly higher advance ratio relative to airspeed to its vicinity, where inflow exists and which can be referenced as Local Aerodynamic Speed (LAS). The advance ratio is simple ratio of airflow speed, to linear speed of wings, which I reference as winding speed. It is very useful in realm of propellers. Also I use it in other form for characterization operations of aircraft presented in the invention. I use it in form of reversed ratio as Winding Ratio (WR), since the presented aircraft can simple glide, without motion of rotor at all. In this case it has the WR equal to zero, instead of infinity if I keep old referencing. Also it always referenced relative LAS. Returning to mentioned pair of operational modes of cycloidal propellers, they were divided on curtate mode, when rotors cinematic mechanics adapted to operation with advance ratio below 1 and prolate mode, when the adaptation targeted to advance ratio above 1. And the adaptation itself was an intention of minimizing powering force reaction normal to the cycloidal path, which reflects intention of minimizing of powering moment, which I discussed before. For the adaptation it can be obviously, a wing will perform some oscillating relative its pivot for curtate mode in rotated referenced frame of the rotor. Simultaneously the wing will perform rotation relative its pivot, looking from steady reference frame outside the rotor in the mode. In prolate mode there will be opposite picture: the wing will be rotated relative rotor and will be oscillated looking outside. For the last, rotation of wings inside of rotor performed in direction opposite of rotation the rotor itself, which can be implements by using double planetary gear transmission with four gears per wing, where one central gear is common. Kinds of such transmission for keeping pitches all wings equal were referenced in many inventions related to cyclorotor aircraft. And it was accompanied with particular solutions of steering wings from neutral position.

In U.S. Pat. No. 2,045,233 of Kirsten et al described cycloidal propeller designed for prolate operation, which utilized the four gears transmission scheme, where one pair of meshed gears used bevel teeth. And steering of wing performed by additional differential connected to first of the mentioned bevel gear. Those differentials of each wing participate in common movement by levers pivoted on common eccentric. Also there exist two handling inputs. One regulates value of eccentricity and seconds direction of eccentricity. Also the last regulation was blocked with regulation of common pitch by rotation of central gear. Now from point of view of PGS state there exist steering of gain by level of eccentricity, steering of skew by direction of eccentricity and steering of pitch by blocking with skew regulation. So there missed possibility for changing pitch independently of skew. Nevertheless, inventors claimed it as positive feature, which permits more effective action, having common control for center of symmetry and pitch. Although invertors only guess in that effective action, it exists indeed, but only for propelling, which can be useable for runway operations of SAA. In any case this solution cannot be adapted for target aircraft, because the steering elements obstructed central area of rotor, which isn't permit place here central powering shaft. Also separating pitch and skew control for the scheme need additional steady base inside, which leads here to exceptional complexity.

In U.S. Pat. No. 5,100,080 of Servanty described cycloidal rotor for horizontal flight, which also utilized the four gears transmission scheme. In the rotor, steering of each wing performed by rotated hydraulic actuator, embedded in coupling of two intermediate gears of the four gears transmission scheme. The actuator assured correct pitch for wing in each instant, which managed by special calculator. Also there exists mechanics for handling neutral common pitch. The solution has exceptional flexibility for handling pitches of particular wings, which out of range of PGS state. Also the solution isn't secure and dangerous. Indeed, the pitch calculated for some instant, correct only in vicinity of the specific phase. In case of outage hydraulic pressure or electricity of calculator, the remained or not assigned pitch will wrong from other phase, which can drastically change overall lifting force, leading to aircraft incident. And so this example demonstrated additional advantage of mechanical steering fitted to limitation of PGS state: In case of power outage, steering will be continue operating correctly, since the state simple remains as mechanical state for any intermediate phase of any wing.

In U.S. Pat. No. 6,932,296 of Tierney described an unmanned aircraft with cycloidal rotor, having possibilities to operate in curtate mode, prolate mode and with fixed wings with separated fan as propeller. It used tree gears transmissions scheme, which can be considered as particular case of four gear scheme, where all four gears are equal, so intermediated coupled pair of gears reduced to one intermediate gear. Also instead of one central gear there is set of central gears, one per each wings. Those central gears have some elements, which permits switching between curtate and prolate mode of operation. In prolate mode the set of central gears is stationary and in curtate it is rotated. Steering of wings performed by moving entire set of central gears by some XY pair of servos. Also there exists some case of handling common pitch by selective griping entire set of central gears upon switching to prolate mode and with possibility changing it in fixed wing mode. The system of gears keeps integrity by links connected their axes pivotally. Also there is some center shaft, to which those links connected and used for lock the rotor in mode of fixed wing operation. Gears related to particular wing occupy they own position in depth of rotor, but links have a common level where they connected to central shaft. The rotor presented for three wings, but placement of gears and links isn't permit having more than five wings. Also for it there can be collisions between links upon steering. Nevertheless, this solution complies with PGS state in its prolate mode of operation. Remarkable feature of the unmanned aircraft is a demonstrating of principal limitation of cyclorotor aircraft based on the law of obeying the “propeller rule” of having minimal projections of lift forces to direction of rotation: the aircraft designed operating with high rotation speed upon low powering moment, and when obeying the mentioned law upon increasing speed leads to decreasing rotation, propulsion power is decreased, so it should use additional fan for propelling in high speed flight instead of utilizing lifting power possibility of primary actuator.

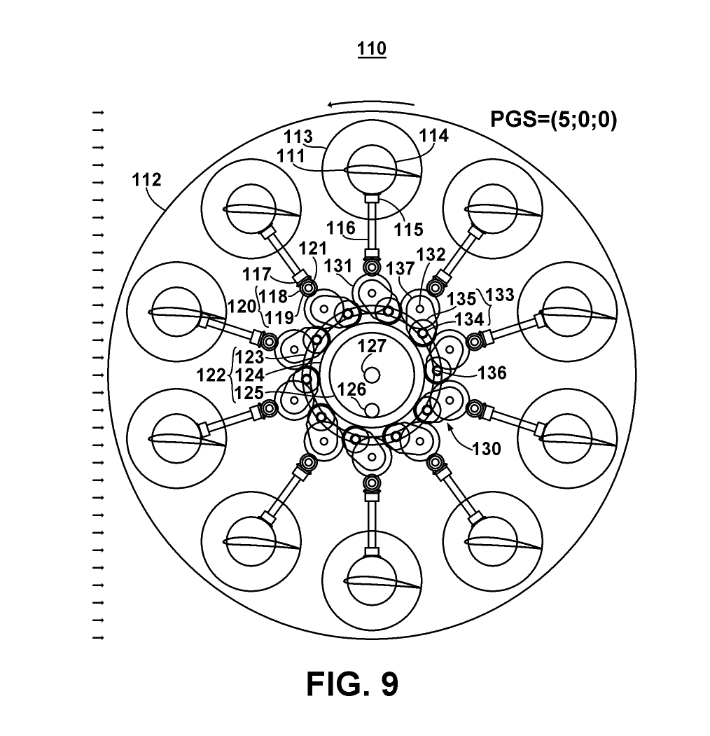

FIG. 9 represents cinematic scheme of rotor used in preferred embodiment. The scheme performed in a manner, which indicates actual clearance of neighbored pieces and ensures missing of any collisions. The view should be understood as transparent projection depicted selected internal elements to faceplate 112 of the rotor 110. Any intersections of selected elements on the scheme mean overlapping those elements in separated plans. The picture represents the rotor 110 in neutral articulation with PGS=(5;0;0) relative to base airflow and with indicated rotational direction, which is appropriate for the particular articulation. The rotor 110 has a faceplate 112, on which mounted elements, which supports shafts of wings 111, those elements and shafts of wings aren't pictured on the scheme. The wing 111 has a circular base 113, which is integral part of the wing 111. A bevel gear 114 with big diameter mounted on the circular base 113. A bevel pinion 115 meshed with bevel gear 114 and mounted on shaft 116. Other end of shaft 116 has a miter gear 117, which meshed with miter gear 118 of cluster 120, which fixed on shaft 121. Other component of the cluster 120 is a pinion 119, which meshed with pitch gear 131 of earring assembly 130. The earring assembly 130 has the mentioned pitch gear 131, fixed on shaft 132, cluster 133, grove follower 136 and shell 137, which can hold a number of supporting bearings. The cluster 133 has a steering pinion 134, which meshed with pitch gear 131, and entry gear 135. A grove follower 136 mounted on the cluster 133 and can move inside of grove ring 123 of cluster 122. The cluster 122 also has a central gear 124, which meshed with entry gears 135 of all earring assemblies 130 and internal gear 125, which meshed with pitch pinion 126. Central powering shaft 127 fixedly connected to faceplate 112.

The cluster 122 with pitch pinion 126 have ability to move in any radial direction up to some limit, changing Gain and Skew of entire PGS state. Shells 134 have some “windows” for pitch gear 131 of neighbor earring assembly 130, preventing collisions upon steering. The pitch gear 131 has its name, because it always synchronized in rotation with related wing 111. The pitch pinion 126 has its name, because its rotation will change Pitch of entire PGS state. The steering pinion 134 has its name, because it directly steers pitch gear 131. Entry gear has its name, because it acts as entry interface for entire earring assembly 130. Pitch gear 131, central gear 124, entry gear 135 and steering pinion 134 are base elements of four gears pitch steering scheme.

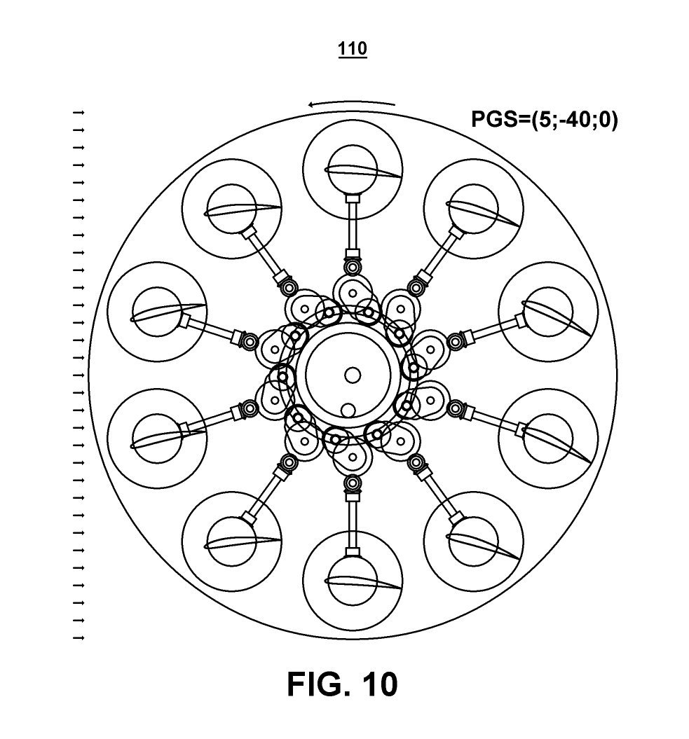

FIG. 10 represents same cinematic scheme as on FIG. 9, but the rotor 110 is in high negative gain articulation with PGS=(5;−40;0), which can be used upon gaining altitude. The scheme demonstrates how will be changed pitches of wings 111 and positions of earring assemblies 130 upon moving entire cluster 122 together with pitch pinion 126 for this articulation. In the high gain articulation still exists the enough clearance between earring assemblies 130, and the applied movement of entire cluster 122 far from maximal.

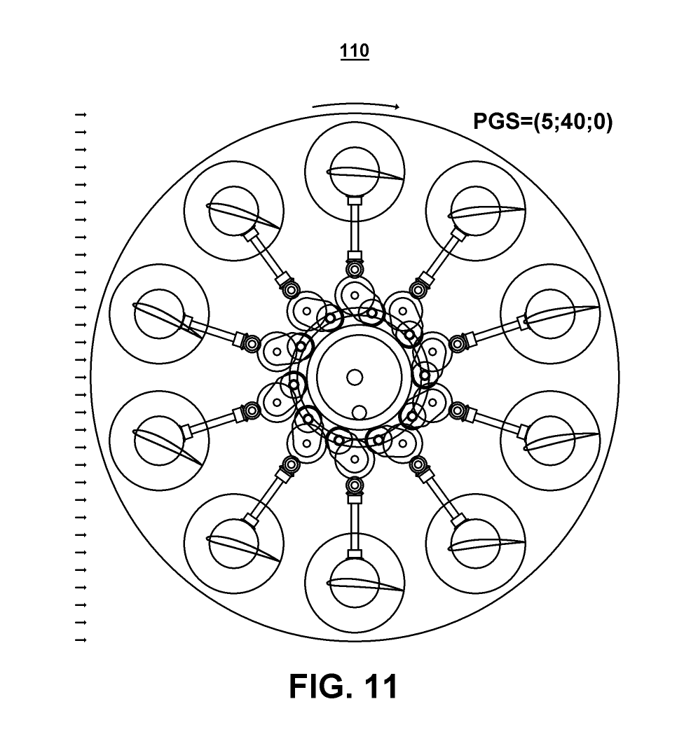

FIG. 11 represents same cinematic scheme as on FIG. 9, but the rotor 110 is in high positive gain articulation with PGS=(5;40;0), which can be used upon recuperative descent. The scheme demonstrates how will be changed pitches of wings 111 and positions of earring assemblies 130 upon moving entire cluster 122 together with pitch pinion 126 for this articulation. Remained clearance here same as for scheme of FIG. 10. Also indicated direction of rotation of entire rotor is opposite, since the articulation related to recuperative descent.

It will be very useful having an end use formulae for obtaining pitch variation of particular wings upon shifting of central gear in four gears pitch steering scheme. The variation will be a function of instant distance between axis of pitch gear 131 and axis of center gear 124. And the variation will be independent from orthogonal offset of the central gear 124 from center of rotor 110 with the fixed distance. The last can be intuitive, but it isn't obvious. However it can be proved upon following thought analyze.

Let central gear 124 moved orthogonal from some pitch gear 131, but their distance will be kept. This movement can be considered as rotation on some angle all four gears participated in steering with frozen meshing state. In such case the pitch gear 131 will obtain additional variation, which is equal of the angle of rotation of the system of those four gears. But in the case, the central gear 124 also should obtain same additional variance as the pitch gear 131, because meshing state is frozen. But actually the central gear 124 is fixed from any rotation by irrotational for this movement pitch pinion 126. And so the pitch pinion 126 will imply a counteraction, which returns the central gear 124 in its original angular position. The reversed rotation of the central gear 124 will break the frozen meshing state of four gears, and pitch gear 131 will also return to its original angular position, because all pitch gears 131 synchronized in their collective angular movement with central gear 124 by equality ratio.

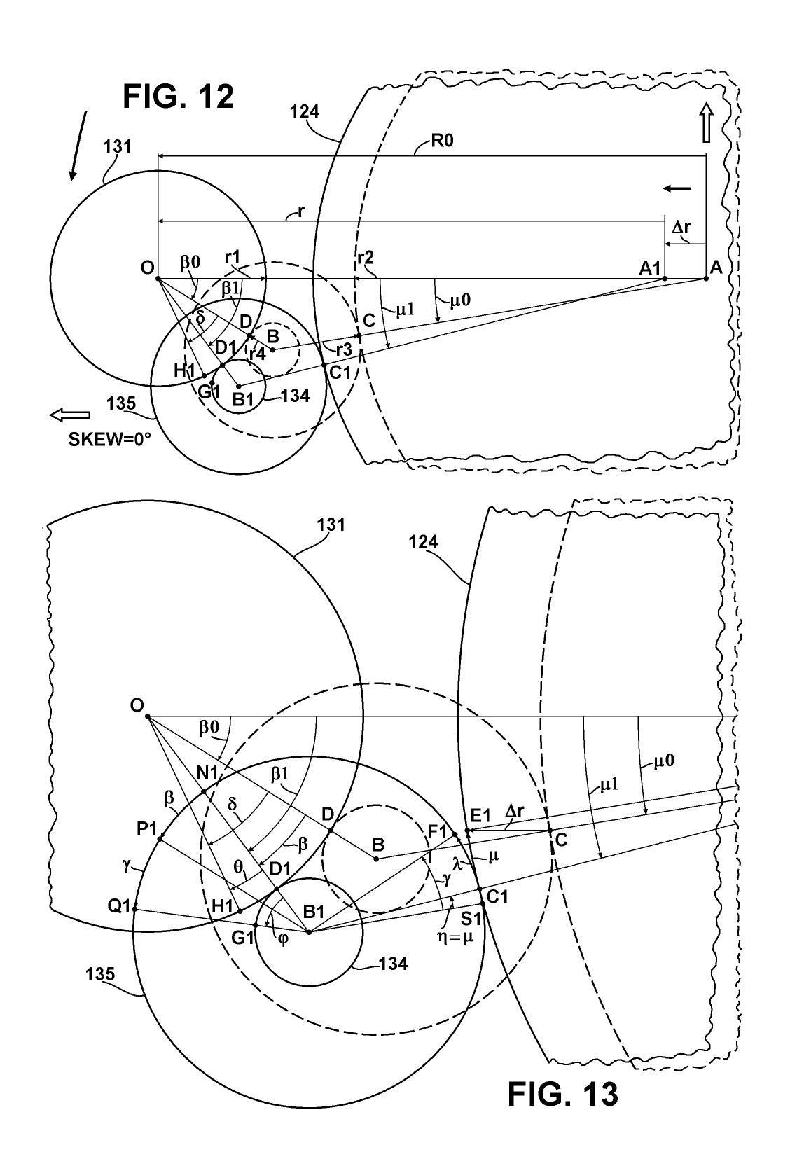

Now let look on FIG. 12 which explains movement all gears relative to some pitch gear 131, upon change its distance from central gear 124. The chart pictures the pitch gear 131 in horizontal position and with zero Skew articulation, but it is invariant for result will obtained. At first, all participated gears have their correspondent radiuses based on their pitch diameters. The pitch gear 131 has radius r1, the central gear 124 has radius r2, the entry gear 135 has radius r3 and the steering pinion 134 has radius r4. At second, there exist a radius of circle where axes of all pitch gears 131 laid. It referenced as R0. At third, there can be build triangle with corners based on axes of pitch gear 131, central gear 124 and cluster 133. In the triangle axis of the pitch gear 131 fixed relative offset, so it referenced by O-letter. Axis of central gear 124 in neutral position referenced as A-letter and axis of cluster 133 referenced as B-letter for this case. In case of offset Δr, last two points will be A1 and B1 respectively. Also for the triangle OAB can be assigned two corner angles for O and A points as β0 and μ0 respectively. And for case of shift they will be referenced as β1 and μ1 respectively. Additionally there can be considered two meshing points: between central gear 124 and entry gear 135 as C-letter and between pitch gear 131 and steering pinion 134 as D-letter. Also for case of shifting they will be referenced as C1 and D1 respectively. And finally pitch variation of the pitch gear 131 upon the shift of the center gear 124 can be referenced as δ and will correspond to reposition of original meshing point D. The point D will be reposed in two instances. One instance will be laid on pitch gear 131 and referenced as H1, and other will be laid on steering pinion 134 and referenced as G1.

The FIG. 13 represents magnified essential part of the FIG. 12 with additionally details for deducing the target variation formulae. At first, there presented reposition of original meshing point C to two points E1 and F1 laid on central gear 124 and entry gear 135 respectively. Here E1 is simple result of offset point C to Δr vector. Changing of angle β0 to β1 upon offsetting corresponds with changing related meshing position, and so angle of this change referenced as β. Also same kind angle μ referenced for other meshing position. And so target angle δ can be considered as sum of angular changing of meshing position β and remainder θ equal to additional rotation, imposed by steering pinion 134 itself. And the angle θ has a complemented angle φ on the steering pinion 134, related to it by simple gear ratio. The angle can be decomposed as sum of common change of meshing position β and angle γ as rotation of entire cluster 133. There angle β secondary pictured as arc between points N1 and P1 on circle of the entry gear 135, where B1P1 is parallel to OB and N1 is simple crossing of OB1 with circle of the entry gear 135. Also angle γ pictured on the circle as arc between points P1 and Q1, where the last is projection of point G1. Angle γ also can be expressed as sum of angle η, as change of meshing position of entry gear 135, and remainder λ. The angle η is equal to μ and pictured as arc on circle of entry gear 135 between points S1 and C1, where B1S1 is parallel to AB. The remainder λ, related to μ by simple gear ratio. So now all components to deducing the target formulae exist.

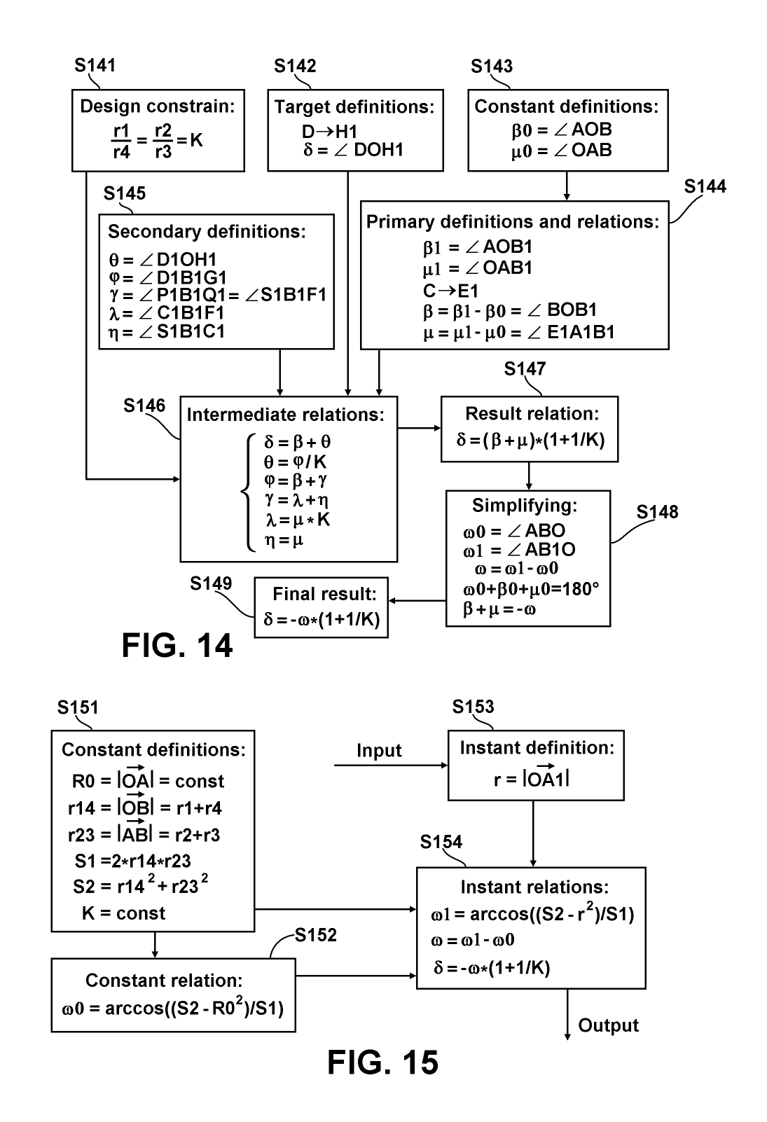

The FIG. 14 represents the entire process of deducing the target formulae by grouping subjects of it. At first, there is one design constrain 5141 of equality of two gear ratios to some K value. At second, there are target definitions 5142 of reposition of primary meshing point on pitch gear 131 with followed definition of variation angle itself. At third, there are two constant definitions S143 for base angles for neutral case. At fourth, there are primary definitions and relations S144 for particular position of pitch gear 131, including base angles for shifted case, reposition of primary meshing point on center gear 124 and simple equations for variations of base angles. At fifth, there are secondary definitions S145, including first remainder at its complementary, angular variation of cluster 133 and second remainder with related change of meshing position. All these four subject fusing together and bring intermediate relations S146, which resolved by simple algebra to result relation S147. The result going to simplifying S148, based on constant sum of angles in triangle, providing final result S149, which states: the pitch variation is equal to product of inversion of variation of summit angle on sum of one and reciprocation of the common gear ratio, where the gear ratio defined as ratio of radius of center gear 124 to radius of entry gear 135.

The FIG. 15 represents data flow and definition for end use application of the pitch variation formulae for particular distance of pitch gear 131 from central gear 124. At first, the application routine should be initialized by constant definition values S151. At second, this initialization should be continued by value from constant relation S152, which based on cosine theorem and provide value of summit angle in neutral case. After it, the routine can acquire input of particular angular position of wing, which equal to angular position of its pitch gear 131 and calculate instant distance, using its instant definition S153. After it, the routine should substitute values from all mentioned subjects to chain of instant relations S154 and calculate the desired variation value for its output.

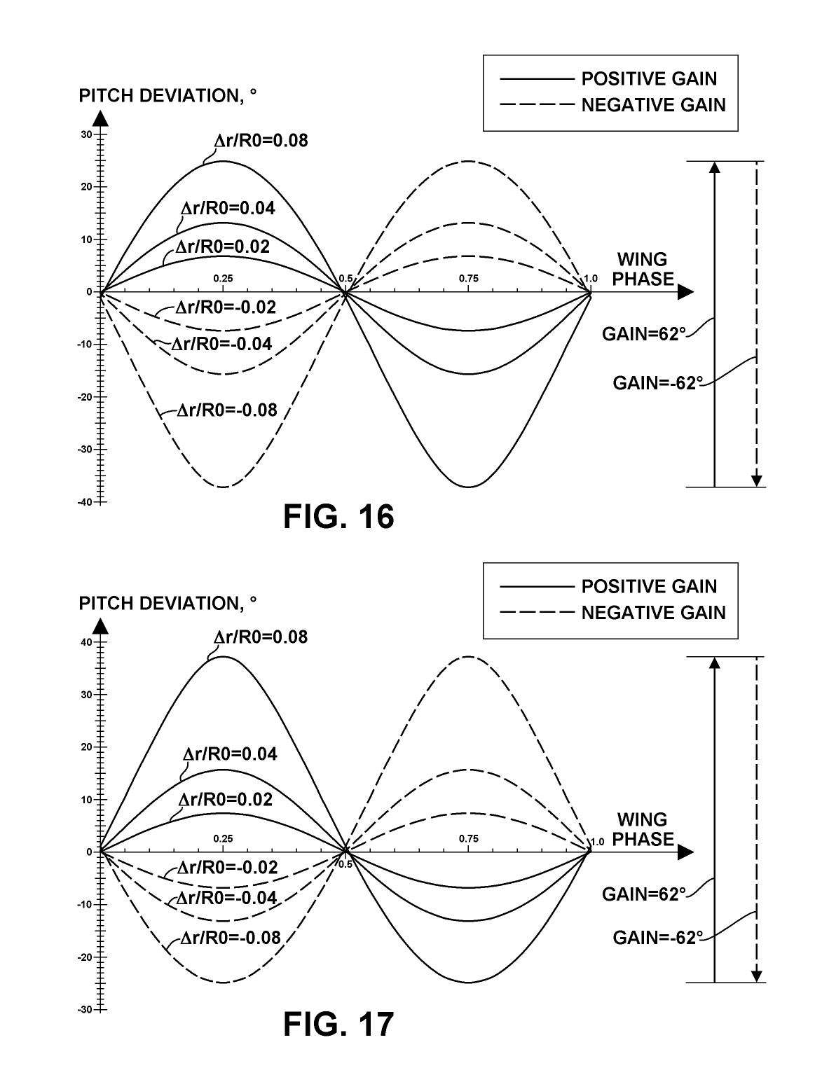

Particular result of using the pitch variation formulae plotted as pitch deviation distribution over entire wings positions of rotor represented on FIG. 16. The result represented for width set of radial offsets of central gear for positive and negative gain. Sign of the Ar value used for reference to some gain selected on such way so it is same as sign of the gain itself. So its ratio to R0 used there as gain parameter, which can be referenced as linear gain. The result corresponds to four gears placement pictured on FIG. 12, which I reference as normal assembling. But cinematic scheme represented on FIG. 9 used other variant of assembly, which I reference as inverted assembling. Correspondent result for pitch deviation distribution over entire wings positions of rotor for case of inverted assembling represented on FIG. 17. There sign of Ar changed for be same with gain itself. The result reflects a some advantage of variant of inverted assembly: main operation modes utilized negative gain and have highly loaded wings near main point near of phase 0.25, so those wings have lower pitch deviation for case of using of inverted assembling, which permits have more exact handling and steering of those wings.

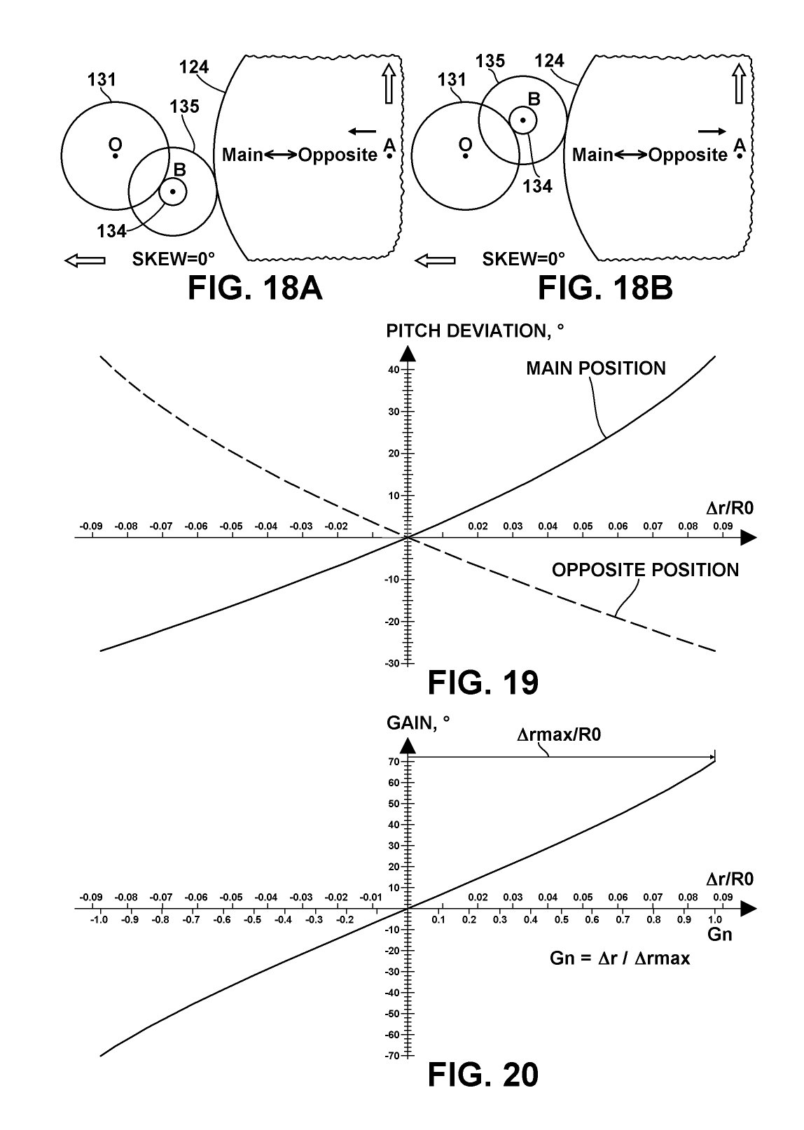

FIGS. 18A and 18B represent features of both normal and inverted assembling respectively by comparative way. For last, entry gear 135 with steering pinion 134 placed in upper elongation relative to pitch gear 131 and center gear 124 on side of zero Skew direction. Also positive direction of linear gain referenced on both charts as black arrow over Main<->Opposite indicator for zero Skew articulation.

Special interest has behavior in change of pitch in main and opposite positions upon changing of linear gain in its entire range. Result of this kind calculation plotted on FIG. 19.

Also can be interesting changing of angular gain itself upon changing of linear gain in its entire range. Result of this kind calculation plotted on FIG. 20. The plot also introduces a linear normalized gain, which is equal to ratio of linear gain to some maximal linear gain related to maximal constructive limit in offset of the central gear, or simple equal to ratio of current offset to its limit. The last definition pictured on the plot below alternative scale based on the linear normalized gain. This normalized variant of gain is very useable for gain indication in case of using mechanical indicator, since mechanics much simpler and exact upon measuring of linear displacement.

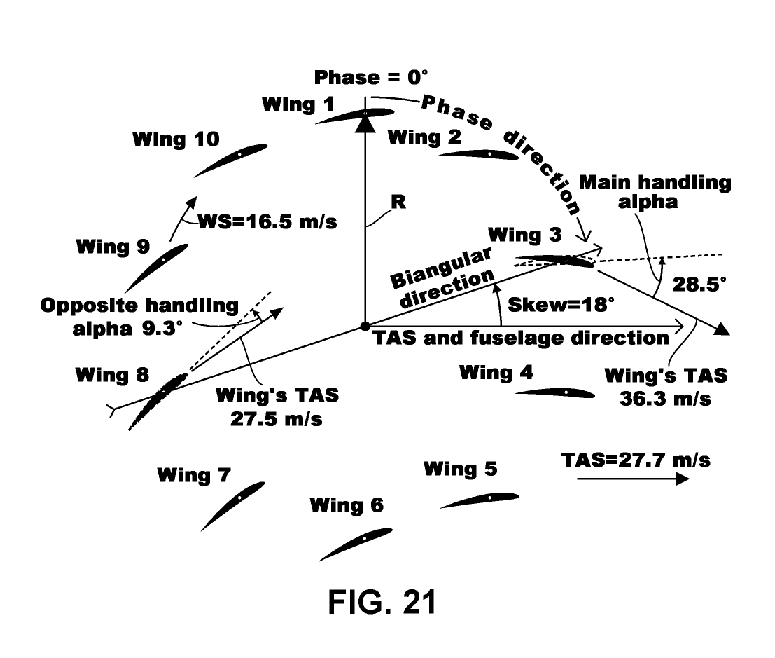

Diagram on FIG. 21 explains high level handling mode, which referenced as biangular handling. The main idea there: the high level handling should have direct relation with angles of attack of wings in two opposite points in some direction. The direction selected to be pointed by Skew angle of PGS state, and so it is equal to gain direction. And so there are two AoAs for main and opposite points. In aerodynamics AoA referenced also as angle alpha. And so I reference those two angles as main handling alpha and opposite handling alpha and they reflected on the diagram, which utilized same PGS state as diagram on FIG. 8. Those two angles represented for Wing 3 and Wing 8. Main difference of the handling from PGS state is using of airflow condition connected to those angles by a way, having those two angles aren't depend from changing of parameters of the flow condition itself. For example, after providing particular values of biangular angles to some flight software routine, they will be constant for any change of airspeed and for any change of winding speed of rotor. The constant behavior will be ensured by correspondent change of P and G components of PGS state by the routine upon measuring changes of airspeed and rotor's winding speed. The diagram presents example of the relation picturing winding speed WS, true aerodynamic speed of entire aircraft TAS, which is parallel to fuselage in the mode of handling and two particular TAS for Wing 3 and Wing 8. Angles of attack relative to those two TAS vectors imply two related pitches for those two wings. Such positions of wings and directions of their chords are depicted on the diagram by dot-line. And they aren't equal to performed actual pitches. This differencing feature reflects special correction of asymmetry of pitch variation imposed by gain to main and opposite points. The correction is significant for high gain values and it is near to zero for low gain. Additionally, for case of existing of some remained error angle between fuselage and TAS vector, the error angle should be in consideration upon handling and should be used for correction resulted PGS-state.

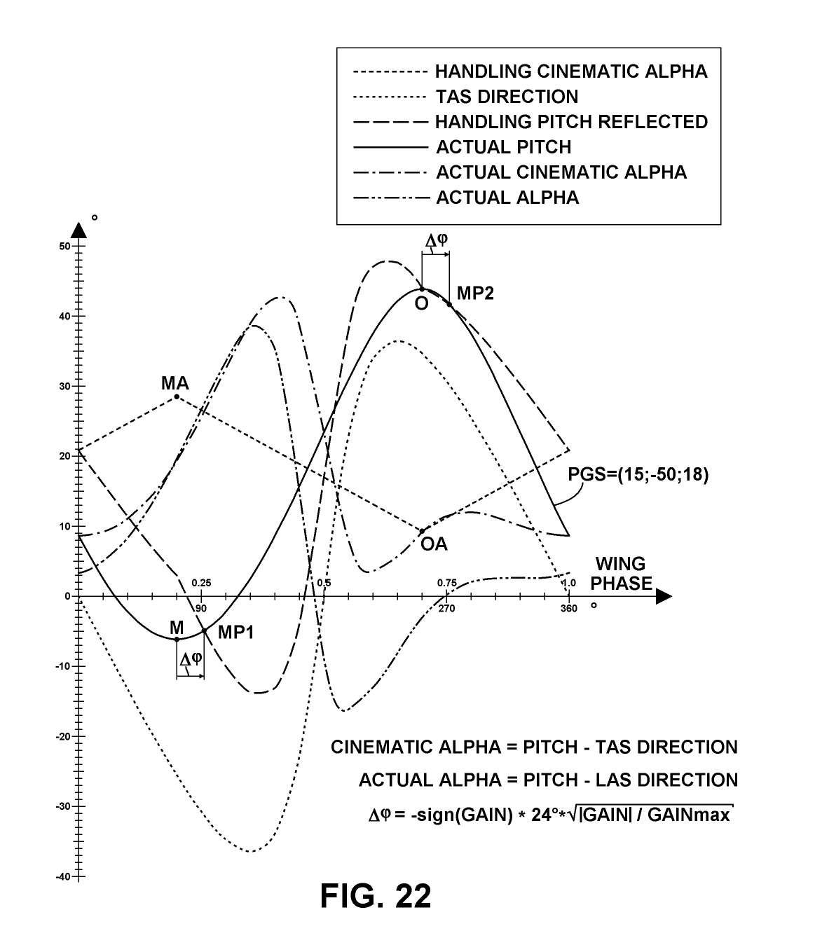

FIG. 22 represents a plot of distributions of all related angular components participated in biangular handling over entire wing positions of rotor for example from FIG. 21. At first, there are values of HANDLING CINEMATIC ALPHA. The word “cinematic” mean the reference flow is simple vectorial sum of TAS of aircraft and cinematic speed component of particular wing for its particular phase. It is not included dynamic perturbations of airflow from actual vorticity distribution over entire rotor. The exclusion means: any handling parameters should be free from all dynamic components, containing some uncertainty errors, for steady referencing. And those biangular values are simple cinematic parameters, although some level of uncertainty can still exists upon measuring the TAS. The primary handling distribution selected to be simple linear between main alpha (MA) and opposite alpha (OA). At second, there are values of the TAS DIRECTION itself. At third there are values of HANDLING PITCH REFLECTED from first relation for cinematic alpha referenced below. Those last values correspond to pitches depicted by dot line on FIG. 21. At fourth, there are values of ACTUAL PITCH resulted from PGS state. Those two kinds of pitch connected by using two match points: MP1, which is shifted from main direction M of PGS state on angle Δφ and MP2, which shifted from opposite direction O of PGS state on same angle. The formulae for the shifting angle represented in third equation at bottom of the plot. It used Gain itself and is simple best rounded approximation for fitting actual pitch distribution to desired handling pitch distribution, which I find through numerical experimentation. The flight software routine used in the equation Gain value from previous cycle of its servicing, since the Gain is also component of target result for fitting match points. At fifth, there are values of ACTUAL CINEMATIC ALPHA, recovered from the first relation referenced below. And at sixth, there are values of ACTUAL ALPHA, recovered from the second relation referenced below. The second relation used LAS instead of TAS. For obtain the LAS, perturbation of base flow by vorticity were split on inflow component and interference distribution component as result of numerical simulation. And the entire result corrects the TAS to LAS.

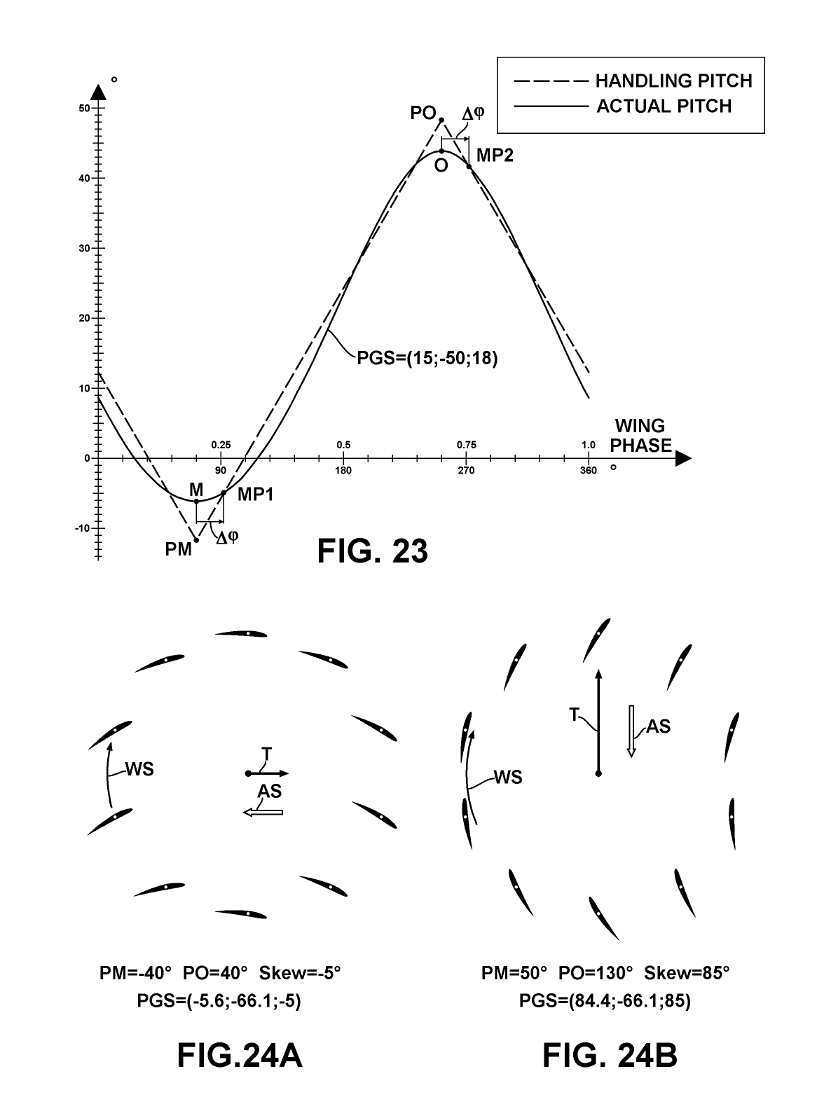

There is also simplified variant of biangular handling mode, which ignored airflow condition, for rare use, which I reference as biangular pitch handling. FIG. 23 represents a plot of distributions of pitches over entire wing positions of rotor for the case utilizing same PGS state as for biangular alpha handling. The ACTUAL PITCH distribution depicted together with values of HANDLING PITCH, which also selected to be simple linear between main pitch (PM) and opposite pitch (PO) as for alpha mode. Matching between two kinds of pitches performs by exactly same algorithm as for alpha mode.

FIGS. 24A and 24B represent diagrams of particular use the biangular pitch handling in a such named “propelling” mode for runway acceleration and for trying vertical takeoff respectively. Those diagrams depict relations of wing articulation, thrust T, winding speed WS and airspeed AS. The main feature of this mode: the P value of PGS is almost same as S value and follows for its change. Here PM and PO values used only for reference. Also thrust force for second case still isn't enough to accomplish it. Also detailed comparative analyze with equivalent rotor operated in curtate mode indicates lower thrust then represented rotor, but also it has a much lower external moment and consumed power. And if enough power for takeoff will be provided for both kinds of rotors, the rotor with curtate movement spends much less power with much lower external moment, but has winding speed much higher then represented rotor, so too high centripetal forces will damage it before this condition.

Before continue to implementation of preferred embodiment of the invention it will be useful to explain correct aerodynamic model for calculation and forecasting of performance the presented aircraft. The model, executed under flight dynamic simulation, provides detailed set of performance values for different flight operations. So I begin with short explanation of relevant aerodynamic aspects of such model.

Base aerodynamic aspect for the aircraft with represented rotor are selection of some airfoil for wings of the rotor and obtain aerodynamic coefficients for section of the airfoil for related range of Reynolds numbers. For any conventional aircraft enough to have three kinds of coefficients: of lift CL, of drag CD and of moment CM, where the last for much of aircrafts used referenced origin on 0.25 of chord. For the presented rotor, having such CM isn't enough. At first I want to use not only symmetric profile, but non-symmetric also, which can provide some advantage in performance. Such profile also has steady moment behavior relative to the 0.25 of chord. But its value itself is too high for steering the airfoil by gear, instead of moment for symmetric airfoil, which is near to zero. So position of pivot for it should be optimized upon moving it more to trailing edge direction, as it pictured on the cinematic scheme on FIG. 9. So having CM values for some particular origin isn't enough due the optimization can be changed. So instead of having a particular CM better is having a coordinates of center of entire aerodynamic force, from which CM for any particular pivot position can be simply calculated. I reference those coordinates as airfoil aerodynamic aggregations CFx and CFy for X and Y coordinates of center of force respectively.

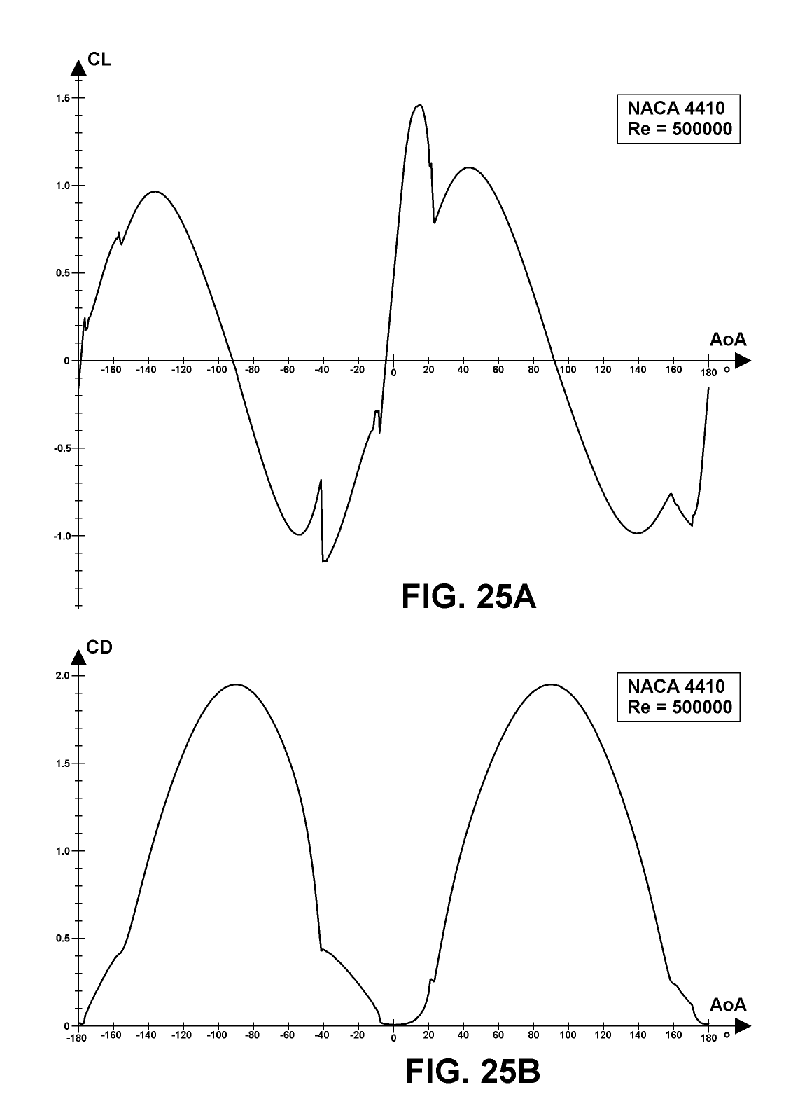

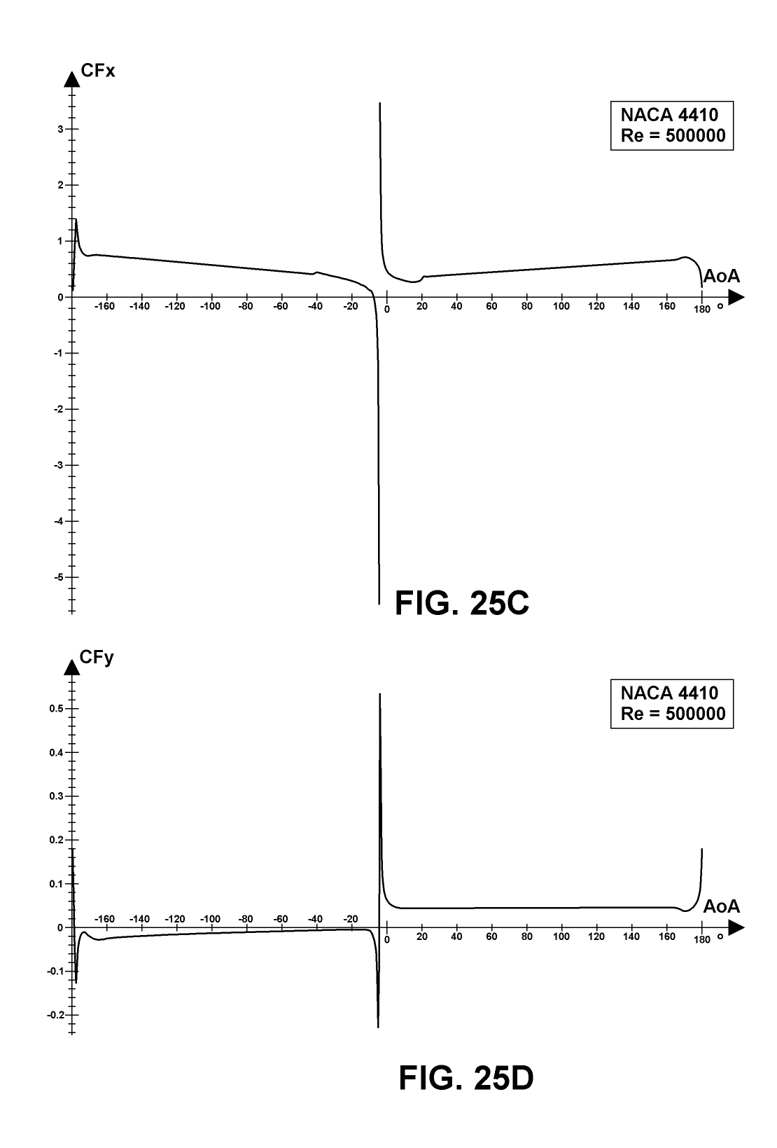

Also it isn't still enough. Wings of presented rotor operating always in prolate mode. And in beginning of acceleration of the aircraft on runway its winding ratio WR is higher than 1. It leads to AoA more than 90° for particular wings, but with lower speed, when the drag is moderate. So I need aerodynamic coefficients and aggregations for entire 360° range of possible AoAs for having enough freedom. Also range of airspeed values over all operations is very width. And Mach number can be ignored from relative low speed aircraft. So finally, there need set of four coefficients and aggregations for entire 360° range of AoAs with width range of Reynolds numbers. So I prepared such set of aerodynamic data for NACA 4410 airfoil in a form friendly for simulation by using composition of the data from multiple sources such as XFOIL paneled simulation, CFD modeling for viscid and inviscid flow and refactoring public data of wind tunnel testing. The data possess some level of uncertainty, but it cannot impact on result of entire simulation on significant level. Examples of distribution of CL, CD, CFx and CFy over entire 360° angles of attack for Reynolds number 500000, used in the flight dynamics simulation, represented as plots on FIGS. 25A, 25B, 25C and 25D respectively.

Next aerodynamic aspect is related with induced drag. It is routine practice for airplanes using special formulas for calculate induced drag and related correction of lift for a given aspect ratio. Those formulas reflect changes in drug and lift created by influence of inflow, depended from lift distribution over wings. But the practice isn't applicable for modeling powered actuators, like the presented rotor or rotor of helicopter, because the modeling implies to know particular lift and drag of each particular wing of rotor. And simple application of mentioned formulas on each separated wing isn't correct, due mutual influence of wings. This problem simple resolved upon knowing the inflow itself. And so the next aerodynamic aspect for the presented rotor is calculation of the entire inflow.

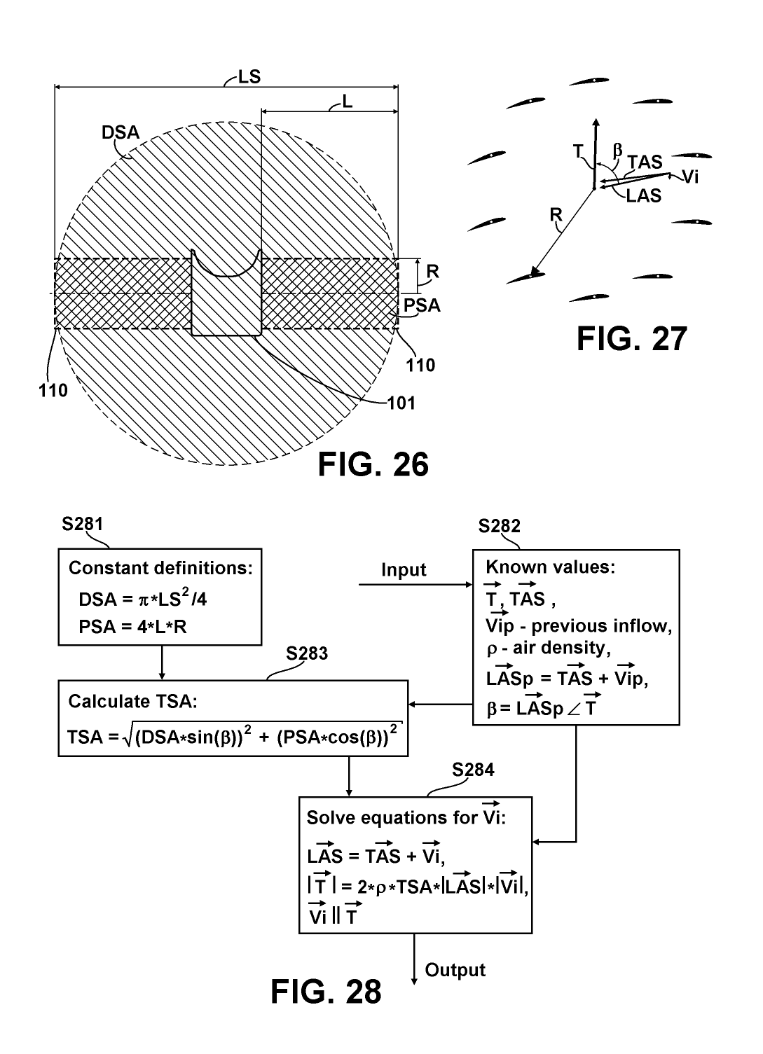

The inflow has simple relation with thrust specific area (TSA) of actuator. From lifting line theory and from point of view of momentum theory of actuators is known: for monoplane with elliptically load wings toward wingspan direction the TSA is simple area of circle based on the wingspan diameter. But presented rotor isn't having the elliptical load distribution. It has presumable equal load distribution. This kind of distribution also very useable for monoplane modeling and it implies some coefficient of efficiency, reflected additional increasing of induced drag due non-constant distribution of induced speed, which is practically above 0.85. But presented rotor from glider's point of view isn't a monoplane. For much of flight operations it can be substituted as tetra-plane with average wing separation about 0.05 to 0.07 of wingspan or as a bit under-performing triplane with average wing separation about 0.075 to 0.1 of wingspan. From work of L. Prandtl “Induced drag of multiplanes”, published in NACA TN 182, 1924, can be simple find a coefficient of induced drag of that triplane over equivalent monoplane. It lays between 0.852 and 0.824 for the referenced wing separation range respectively. This decreasing of induced drag will overlap that increasing due the non-elliptical load. So for having pessimistic appreciation it can be assumed: induced drag of the presented rotor is equal to induced drag of elliptically loaded equivalent monoplane. And so, going from induced drag to inflow, TSA of the presented rotor in case of gliding will be area based on its wingspan LS, as it presented on FIG. 26. I reference the area as downwash specific area (DSA), since it has direct logical connection with downwash feature. Impact of projection cross-area of fuselage 101 will a bit decrease the DSA, but from other side it will a bit increase wings separation of equivalent triplane, so I neglected this impact. The presented rotor exhibits also other kind of TSA: it is propulsion specific area (PSA), which is actualized upon beginning of acceleration on runway. I selected the area as sum of cross-areas of two cylinders based on both rotors 110 with radius R equal to distance of pivot axes of wings from center of rotors and length L for each.

Other parameter need for calculation inflow is trust specific angle, which simple referenced as β. FIG. 27 explains its relation with thrust and airspeed. The inflow moderates TAS to common LAS of rotor. And that LAS has some angle relative to thrust vector. It is the β angle. Its impact on inflow is follows: when the β equal to zero, the rotor performs as pure propeller with TSA equal to PSA and when the β equal to 90°, the rotors performs as pure glider with TSA equal to DSA. In any intermediate case the TSA can be calculated by simple quadrature formulae based on both orthogonal components and the angle β. It is interesting, for helicopter those both areas PSA and DSA are equal, when PSA considered for hovering, so practically helicopter has constant TSA.

The FIG. 28 represents data flow and definition for calculation the inflow. At first, there are constant definitions 5281 for DSA and PSA. At second, there is input of known values 5282, including thrust vector T, TAS vector, vector of previous inflow Vip, air density ρ and also chain calculates values of previous LAS vector LASp and β angle. The process continues in calculation TSA in 5283 with presented quadrature formulae, which utilized DSA, PSA and β. Resulted TSA enters together with TAS and thrust vectors into routine 5284 for solve equations based on the desired inflow vector Vi. Those equations consist from: equation for presumed total flow LAS; scalar equation reflected moment conservation law based on presumed total mass flow and magnitude of unknown inflow; and relation for restoring entire inflow vector. The routine resolves two first equations together by using iterative Newton method and restores the entire inflow vector to output.

Third aerodynamic aspect is interference of wings of rotor. Each wing has its own vorticity, which impacts on base flow of other wings. This changing in base flow of other wings changes their lift forces. And changing of lift forces reflects in changing of vorticity. And so there are loops with mutual dependences. Final correct distribution of airflow over wings permits correct substitution of aerodynamic coefficients and aggregations for obtaining correct distribution of forces and moments.

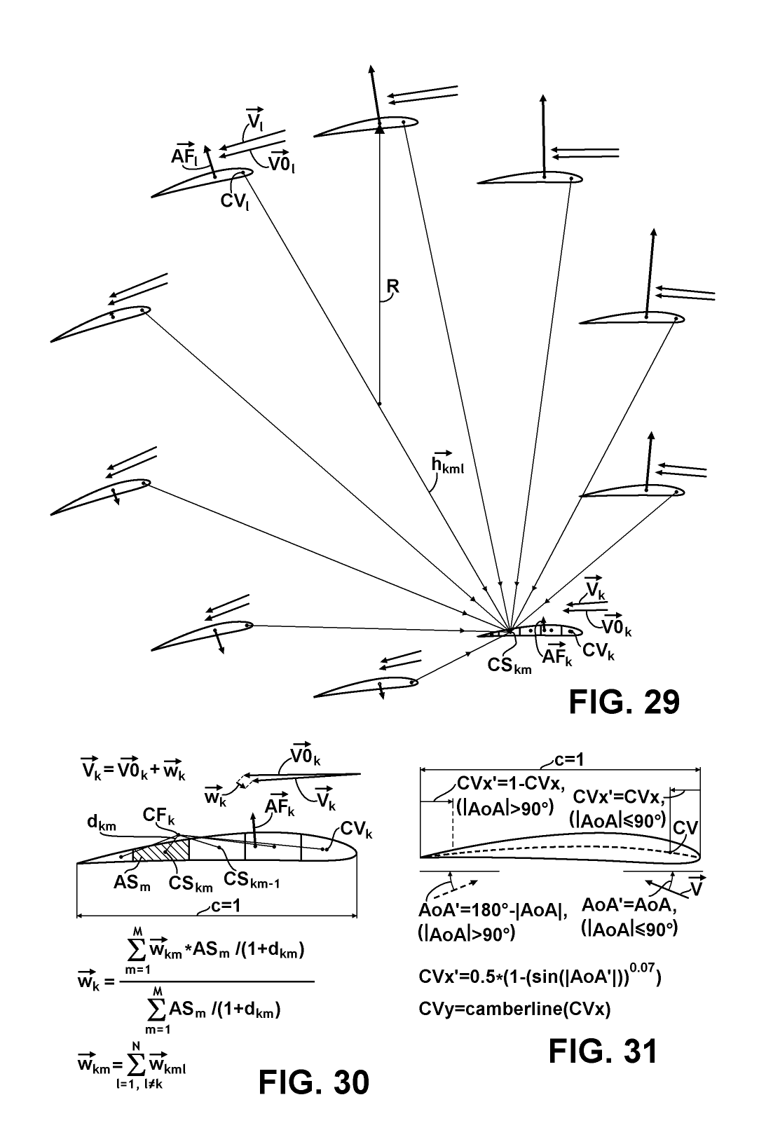

For modeling this aspect I divided each of N wings on M segments along their chord. It permits define an elementary influence of all vorticities from all other (foreign) wings on those segment as it explained on FIG. 29. The chart depicts wings of rotor with typical distribution of aerodynamic forces AF, base flow speed vectors V0 and actual speed vectors V. Those V0 vectors already have inflow included and those V vectors are simple individual LAS of related wings. Each wing also has its own center of vorticity CV. Wing with index “k” is current destined wing. Its m-th segment receives superposition of induced speeds from CVs of all other wings, where wing with index “l” is current source wing. Radius-vector from l-th CV toward center CS of m-th segment of k-th wing referenced as h-vector with index combination “kml”.

The FIG. 30 represents the magnified k-th wing from the FIG. 29 and explains how induced speeds “w” from all segments of wing contributed to common induced speed. I reference it as consolidation of interference induced speed vector over entire wing. For this consolidation I simple use weighting formulae, which referenced under the shape of the wing. Weighting parameter in the formulae is ratio of area AS of particular segment “m” to sum of distance to center of aerodynamic force CF for the k-th wing with chord length, which is equal to 1 upon normalization. All constituents of the consolidation formulae depicted and defined on the chart. And at bottom of the chart simple superposition formulae represented for calculation of induced speed on segment itself. On up simple formulae provides result for the k-th V-vector.

The FIG. 31 explains calculation of position of the center of vorticity (CVx;CVy) on wing dependently of AoA. The center of vorticity itself isn't actually exists, since general symmetry of vorticity distribution is too complicated for it. And so it is only approximation for it. At first I find main AoA′, which equal to AoA for first and fourth quadrants of the angle and equal to 180°−|AoA| for others. After it, I find main CVx′ value by first empiric formulae at bottom of chart. And resulted CVx will be equal to the CVx′ for first and fourth quadrants of the angle and equal to 1-CVx′ for others. CVy calculated simple as y-coordinate of camber-line of the used airfoil for the CVx coordinate. The approximation simple reflects the fact of concentrating vorticity toward related leading edge of airfoil for high AoAs.

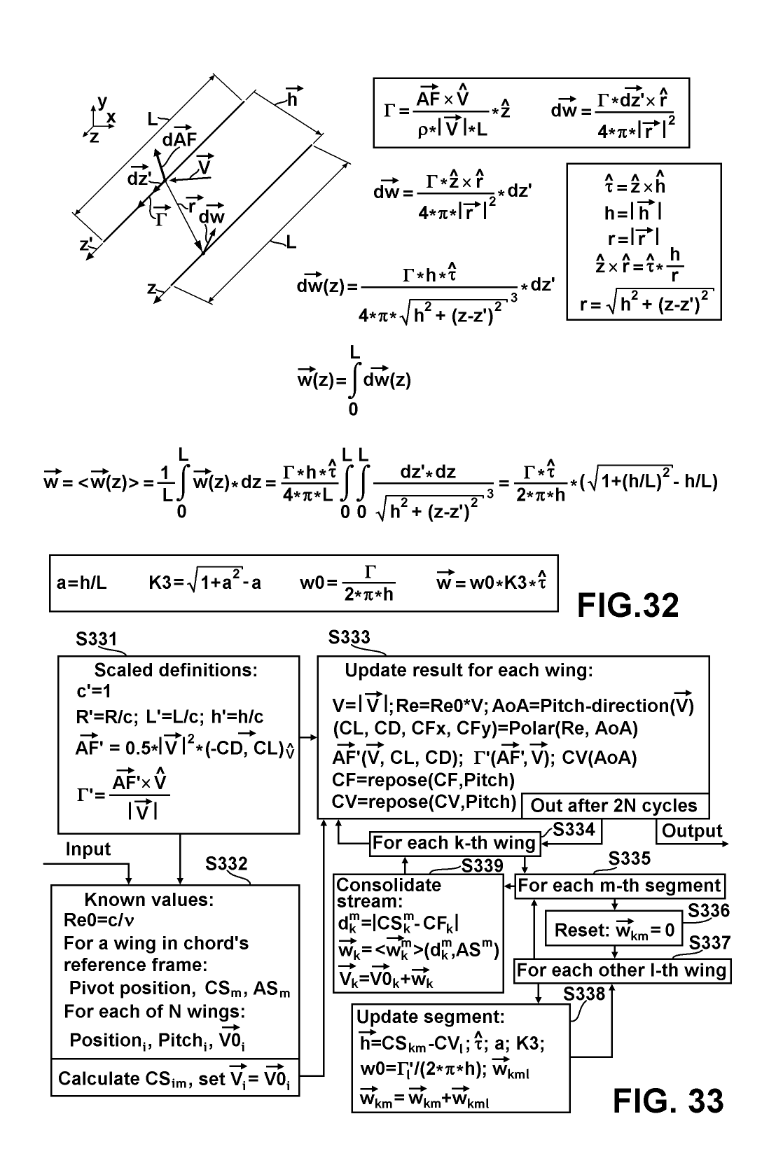

Center of vorticity and counter-parted center of segment aren't points. They can be considered as linear segments with length of wing L, with presumed flat distribution equal to vorticity distribution from equalized load distribution sources, having same average load as actual wing. So there need some specific formulae, based on correct integration on both sides for calculating the elementary value of induced speed. The FIG. 32 explains deducing of the formulae. It has in upper-left corner a 3-d charts depicts linear vorticity source and linear center of destined segment. Those both linear elements oriented in z-direction. Y-direction is on up and x-direction is on right. Z-coordinate on sourced segment designated as z′, and for destined segment: simple as z, for separating different integration variables. Vector-h from FIG. 29 also represented there. The chart depicts infinite small inducing action of speed from some sub-segment on sourced segment to some sub-segment of destined segment. Length of sourced sub-segment is spatial differential dz′ and length of destined: dz. The sourced sub-segment possesses some differential value of aerodynamic force vector-dAF, oriented perpendicular the segment and some value of circulation vector-F, oriented along the segment, where both induced by speed vector-V of the segment. Those two differential sub-segments connected by r-vector. And on destined sub-segment exists induced differential speed vector-dw, which is perpendicular to r-vector and destined segment. On upper-right side of the chart in common frame referenced two base equations. The first is reversed formulation of Joukowski theorem for case of equally loaded wing, which relates signed scalar circulation Γ with cross-product of entire aerodynamic force AF and vector-V. Second equation in the frame is Biot-Savart law for induced speed, which relates differential of it with cross-product of projection of circulation on vector-dz′ and vector-r. Under the frame expressed Biot-Savart law, which reorganized to have scalar dz′ differential on its right side. A frame on middle-right side of the chart introduces normalized t-vector, which is cross-product of normalized z-vector and normalized h-vector and it is simple direction of dw-vector. Also the frame contains simplified notation for magnitudes h and r vectors as simple h and r, expression for cross-product of normalized z-vector and normalized r-vector, which utilized the normalized t-vector and ratio of h to r, and expression for r as function of z and z′. The last two expressions substituted in equation for vector-dw from first line outside of the frame and represented at second line as function from z. The third line has a simple expression of integration of the z-functional differential dw over entire length of sourced segment. Forth line expresses resulted elementary induced speed vector-w as result of averaging spatial distribution of the induced speed vector over entire length of destined segment. So after substitution of the first integral, there is double integral expression, which resulted to simple algebraic formulae upon resolving those two integrals, using tables of integrals. Finally, a frame on bottom of the chart contains chain form of the formulae, which is friendlier for calculation. At first, there is 3-d aspect coefficient “a” equal to ratio of h to L. At second, there is a 3-d factor coefficient K3 expressed from “a”. At third, there is maximal magnitude of the induced speed w0, expressed by using entire circulation Γ and distance between segments h. And at fourth, there is resulted vector-w expressed as product of w0, K3 and normalized τ-vector.

The FIG. 33 represents data flow and definition chart for calculation state of interference corrected airflow of entire rotor. For simplify the process I use scaling of its constituents to unitary wing's chord, unitary air density and unitary wing's area. But airspeed kept in absolute units. So at first, there are scaled definitions S331, where each scaled component has a′ sign, including chord itself, radius of rotor, length of wings, distances between source and destination segments, formulation aerodynamic force and formulation of circulation, where for last used two-dimensional scalar version of the cross-product. At second, there is input setup of known values S332, which includes Reynolds number ReO=c/ν, normalized on speed, common and constant pivot's and segments' properties and distributions of wings positions, pitches and base flows. And the setup finalized by calculating spatial distribution of centers of segments and setting distribution of initial airspeed equal to respective base flow. After the setup, main cycle for updating result of each wing S333 begins. It includes calculating of speed magnitude, Reynolds number, AoA, querying of aerodynamic coefficients and aggregations, referenced there as Polar, calculating scaled aerodynamic force and circulation, calculating center of vorticity relative chord and reposition CF and CV relative rotor's origin, which is center of rotor. After 2N cycles of this updating completed result passes to output. In other case, the updating cycle continue for updating distribution of airspeeds thyself, beginning from walkthrough of destined wings S334. This walkthrough begins from walkthrough of segments S335, which begins from reset of related induced speed to zero S336 and continue with walkthrough of foreign sourced wings S337. The last walkthrough performs incremental update of current segment S338, which includes: calculation radius-vector from current CV to current CS, calculation direction of induced speed, calculating 3-d aspect coefficient, calculating 3-d factor coefficient, calculating maximal magnitude of induced speed, calculating induced speed itself and accumulating the induced speed on current segment. After it, the last walkthrough S337 continue. After the walkthrough S337 finalized, it returned to continue walkthrough for next segment S335. After walkthrough of segment S335 finalized, there begins consolidating stream S339 for current destined wing. This consolidating used formulation referenced on FIG. 30 (I used there tensorial notation for compactness), which finalized by updating the airspeed of current destined speed. The consolidating returns to continue walkthrough of destined wings S334. The walkthrough of destined wings S334 finished by initiation of next main cycle for updating of result S333.

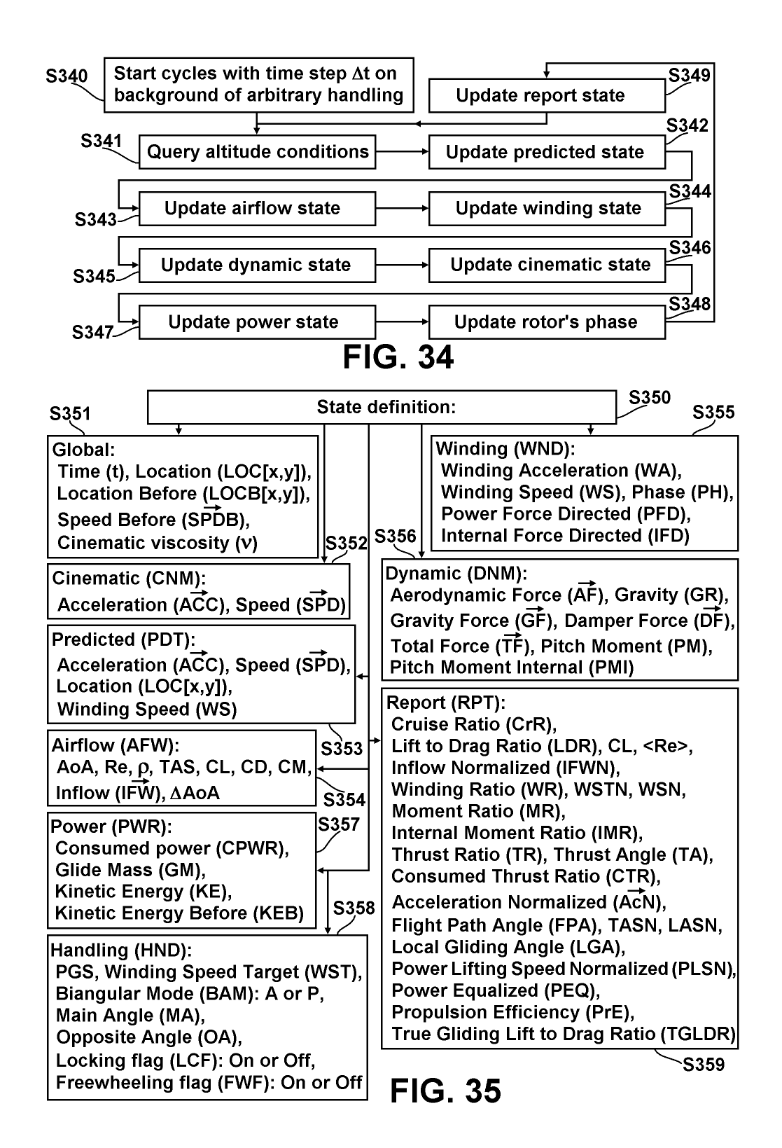

Flight dynamic simulation based on all referenced aerodynamic aspects, base mechanics laws and specific features of the modeled aircraft. Also the simulation generally applicable for aircraft with non-circular actuators, such as aircraft from FIG. 6, or for aircraft without managed PGS-state, such as cyclorotor aircraft operated in curtate mode, upon having known distributions wings' positions and their pitches and corrected inflow modeling for non-circular actuators. Entire simulation process can be considered as data flow inside of some machine state. FIG. 34 represents data flow inside of such machine. The process starts as sequence of cycles with some time step Δt on background of arbitrary handling S340, including supervising of result of the simulation in the background, and includes chain of updates of different components of entire state with order specified on the charts and locked in closed loop. Each specified update has a name, which generally points on updating of existed component of state with same name. But it is only generally, because some updates can update also other components of the state as it further specified in details.

Entire state of modeling aircraft defined in accordance with chart represented on FIG. 35. The entire state definition S350 has nine kinds of data as it specified on the chart, were all specified kinds are applicable to entire aircraft and some from them also to each wing of the rotor on particular manner.

At first, there is a global state S351, which doesn't has a identifier for referencing upon entire update. The state includes: time “t”, location point for current cycle LOC, which can be also referenced as vector, same kind location point for cycle before current LOCB, speed vector for cycle before current SPDB and cinematic viscosity of air ν. Location components of this kind are also applicable for particular wings.

At second, there is cinematic state 5352, which referenced by identifier CNM. It includes acceleration vector ACC and speed vector SPD. This kind is also applicable for particular wings.

At third, there is predicted state 5353, which referenced by identifier PDT. It includes acceleration vector ACC, speed vector SPD, point location LOC and winding speed WS. All components of the state, except the last, applicable for particular wings also.

At fourth, there is airflow state 5354, which referenced by identifier AFW. It includes angle of attack AoA, Reynolds number Re, air density p, magnitude of true airspeed TAS, lift coefficient CL, drag coefficient CD, moment coefficient CM, inflow vector IFW and steering variation of angle of attack by inflow and interference AAoA. This kind is mainly applicable for particular wings and partially for entire aircraft.

At fifth, there is winding state 5355, which referenced by identifier WND. It includes winding acceleration value at rotor radius WA, related actual winding speed value WS, phase of rotor PH, which uses angular position of some zero-wing as origin, powering force PFD, which directed to one of two possible directions, and related internal force directed IFD, which also applicable for locked rotor. This kind isn't applicable for particular wings.

At sixth, there is dynamic state 5356, which referenced by identifier DNM. It includes aerodynamic force vector AF, magnitude of gravity acceleration GR, vector of gravity force GF, damper force from undercarriage on runway DF, total force vector TF, pitch moment of entire aircraft induced by rotor PM or wing's pitch moment and internal pitch moment induced by rotor through its steering mechanics PMI. All components of this state, except DF and PMI are applicable for particular wings.

At seventh there is power state 5357, which referenced by identifier PWR. It includes consumed power CPWR, glide mass GM, kinetic energy KE and kinetic energy for cycle before current KEB. GM and KE components are applicable for particular wings.

At eighth there is handling state 5358, which referenced by identifier HND. It includes entire PGS state PGS, target winding speed for rotor's controller WST, mode of biangular handling BAM, which can have two states: A or P, value of main angle of biangular handling MA, value of opposite angle of biangular handling OA, locking flag LCF, which can have values On or Off and freewheeling flag FWF, which also can have values On or Off. This kind isn't applicable for particular wings.

And at ninth there is report state 5359, which referenced by identifier RPT. It has only dimensionless components, which permit invariant analyze of result of modeling and capabilities of modeled and equivalent aircraft. It has some known kind components and some are new and will be introduced there or in details of their updating. The state includes following components: cruise ratio CrR, which equal to 1 for perfectly balanced power on cruise, equivalent lift to drag ratio of entire aircraft LDR, equivalent lift coefficient CL, average Reynolds number <Re>, normalized magnitude of inflow IFWN, where normalization value will be explained in details of updating, winding ratio WR, normalized target winding speed WSTN, normalized winding speed WSN, moment ratio MR, which is pitch moment normalized on product of entire weight of aircraft and rotor radius, internal moment ratio IMR, which is same way normalized internal pitch moment, thrust ratio TR, which is entire thrust normalized on weight of aircraft, thrust angle TA, which is simple direction of thrust, consumed thrust ratio CTR (see FIG. 1 for CT), which is same way normalized consumed thrust, normalized acceleration vector AcN, which uses current gravity acceleration for normalization, flight path angle FPA, normalized TAS magnitude TASN, normalized LAS magnitude LASN, local gliding angle LGA, which I introduced before upon explanation of splitting power of gravitic thrust, normalized power lifting speed PLSN (see FIG. 1 for PLS), power equalized PEQ, where equalization value will be explained in details of updating, propulsion efficiency PrE, true gliding lift to drag ratio TGLDR, which is LDR free from losses due non-ideal propulsion efficiency. This kind of state isn't applicable on particular wings.

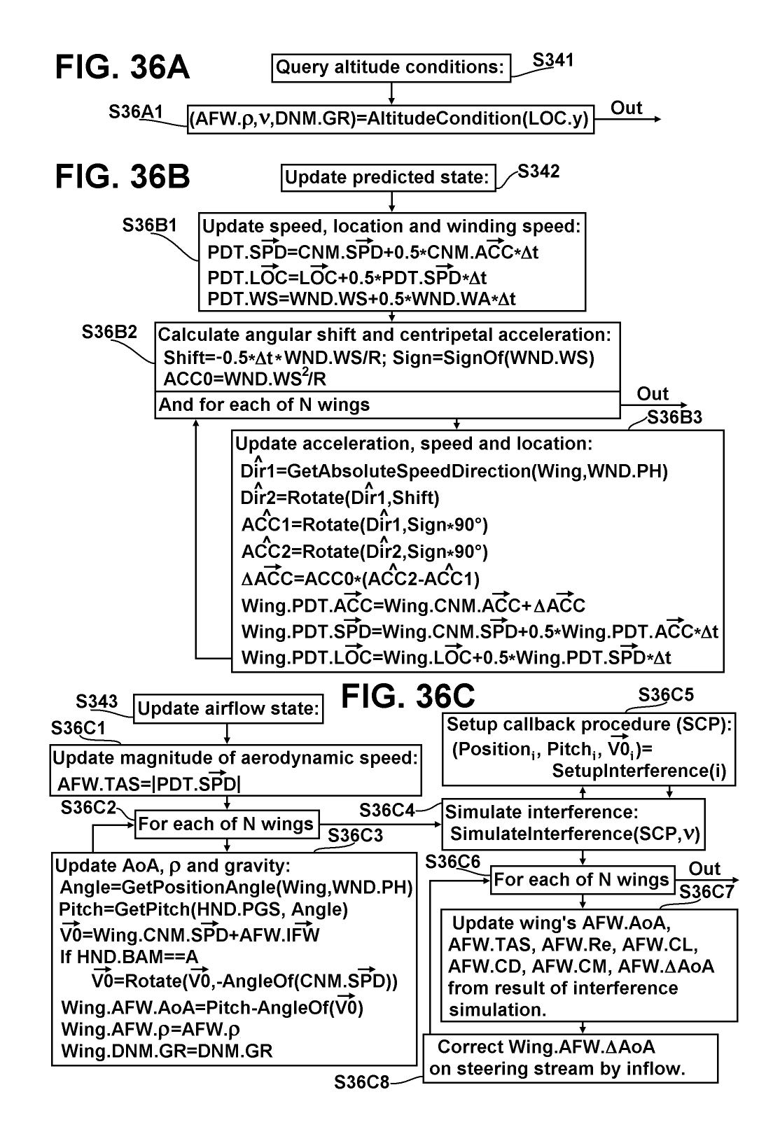

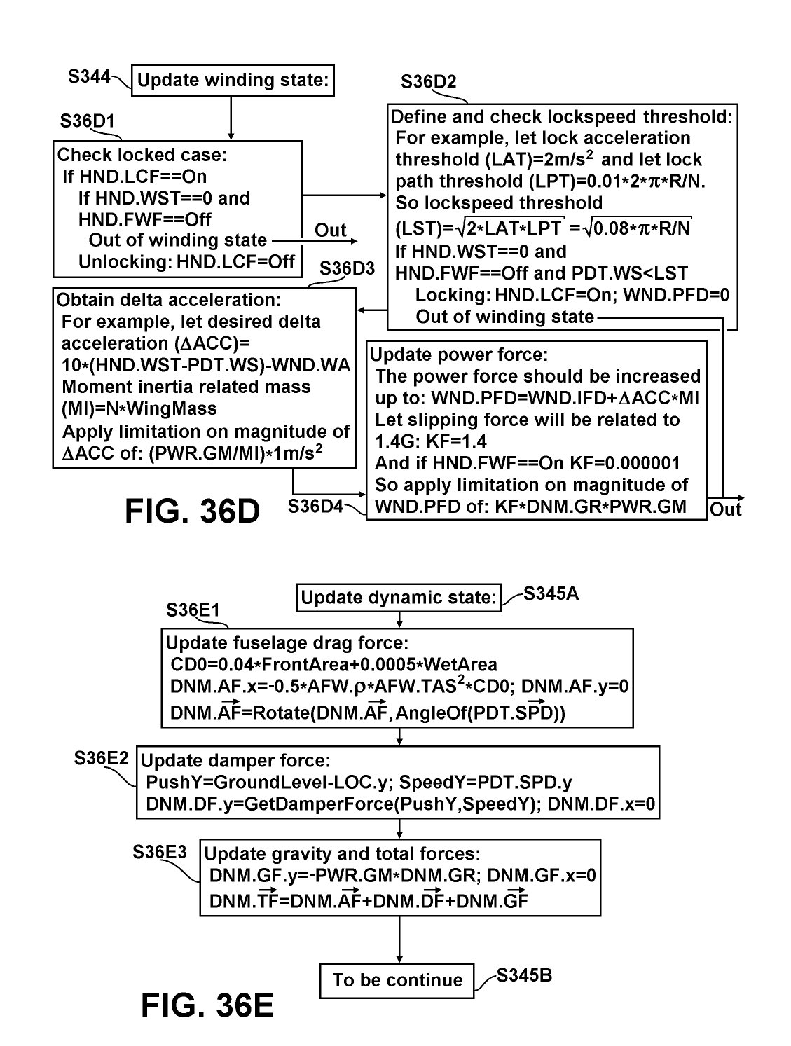

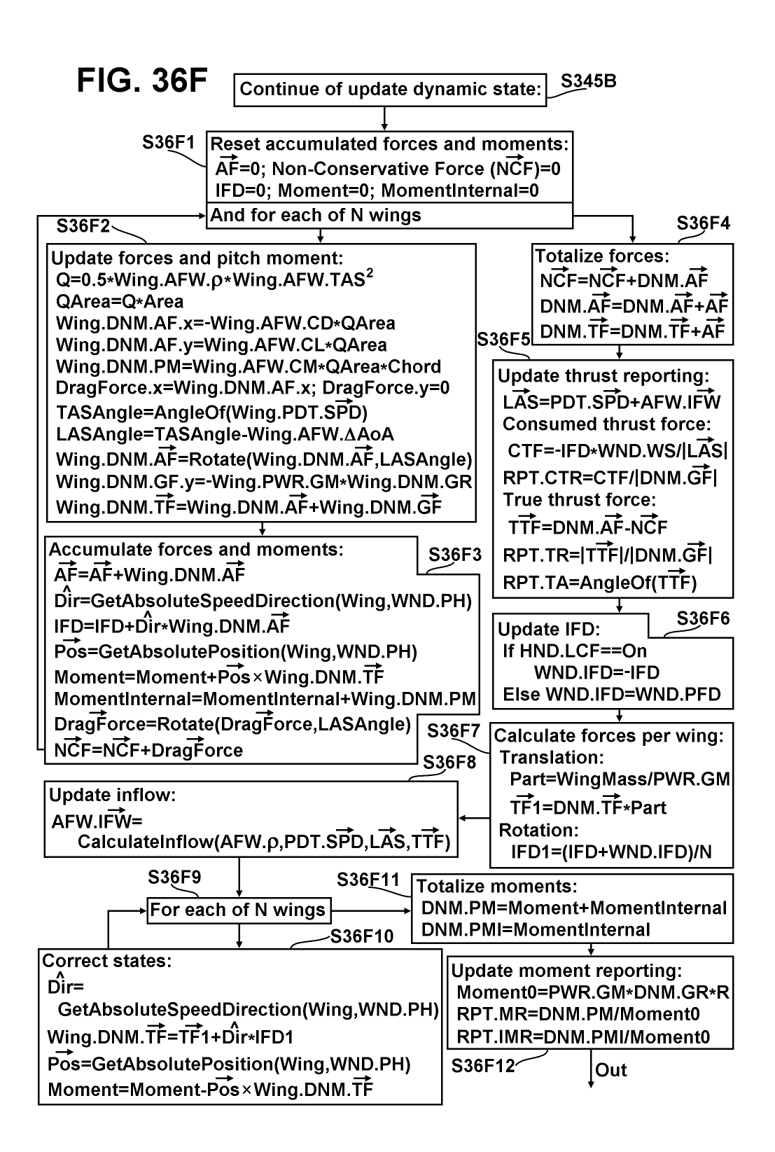

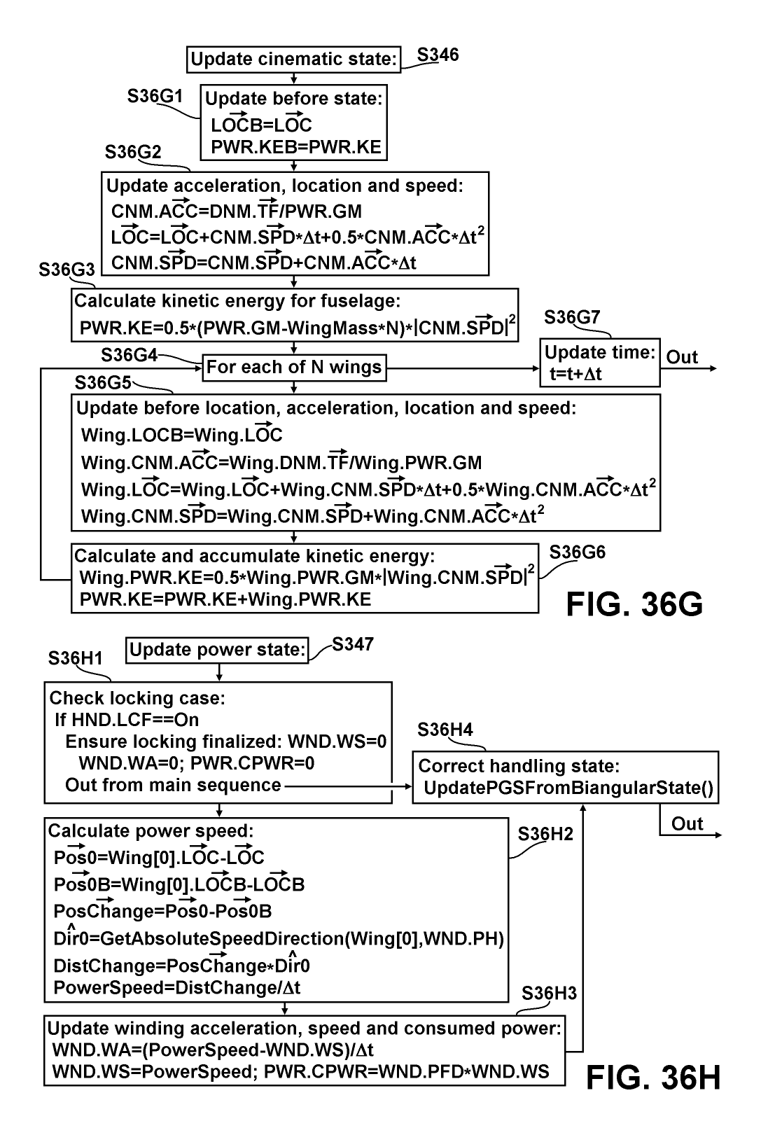

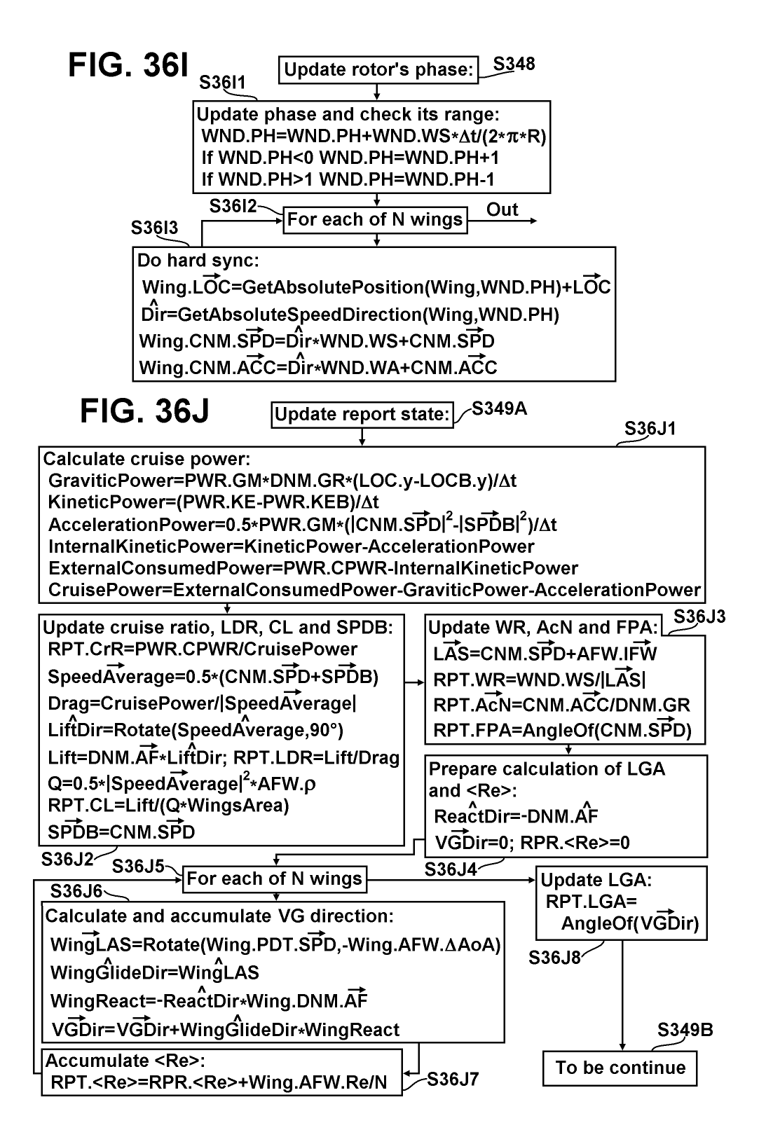

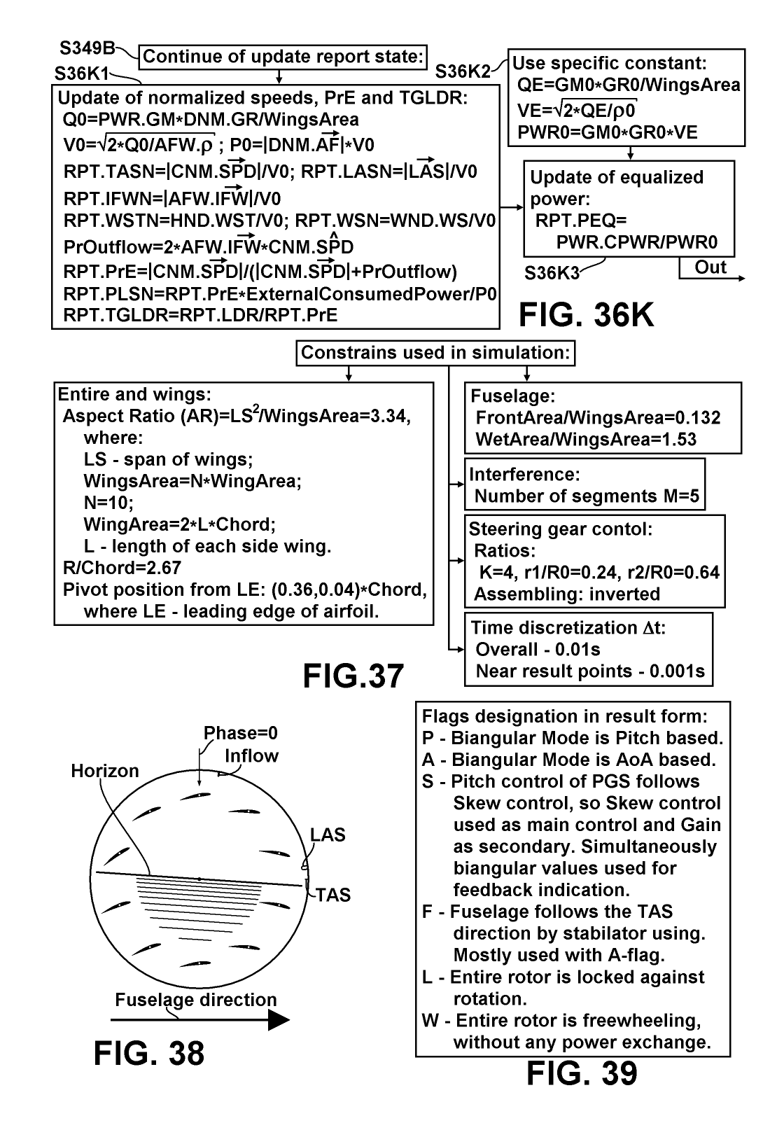

Query altitude condition S341 represented on FIG. 36A and includes process S36A1 with only call the entire query based on standard atmosphere and y-coordinate of location and passing values of air density, cinematic viscosity and gravity acceleration to related components of state.

Update of predicted state S342 represented on FIG. 36B. The prediction based on numerical integration of current cinematic values on half of time-step over their related derivatives. It begins from updating speed, location and winding speed S36B1 of entire aircraft on chain manner, using current values of acceleration and speed of cinematic state for obtain predicted speed, which used in obtaining predicted location. And same logic used for obtain predicted winding speed. Next there followed calculation of angular shift and centripetal acceleration S36B2, which used as preamble of walkthrough of all wings. Here intermediate Shift variable stores predicted angular shift of entire rotor, which is common for all wings, and intermediate variable ACCO stores common centripetal acceleration. Also third auxiliary variable Sign stores actual direction of winding speed. The mentioned walkthrough for current wing consists from updating acceleration, speed and location S36B3. The process begins from obtaining current speed direction of current wing Dir1, using phase of rotor and referencing to the wing by some function, which referenced as “GetAbsoluteSpeedDirection”. Its name is self-explaining and word “Absolute” mean there used referenced frame parallel to horizon, instead of reference frame parallel to fuselage. Next call of simple function “Rotate” provides predicted direction of speed of the wing Dir2, using common predicted Shift value. After it, for each of two directions of speed calculated respective directions of related centripetal acceleration ACC1 and ACC2, by rotating directions of speed on right angle in correct direction, using the auxiliary Sign value. After it, calculated variation of acceleration vector ΔACC by producing common value of centripetal acceleration ACCO on difference between ACC2 and ACC1. This variation used for obtain predicted acceleration of the wing by correcting acceleration from cinematic state. Finally predicted speed and location of wing calculated exactly on same manner as it was for entire aircraft. The update goes out after updating of last wing.

Update of airflow state S343 represented on FIG. 36C and begins from updating magnitude of aerodynamic speed S36C1, using predicted speed value. The process follows by walkthrough of all wings S36C2, which includes updating of AoA, p and gravity S36C3, where last two simple distribution of related values from state of entire aircraft and calculation of AoA performed as follows. At first, there obtained angle of position of current wing relative to fuselage by self-explaining function “GetPositionAngle”, using phase of rotor and referencing to the wing. At second, there obtained pitch of wing relative to fuselage by self-explaining function “GetPitch” using current PGS state and the angle of wing position obtained before. At third, there calculated intermediate LAS vector V0 from TAS of wing and common inflow. At fourth, there performed correction the V0 vector for case when obtained pitch of wing isn't equal to absolute pitch of wing relative horizon. It is case, when fuselage follows direction of stream, practically equal to TAS direction and always used in alpha mode of biangular handling and very rare in other case, so for simplicity I check there the “A” flag. At last the AoA calculated, using values of pitch and direction of V0 in common reference frame. After finalizing the walkthrough S36C2, process goes to simulating interference S36C4 by calling a “SimulateInterference” function, which reused current cinematic viscosity and redirection to some callback procedure for setup initial state of all wings in accordance with requirements of the “SimulateInterference” functionality as it was referenced in explanation for FIG. 31. A setup callback procedure S36C5 called by the “SimulateInterference” for each wing, providing its index “i”. The “SetupInterference” implementation of the procedure provides position, pitch and base flow V0, all for absolute reference frame, as its result, back to “SimulateInterference” function. After the simulating interference S36C4 finalized, process goes to walkthrough of all wings S36C6, which begins with correcting of all end use components of current wing from result of interference simulation S36C7 and continues by correction AAoA value of current wing on steering stream by inflow S36C8, since it was out of scope of interference simulation. The update goes out after the last wing will be proceeding.

Update of winding state 5344 represented on FIG. 36D and begins from checking locked case S36D1. The presented logic means: in case of locking flag isn't set process continues to next entity of the updating, but in other, it can be reset in case of non-zero target winding speed assigned or set flag for freewheeling, and in other case process will go out from the updating. After it, the process follows to checking lockspeed threshold S36D2, which defined, using its relation with acceleration, as it referenced there. Also logic presented there means: rotor will be locked in case of target winding speed assigned to zero and rotor not in freewheeling state and predicted winding speed less than lockspeed threshold. In case of the locking flag will be set to On, directed power force will be set to zero and process will go out from the updating. In other case process follows to obtaining delta acceleration S36D3. From example presented there can be understand, the delta acceleration ΔACC is a acceleration needs to add to current winding acceleration for accelerate rotor, rotated with predicted winding speed, up to target winding speed for time of 0.1 second. Additionally here calculated and applied a limitation for magnitude of the delta acceleration ΔACC, which value is reciprocate proportional to inertial abilities of rotor as it presented there. After it, process follows to updating power force S36D4, which begins from calculating desired directed power force by addition force, implied by delta acceleration ΔACC, to directed internal force and continues by selecting limit of the total winding acceleration. In case of freewheeling the limit selected as very low value, but for other case it is selected as 1.4 g. So magnitude of the directed power force will be limited below value related to the acceleration limit and process will go out from this updating.

First part of update dynamic state S345A represented on FIG. 36E and begins from updating of fuselage drag force S36E1. It based on known values of FrontArea and WetArea parameters of fuselage and result stored as entire aerodynamic force, having only the drag component. After it, process follows to updating damper force S36E2, which begins from calculating two parameters PushY and SpeedY. The first parameter is excursion of undercarriage under load of aircraft, which calculated simple as difference between known GroundLevel parameter and actual altitude. The second parameter simple equal to predicted vertical speed of aircraft. Those two parameters passed to functionality referenced as “GetDamperForce” functions, which calculated the force based on some damping model of typical undercarriage. The force is zero for negative PushY parameter, when undercarriage doesn't touch the ground. For particular case used in the simulation the force considered be vertical, but in generic case it can have some angle on slopped ground. After it, process follows to updating gravity and total forces S36E3, where the last is preliminary balance of all forces known at this point. After it, process continues to remained part of the updating S345B on other page.

Remained part of update dynamic state S345B represented on FIG. 36F and begins from resetting accumulated forces and moments S36F1, which is preamble of walkthrough on all wings. The resetting applies on set of intermediate variables, including accumulators for aerodynamic force AF, for non-conservative drag forces NCF, for internal directed force IFD, for moment “Moment” and for internal moment Momentlnternal. The mentioned walkthrough begins from updating forces and pitch moment S36F2 for current wing, starting from calculation dynamic pressure Q and related stagnation force QArea, which used in followed calculation of lift and drag components of wing's aerodynamic force and its pitch moment, and continued by storing drag force component in separate auxiliary vector variable DragForce. It follows by calculation angle of flow LASAngle, using angle of TAS and stream steering angle for the current wing. After it, entire aerodynamic force of the current wing rotated to correct direction of LASAngle with followed calculation of gravity force and total force of the current wing. After it, the walkthrough goes to accumulating forces and moments S36F3, which begins from accumulating of aerodynamic force and follows by accumulating projection of aerodynamic force on direction of rotation speed to IFD accumulator. It followed by calculation external moment as cross-product of wing's position on its total force with accumulating it to “Moment” accumulator and accumulating wing's pitch moment to MomentInternal accumulator. Last accumulating value is content of DragForce vector variable, which rotated to correct direction of LASAngle and accumulated to NCF vector accumulator. After finalizing the walkthrough, process goes to totalizing forces S36F4, which begins from accumulating NCF by aerodynamic force of entire aircraft, which in the point keeps only the drag contribution, and followed by accumulating the AF vector to aerodynamic force and total force dynamic state components of entire aircraft. After it, process goes to updating thrust reporting S36F5, which starts from calculating LAS vector of entire aircraft, using predicted speed and inflow. The value used for calculating consumed thrust CTF by refactoring it from consumed power based on product IFD accumulator and winding speed. After normalizing on magnitude of gravity force, result stored in RPT.CTR. Next there calculated true thrust force TTF by discarding non-conservative contribution NCF from entire aerodynamic force. Magnitude of the TTF value normalized on entire gravity force and stored in RPT.TR and direction of the TTF value stored in RPT.TA. After it, process goes to update IFD of winding state S36F6. The logic presented there means: if rotor locked assign the target IFD to inversion of accumulated value, but in other case assign it equal to PFD. After it, process goes to calculating per wing forces S36F7, which means: each wing has same back projection of total force upon participation in collective movement. At first, here calculated translation force TF1, using participation coefficient Part of entire total force, which equal to fraction of wing-mass in entire mass. At second, here calculated rotation force IFD 1 as N-th fraction of sum of accumulated IFD and its value from winding state. In case of locked rotor the last will be equal to zero. After it, process goes to updating inflow S36F8, which performed by call a function “CalculateInflow”, which implements functionality explained for chart on FIG. 28, using as input values of air density, predicted speed vector, LAS vector and true thrust vector. After it, process goes to walkthrough S36F9 on all wings, which performs correcting states S36F10, which includes: in first, assigning to current wing total force equal to sum of translation force TF1 and projection of rotation force IFD 1 on direction on the wings rotation speed, and in second, it includes correction of “Moment” accumulator on moment value imposed by wing's actual total force reaction, which is simple moment from inertial force, since true total force is always opposite to inertial force. After finalizing the walkthrough S36F9, process goes to totalizing moments S36F11, where external and internal moments accumulated together to common pitch moment of aircraft and internal moment stored separately. After it, process goes to updating of moment reporting S36F12, where calculated moment normalizing value Moment0, and values of both moments normalized and stored in RPT.MR and RPT.IMR. And so the updating goes out.

Update of cinematic state S346 represented on FIG. 36G and begins from updating before state S36G1 for location and kinetic energy of entire aircraft. After it, process continues by updating acceleration, location and speed S36G2 of entire aircraft, which based on second Newton's law and step-integration over base cinematic equations. It continued by calculating kinetic energy for fuselage S36G3, using updated value of speed. After it, process goes to walkthrough on all wings S36G4, which begins from updating before location, acceleration, location and speed S36G5 for current wing, which performed on same manner like for entire aircraft, and continued by calculating and accumulating kinetic energy S36G6 for current wing and entire aircraft respectively. After finalizing the walkthrough S36G4, process performs update time S36G7 and goes out.

Update of power state S347 represented on FIG. 36H and begins from checking of locking case S36H1. The logic presented there means: for case of locking flag is set, ensure the locking finalized by resetting winding speed, acceleration and consumed power and go out from main sequence to correcting handling state S36H4, but for other case, continue the main sequence going to calculate power speed S36H2. The calculation performed by measuring projection of moving first wing on direction its rotation from its position on previous cycle, as it specified on the chart. The projected offset, referenced as DistChange, permits calculation the PowerSpeed value by dividing on time-step. After it, process continued by updating winding acceleration, speed and consumed power S36H3, using the calculated value of PowerSpeed, as it specified on the chart. After it, process goes to correcting handling state S36H4, by calling function “UpdatePGSFromBiangularState”, which functionality implemented in accordance with handling relations explained for FIG. 22, having up-to-date value of winding speed. And so the updating goes out.

Update of rotor's phase S348 represented on FIG. 36I and begins from updating phase and checking its range S36I1, where the first performed by step-integration of current phase, using actual winding speed and rotor radius, and the second is simple ensures the phase laid in range from zero to one. After it, process goes to walkthrough on all wings S36I2, which performs hard sync S36I3 of current wing, which ensures: its all-cinematic properties are in accordance with constrains of integrity of rigid rotor. After finalizing the walkthrough S36I2, the updating goes out.

First part of update report state S349A represented on FIG. 36J and begins from calculating of cruise power S36J1. The cruise power is simple a power need for performing cruise flight with power consuming equal to all current non-conservative power losses. It calculates by careful analyze of power distribution. At first, there calculated value GraviticPower as trend of changing of gravitic potential energy, using previous value of altitude. At second, there calculated value KineticPower as trend of changing kinetic energy, using previous value of kinetic energy. At third, there calculated value AccelerationPower as trend of changing kinetic energy of center of gravity, using previous value of speed. At fourth, there calculated value InternalKineticPower by discarding the AccelerationPower value from KineticPower value and the result reflects power related to kinetic energy of rotation. At fifth, there calculated value of ExternalConsumedPower by discarding the value of InternalKineticPower from total consumed power. And finally, value CruisePower calculated by discarding values of GraviticPower and AccelerationPower from ExternalConsumedPower. The calculation can be simplified, but this way better explains the power distribution. After it, process goes to updating cruise ratio, LDR, CL and SPDB S36J2, which begins from calculating cruise ratio by dividing consumed power on the CruisePower value. After it, SpeedAverage vector calculated by averaging between current speed and previous speed, which used for calculate equivalent drag component by dividing the CruisePower value on magnitude of the SpeedAverage vector. After it, equivalent lift component calculated by projection entire aerodynamic force to direction perpendicular of the SpeedAverage vector. After it, RPT.LDR simple calculated as ratio of those two components, which follows by calculating RPT.CL using the equivalent lift component, stagnation pressure, based on the SpeedAverage magnitude, and total area of wings. Previous speed vector SPDB updated after it to current speed value. After it, process goes to updating of WR, AcN and FPA S36J3, which begins from calculation LAS vector from current speed and inflow. The value used for calculate RPT.WR by normalizing winding speed on magnitude of the LAS vector. Updating of RPT.AcN vector and RPT.FPA simple follows after it as it pictured there. After it, process goes to preparing of calculation of LGA and <Re> S36J4 by calculating normalized vector ReactDir, which is opposite to direction of entire aerodynamic force and means direction of inertial vertical. Additionally, the prepare resets VGDir vector, which used as accumulator of wings partial impact to LGA direction and RPT.<Re> value, which will be used for accumulation too. After it, process goes to walkthrough on all wings S36J5, which begins from calculating and accumulating of VG direction S36J6 as impact from current wing. At first, there calculated WingLAS vector by rotating vector of predicted speed of the wing to its stream steering angle. At second, its normalized value assigned to WinGlideDir vector, and so it points to direction of gravitic propulsion for the wing. At third, WingReact value calculates inverted projection of aerodynamic force of the wing on direction of common inertial vertical. And finally, the VGDir vector accumulates WinGlideDir vector weighted in WingReact value basis. After it, the walkthrough follows to accumulating of <Re> S36J7, where the RPT.<Re> accumulates N-th fraction of the Reynolds number of current wing, doing the actual averaging. After finalizing the walkthrough S36J5, process goes to updating of LGA S36J8, where direction angle of the VGDir vector assigned to RPT.LGA. After it process continues to remained part of the updating S349B on other page.

Remained part of update report state S349B represented on FIG. 36K and begins from updating of normalized speeds, PrE and TGLDR S36K1. At first, there calculated normalizing stagnation pressure Q0 by dividing current entire weight on total area of wings. At second, there calculated normalizing speed V0, based on the Q0 and current air density. At third, there calculated specific refactoring power P0, based on the V0 and magnitude of aerodynamic force. At fourth, there calculated all remained values of report state with meaning of speed, except PLSN, by dividing related values of other states on the V0, as it specified there. At fifth, there calculated propulsion inflow PrInflow as projection of inflow on TAS direction. At sixth, there calculated RPT.PrE as ratio of TAS magnitude to its sum with PrInflow in accordance with Froude formulae for actuator. At seventh, there calculated RPT.PLSN as ratio of ExternalConsumedPower value to P0, scaled on the propulsion efficiency, by using formulae for PLS from FIG. 1. And finally, true gliding LDR RPT.TGLDR calculated by correcting value of equivalent LDR, dividing it on the propulsion efficiency. After it, process goes to updating of equalized power S36K3, which calculated the RPT.PEQ by dividing consumed power on specific equalization constant PWR0. The specific constant defined and calculated in S36K2 relations as follows. At first, calculated constant equalizing stagnation pressure QE, which based on started mass of aircraft GM0, gravity acceleration on ground level GR0 and total area of wings. At second, constant equalizing speed VE calculated, using QE and air density on ground level ρ0. And finally the specific equalizing power calculated as product GM0, GR0 and VE. After calculation of the RPT.PEQ, the updating goes out.

The self-explaining diagram on FIG. 37 represents simulation constrains grouped by their modalities.

Result of the simulation used charts, where each is kind of reporting form with fixed placement and represents all elements of handling state HND and report state RPT. Also it pictures a Rotor State Indicator (RSI). The indicator and its related features represented on FIG. 38. The horizontal direction of the indicator is always parallel to fuselage, but picture of horizon inside inclined on flight path angle. Wings of rotor always pictured in position having one wing in vertical position exact, where is zero phase, but each wing inclined on angle of its actual pitch. Also there are additional three indicators inside and near of its circular border. The thinnest indicator is TAS direction indicator. The middle width indicator is inflow direction indicator. And widest indicator with bended line over its rim is LAS direction indicator. The RSI also can be used in cockpit instrumentation.

The reporting form pictured all flags of handling state in common field by using designation of particular flags as it defined on self-explaining data definition chart of FIG. 39. It contains also additional flags and explains all flags in details.

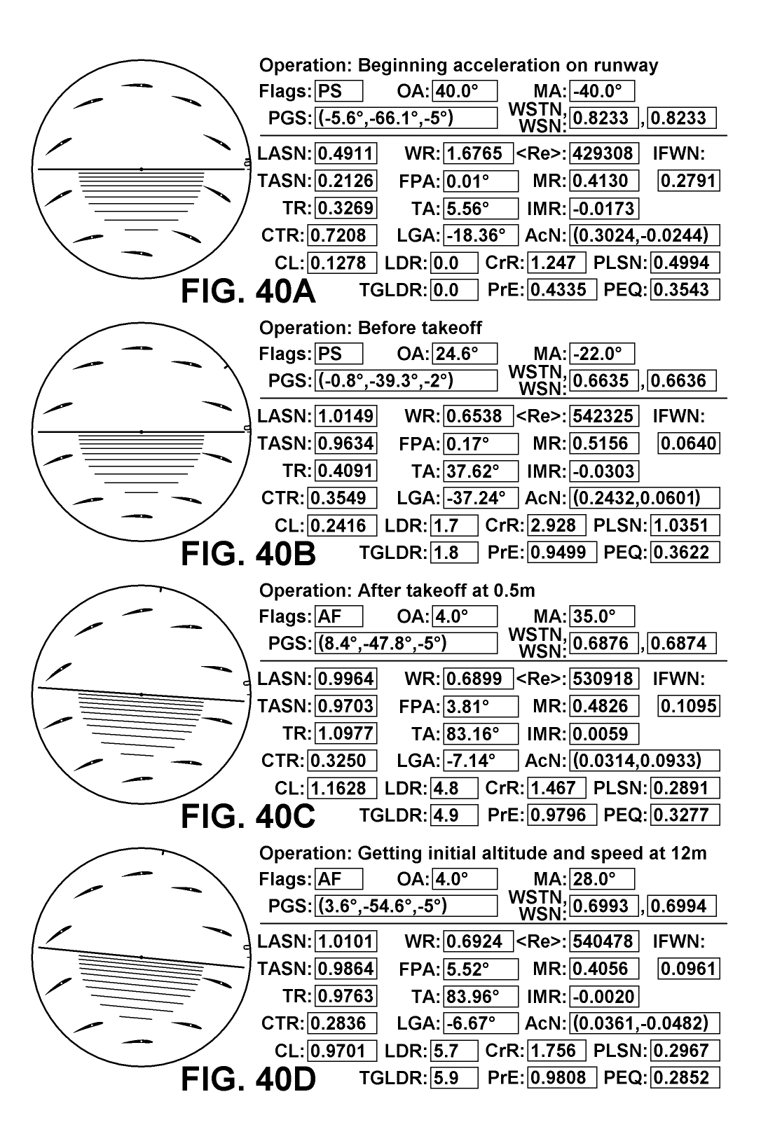

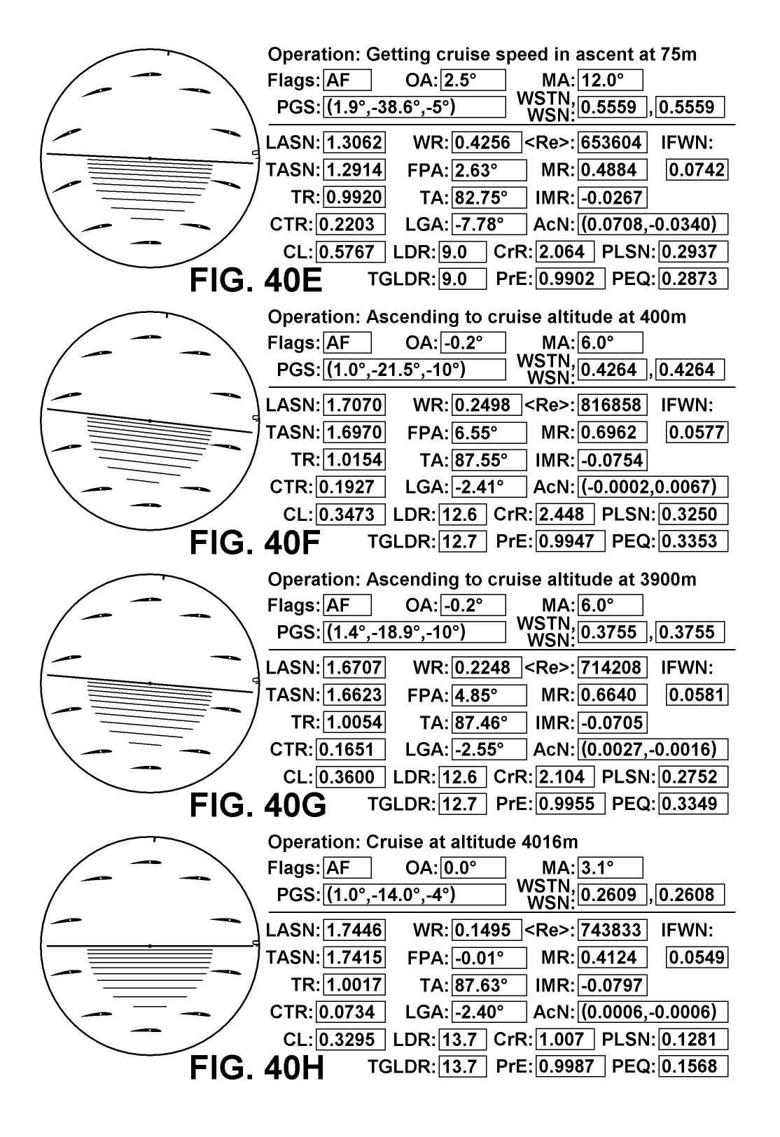

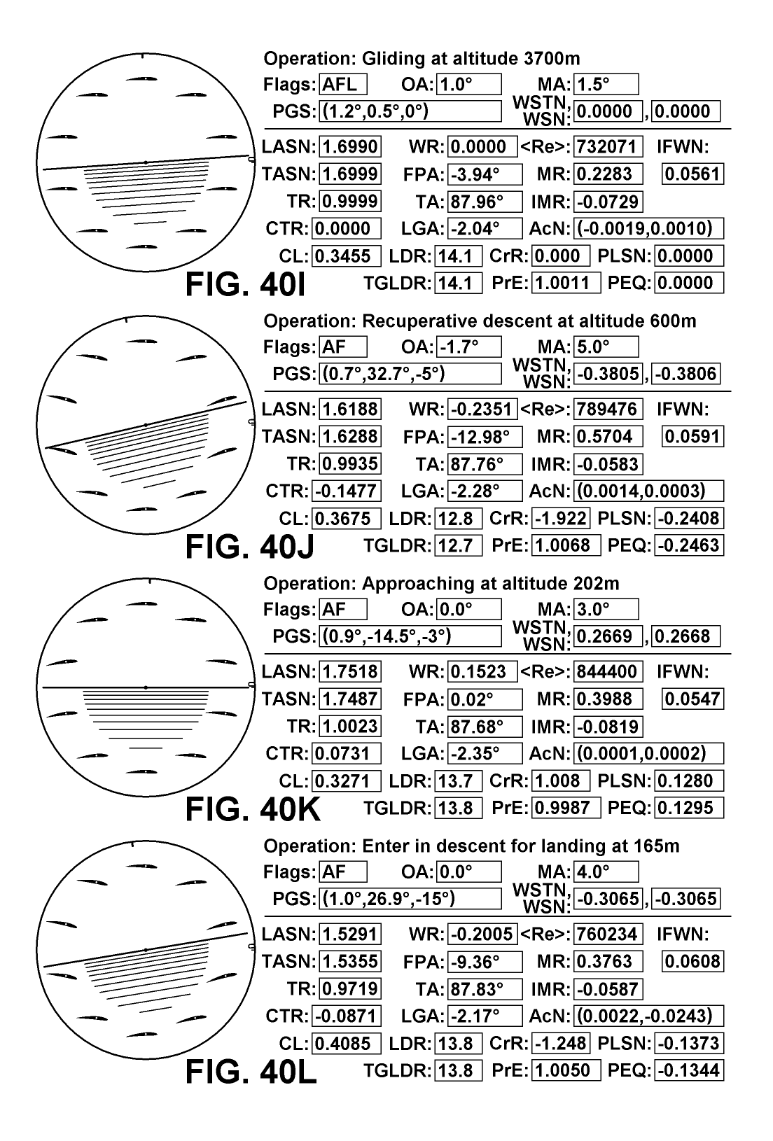

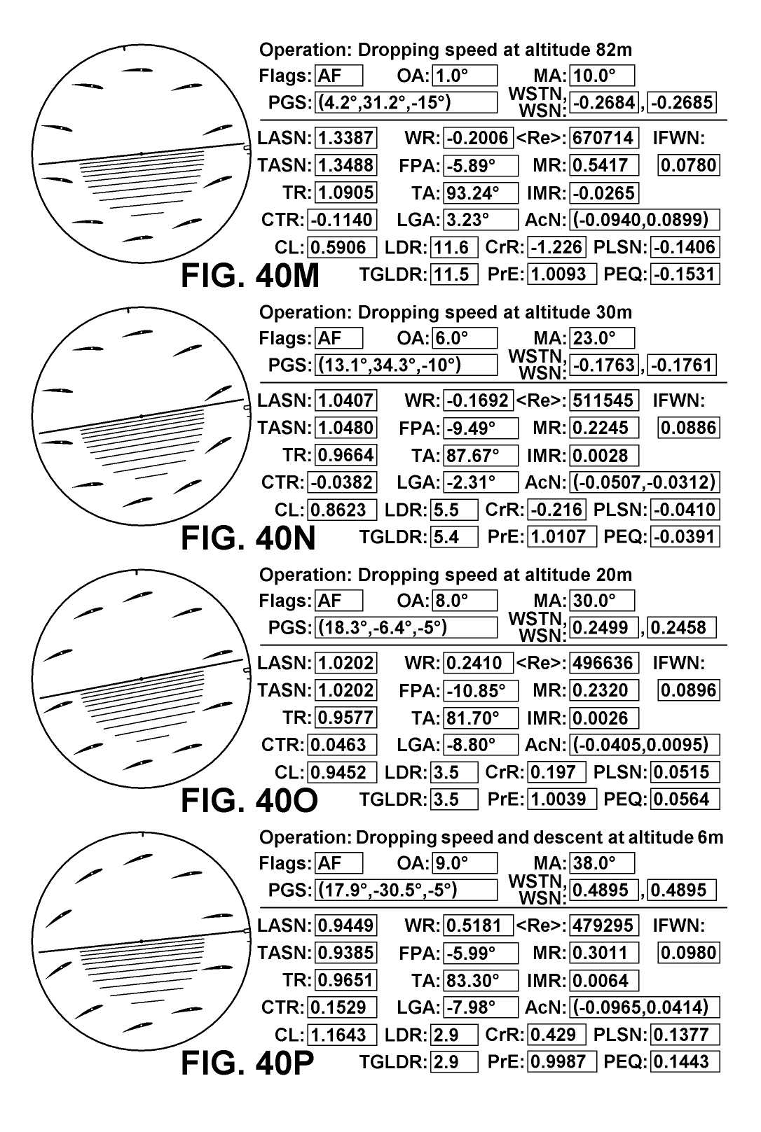

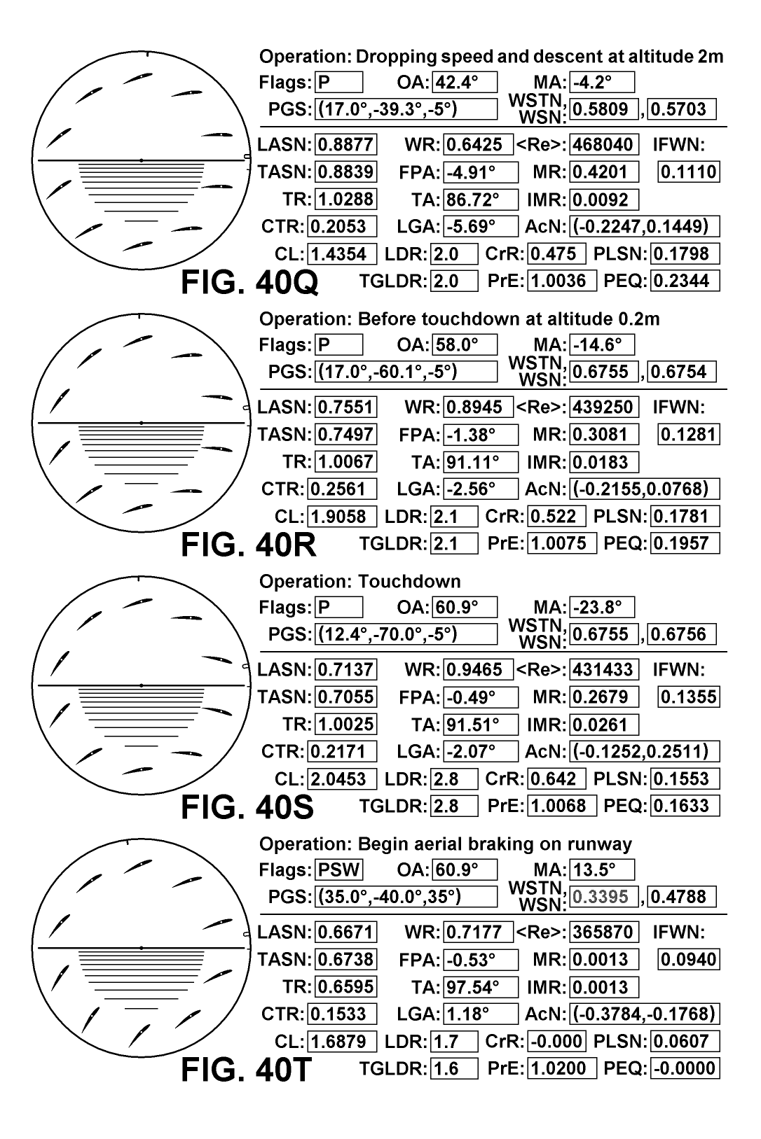

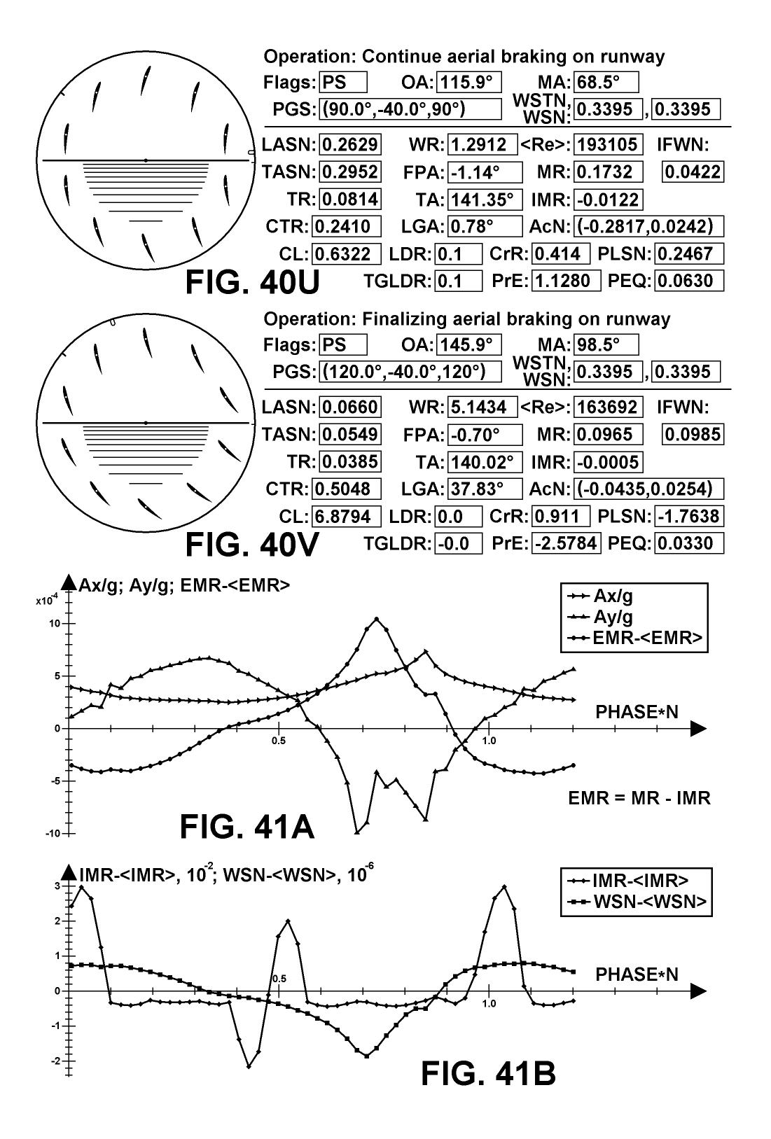

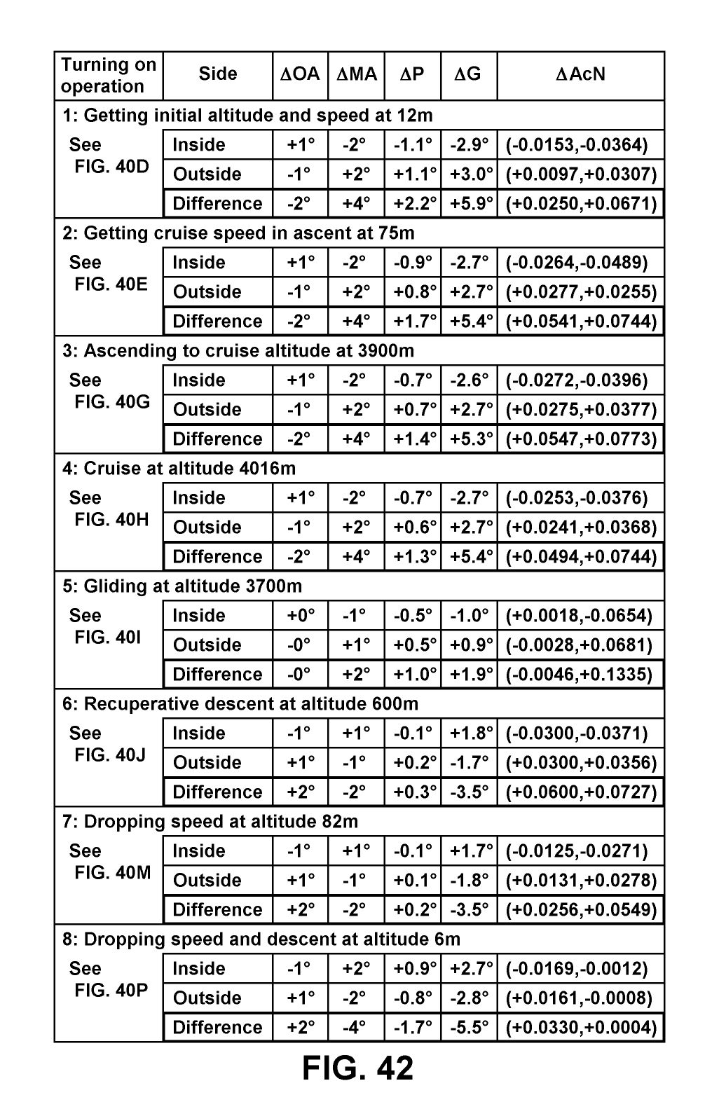

The simulation was performed over entire flight from takeoff to landing with runway operations, and after it states of particular flight operation were reported to presented result in natural flight order. The result represented on lettered components of FIG. 40. I will comment particular values for all flight operations.

The FIG. 40A represents result for “Beginning acceleration on runway” operation, where rotor acts in “propelling” mode, which reflected in PS flags, and its winding speed WSN is highest from all operations. The aircraft still has very low TASN, but LASN is moderate due inflow IFWN. Nevertheless, its winding ratio WR is more than one. Thrust angle TA is low and near to horizon, and so inflow direction on RSI follows it. Consumed thrust ratio CTR is very high, and PLSN is moderate, which indicates: the aircraft acts as horizontal lift, moving along its inertial vertical. And inertial forces indeed are high, which reflected in high value of horizontal acceleration AcN. Such 0.3 g-acceleration indicates: the aircraft can perform short takeoff Thrust ratio is some higher then that acceleration, because some drag exists too. Moment ratio MR is moderate, but IMR is very low. Propulsion efficiency PrE is low, but equalized power only a bit below its maximal value, due margin imposed by low TASN. From glider's point of view CL is very low and LDR is zero.

The FIG. 40B represents result for “Before takeoff” operation, where rotor still acts in “propelling” mode, but TASN is significant enough for takeoff. Articulation of rotor changed mainly by decreasing magnitude of gain in PGS state. Also WS decreased too, and inflow significantly dropped. WR dropped significantly below one. Also CTR dropped too. But TR increased, due representing a significant lift component, which represents in moderate TA, increased CL and appearing low LDR and a bit higher TGLDR. Horizontal component of AcN some decreased. PrE rose significantly, and so PLSN and cruise ratio CrR, indicating high overpowering for the car-like cruise. Also PEQ is about its maximal value. MR some increased. Aircraft begins elevating on undercarriage, which reflected in low vertical component of AcN.

The FIG. 40C represents result for “After takeoff at 0.5 meters” operation, where rotor acts in biangular alpha-mode with stream following, which reflected in AF flags. Main alpha MA is very high and opposite alpha OA is moderate. WSN a bit increased, and so WR. CL is high, and so LDR increased significantly. TR now is higher than one, and its angle only on 7° below vertical. IFWN increased due increased TR. MR a bit decreased and IMR changed its sign. Vertical acceleration increased and horizontal dropped. Aircraft already has significant vertical speed, which reflected in FPA and inclined horizon on RSI. Remained horizontal acceleration accompanied by moderate negative LGA, and so gravitic propulsion already works, which reflected also in increased PrE. Although PLSN is dropped it is high for the vertical lifting. CrR dropped, since the low gliding performance isn't suit an optimal cruise. Also PEQ some decreased.

The FIG. 40D represents result for “Getting initial altitude and speed at 12 meters” operation. MA decreased, but still is high. WSTN decreased a bit, and so WR. IFWN a bit decreased, but LASN and TASN a bit increased. TR decreased a bit below one, which reflected in low negative vertical acceleration, but horizontal component of AcN a bit increased. CL decreased below one and LDR some increased, and so CrR. PLSN increased a bit, but PEQ and CTR continue decreasing. PrE increased a bit. Vertical speed continues increasing, which reflected in FPA. MR decreased, and IMR changed its sign back to negative.

The FIG. 40E represents result for “Getting cruise speed in ascent at 75 meters” operation. MA dropped to moderate value and so OA. Also WSTN decreased. It reflected in significantly decreased magnitude of negative gain in PGS state. LASN and TASN moderate increased, which reflected also in decreased WR. Average Reynolds number increased. IFWN continues decrease. TR a bit below one, which reflects in low negative vertical acceleration, but horizontal component significantly raised, which reflected also in increased negative LGA, which value is high for significantly increased LDR. Also PrE continues increase, crossing level of 99 percents, and CrR increased more. PLSN decreased insignificantly. CTR continues decrease due decreasing drag, and CL continues decrease due increasing speed. MR increased and IMR continues increase toward negative direction. Vertical speed decreased, which reflected in decreased FPA.

The FIG. 40F represents result for “Ascending to cruise altitude at 400 meters” operation. MA dropped to normal value for ascent, and so OA. Skew inclined more to negative direction. WSTN continues decreasing, and so decreased magnitude of negative gain in PGS state. LASN and TASN significantly increased, which reflects also in drastically decreased WR. Average Reynolds number increased to maximal value. IFWN additionally decreased. TR is a bit above one, which reflected in very low positive vertical acceleration, also horizontal component near to zero. LGA dropped to its neutral value. LDR significantly increased. PrE continues increase and CrR increased to its maximal value and so PLSN. CTR decreased more, and CL decreased significantly. MR increased to its maximal value, and IMR significantly increased toward negative direction. Vertical speed increased to its maximal value, which reflected in increased FPA. PEQ increased to some below its maximal value.

The FIG. 40G represents result for “Ascending to cruise altitude at 3900 meters” operation. Biangular angles and skew aren't changed, but WSTN some decreased for keep constant value of PEQ. LASN and TASN a bit decreased. WR a bit decreased, and so <Re>, particularly due increased cinematic viscosity. IFWN insignificantly increased. TR, AcN and LGA are in equilibrium. LDR remained without change. PrE a bit increased. CrR some decreased, and so PLSN in accordance with WSN. CTR decreased more, and CL increased a bit. MR a bit decreased, and so magnitude of IMR. Vertical speed a bit decreased, which particularly reflected in some decreased FPA.

The FIG. 40H represents result for “Cruise at altitude 4016 meters” operation. MA decreased to its optimal cruise value and OA increased a bit. Also inclination of skew dropped and used for fine-tuning for perfect cruise. WSTN dropped, and so PEQ and PLSN. Negative value of gain additionally decreased. CrR indicates perfect cruise. PrE increased to its maximal value for positive powering, just about eighth percent below ideal level. LASN and TASN some increased. WR decreased significantly, and <Re> increased a bit. IFWN a bit decreased. TR, AcN and LGA are in equilibrium. LDR increased to its maximal value for powered flight. CTR dropped in two times, and CL decreased to its minimal and optimal value. MR decreased, but negative value of IMR increased, due low CL.

The FIG. 40I represents result for “Gliding at altitude 3700 meters” operation. WSTN is zero and rotor locked. MA decreased to its optimal gliding value and OA some increased. Skew set to zero, also gain and pitch a bit above zero, having all wing pitches about flat. Nevertheless, wings differently loaded due interference, which reflected in low but significant MR, and so external MR will be more higher, due significant negative value of IMR. All power related values are zero. TAS, LAS and <Re> decreased a bit, but kept high. IFWN insignificantly increased. TR, AcN and LGA are in equilibrium. LDR a bit increased to its maximal value. CL a bit increased. PrE is insignificantly more then one due direction of inflow, almost perfectly perpendicular to TAS.

The FIG. 40J represents result for “Recuperative descent at altitude 600 meters” operation. WSTN set to high negative value. MA increased to value of high-speed descent and OA significantly decreased, keeping above-moderate value of MR, need for the operation. Negative value of IMR a bit decreased. Gain has high positive value, which reflected on RSI, and skew a bit decreased. LASN and TASN some decreased, but <Re> increased, due dropping altitude. TR, AcN and LGA are in equilibrium. CL a bit increased and LDR decreased to its value on ascent. CTR has moderate negative value. CrR has high negative value and so PLSN and PEQ. So recuperating power is about two thirds of its value on ascent, but vertical speed is much higher, which reflects in high negative value of FPA and in inclination of horizon on RSI. PrE is a bit more than one, since inflow has some increased projection to back of TAS.

The FIG. 40K represents result for “Approaching at altitude 202 meters” operation. It is also low altitude cruise, and so it very low differed from high altitude cruise. But some differences exist. They are some increased WSN and WR, increased value of <Re> and highest negative value of IMR.

The FIG. 40L represents result for “Enter in descent for landing at 165 meters” operation. The operation is moderate speed variant of recuperative descent from FIG. 40J and can be characterized lower MA, higher OA, much higher negative skew and lower negative value of WSTN, with lower recuperation power. Also TASN, LASN and vertical speed are lower, the last reflected in less inclined FPA. Also CL some increased and LDR is so high as for cruise, although IFWN a bit increased. AcN has low negative vertical acceleration.

The FIG. 40M represents result for “Dropping speed at altitude 82 meters” operation. MA moderate increased, OA increased some, and so gain increased. WSTN some decreased. LASN, TASN and <Re> decreased, but WR remained constant. Slope of FPA decreased. MR significantly increased, and negative IMR value dropped. IFWN increased, and so CL, leading to some decreasing of LDR. TR increased significantly more than one, which is reflected also in significant positive vertical acceleration in AcN. Horizontal component of AcN reflects significant deceleration, which accompanied also with significant positive value of LGA. And so gravity force provides now negative propulsion. Also projection of its reaction on flight direction is negative, providing additional negative propulsion through negative powering. It is reflected also in TA, which value is more than right angle. CrR and PLSN changed insignificantly, and negative PEQ some increased. Aircraft on the operation can be considered as glider flaring up with high LDR, converting speed to altitude with high efficiency, and elevator, which going down converting the gained altitude from glider to negative power. And so the recuperative deceleration works.

The FIG. 40N represents result for “Dropping speed at altitude 30 meters” operation. MA significantly increased, and so OA. Negative value of WSTN decreased significantly, but gain increased additionally. Negative value of skew decreased. LASN, TASN and <Re> decreased more and WR also decreased. Slope of FPA increased. MR dropped and IMR changed its sign and stays near to zero. IFWN additionally increased and CL increased more, leading to dropping LDR at two times. TR is some below one, reflected also in low negative vertical acceleration in AcN. Negative horizontal component of AcN some dropped, which reflected in LGA, which negative slope is too low for providing enough gravitic thrust for such low LDR. And so deceleration now performed by increased aerodynamic drag itself with relative low rate. TA now switched to below right angle position. Negative values of CrR, PLSN and PEQ dropped significantly. PrE has its maximal value about one due combination of high aerodynamic drag, inflow and remained negative powering.

The FIG. 40O represents result for “Dropping speed at altitude 20 meters” operation. MA increased rapidly, and OA some increased. Negative value of skew additionally decreased. WSTN switched to positive direction and has moderate low value. And the process continues, which indicated by significant difference between WSTN and WSN values. So gain is switched too, having low negative value. LASN, TASN and <Re> some decreased. WR has moderate value in correspondence with WSN. Slope of FPA additionally increased. MR, IMR and IFWN almost aren't changed, but MR contains some impact from moment imposed by inertia of rotor. CL continues increase and LDR additionally dropped. TR a bit decreasing, but vertical component of AcN is a bit positive, since projection aerodynamic drag on vertical also participates in compensation of entire weight of aircraft. The high drag reflected in additionally dropped LDR. Horizontal component of AcN has small negative value. Negative value of LGA significantly increased, but gravitic thrust stays in balance with aerodynamic drag. TA decreased in accordance with decreased LDR. CTR, CrR, PLSN and PEQ have low positive values. So aircraft continue going down upon switching to positive powered mode.

The FIG. 40P represents result for “Dropping speed and descent at altitude 6 meters” operation. MA increased to very high value, which is almost maximal for operation in alpha-mode of biangular handling, and OA increased a bit. WSTN increased significantly to moderate value, and so value of negative gain. LASN and TASN continue decreasing with higher rate, but <Re> decreased insignificantly, due increasing speed of rotation, which also reflected in highly increased WR. Slope of FPA decreased in two times, so LAS directed exactly along inclined horizon. MR increased, but it is free now from impact of moment inertia of rotor. IMR increased, but has very low value. IFWN some increased, but CL increased more, crossing level of one. So LDR additionally decreased. TR a bit increased, and vertical component of AcN increased more. Also negative value of its horizontal component increased significantly. CTR, CrR, PLSN and PEQ raised in three times, but stay moderate low. PrE a bit decreased, but has its high value due high drag itself. Aircraft is in proximity for entering to horizontal fuselage mode.

The FIG. 40Q represents result for “Dropping speed and descent at altitude 2 meters” operation. Biangular handling mode switched to pitch-based mode, and stream following was disabled, leading to horizontal orientation of fuselage, due appropriate action of stabilator. And those biangular values of pitch mostly used for additional indication, and so gain and WSTN will be primary handlers until touchdown. And so value of negative gain and WSTN moderate increased, accompanied with very low decreasing of pitch. MA is a bit below horizontal position and OA is a bit below inclining on 45°. Also by looking on RSI, those differences look nullified, which is because feature of shifting of match points under high gain. WSTN is in progress of increasing, which reflected in its significant difference from WSN. LASN and TASN additionally decreased, but <Re> decreased a bit. WR continues increasing. MR increased to moderate value, particularly due inertia of rotor. IFWN continue increasing. CL rose significantly, and LDR additionally dropped. TR increased, crossing level of one, but vertical acceleration in AcN increased more, mostly due high value of projection of drag force. The last reflected in high value of deceleration in AcN, crossing level of 0.2 g. Also gravitic propulsion kept low, which reflected in relative low slopped LGA. FPA slope some decreased also. CTR, PLSN and PEQ increased significantly, but stay moderate. CrR increased insignificantly, because increased drag, and so PrE stays high. Now moderate value of PEQ is maximal for landing sequence.

The FIG. 40R represents result for “Before touchdown at altitude 0.2 meters” operation. Gain drastically increased, and WSTN increased moderate and stays steady. It also reflected in decreasing MA and increasing OA, like as flaps on airplane. LASN and TASN additionally decreased and <Re> decreased a bit. MR some decreased and IMR increased in two times, but stays low. IFWN some increased. CL significantly increased, just a bit below level of two, but LDR insignificantly increased, due decreasing of drag, which reflected in a bit only decreased deceleration in AcN over decreased power. Also slope of LGA additionally decreased. TR a bit decreased, and TA is a bit more than right angle, which reflected in increased PrE. FPA slope decreased significantly. CTR increased due decreasing of speed. PEQ some decreased, and PLSN decreased insignificantly. CrR a bit increased, reflecting decreased drag.

The FIG. 40S represents result for “Touchdown” operation. Pitch control of PGS was decreased for keep vertical descent speed against be too low, and negative gain was increased to almost to its maximal value. LASN and TASN some decreased, but <Re> decreased less. WR increased, having its maximal value for landing sequence, but nevertheless it remained some below of one. IFWN additionally increased, having its maximal value. CL increased too, crossing level of two. LDR increased significantly, but stays low. CTR, PLSN and PEQ decreased, due of decreased drag, and so CrR increased, and horizontal deceleration in AcN decreased too. Vertical acceleration in AcN drastically rose up to level 0.25 g, reflecting push from undercarriage. MR some decreased and IMR some increased. FPA decreased to almost horizontal direction. TR a bit decreased and TA a bit increased. Slope of LGA some decreased, and PrE decreased insignificantly. Runway path should be short, since remained TAS is only 70 percents of specific stagnation speed.

The FIG. 40T represents result for “Begin aerial braking on runway” operation. Handling switched to S-mode operation, when pitch follows changes of skew. Additionally pitch and skew set to equal values of 35°. Negative gain was dropped to about of half of its maximal value. Also rotor was switched to freewheeling mode for utilize its freewheeling power upon deceleration of rotor. In the mode target winding speed is meaningless and can be used only as hint indication of minimal winding speed, when the freewheeling mode should be switched off. And so WSTN indicates the value, having dimmed appearance by dithering. WSN, LASN, TASN, WR and <Re> decreased. Since external moment in the freewheeling mode is zero, MR dropped to value of IMR, which is very low. TR significantly decreased, and aircraft continue descending on undercarriage, having low negative FPA. TA increased and so PrE. CTR and PLSN decreased, and they aren't equal to zero, since their calculation based on external consumed power and now reflect power spending by freewheeling rotor. CL dropped and so LDR. AcN exhibits very high deceleration of 0.38 g for its horizontal component, mostly from drag, but it has also particular impact from negative gravitic thrust, reflected from low positive value of LGA. The high deceleration additionally permits having short path on runway in time of landing.

The FIG. 40U represents result for “Continue aerial braking on runway” operation. Skew and pitch increased to right angle for maximize drag. Freewheeling mode switched off. WSTN has moderate low value. LASN and TASN dropped more than two times and <Re> dropped less. WR rose, crossing level of one. Horizontal deceleration in AcN some decreased, but stays high. TR is low and TA is highly back directed. MR is low and IMR changed its sign to negative and stays low. IFWN and CL dropped more than two times and LDR near to zero. CTR increased due of dropping TAS, PLSN increased due dropped lift component of aerodynamic force, and PEQ is low. CrR reflects high drag. High PrE reflects opposite direction of inflow. Aircraft continue descent on undercarriage with oscillations, reflected in low vertical acceleration in AcN.

The FIG. 40T represents result for “Finalizing aerial braking on runway” operation. Skew and pitch increased to direction above direction of inflow, which indicated by TA. And the direction is also near to TAS opposite direction. LASN and TASN dropped many times, so WR is very high. IFWN increased to value much higher than TASN, so rotor now works in reversed “propeller mode” and LAS direction is opposite to TAS. TR and PEQ dropped about two times, but CTR rose in two times due of dropped TAS. PrE increased and has negative sign due opposite directions of LAS and TAS, which reflected in PLSN. Also AcN exhibits much low deceleration. Nevertheless, the current thrust almost enough for compensate losses, which reflected by CrR, which is near to one. And so this mode of operation can be used for taxi operations in two directions upon changing direction of winding speed. Also for those taxi operations can be used rotor with articulation like as on FIG. 40A.

It can be understand, from the presented analyze of result of the simulation, the aircraft with presented rotor will perform well for all operations. The only problem is the relatively high IMR on cruise, which can lead to significant wearing of steering gears. But the problem can be avoided by using symmetric airfoil for wings of rotor. Also exists other problem, which is out of scope of presented analyze. It is vibrations of rotor, which should be enough low for comfortable flight.

There can be selected five components for those analyze of vibrations. The first two are same as I presented for analyze of “wired wings” simulation. They are horizontal and vertical components of acceleration of entire aircraft normalized on gravity acceleration at ground level. The third component is deviation of external moment ratio or shaft moment, which referenced as EMR. This deviation calculated as difference between instant value and value averaged over all analyzed samples. The fourth component is deviation of IMR. And the fifth component is deviation of WSN. Also it can be understand: for that analyze enough only samples laid in time between similar position any of two neighbor wings or a bit more. The time period is N-th fraction of entire phase of rotor, and so I reference it as minor phase. Also I consider it changes from zero to N, instead of zero to one, since it is better for analyze. And so I extracted such data from result of flight simulation for cruise flight referenced on FIG. 40H and prepared plots for it. Those plots represented on FIGS. 41A and 41B, where the FIG. 41A represents first three mentioned components and the FIG. 41A two remained, which are exactly synchronized by their common x-axis of minor phase. Also FIG. 41A has a relation for calculate EMR in its bottom for reference.

The first plot exposes enough low deviations for vertical acceleration and EMR. For case of referencing EMR on radius of rotor, both will be below 0.001 g on amplitude basis. And also they are in counter phase, so some compensation will exists, since center gravity of aircraft placed some on forward side of rotor. And for horizontal acceleration those variations are much low.

The second plot exposes significantly high deviations for IMR, which have amplitude about 0.03 g on radius of rotor and high harmonics spectra. Also deviations of WSN, presented there, are low with amplitude below 0.000002 or 0.2 mm/s for case of using normalizing speed of 100 m/s. Also they synchronized with EMR. Vibrations from IMR can be reduced simple by using symmetric airfoil. But there also exists other way. It can be performed by active vibration reduction system VRS, which poses special patterns of additional current on coils of electric engine of rotor for compensate vibrations propagated through steady elements of rotor. Those patterns should be synchronized with minor phase of rotor. Also low level of WSN variations provides margin enough for it. Also the VRS will be more simplified in case of number of wings is a common divider of number of poles of engine. Also the pattern itself doesn't follow on straightforward manner from the presented plots, since it depends from actual mechanics properties of all tiers of aircraft near rotor's vicinity and from particular flight operations. And so it can be obtained only experimentally or by detailed modeling.

Other important feature of flight is handling aircraft upon turn. The presented flight simulations are 2-dimensional only. Nevertheless, they permit simple obtain the result for turning too. Suppose the aircraft in turn has an inside of turn and an outside of turn. And so each side can be modeled separately with some differences in handling for particular operation. After it, only need to compare differences of behavior of components of acceleration for two sides and provide difference for handling accompanied with related difference of acceleration. For case of well-posed turn, which referenced as coordinated turn, its introduction begins from roll inside of target turn. And so this roll resulted from differences in vertical acceleration between wings. The roll on airplane performed by ailerons, which have adverse effect on the turn by posing horizontal acceleration in wrong direction due of adverse drag distribution. And so airplane begins counter rotation in case of do nothing. And so for prevent it, two features used. The main feature is increasing pitch by elevator, which leads to increasing lift and flight path curvature consequently. And, since plan of such curvature inclined correspondingly with existed roll, inertial vertical of introduced curvature also inclined, introducing rotation in right direction. Also correctly performed coordinated turn prevent airplane from slipping. Additional feature there is action of rudder, which enforces beginning of the rotation. So finally, tendency to rotation in any direction will be presented by difference in components of horizontal acceleration between wings. Also if an aircraft upon performing turn has same relations in direction of acceleration of its wings as for coordinated turn, it will be the coordinated turn, since correct difference of horizontal acceleration will introduce same inclining of inertial vertical, as for case of increasing pitch. And so I did some experimentation upon simulation and find such correct combinations of desired accelerations between sides with related handling.

The result for different flight operation represented as table on FIG. 42. There are eight operations, which apply on all spectra of entire flight. They can be split on three categories.

The first is category of normal turning I referenced it as normal, because cruise operation itself belongs to it. For the normal category turn introduced by apply difference in outside from inside for deviations of MAs on some angle and correspondent half of it difference for deviations of OAs. Those deviations presented in separated columns for OA, MA and related P and G. And the last column is the deviations of acceleration itself. The normal category includes first four operations from low speed ascending flight up to cruise. Also ratio between horizontal and vertical components of induced acceleration is differed, so for some operations roll can be too high relative to rotation. For this case there can be need additional articulation for increasing common lift for enforcing coordinated turn upon inclining inertial vertical. And after entering to coordinated turn only the additional lift increasing articulation should be kept as all airplanes do. But in any case the table listed all variants, having avoidance of adverse back rotation behavior, featured for ailerons of airplane.

The second category contains only gliding itself and it is case of neutral turning. For the case horizontal rotation is near to zero. It is enough for perform rotation upon articulate for additional lift in coordinated turn, but it can be less effective than for normal case. And so rudder can speed up that turn. Only low difference in MAs need for entering in turn for the category. And direction of the difference is same as for normal category.

The third category contains all remained operations and it is case of inverted turning, since direction of articulated controls there opposite to normal turning But they have some differences. First two operations there are recuperative descents with differed level of back power. Both operations used same magnitudes of applied differences on MAs and OAs instead of normal category. But operation with higher power has much higher rate of horizontal rotation. The third operation is part of landing sequence at low altitude, were turning can be difficult, due of risk enter in slip upon roll in time of introduction the turn. But for this case exists possibility perform flat turn without roll at all. For this case magnitude of difference between MAs should be two times more than magnitude of related articulation for OAs.

Using such differed categories of handling turn can be problematic for pilot. But it can be resolved by using flight computer, which interprets movement of joystick to related changes of parameters of biangular handling and PGS state for both sides rotors dependently of current operational state, related to particular category.

Other advantage of this handling for turn is possibility to couple shafts of two rotors altogether, having redundancy in case of malfunction of engine or locking system. Also the common shaft itself adds additional rigidness for rotors base. In other case rotors should use different rotation for accomplish the turn, which is not well decision, since on pure gliding both rotors should be locked against rotation and some possibility for turning should be exist.

For following description of preferred embodiment accompanied drawings may induce sensation of to scale representation. Nevertheless, those drawings may have deviations from to scale representation, and certain elements may be exaggerated in scale or pictured with some generalization for corrected and simplified expression their related features.

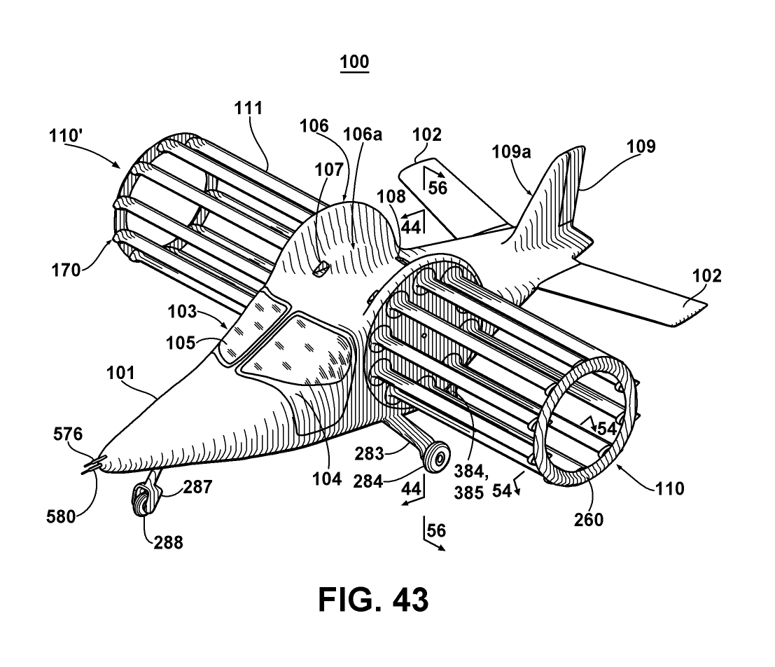

Referred now to FIG. 43 there is illustrated aircraft in accordance with the invention and generally designated by the numeral 100. In particular it is experimental two seats vehicle. The aircraft includes a generally streamlined elongated fuselage 101, stabilators 102 on each side of fuselage 101, rotors 110 on left side and 110′ on right side of fuselage 101, which cinematic scheme was presented on FIG. 9, vertical stabilizer 109a, as integral part of fuselage 101, with rudder 109 and additional components. Those components include: undercarriage bow 283, attached to fuselage 101, two undercarriage wheels 284 mounted on each side of the undercarriage bow 283, nose support fork with damper 287 attached to fuselage 101 with possibility of rotation over its own axis, nose wheel 288, mounted on nose support fork with damper 287, parking support 384, attached to fuselage 101 with possibility of retracting, parking wheel 385, mounted on parking support 384, pitot-static tube (PST) 576, attached to fuselage 101 on upper side of its nose, and stream deviation tube (SDT) 580, attached to fuselage 101 on center of its nose. The fuselage 101 has cabin 103 for pilot and passenger on its forward side. Entry to this cabin 103 performed by using two doors 104 on each side of fuselage 101, and each door 104 has its own window 105. Also the fuselage 101 has two rotor's sockets 106 on each side, where rotors 110 and 110′ mounted with possibility to extraction out for maintenance or reassembly purposes. Those sockets 106 are integral parts of the fuselage 101, continue inside of fuselage 101 also in bottom and have generally conical shape with continuation to engine's fairings 106a. Those engine's fairings 106a provide additional space for electrical engines of each rotor 110 and their cooling system and have air inlets 107 and air outlets 108 for those cooling systems. Each wing 111 of each rotor 110 or 110′ connected pivotally on its outer end to related common end rotor support ring 260, which provides enough rigidness for entire rotor 110. End of each wing 111 has a fairing 170, which provides enough space for system of pivot's bearings. Also those fairings 170 act with end ring 260 as distributed wing-fence for alleviate induced drag. Stabilators 102 used for keeping correct orientation of fuselage 101 upon entire flight by compensating moment variations induced by rotors 110 and 110′, which mainly compensated by impact from optimal placement of center gravity. Parking supports 384 with parking wheels 385 used for service support of aft part of empty aircraft 100 upon parking, which can have the center gravity behind of undercarriage wheels 284. Also there can be variant of the aircraft 100 without parking wheels, which has the undercarriage bow 283 attached to fuselage 101 behind of center of rotor's socket 106.

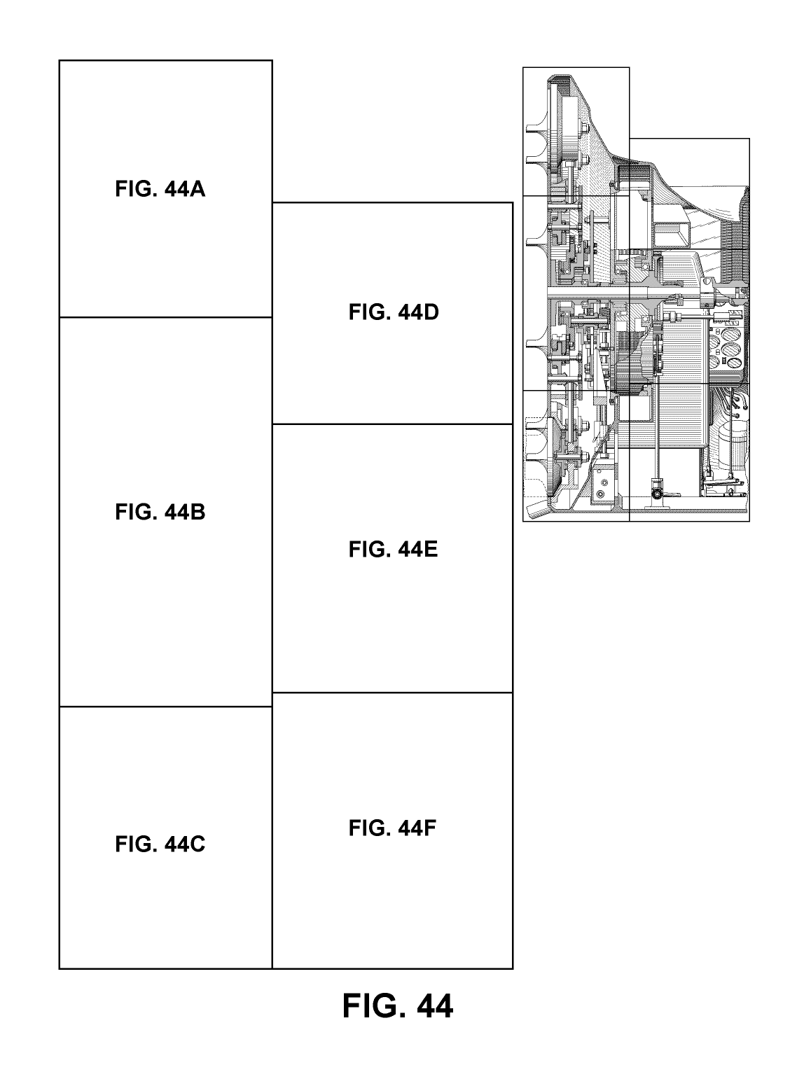

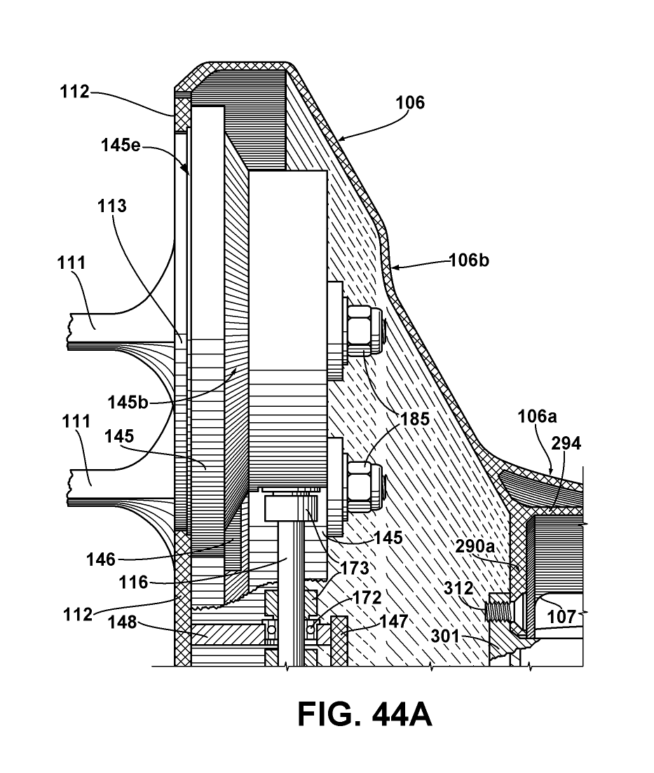

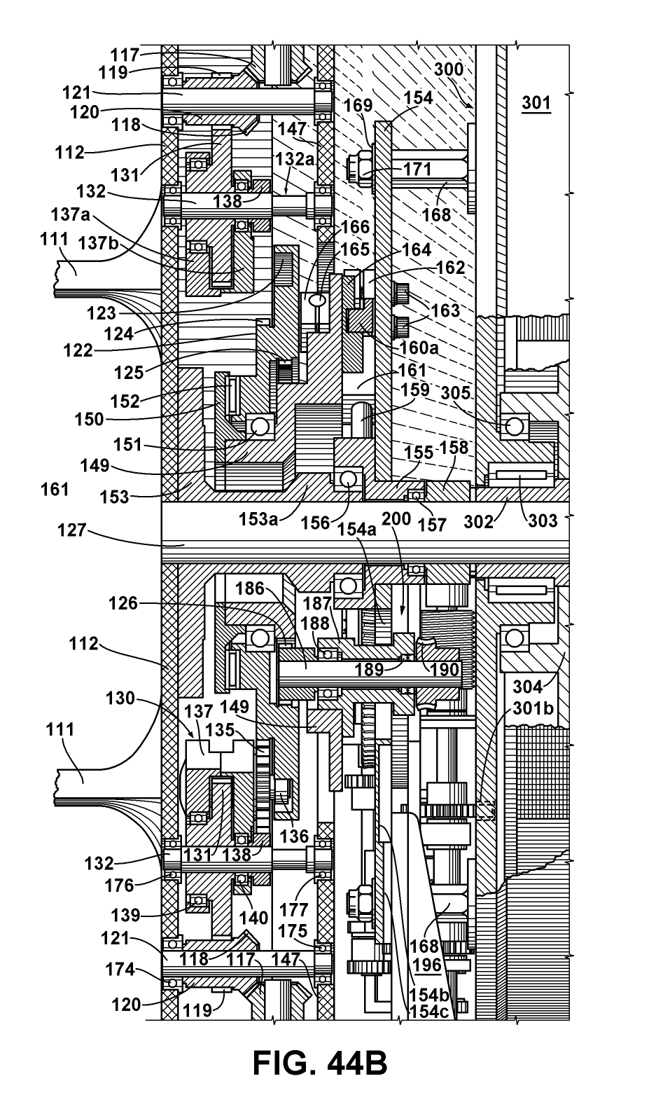

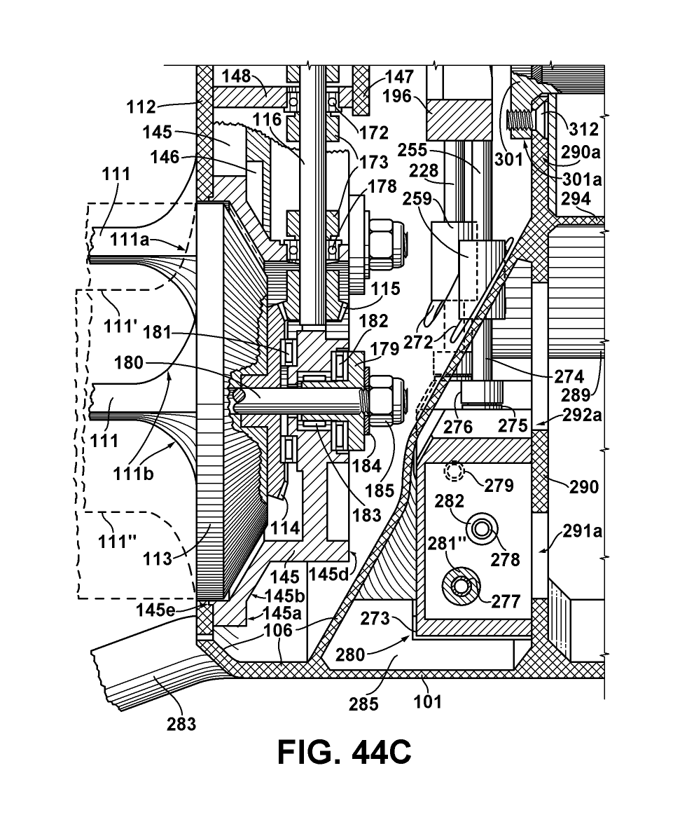

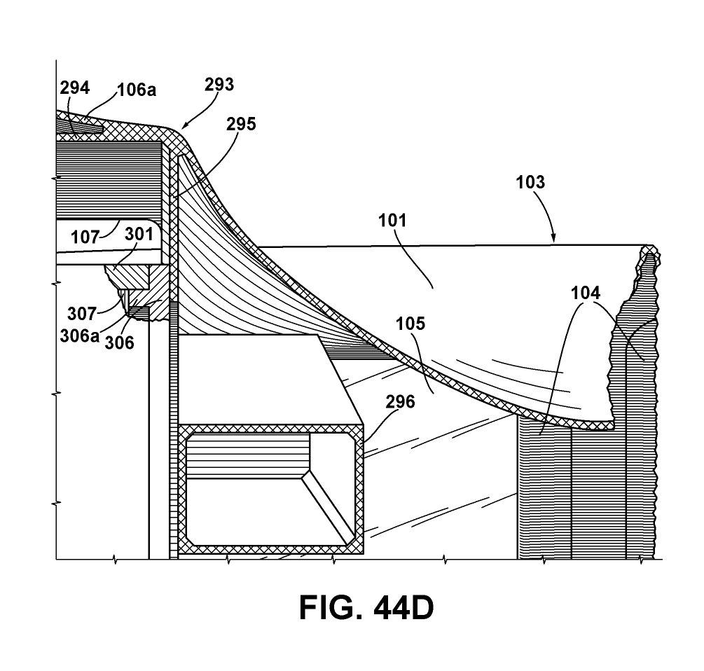

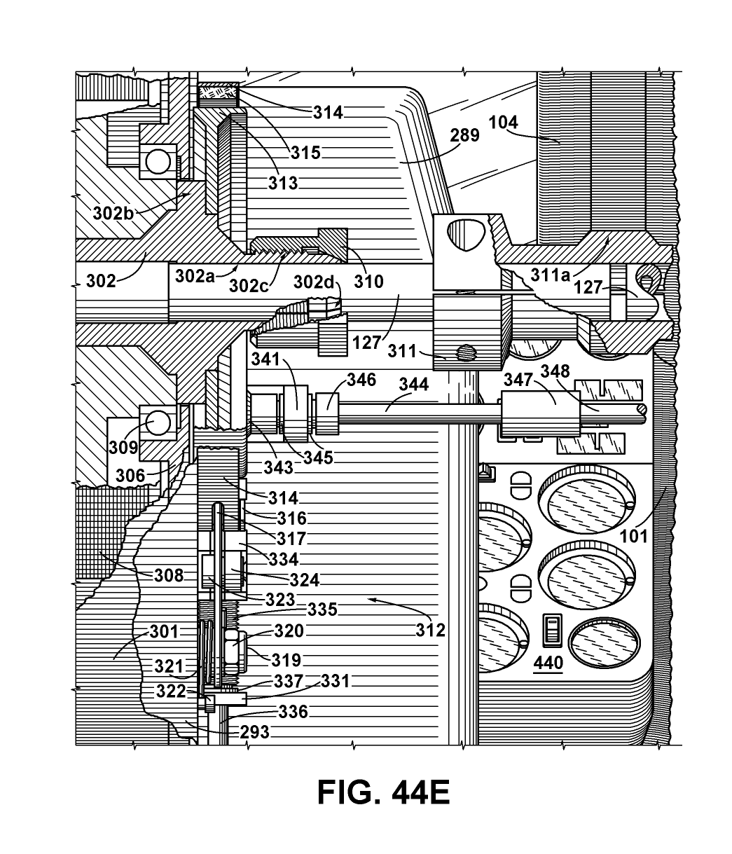

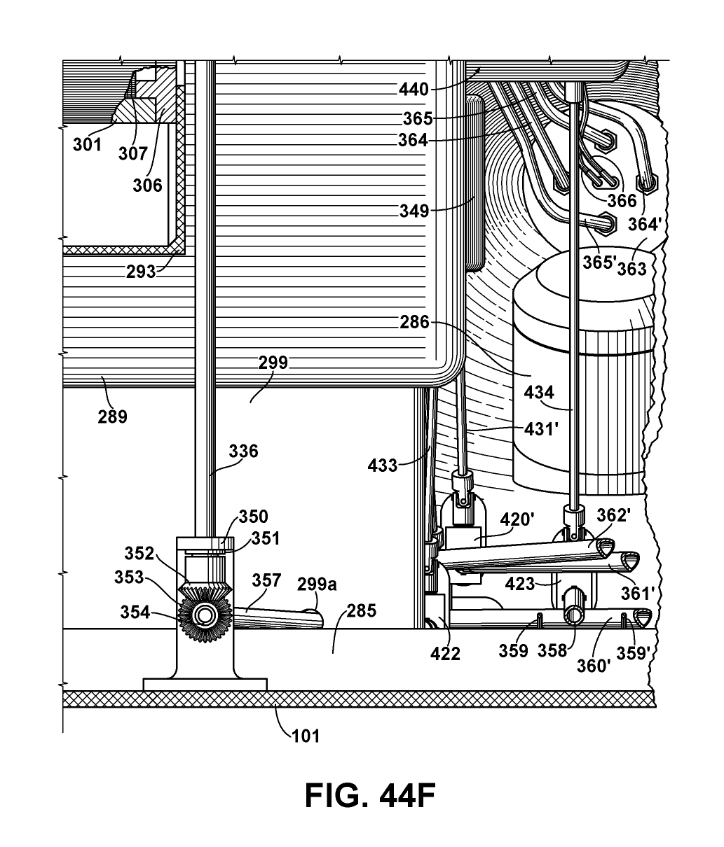

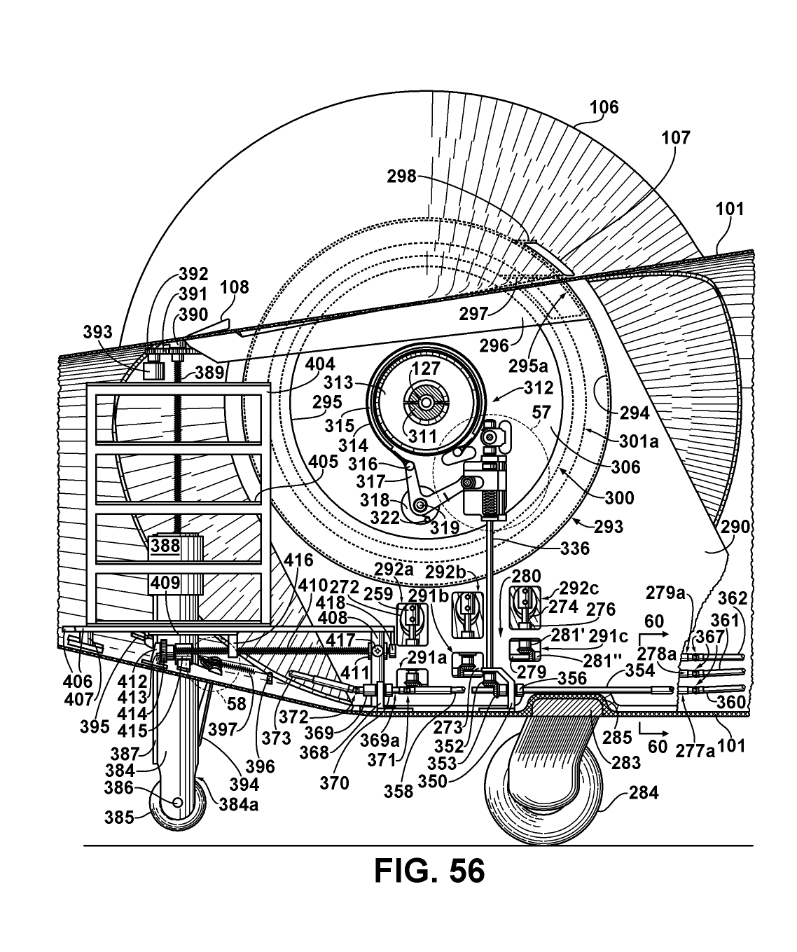

Referred now to all parts of FIG. 44 and FIG. 56 rotor's socket 106 continues inside of fuselage 101 up to side force plate 290, which is integral part of fuselage 101. This side force plate 290 has vertical orientation and begins from floor of fuselage in an area shifted forward from center of rotor 110. This shifting leads to inclined parallel rims of the side force plate 290, which continue to up and join in common semicircular shape coaxial with axis of rotor 110. From other side, looking on floor of fuselage 101 between its join with left and right side force plates 290, rims of those side force plates 290 can be considered continued to each other side, since thickness of floor in the considered area increased. Also undercarriage bow 283 placed in the high thickness area, inserted and fixed to special pocket 285. And so presented construction reflects preferred method of its manufacturing. It is using interleaving of composite materials for entire fuselage 101 and for some other elements, which is reflected in diagonal cross hatching for those elements. It can be understood from presented design, the side force plates 290 are main conductors of aerodynamic forces from rotors 110 and 110′ to fuselage 101 and it's content. The side force plate 290 has socket 293 for electrical engine 300 as its integral accompanied part inside aircraft 100 along axis of rotor 110. This engine socket 293 comprises from drum 294 and back-ring 295. Also the socket 293 continued on part of side force plate 290 toward axis of rotor 110 up to hole for the engine 300 and referenced as setup ring area 290a FIGS. 44A and 44C.

Body 301 of engine 300 inserted in socket 293 from outside, and so it is friendly for maintenance. The body 301 has setup flange 301a, which used to fix the engine 300 to the setup ring area 290a by using screws 312. After the setup, engine 300 is included in chain of aerodynamic force conduction between rotor 110 and side force plate 290. Central powering shaft 127 of rotor 110 inserted in hollow shaft 302 FIGS. 44B and 44E of engine 300 upon inserting the entire rotor 110 into socket 106. The central powering shaft 127 fixed to the hollow shaft 302 by clamping in its fine tolerance collet area 302a by clamping nut 310, utilizing threaded area 302c and clamping cone 302d of the hollow shaft 302. Also this end of the hollow shaft 302 is slotted, as it need for collet. The hollow shaft 302 has main radial support by using high load needle bearing 303, which placed on rotor's 110 side of engine's body 301 in thick-walled nest. From other side the hollow shaft 302 used radial and axial support of engine's rotor 304, provided by middle load bearing 309 in engine's lid 306. The engine's rotor 304 has hole correspondent with shape of hollow shaft 302, in which the hollow shaft 302 inserted. Their common interface has a conical segment, which provides exact centering. The hollow shaft 302 has setup flange 302b, which used for fixing it to engine's rotor 304 by non-shown screws. Other side of engine's rotor 304 has radial and axial support provided by low load bearing 305, which placed coaxially with needle bearing 303. This construction provides possibility for extraction the hollow shaft 302 from engine 300 upon maintenance of the engine, keeping the engine 300 functional. Also it permits using lightweight alloy for engine's rotor 304 with high quality steel alloy of hollow shaft 302. Also the rotor's engine 304 has relatively thin thickness of its medial disc shaped body with some magnetic related elements on its perimeter for creating desired distribution of rotor's poles 308. The lid 306 has centering ring 306a FIG. 44D on its perimeter, which enters inside of engine's body 301 in vicinity of engine stator's lamination 307. Central shafts 127 of both side rotors coupled together by common coupling 311, which has thickening ring area 311a in its center for additional enforcement. The common coupling 311 has construction from two halves clamped by two non-shown screws per each side. The back-ring 295 of engine socket 293 connected with lid 306 of engine 300 by using non-shown screws with some sealing, so air cannot leak between the back-ring 295 and lid 306. Space between engine's body 301 and socket drum 294 connected with air inlet 107 by using air separating plate 297 from bottom and air sealing plate 298 FIG. 56. The air separating plate 297 inserted inside of socket 293 up to engine's body 301, so air from inlet 107 can move only over the plate 297, around engine's body 301 and exit from window 295a, which exists in back-ring 295 under the separating plate 297. The window 295a simultaneously placed inside of air conduction tube 296, which connected with air outlet 108 on its other end. And so by this way air pass over the engine cooling system. Also the conduction tube 296 fixed to back-ring 295 and to fuselage 101 near air outlet 108, which provides additional enforcement, since the tube 296 is from composite material too. Additionally, engine's socket 293 and fuselage 101 have special non-shown holes, which used for a screwdriver upon setup engine 300 for screws 312, and sealed after it.

The central powering shaft 127 of rotor 110 represents rotational tier of the rotor's setup. Also the rotor 110 has irrotational tier, which back end represented by steady base 154 FIG. 44B. The steady base 154 is mounted on engine's body 301 on ends of mounting supports 168, using washers 169 and nuts 171. This fraction of setup performed from faceplate 112 of rotor 110. So the faceplate 112 has at least one hole for a tubular wrench, handling the nut 171, since the rotor 110 can be rotated upon the setup. This hole or holes should be sealed after setup, so they aren't shown. The washers 169 fixed on the steady base 154 against fall in advance.

Referred now to FIG. 44C wings 111 have fillet areas 111b on their both sides over bases 113 for accommodating high remained bending forces and decreasing interference from fuselage proximity. Also leading edge of each wing 111 has transition 111a over the fillet area, which reflects used pivot ratio for airfoil. Limits of area occupied by wing upon its rotation around its pivot referenced as 111′ and 111″ for upward and downward orientations of leading edge respectively.

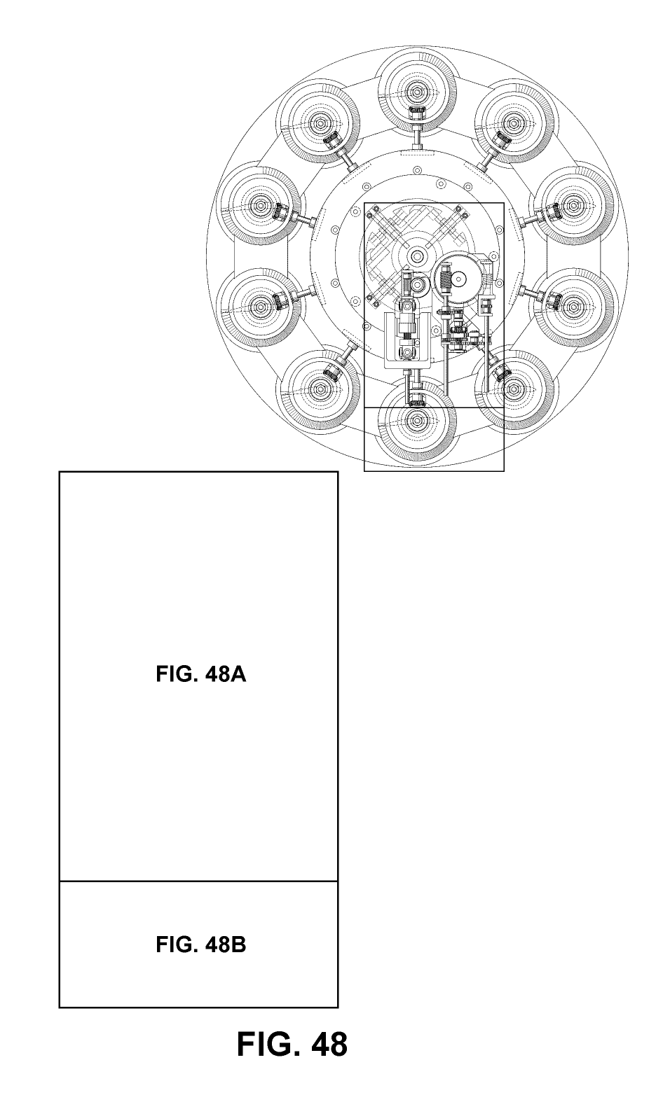

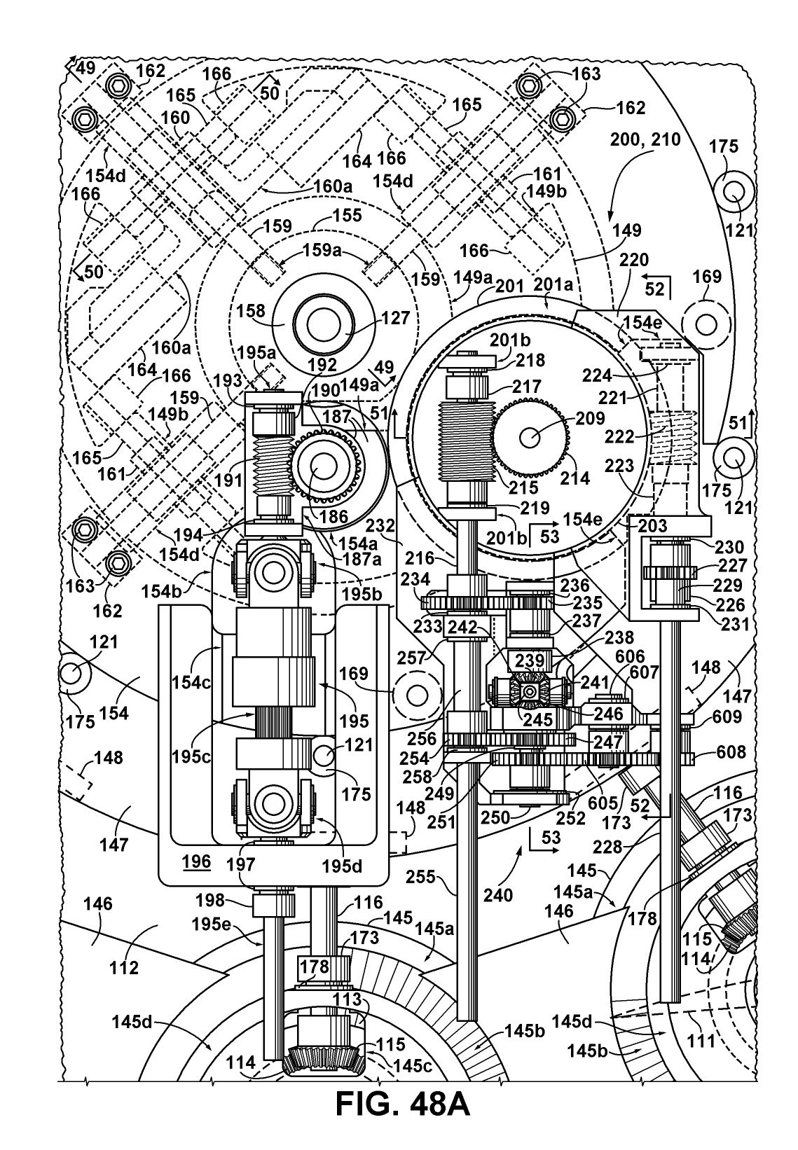

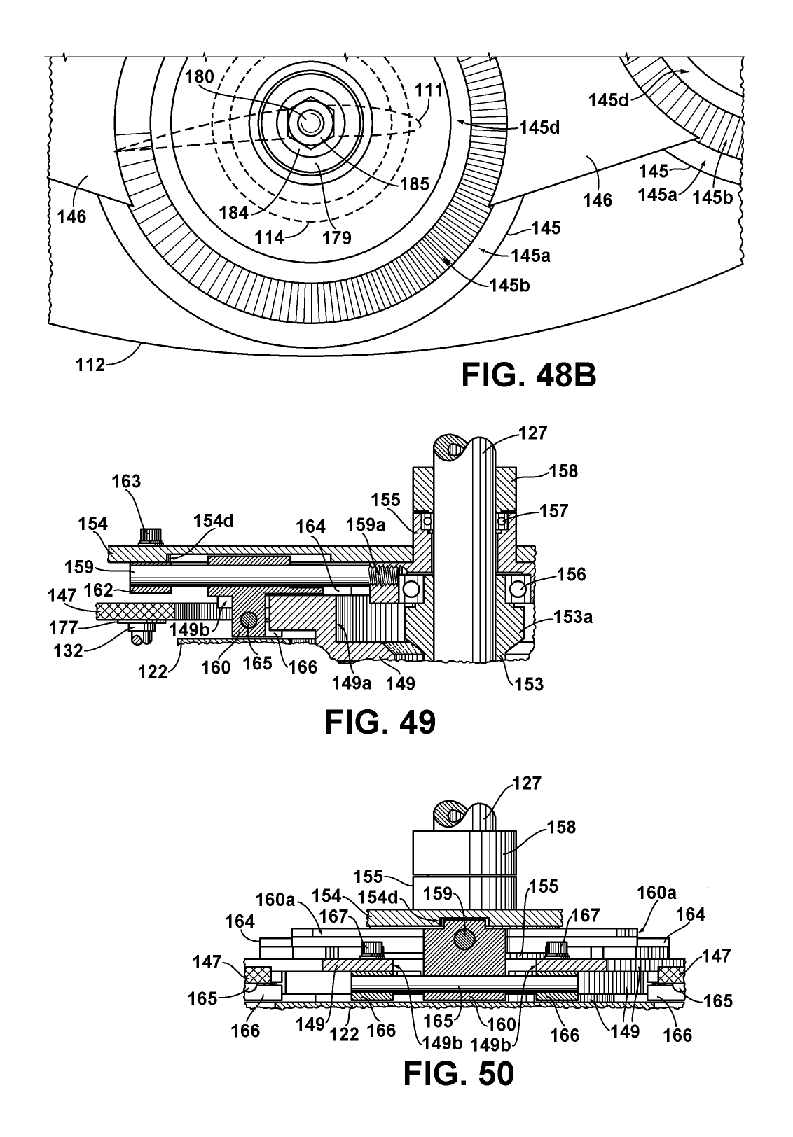

Referred now to FIGS. 44A, 44B, 44C, 48A and 48B rotor 110 has faceplate 112, which has circular form and manufactured from plate of composite material. The faceplate 112 has ten holes near its perimeter, where wing's sockets 145 mounted by some non-shown screws, interleaved with bridges 146. Those wing's sockets 145 turned from lightweight alloy and have cup like shape with additional features. Those features, looking from side and beginning from direction of faceplate 112 are: centering ring 145e, for which main holes of faceplate 112 have a complementary grows, base ring 145a used for its mounting and mounting bridges 146, cone segment 145b, for which bridges 146 have complementary rims and back-ring 145d. Additional feature there is window 145c, which milled in floor of the “cup”, which placed about of medial level of back-ring 145d. The disc shaped floor transited in center in generally cylindrical area with hole in its center. In the hole placed radial needle bearing 183, which has inside tail of tubular flange 179, with wing's shaft 180. The shaft 180 protruded from center of wing's base 113, which has inside of wing's socket 145 conical shape followed after cylindrical area. Bevel gear 114 attached to top of the cone of the base 113, having shaft 180 inside of its center. This attachment performed by non-shown screws inside of toothed ring of the bevel gear 114, which are well suited to cope with transmitting significant rotation moment. Primary thrust bearing 181 placed over the bevel gear 114 under corresponding ring area of wing's socket 145, accommodating high thrust forces induced from remained bending moment of wing 111 and additionally secures attachment of the bevel gear 114. Secondary thrust bearing 182 placed from other side of wing's socket 145 under flanged area of tubular flange 179. Nut 185 fixes the wing 111 in socket 145, laying on washer 184. Flange bearing 178 in hole of back-ring 145d supports shaft 116, which rotates bevel pinion 115, fixed on it and meshed with bevel gear 114. The bevel pinion 115 occupies window 145c, so the window 145c used for clearance and also for setup and maintenance. This setup and maintenance can include installation or extracting of entire wing 111 from wing's socket 145 on installed rotor 110. For this case a special non-shown window or hatch in rotor's socket 106 used for unscrewing nut 185 after positioning related wing 111 against it. Also it permits simplified installation of entire rotor 110 and transportation of entire aircraft 100 without wings 111, mounted on rotors 110 and 110′.

Rotor 110 has back-ring 147 mounted on tops of ribs 148, which are mounted on faceplate 112, using non-shown screws for both sided of those ribs 148. The back-ring 147 placed coaxially with faceplate 112, and ribs 148 placed in directions connected centers of wing's sockets 145 and center of rotor 110. The back-ring 147 also manufactured from composite material and has same positions of setup holes for nuts 185 as faceplate 112. Each rib 148 has flange-bearing 172 inside it, which supports other end of shaft 116, having miter gear 117 fixed on it. Shaft 116 locked on both sides against axial movement by locking hubs 173. Each shaft 121 supported by flange-bearing 174, placed inside of faceplate 112 and by flange-bearing 175 placed inside of back-ring 147. Cluster 120 fixed on shaft 121 and has its miter gear 118 meshed with miter gear 117. Pinion 119 of cluster 120 meshed with pitch gear 131 of earring assembly 130, which shaft 132 supported in flange-bearings 176 and 177 placed inside of faceplate 112 and back-ring 147 respectively.

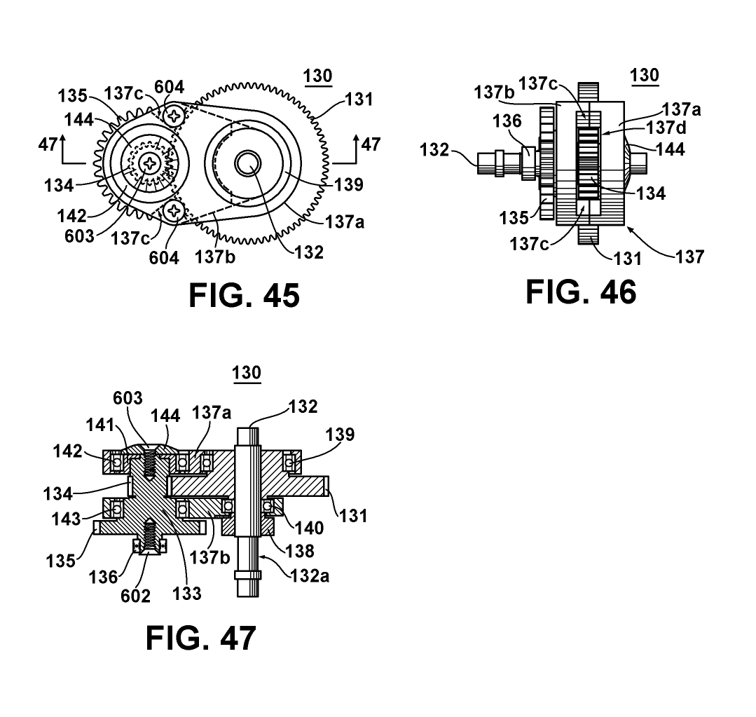

Referred now to FIGS. 44B and 45 through 47 earring assembly 130 has shell 137, which consists from two halves 137a and 137b placed from face-side and backside respectively. Those two halves of shell 137 fixed together by two screws 604. Half shell 137a has bearing 139 FIGS. 44B, 47, which supports hub of pitch gear 131. Shaft 132 inserted in pitch gear 131 and fixed in its hub. Other side of shaft 132 has bearing 140, dressed on its and inserted in half shell 137b for its support. Other inner side of bearing 140 has axial support by locking hub 138, fixed on shaft 132 outside of half shell 137b. Shaft 132 has clearance grove 132a against collision from cluster 122 of rotor 110 for case of high values of gain. Other side of half shell 137b has bearing 143, which supports cluster 133, inserted outside of half shell 137b. The cluster 133 has entry gear 135, remained outside of shell 137 and steering pinion 134, which meshed with pitch gear 131. Adapting flange 141 dressed over end of cluster 133 and supported in bearing 142, which placed in half shell 137a. Closing washer 144 with screw 603 fixed the cluster 133 against fall out. Grove follower 136 dressed on cluster 133 and fixed by screw 602 against fall out. Halves of shell 137 contacted only on small fixing bases 137c FIGS. 45, 46 enough for having holes for screws 604, so they aren't obstruct pitch gear 131. From other side those fixing bases 137c decreased for having big clearance window 137d FIG. 46 against collision from pitch gear 131 of neighbor earring assembly.

Referred now to FIG. 44B central cluster 122 supported by radial bearing 151 on shifting base 149. Additionally, the cluster 122 supported by thrust bearing 152, which placed on closing flange 150, which fixed on shifting base 149, providing additional fixation of inner ring of bearing 151. Central gear 124 of cluster 122 meshed with entry gears 135 of all earring assemblies 130. Grove followers 136 of all earring assemblies 130 placed inside of grove ring 123 of cluster 122. Flanged hub 153 fixed on central powering shaft 127 in vicinity of its shaft setup ring 153a, which thick enough for having setscrews inside it. Shifting base 149 has inside conical profile, correspondent to shape of the setup ring 153a, enough for desired clearance upon movement of shifting base. Flange side of flanged hub 153 fixed to face plate 112, using non-shown screws or rivets. Part of central powering shaft 127, protruded from flanged hub 153, used for centering the flanged hub 153 on faceplate 112 upon fixing the flanging hub 153 by entering in correspondent central hole in faceplate 112. Steady flange 155 enters inside of central hole of steady base 154 and fixed by non-shown screws. It has primary bearing 156 inside, supported by flanged hub 153. Also the steady flange 155 has secondary bearing 157 inside its other end, which supported by central powering shaft 127. The bearing 157 fixed in axial direction by closing hub 158, fixed on central powering shaft 127.

Referred now to FIGS. 44B, 48A and 49 steady flange 155 has three threaded holes, in which three radial rods 159 screwed on their threaded areas 159a, where central of those rods 159 oriented in 45 degrees up and back, and two other rods 159 are perpendicular to central, spanning in opposite directions. Peripheral ends of rods 159 are fixed inside of clamps 162 mounted on steady base 154, using pair screws with washers 163. Each radial rod 159 has cross-holes bearing 161 or extended cross-holes bearing 160 dressed on it, where extended cross-holes bearing placed only on central radial rod 159. Steady base 154 has three radial clearance dips 154d FIGS. 48A, 49 for moving each cross-holes bearing 161 or extended cross-holes bearing 160 in radial direction over rods 159 without obstruction. Shifting base 149 has three side-slots 149b on its periphery, which correspond in directions to radial rods 159, see also FIG. 50. Tangential rod 165 laid over each slot 149b in direction perpendicular to related radial rod 159 and fixed by clamps 166 on its ends. Those clamps 166 mounted on shifting base 149 by using one screw with washer 167 FIG. 50 per each clamp 166. Those tangential rods 165 inserted in other holes of related cross-holes bearings 161 or extended cross-holes bearing 160. This kind of connectivity between steady base 154 and shifting base 149 permits moving the shifting base 149 in any direction, but firmly disables any rotation of the shifting base 149. And so, rotation and moving of cluster 122 are decomposed. More than, the presented system of rods provides also retention functionality for having the shifting base 149 in fixed position along axis of rotor 110. Rotation disability of the shifting base 149 can be decomposed on radial component and tangential component from point of view of tolerances between rods 159, 165 and holes of cross-holes bearings 160 or 161. The radial component has its own base about of distance from center of nearest cross-holes bearing to center of rotor 110, and it is big. The tangential component has its own base about length of hole for tangential road 165, and it is significantly less than radial. So overall rotation disabilities can be less than desired. The problem resolved by using extended cross-holes bearing 160, which has crampons 160a on its sides. Those crampons 160a extend the tangential base by entering in saddles 164 mounted on shifting base 149.

Referred now to FIGS. 44B and 48A pitch flanged bracket 187 mount on shifting base 149 in a hole opened to inside space of the shifting base 149 and fixed by non-shown screws. Primary bearing 188 of pitch flanged bracket 187 supports pitch steering shaft 186. Other end of the pitch steering shaft 186 is supported by secondary bearing 189. Pitch pinion 126 fixed on pitch steering shaft 186 and meshed with internal gear 125 of central cluster 122. Shifting base 149 has a hole opened to outside, which provides clearance for pitch pinion 126. Pitch worm gear 190 fixed on other end of pitch steering shaft 186. Shifting base 149 has internal perimeter shape 149a correspondent to outer shape of steady flange 155 with clearance enough for unobstructed movement upon its shifting. Their shapes are generally circular, but have flat segment near vicinity of mounting pitch flanged bracket 187. Steady base 154 has hole 154a, which provides clearance enough for moving pitch flanged bracket 187 upon moving the shifting base 149 and permits using screwdriver upon mounting the pitch flanged bracket 187. Upper side of pitch flanged bracket 187 has worm support bracket 187a FIG. 48A, which inner end has flange-bearing 193 inside its hole and outer end has flange-bearing 194 inside its hole. Those flange-bearings support inner shaft 195a of telescopic universal joint assembly 195. Pitch worm 191 placed over inner shaft 195a inside of worm support bracket 187a and meshed with pitch worm gear 190. Locking hub 192 fixed inner shaft 195a against axial moving.

The telescopic universal joint assembly 195 consists from inner universal joint 195b, outer universal joint 195d and meshed spline-pair 195c between them Inner shaft 195a belongs to the inner universal joint 195b. Outer shaft 195e belongs to the outer universal joint 195d and supported by two flange-bearings 197 inserted in common hole of pitch bracket 196, which mounted on steady base 154 by non-shown screws. Locking hub 198 fixed outer shaft 195e against axial moving. Steady base 154 has clearance dip 154b near of vicinity of inner universal joint 195b, which enough for moving and rotation this universal joint. Other clearance dip 154c placed near, in vicinity of spline-pair 195c between sides of pitch bracket 196 and it is less deep, but enough for transverse moving the spline-pair segment. The outer shaft 195e is one of interfaces of steering tier of setup of rotor 110.

Steering of gain and skew incorporated in common Gain-Skew-node 200 or simple GS-node, which referenced on FIG. 44B without details. Detailed construction of it can be understood, looking on FIGS. 48A and 51 through 53. The GS-node 200 can be split on two logical domains: GS-variator 210 FIGS. 48A, 51 and 52 and Skew-to-Gain-compensator 240 FIGS. 48A, 52 and 53 or simple SG-compensator. Circular mounting base 201a of flange 201 of GS-variator 210 used as setup interface of entire GS-node 200, since flange 201 inserted in correspondent hole 154e of steady base 154 opened to outside, laying on it, and fixed there by non-shown screws. Direction of this interface will be referenced as bottom, and opposite as upper direction.

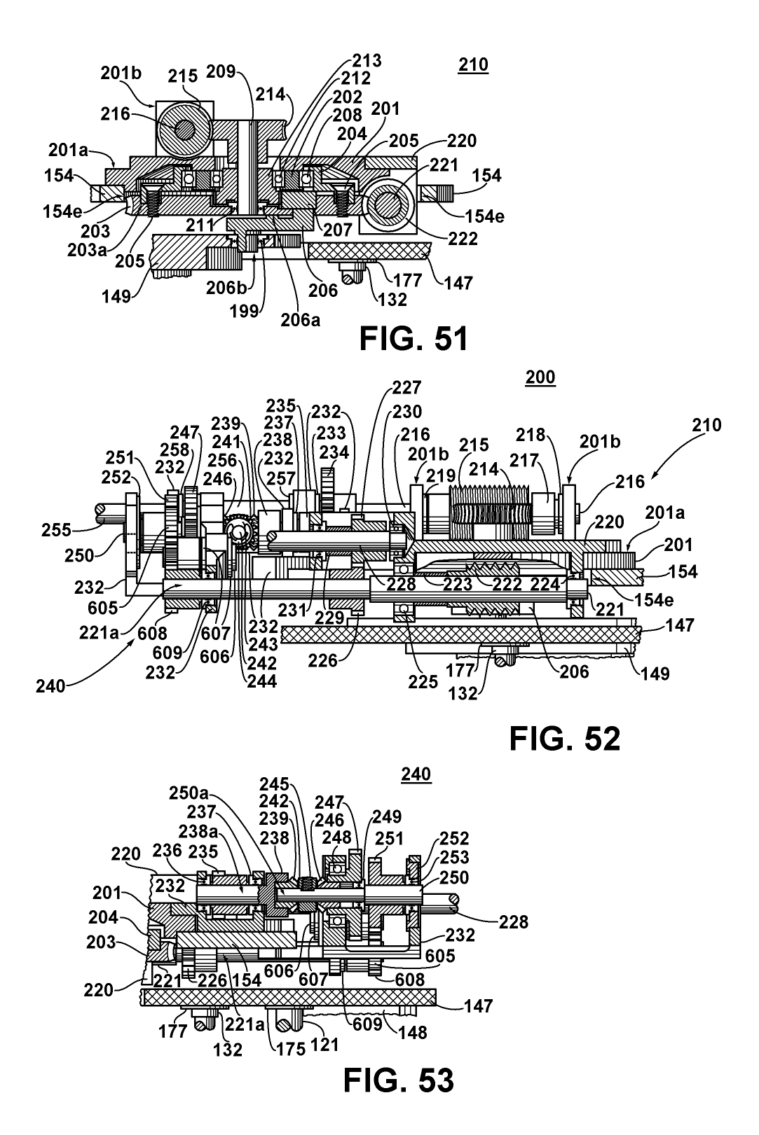

Flange 201 used for assembly inside it, from bottom direction, main components of GS-variator 210. Intermediate ring 202 FIG. 51 mounted inside of flange 201 and fixed to it by non-shown screws inserted from outside of flange 201. This fixation of the intermediate ring 202 is operation, which finalized assembling of content of flange 201. The intermediate ring 202 fixes outer bearing 208 and inner bearing 212, and placed between them. Retaining ring 204 supported by outer bearing 208 in radial and axial bottom directions and fixed on skew worm gear 203 by screws 205, using mounting grow 203a of the gear 203 for its centering. Center hole of the skew worm gear 203 has flange-bearing 211 inside it, which supports gain steering shaft 209 in radial and axial bottom directions. Gain gear 213 fixed on gain steering shaft 209, and its hub inserted into inner bearing 212, obtaining secondary radial and upper axial supports. The last upper axial support propagated to skew worm gear 203 also. The skew worm gear 203 has in its center circular dip in which the gain gear 213 can be rotated freely. Also the skew worm gear 203 has other rectangular dip in which toothed rack 207 placed and can be moved, slipping on its bottom and toothed-opposite surfaces. The toothed rack 207 meshed with gain gear 213 and connected with steering lead 206, which inserted from rectangular hole of skew worm gear 213, from its bottom, and fixed by non-shown screws. The steering lead 206 has slipping ledge 206a, which slips over bottom surface of skew worm gear 203, completing vertical support of toothed rack 207 and its own. Also the steering ledge has steering pin 206b, which enters inside of flange-bearing 199 placed in a hole on periphery of shifting base 109. Gain worm gear 214 fixed on gain steering shaft 209. Flange 201 has two G-worm supports 201b. Flange-bearings 218 and 219 inserted in inner and outer supports 201b respectively and support gain inner shaft 216, on which gain worm 215 fixed, meshing with gain worm gear 214. Locking hub 217 fixed gain inner shaft 216 against axial movement.

Skew bracket 220 mounted on mounting base 201a of flange 201 on side opposite to gain worm 215 and fixed by non-shown screws. Skew steering shaft 221 supported in skew bracket 220 by flange-bearing 224 on its end and by bearing 225 on its entry. Skew worm 222 is fixed on skew steering shaft 221 and meshed with skew worm gear 203, occupying sectored cylindrical space, milled inside of flange 201 for it. Spacer 223 placed on shaft 221 and used for propagate secondary axial support from bearing 225 fixed inside of skew bracket 220 by non-shown setscrews. The skew steering shaft 221 has tail 221a, on which gear 226 fixed. Skew outer shaft 228 placed in appropriate position and supported by flange-bearings 230 and 231 on its end and entry respectively, inserted in skew bracket 220. Gear 227 fixed on the skew outer shaft 228 and meshed with equal gear 226. Spacer 229 placed on skew outer shaft 228 and used for secondary axial support of the shaft. The skew outer shaft 228 is other of interfaces of steering tier of setup of rotor 110.

The GS-variator 210 permits having desired gain for any particular skew by placing steering pin 206b in desired shifted position. For this placement of steering pin 206b needed appropriate rotations of gain inner shaft 216 and skew steering shaft 221. But the GS-variator 210 has principal drawback for use: desired position of the steering pin isn't decomposable to gain and skew values on worm shafts of the variator, since induced gain depends from skew by its mechanics. Indeed, consider gain has fixed and skew changing. So, for having gain remain unchanged, gain worm gear 214 should be rotated with same angular speed as skew worm gear 203. But it fixed by gain worm 215 and induces adverse movement of toothed rack 207. So for having decomposable mechanics, the GS-variator 210 should be accompanied by a compensator, which will rotate the gain inner shaft 216 with speed exactly needed for rotating gain worm gear 214 with same angular speed as undergoes skew worm gear 203. This task can be accomplished explicitly, when gain inner shaft and skew outer shaft are under control of a computer or a sophisticated control. But doing this task implicitly, through pure mechanics has significant advantage, especially in electricity outage. And so, it accomplished by SG-compensator 240.

When the presented aircraft handling in biangular mode, for example by changing main angle, speed of changing gain about two times higher than speed of changing pitch. And so, this ratio is optimal for most operations and should be reflected in mechanics by default. It leads to necessity having additional reducer for gain for its desired fine handling. Main feature of the reducer is having coaxial relation of outer and inner shafts, so it should have two pair of gears with equally sum of teeth of gears in each pair. And particularly those two pairs of gears selected to be equal. This kind of reducer composed with SG-compensator 240. The composition means: inserting differential of SG-compensator 240 between two equal stages of the mentioned reducer.

Elements of SG-compensator 240 with reducer of gain distributed on gain bracket 232 FIGS. 48A, 52 and 53, which has complex shape, mounted on mounting base 201a of flange 201 and fixed by non-shown screws. Outer end of gain inner shaft 216 has additional support by flange-bearing 233, inserted in gain bracket 232. Flange-bearing 257 shares common hole with flange-bearing 233 and supports inner end of gain outer shaft 255, which entry supported by flange-bearing 258, inserted in other hole of gain bracket 232. Outer reduction pinion 254 fixed on gain outer shaft 255. Spacer 256 placed on gain outer shaft 255 and used for secondary axial support of the shaft Inner reduction gear 234 fixed on gain inner shaft 216 and meshed with inner reduction pinion 235, which fixed on tail of 238a of adapter 238, providing to it full rotational support in correspondence with flanged-bearings 236 and 237 inserted in end and entry holes of gain bracket 232 for the tail 238a respectively. The inner reduction gear 234 consumes extensible space in direction toward engine 300, so engine's body 301 has clearance dip 301b FIG. 44B, in which the inner reduction gear 234 enters particularly Inner miter gear 239 is fixed in adapter 238. Outer reduction gear 247 supported on its hub by bearing 248 FIG. 53, inserted in gain bracket 232, and it meshed with outer reduction pinion 254. Outer miter gear 246 fixed in hub of outer reduction gear 247. Adapting ring 252 inserted in big hole of gain bracket 232 and accommodated flange-bearing 253, which supports compensating shaft 250. The mentioned big hole created upon drilling hole for bearing 248 and used for setup too. Flange-bearing 249 inserted in central hole of outer reduction gear 247 and supports tail 250a of compensating shaft 250. Compensating gear 251 fixed on compensating shaft 250, completing its axial support. The tail 250a enters in central holes of outer and inner miter gears 246 and 239 and can rotate inside of those holes freely. Transverse shaft 242 has rectangular body in its center and freely rotated intermediate miter gears 241 on its ends, which axially supported and fixed by washers 243 and E-rings 244. Transverse shaft 242 with intermediate miter gears 241 placed relative inner and outer miter gears 239 and 246 in meshing position for creating differential before setup of compensating shaft 250. After it, tail 250a inserted in outer miter gear 246, central hole of transverse shaft 242 and inner miter gear 239. After it, tail 250a fixed in central hole of transverse shaft 242 by setscrew 245, creating a spider of the completed differential. Compensating pinion 608 fixed on tail 221a of skew steering shaft 221, which has additional support by flange bearing 609 inserted in gain bracket 232. Intermediate gear 605 meshed with compensating pinion 608 and compensating gear 251 and fixed on intermediate shaft 606, supported by pair of flange-bearings 607, inserted in gain bracket 232. The gain outer shaft 255 is last of interfaces of steering tier of setup of rotor 110.

The presented SG-compensator 240 permits composition of gain and skew values on gain outer shaft 255 and skew outer shaft 228 to gain and skew state of rotor, but imply strict mode of operation. This strict mode means: a non-rotated gain outer shaft 255 or skew outer shaft 228 should be in hold on or locked state, when other from them is rotated. Indeed, the differential of the SG-compensator imply mutually propagation of rotation from gain shaft to skew shaft and vice versa. Mechanical friction will diminish the effect, but nevertheless it will exist. Practically the problem can resolved upon using electromechanical control by servos of gain and skew, which compensate any adverse deviation of angular position of related shafts automatically. But for case of pure mechanical handling there should be mechanical elements for locking non-operable control shafts.

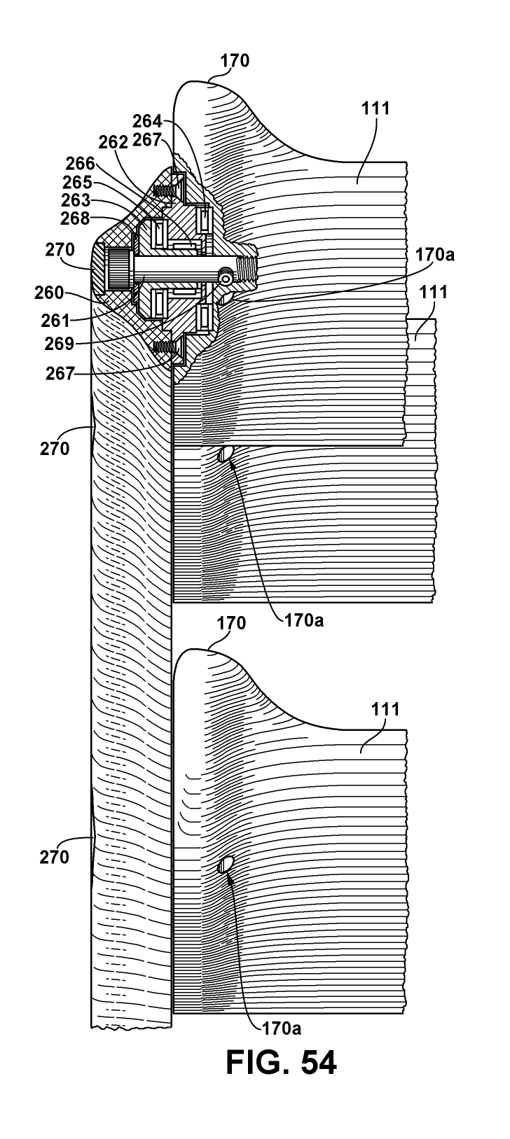

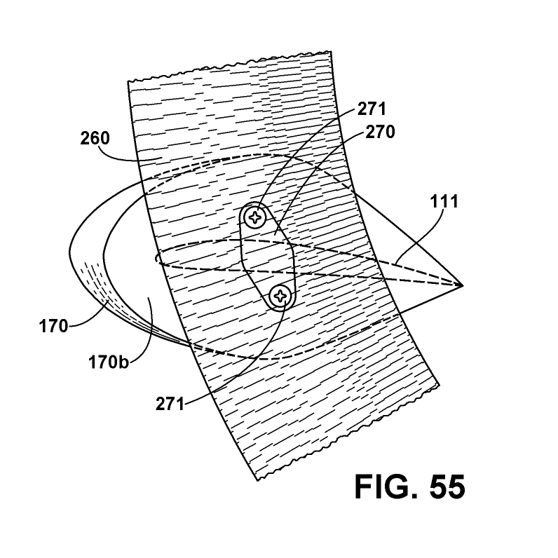

Referred to FIGS. 43, 54 and 55 end rotor support ring 260 has flat surface from side of wings 111 and streamlined surface from outer side, which can be characterized by bell like shape. It manufactured from composite material and has equidistant holes related to correspondent wings. Inside of those holes placed elements for connection wings 111. End wing adapting flanges 262 particularly inserted to holes of end rotor support ring 260 and fixed by screws 267 over outer ring of each adapting flange 262. End wing radial needle bearing 266 inserted in each adapting flange 262 from interior of support ring 260. End wing tubular flange 263 inserted in end wing radial needle bearing 266 from interior of support ring 260, having end wing secondary thrust bearing 265 between its flange and adapting flange 262. Washer 268 lays over tubular flange 263. End wing fairing 170 has flat end wing base 170b FIG. 55. And from this direction, it has an interior space used for its rotational mating with adapting flange 262, and end wing primary thrust bearing 264 laid over the adapting flange 262. End wing bolt 261 inserted through hole in support ring 260 in washer 268, tubular flange 263 and end wing fairing 170, where it screwed in correspondent thread. Two setscrews 269 fix the end wing bolt 261 against unscrewing, using setup holes 170a on both sides of end wing fairing 170. End wing seal 270 from plastic closes outer holes of the support ring 260 and fixed by two screws 271 FIG. 55. After this connection, thin gap remained between flat side of the support ring 260 and end wing base 170b with possibility of free rotation of entire wing 111, supported against consoled bending.

Referred to FIGS. 44C and 56 all three interfaces of steering rotor setup tier: outer shaft 195a for pitch, gain outer shaft 255 and skew outer shaft 228 connected with related coupled shafts 274 of PGS gearbox 280 by PGS couplings 259. The PGS gearbox 280 placed between rotor socket 106 and side force plate 290, and its body 273 fixed to the side force plate 290 by non-shown screws. Rotor socket 106 has three windows 272, which can be crossed by PGS couplings 259. In time of rotor setup, couplings 259 dressed on shafts 274 and lay freely on PGS gearbox 280. After other tiers will be secured, those couplings 259 moved up and fixed from both sides on respective shafts. Windows 292a, 292b and 292c in side force plate 290 used for this operation for pitch, gain and skew respectively. Coupled shafts 274 of PGS gearbox 280 supported by pair of flanged-bearings 275 from outside and inside of body 273 and axially secured by locking hubs 276. Vertical miter gears 281′ placed inside of PGS gearbox on ends of coupled shafts 274 in different vertical positions. Horizontal miter gears 281″ meshed with vertical miter gears 281′ and fixed on primary shafts 277, 278 and 279 for pitch, gain and skew respectively. Each of those primary shafts supported by pair of flange-bearings 282 FIG. 44C and has non-shown locking hub too. Also those primary shafts are tubular to be lightweight. Horizontal miter gear 281″ can be placed on its shaft from either side of vertical miter gear 281′. This permits adjust correct direction of rotation of any primary shaft on both sides of the aircraft 100. Also construction of right side rotor 110′ is exactly symmetrical to left side rotor 110, except of worms used for PGS steering. They on both can be used of right-handed kind, since the PGS gearbox permits simple adjust directions of steering with end use control. Also construction of SG-compensator is invariant to chirality of worms, since it used two worms in compensation loop. They only need have same chirality. Body 273 of PGS gearbox 280 is opened to direction of side force plate 290, which has maintenance windows 291a, 291b and 291c for pitch, gain and skew respectively. Separated sheets or common sheet can close all setup and maintenance windows after respective operation.

Referred to FIGS. 44F, 56 and 60 secondary shafts 360, 361 and 362 for pitch, gain and skew respectively connected with they respective primary shafts 277, 278 and 279 by using universal joints 367 FIG. 56. Also primary shafts near of that connection have adapting tubes 277a, 278a and 279a for pitch, gain and skew respectively, which used for adapt total length of both primary and secondary shafts. Those secondary shafts referenced for right side of aircraft 100 as 360′, 361′ and 362′ for pitch, gain and skew respectively. All that secondary shafts go to direction of cockpit 440 FIG. 44F. Right side secondary shafts are more inclined in horizontal direction and utilized some holes or windows in right side force plate 290.

Referred to FIGS. 44E and 56 elements of locker 312 of rotor 110 mounted on engine 300. The entire locker 312 is kind of band brake, which used on some bicycles, but adapted to have precision control. Locker's drum 313 mounted on setup flange 302b of hollow shaft 302 by using non-shown screws. Locker's band 314 with frictional lining 315 goes over perimeter of the drum 313 on some distance, when locker 312 is in non-locked state. Looking additionally on FIG. 57, one end of band 314 is dressed over axel on base 327, which fixed on engine's lid 306 by screws 328. Also the end of band 314 pivotally fixed on the axel 327 by washer 329 and screw 330 against fall out. Other end of band 314 pivotally fixed on end of pulling lever 317 by sharing common pulling axel 316. The pulling lever 317 fixed to its shaft 319 by nut with washer 320 and can pivotally rotated with the shaft 319 relative to its base 318 FIG. 56, which fixed on engine's lid 306 by non-shown screws. Other end of pulling lever 317 has axel 323 inserted from engine's side to correspondent hole. Grove follower 324 dressed on the axel 323 from other side of lever 327 between two washers 325 FIG. 57 and fixed by screw 326 together with the axel 323 against fall out. Locker's main bracket 331 mounted on engine's lid 306 and fixed by four screws 332. Locker's screw 335 fixed on outer locking shaft 336, which supported by flange-bearing 337, inserted in bottom side of locker's main bracket 331, and by two flange-bearings 338, inserted in upper side of locker's main bracket 331. Threaded lead 334 can move in vertical direction upon rotation of locker's screw 335 inside it. Conducting rod 333 fixed on locker's main bracket 331 parallel to locker's screw 335 and inserted in corresponding hole of threaded lead 334, additionally aligning it upon its movement. The threaded lead 334 has a slot or grove in which grove follower 324 of pulling lever 317 placed and can move in horizontal direction. Also the threaded lead 334 has a thin slot from direction of pulling lever 317, in which remained area of end of the pulling lever 317 over diameter of grove follower 324 can move freely for clearance or for additional aligning of the pulling lever 317. It can be understood from the presented construction, rotation of outer locking shaft 336 permits precision control of locking state of rotor 110. Locking hub 339 fixed on outer locking shaft 336 over top of upper flange-bearing 338, providing additional axial support. Miter gear 340 fixed on upper end of outer locking shaft 336 and oriented to down. It used for link with right side rotor's locker, and on the right side it placed in opposite bottom place, instead of hub locker 339.

Referred to FIGS. 44E and 57 locker's link bracket 341 mounted on engine's lid 306 and fixed by two screws with washers 342. Side linking shaft 344 is supported by two flange-bearings 345 in locker's link bracket 341. Miter gear 343 fixed on inner end of side linking shaft 344, meshing with miter gear 340. Locking hub 346 completes axial support of side linking shaft 344. Locker link coupling 347 connect side linking shaft 344 with center linking shaft 348, which used for have ability for setup of the entire locker link itself.

Referred to FIGS. 44F and 56 lock gears bracket 350 fixed on floor of fuselage 101 by non-shown screws. End of outer locking shaft 336 enters to the lock gears bracket 350 from up and supported by flange-bearing 351. Miter gear 352 fixed on end of outer locking shaft 336 and meshed with miter gear 353, which fixed on primary lock shaft 354. The primary lock shaft 354 supported by two non-referenced flange-bearings inside of lock gear brackets 350 and has additional axial support by locking hub 356 FIG. 56, fixed on it. Also the primary lock shaft 354 significantly protruded to back, permitting place the miter gear on opposite side for adjust rotation of lock shaft 354 to correct direction upon switching it on control side.

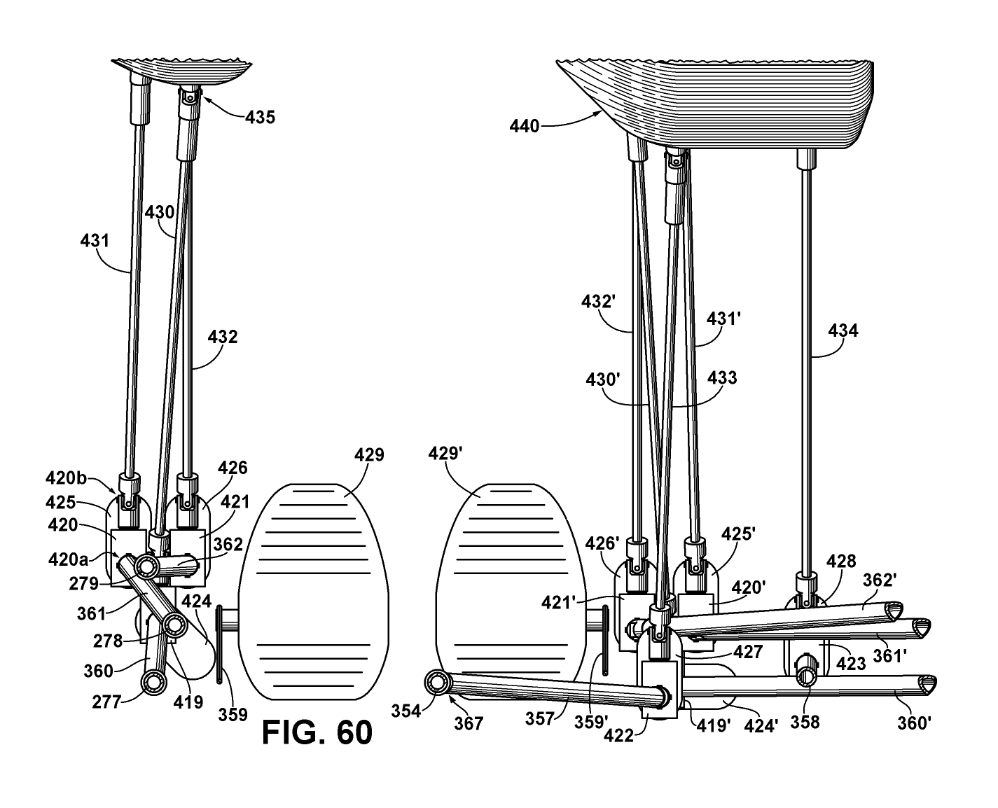

Referred to FIGS. 44F and 60 secondary lock shaft 357 connected with primary lock shaft 354 by universal joint 367, like as same connections for PGS controls. By its way to direction of cockpit 440, the secondary lock shaft 357 goes through hole 299a in stand 299 of pilot seat 289.

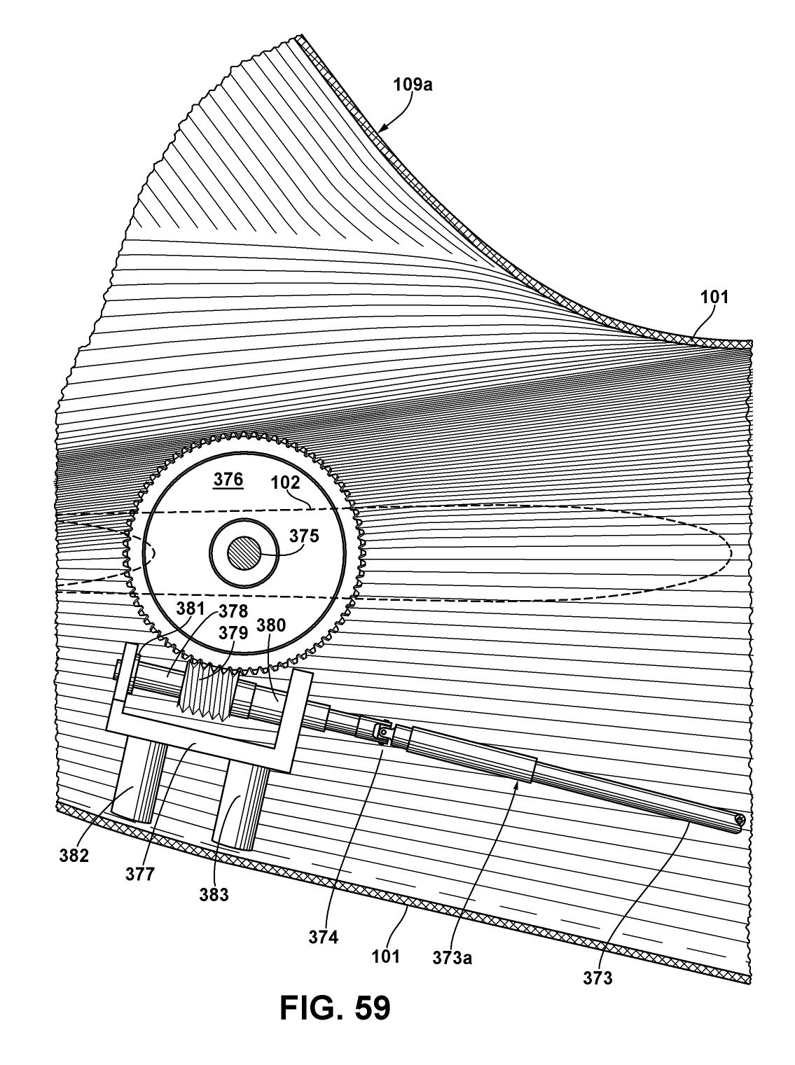

Referred to FIG. 59 stabilator worm gear 376 resided inside of fuselage 101 under vertical stabilizer 109a and fixed on stabilator pivot shaft 375, which connects two sided stabilators 102 altogether. Stabilator worm bracket 377 mounted on aft support 382 and forward support 383 on floor of fuselage 101, parallel to the floor, under stabilator worm gear 376. Stabilator steering shaft 378 supported by flange-bearing 381 in stabilator worm bracket 377 on its end. Entry of stabilator steering shaft 378 supported by non-shown bearing inside of stabilator worm bracket 377. Stabilator worm 379 fixed on stabilator steering shaft 378 and meshed with stabilator worm gear 376. Spacer 380 placed on stabilator steering shaft 378, completing its axial fixation. Primary stabilator pitch shaft 373 connected to stabilator steering shaft 378 by universal joint 374, having near it adapting tube 373a. Optionally to presented construction stabilator worm bracket 377 can be extended for accept additional support from stabilator pivot shaft 375, which prevent changing axial distance between stabilator worm gear 376 and stabilator worm 379 under deformation of fuselage, induced by forces from stabilators. In this case, rubber washers should be inserted between stabilator worm bracket 377 and both supports 382 and 383.

Referred to FIG. 56 stabilator pitch (SP) conducting bracket 368 mounted on floor of fuselage 101 near of aft vicinity of the floor horizontal segment and a bit shifted toward left side of fuselage 101 from its centerline. SP conducting connector 369 supported by two non-referenced flange-bearings inside of SP conducting bracket 368 and axially secured by locking hub 370 fixed on its tail 369a. Universal joint 372 connected with stabilator pitch shaft 373 from one side and inserted in the SP conducting connector 369 from other side, where it fixed. Universal joint 371 connects tail 369a of SP conducting connector 369 with secondary stabilator pitch shaft 358, which goes to direction of cockpit 440, see FIG. 44F also.

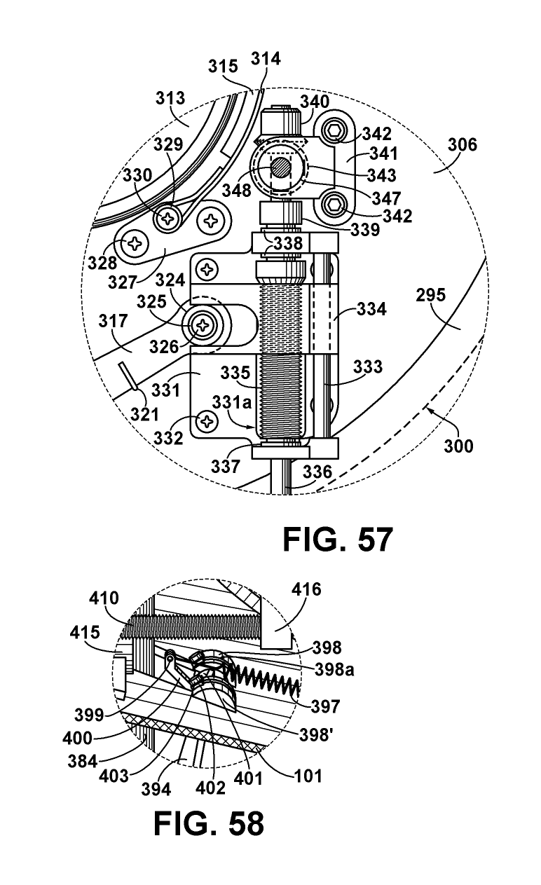

Parking support 384 placed on each side of presented aircraft and occupies interior space near aft vicinity of rotor's socket 106 outside inner level in axial direction of engine 300. It can be retract or put out upon respective rotation of retracting screw 389, which screwed inside of related threaded complement, placed inside of the parking support 384, which manufactured from high diameter tube from lightweight alloy. Bottom end 384a of the parking support 384 slotted and rounded, which permits insert in the slot the parking wheel 385, freely rotated on axel 386. Keying rib 387 fixedly attached to aft side of the parking support 384, which prevent its rotation in accordance with corresponding slot in conductor 388, in which the parking support 384 can slippery move, and which is fixed to fuselage 101. Heel 390 fixed on upper side of fuselage 101 and permits free rotation of retracting screw 389 in it and secures the retracting screw 389 against fall out. Retracting gear 391 fixed on non-threaded segment of the retracting screw 389 and meshed with retracting pinion 392 of retracting servo 393, which fixed on fuselage 101. Parking hatch 394 can be open by parking wheel 385 itself, when the parking support 384 going down, and its shape is exactly corresponded to shape of opened window and can have pressurizing level of sealing. This ability permitted by related level of pivot system of the hatch 394, which detailed on FIG. 58. Outer and inner side segmented saddles 398 and 398′ respectively fixed on fuselage 101 and have inside each a segmented pivot 401, which fixed to related side of parking hatch 394 and can rotationally move inside interior of saddles. These segmented pivots 401 additionally secured by related radial washers 402 with screws 403, which inserted in slots 398a and screwed into these segmented pivots 401. Lever 400 fixed on hatch 394 and used for retracting the hatch 394 by spring 397, pivotally connected to the axel 399 in end of the lever 400. Other end of the spring 397 pivotally fixed on support 396 mounted on fuselage 101. Shape and shifting of outer end of retracting hatch 394 optimally corresponds to tubular shape of parking support 384 and to toroidal shape of parking wheel 385 for retracting operation. Its begins with slipping the end of parking hatch 394 over forward-outer side of parking support 384 and smoothly moves on forward outer side of parking wheel 385. In the points the parking wheel 385 begins rotate, instead of problematic slipping, until entire wheel 385 will over the hatch 394, and so entire retracting performed without obstructions. Electromechanical latch 395 mounted inside of fuselage 101, near aft vicinity of parking hatch 394, and secured closed state of the parking hatch 394.

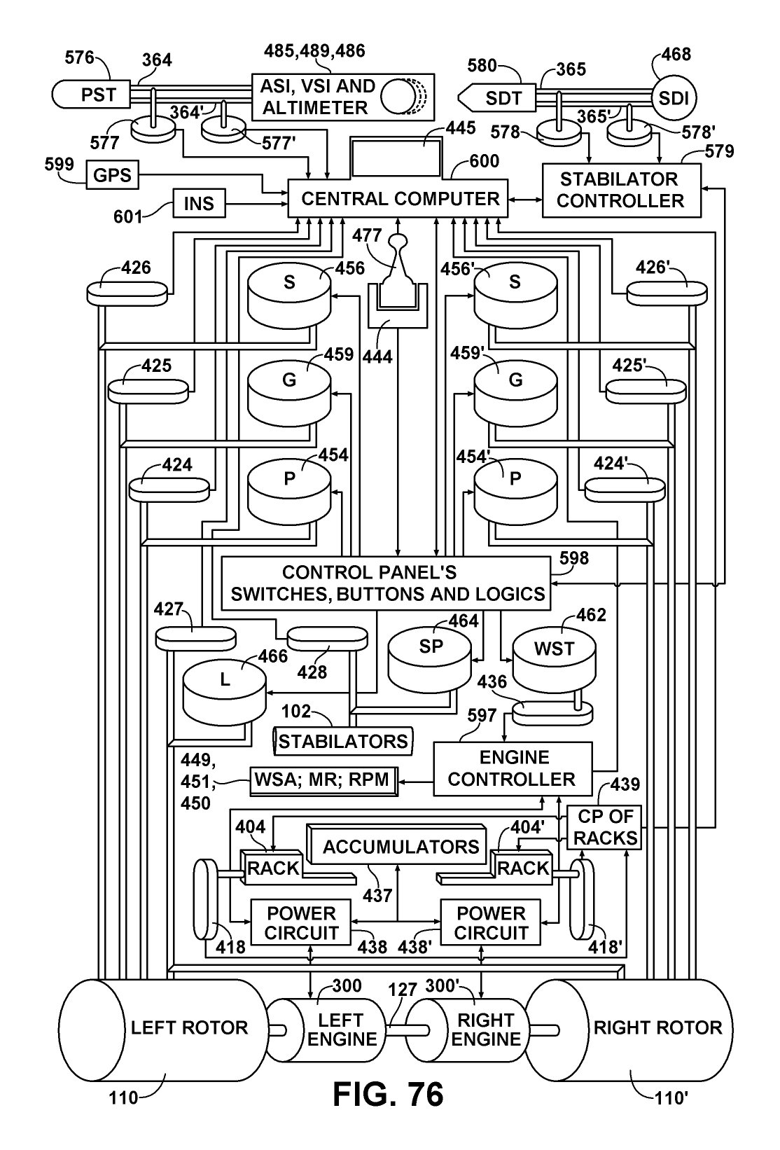

Referred to FIG. 56 main part of accumulators 437 FIG. 76 of aircraft 100 placed on two racks 404 FIGS. 56 and 404′ FIG. 76 on each side of the aircraft 100. Accumulators 437 fixed on shelves 405, but they aren't shown itself, due target of presenting others elements of aircraft's interior. Additionally, aircraft 100 has place for accumulators in its forward apartment, along forward-side walls. FIG. 44F provides example of it for nose site accumulators 349. This position of accumulators' permits shifting center of gravity to forward, which is desirable, since can decrease moment compensating force provided by stabilators 102, which work in partial downwash. Additionally, each accumulator rack can be moved in flight or before it in longitudinal direction. It permits alleviate moment changing due variability of aircraft's load, which can shift needed operating range for stabilators outside of workable limits upon takeoff or upon cruise. Also it can be used as assistance for stabilators for optimizing performance.

Referred to FIG. 56 accumulator rack 404 placed on two saddles 406, which placed relative axis of rotor 110 in position, permitted to rack 404 be very near to elements of rotor's locker 312 without obstruction upon its slipping over saddles 406. Saddles 406 are mounted on aft-supports 407 and forward-supports 408, which fixed to fuselage 101. Bottom sliding plate 409 fixed to rack 404 and secures it against fall out from saddles 406. Threaded rib 416 mounted on forward end of bottom sliding plate 409. Screw 410 can move the rack 404 upon its rotation. Forward-support 411 for screw 410 mounted between pair of forward-supports 408 and fixed to them by using screws 417. Aft-support 412 for screw 410 fixed to inclined floor of fuselage 101. Rack moving gear 413 fixed on screw 410 near of aft-support 412 and meshed with rack moving pinion 414 of rack moving servo 415, mounted on floor of fuselage 101. Rack position encoder 418 rotationally connected on its entry to shaft of screw 410 protruded from forward side of screw's forward-support 411 and mounted on bottom side of one or both saddles 410.

As optional variant of presented implementation of movable rack 404 of accumulators 437, it can be modified for having only three shelves 405 in vertical direction, lowering center of gravity, but be two times longer, since it permitted by clearance in presented implementation. For this case it can be on 40 percents thinner in axial direction, increasing cargo space between rotors. Also longitudinal movement can be increased for better alleviating of the moment issue.

Referred to FIG. 44F nose wheel node 286 mounted on forward floor of fuselage 101, to which nose support fork with damper 287 FIG. 43 connected. Sensors port 363 mounted inside nose of fuselage, having PST 576 and SDT 580 connected to it outside, see FIG. 43. Pitot pressure hose 364, static pressure hose 364′, upward pressure hose 365 and downward pressure hose 365′ connected to the sensors port 363 and go to direction of cockpit 440. Also the sensors port 363 has in its center a socket, to which connected pair of electrical wires 366 for anti-icing heaters of PST and SDT from direction of cockpit 440.

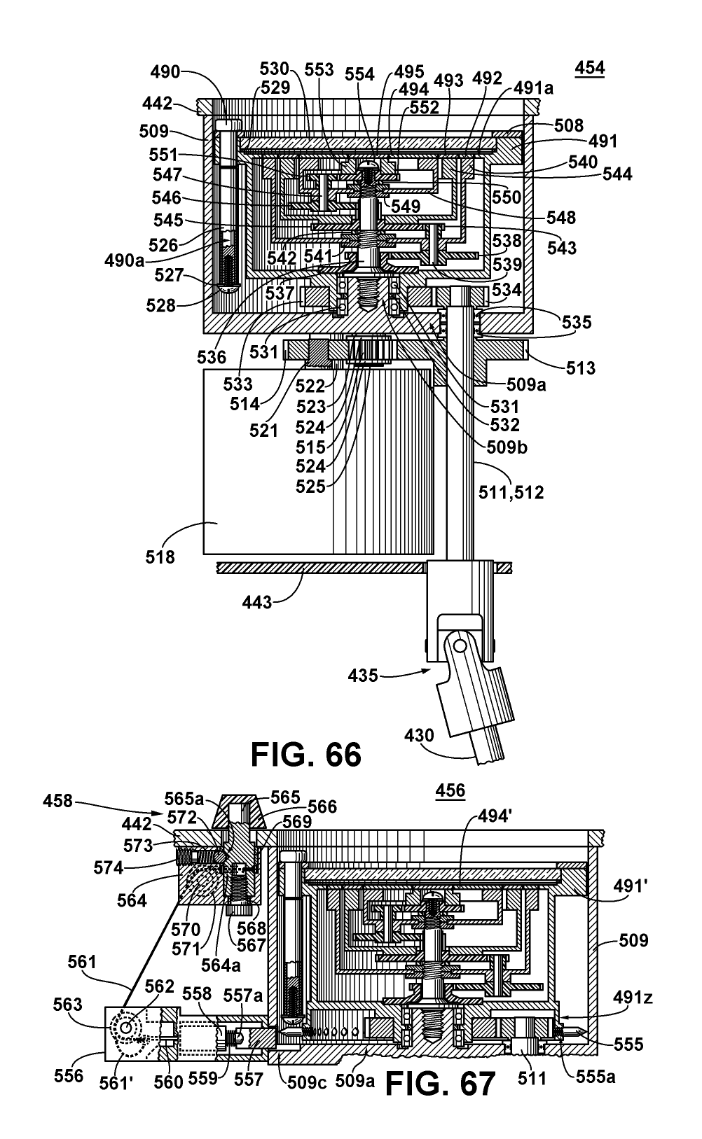

Referred to FIG. 60 all secondary control shafts: 360, 361, 362, 360′, 361′, 362′, 357 and 358 connected to diverters: 419, 420, 421, 419′, 420′, 421′, 422 and 423 respectively. There each diverter, for example left gain diverter 420, is a box, having inside pair of meshed miter gears on shafts, supported with related bearings, which has outside horizontal universal joint 420a and vertical universal joint 420b. So secondary shaft of left gain 361 connected to horizontal universal joint 420a and vertical universal joint 420b used for linking to upper universal joint 435 mounted on exit shaft 512 FIG. 66 of respective trimmer of cockpit 440. And so linking shafts 430, 431, 432, 430′, 431′, 432′, 433 and 434 connect diverters 419, 420, 421, 419′, 420′, 421′, 422 and 423 to related upper universal joints 435 respectively Inner shaft of each horizontal universal joint goes through its diverter and rotationally connected to related encoder, fixed against rotation on the diverter or fuselage. So diverters 419, 420, 421, 419′, 420′, 421′, 422 and 423 rotationally connected with encoders 424, 425, 426, 424′, 425′, 426′, 427 and 428 respectively. Left pedal 429 and right pedal 429′ placed under cockpit 440 and connected by respective wires 359 and 359′ to rudder 109 FIG. 43, see also FIG. 44F. Some non-shown pulleys used for conducting wires 359 and 359′. Connectivity and using of rudder's pedals 429 and 429′ are same as for conventional airplane.

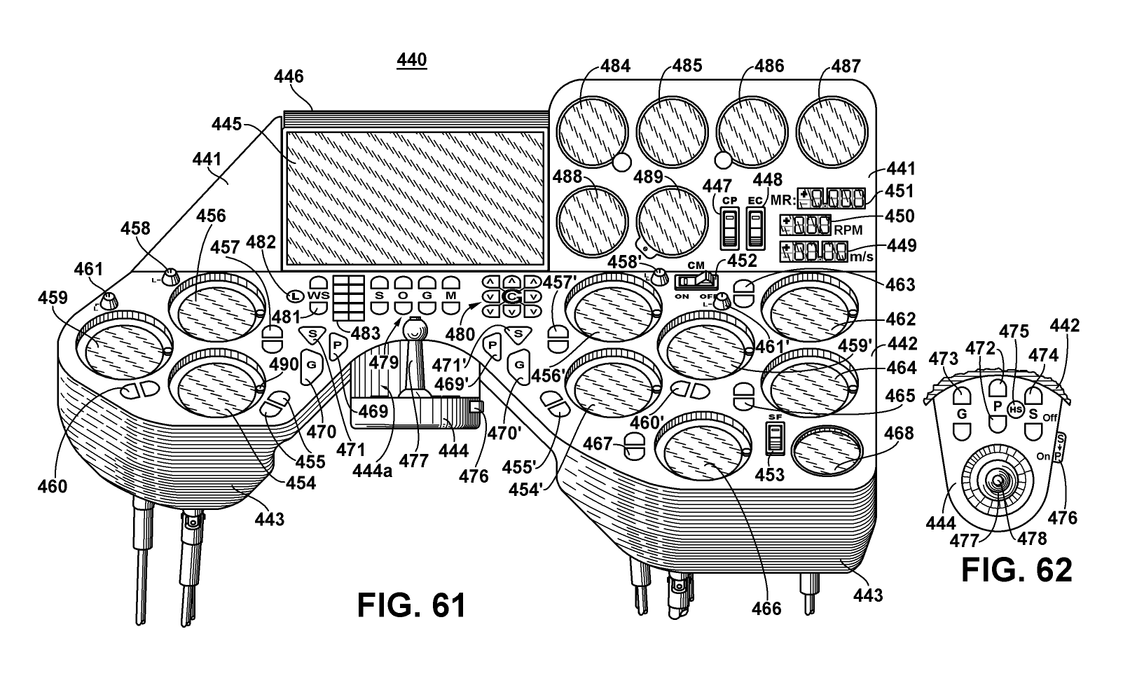

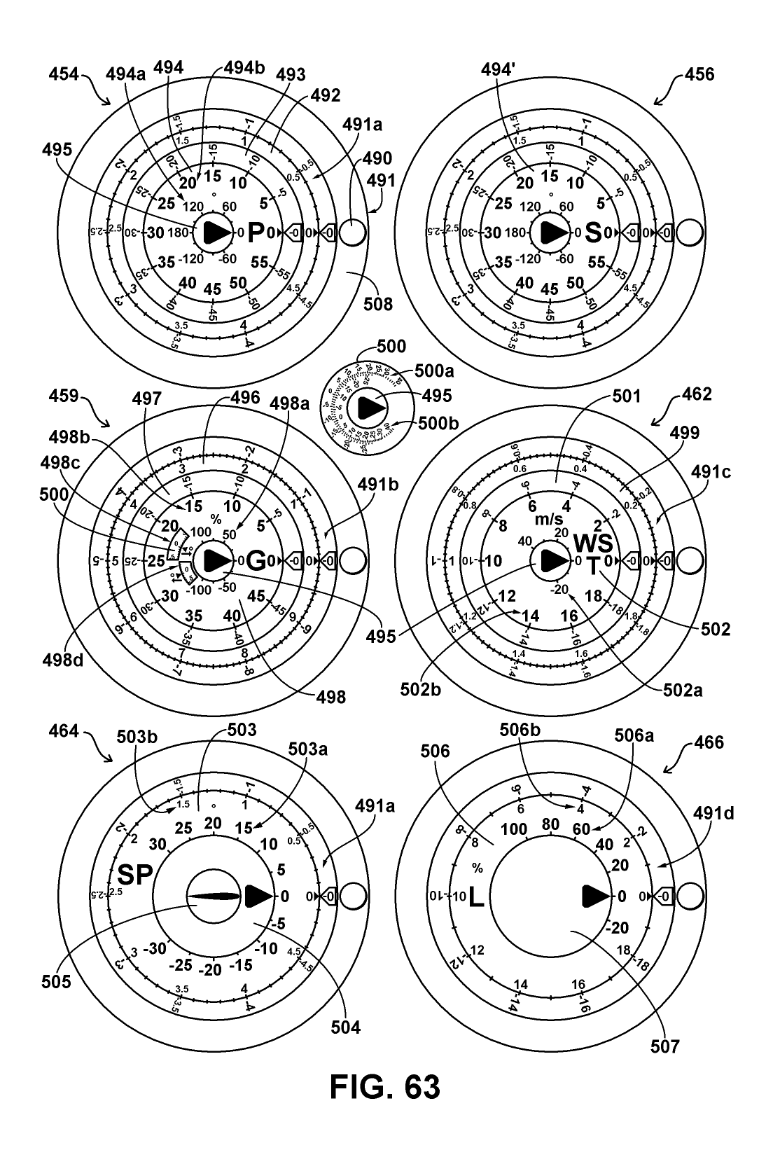

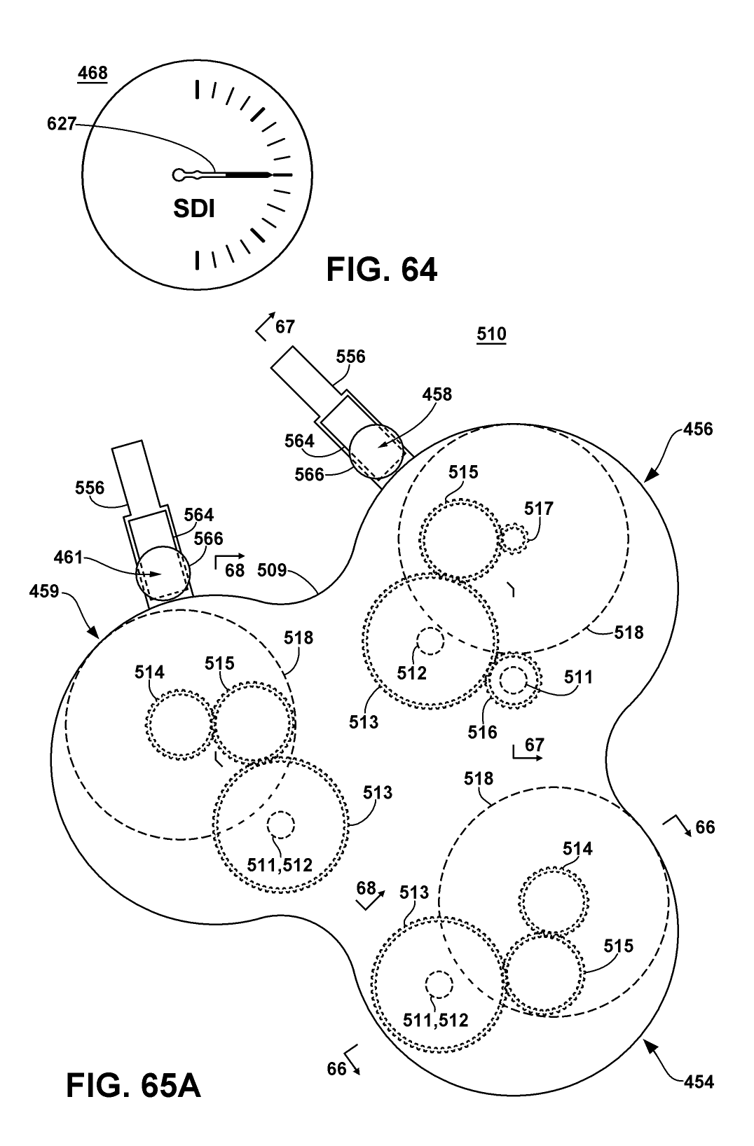

Referred to FIG. 61 cockpit 440 has two main domains: indication panel 441, which has generally vertical orientation and control panel 442, which is inclined about on 45 degrees. Display 445 of central computer 600 FIG. 76 placed on indication panel 441 under anti-glaring canvas 446 and pivotally inclined toward the canvas 446 on some angle. CP-switch 447 placed on indicator panel 441 and used for managing power state of components of Control Panel 442. EC-switch 448 placed on indicator panel 441 and used for managing power state of Engine Controller 597 FIG. 76. WSA-indicator 449 placed on indicator panel 441 and used for indication of actual winding speed of rotors 110 and 110′ by engine controller 597. RPM-indicator 450 placed on indicator panel 441 and used for indication of RPM of rotors 110 and 110′ by engine controller 597. MR-indicator 451 placed on indicator panel 441 and used for indication of Moment Ratio (external) on common powering shaft 127 FIG. 76 by engine controller 597, with using some preset value of entire weight of aircraft 100 as level of the MR normalization.

CM-switch 452 placed on control panel 442 and used for enabling Computer Management over all trimmers of control panel 442. SF-switch 453 placed on control panel 442 and used for enable automatic Stream Following mode of operation of stabilators 102 FIG. 76 from side of stabilator controller 579 FIG. 76.

Control panel 442 contains a number of trimmers, which used for control and indication of handling-able mechanical features of aircraft 100. Those features include: each side PGS state, target winding speed of rotors (WST), stabilator pitch (SP) and locking state of rotors. Those trimmers mounted on the control panel 442 from its bottom and closed by cover 443 from sides of control panel 442 and their bottoms, together with other elements of control panel 442, see FIG. 66 also. Trimmers for PGS state placed symmetrically for pilot. Pitch-trimmers 454 and 454′ placed on inside-down of left and right sides respectively. Skew-trimmers 456 and 456′ placed on inside-up of left and right sides respectively. Gain-trimmers 459 and 459′ placed on outside-middle of left and right sides respectively. Meaning of this placement for Gain-trimmers is: reflecting maximal impact of gain change on turning operations. WST-trimmer 462 placed on right side under WSA-indicator 449. SP-trimmer 464 placed in middle height of right side over SF-switch 453, which operation inserts the SP-trimmer 464 in automatic controlled loop. Also there is Stream Deviation Indicator (SDI) 468 under the SP-trimmer 464, which can assist for case of manual handling of the SP-trimmer 464 or indicate efficiency of the automatic controlled loop. Lock-trimmer 466 placed in remained bottom medial-right side. Manual handling of each trimmer permitted by retractable handler 490, which can directly rotate face side of trimmer, see FIG. 66 also. Exactly same rotation of face side of each trimmer with its handle 490 performs in case non-manual handling. So face side of each trimmer placed under face level of control panel 442, including its handler 490 too. It resolves possible obstruction problem for pilot, since self-rotating of handle 490 over level of control panel 442 can be dangerous.

Each trimmer can change its handled value by using pair of buttons near it, where lower button used for decreasing value with some speed, and upper button used for increasing it with same speed. Buttons 455 and 455′ changes values of pitch-trimmers 454 and 454′ respectively. Buttons 457 and 457′ changes values of skew-trimmers 456 and 456′ respectively. Buttons 460 and 460′ changes values of gain-trimmers 459 and 459′ respectively. Buttons 463, 465 and 467 changes values of WST-trimmer 462, SP-trimmer 464 and lock-trimmer 466 respectively. Orientation of buttons for pitch and gain changing isn't vertical. Their inclinations reflect impact of related feature on turning operation upon normal mode of turning, which includes cruise, see explanation for FIG. 42. This impact is moderate for pitch and high for gain. Also directions of those inclinations reflected the normal mode of turning. For example inclination of left gain buttons hints: “press leftist button of left gain for turning to left”. Also this turning action should be accompanied by pressing of opposite button of other side gain, which for this example will be “leftist of right gain”.

Gain and skew trimmers should have abilities for strict handling as it was mentioned upon describing of SG-compensator 240. So they have special locking knobs on their upper-outer sides. Locking knobs 458 and 458′ belong to skew-trimmers 456 and 456′ respectively. Locking knobs 461 and 461′ belong to gain-trimmers 459 and 459′ respectively. In case of computer managed handling, impact of those locking knobs is irrelevant. But for case of manual handling, locking knob of each desired being locked trimmer should be rotated to locking position, which indicated by letter “L” near a tick of the exact position. And for case of non-manual handling without computer management, any locking knob can be in locking positions; it will be unlocked automatically. Also each locking knob fixes its normal or locking position with some force, but it doesn't fix its intermediate position.

Joystick pad 444 mounted some below upper level of control panel 442 on its concave support 444a, which adjusted with central concave rim of the control panel 442. It has joystick 477 mounted on its center and other controls, see FIG. 62 also. Pairs of buttons of common controls placed in forward of joystick 477. Those pairs are: common pitch 472, common gain 473 and common skew 474. There upper buttons increase related value for both rotors and lower buttons decrease it. HS-button 475 placed between pairs of common pitch and common skew buttons. When the button pressed, both side trimmers of pitch and skew will be operated with High Speed of change in case of having related commands for changing. This high-speed feature needed for beginning and finalizing aerial braking on runway, when pitch and skew drastically changed simultaneously, see FIG. 40T and FIG. 40U. S->P-switch 476 placed on right side wall of the pad 444. It enables for pitch-trimmers follow with same speed and direction after changes of skew-trimmers, so only common skew buttons 474 can be used. This feature services all runway operations and also was referenced as “propelling” mode; see FIGS. 24A, 39 and 40A.

Buttons for sides differential operations placed on respective sides from central of control panel 442. Those differential buttons for pitch are P-buttons 469 and 469′ for left and right side respectively. Same kind buttons for gain are G-buttons 470 and 470′. And for skew they are 471 and 471'S-buttons. Pressing of each of those buttons will decrease related value on side, where the button was pressed, and increase related value on other side. The decreasing was selected, because decreased value for pitch and gain placed inside of normal mode turning P-buttons and G-buttons service turning operation for more convenient way than pair buttons, placed near trimmers. And S-buttons placed there for completeness. So all buttons reflect their “decreasing” action, having shape with narrowed end on bottom. Additionally P-buttons and G-buttons have side-pointing shift of the bottom end and increased high, which reflects their impact on turning's ability.

Prior to this point all described handling buttons were designed for operation without using computer managed handling, i.e. CM-switch 452 should be in “OFF” position for it. In the mode only simple electromechanical logic used for their variations. It provided additional level of redundancy to computer managed handling. And manual handling of trimmers is third, lowest level of redundancy. This architecture was selected, because the presented aircraft is experimental and all tiers of its entire handling pipeline should be researched and optimized. So for end user aircraft some redundancy levels can be simplified or eliminated, leaving more simplified aircraft handling interface, like as only components of computer managed handling.

Elements of computer managed handling placed directly under display 445 and additionally included joystick 477 with capture button 478 FIG. 62 on its top. The capture button 478 used for enable the joystick 477 and store its initial position and initial values of control features as reference point for future deviation of the joystick 477 from its initial position. And so handling of presented aircraft with joystick is generally variational, which permits accommodate very high operative ranges of handling features, having high variation sensitivity for particular operations, for pilot friendly convenient handling. For simplest kind of this handling, computer sophisticate interprets spatial motion of joystick to spatial and cinematic evolution of aircraft. Also those kinds of such interpretation can be flexible parameterized and switched by pilot's demand for different operations.

Pad of common handling 479 placed in center under display 445 and has four pairs of buttons, where upper buttons increase respected values and bottom buttons decrease. There S-buttons manage skew, O-buttons manage opposite value of biangular control, M-buttons manage main value of biangular control and G-buttons manage difference between main and opposite values of biangular control, which variations for low gain in pitch-mode of biangular control very near to variations of gain of PGS state. So this parameter can be considered as high level gain or biangular gain, and G-button placed between O-button and M-button for reflecting its difference nature. All this SOGM-buttons manage respected parameters for both sides' rotors simultaneously, reflected in word “common” in name the pad 479.

Pad of in turn handling 480 placed on right side from pad of common handling 479. It has in its center C-letter inside of G-letter. The G-letter connected by diagonal lines to buttons in four corners of the pad 480. Those corner buttons used for managing high-level gain on same manner as used for G-buttons 470 and 470′. Here bottom-corner buttons decrease high level gain value for side where it was pressed and simultaneously increase it for opposite side. This bottom corner buttons used for normal mode of turning operation. Variation of high-level gain for turning on cruise operation can be simple deduced looking in table on FIG. 42. It has same sign as for variation of gain of PGS state and a bit higher. And so same logic for turning using high-level gain used as for low-level gain. It also reflected in bottom direction arrow signs pictured on lower corner buttons. Upper corners buttons used for case of inverted mode of turning, which applicable for much of operations upon descent of presented aircraft. Some kind of high-level pitch can be defined for biangular mode, like as it was for high-level gain. It will be simple average value of opposite and main angles. But I don't use the word “pitch” for this value. It is better use word “collective” for each side rotor, like it used for rotor of helicopter, since the word has more universal meaning for both modes of biangular handling, like as word “gain”. So C-letter in center of the pad 480 hints on the word “collective”, like G-letter on word “gain”. Center side buttons of the pad 480 used for decrease collective angle of rotor on side where the button was pressed and increase for opposite side and it reflected in bottom direction arrow signs pictured on them. It is OK for normal mode of turning, but for inverted mode here needs other buttons for intuitive handling, like as upper corner buttons used for gain. Those buttons can be added to each respected side of the pad 480, but there is other way for the intuitive handling. Instead of looking to opposite direction buttons, which yet needs some switch in thinking, better is use the switch as thinking for normal mode of turning managed by inside-turn controls, and for inverted mode of turning as managed by outside-turn controls. So outer-turn low corner and center side buttons of the pad 480 can be used for initiation the turning Center upper button of the pad 480 increases collective angles for both rotors simultaneously and it can be used for assistance in coordinated turn, decreasing inside-turn slipping upon entering in turn. Similarly, center bottom button of the pad 480 decreases collective angles for both rotors simultaneously and it can be used for assistance in coordinated turn balancing against having outer-turn slipping and for exiting from turn. Those two vertical buttons of pad 480 can be used also without connection with turn. They can be considered as complement to four common handling buttons of pad 479 as fifth C-buttons for common collective control.

WS-buttons 481 are simple computer managed equivalent of pair of WST buttons, which placed in more convenient place. L-button 482 is simple button for lock command. Without the button lock of rotors will be performed when two conditions will occur altogether. The first condition is having the WST equal to zero (with some error range of course). The second condition is having magnitude of actual winding speed (WSA) below some threshold; see S36D2 on FIG. 36D. And the L-button 482 only send a command to reset the WST value with a speed of natural rotation of servo of WST-trimmer 462. This finite speed of rotation of the WST-trimmer prevents performing too fast lock, which can induce very high moment on rotor's shaft 127 and on related elements. Also using WS-buttons 481 is subject of the WST changing speed limitation.

Extended command pad 483 used for selection particular commands by pilot's demand. They can include particular customization of control buttons and joystick for particular flight operations, any switches for display's 445 representations or any other commands. Also display 445 can be touch-sensitive.

Indicator panel 441 has also standard instruments, which can assist to information on display 445 or used independently, especially as standby instruments. Those instruments currently selected as: Attitude Indicator (AI) 484, AirSpeed Indicator (ASI) 485, altimeter 486, compass 487, Turn and Slip Indicator (TSI) 488 and Vertical Speed Indicator (VSI) 489. Indicated speed (IAS) of airspeed indicator 485 will be proportional to LASN, which is only low changes for normal flight over high range of operation altitudes, see FIGS. 40F through 40K. And so the airspeed indicator 485 well suited for standby control of presented aircraft.

Designing of trimmers for control of presented aircraft isn't a simple task, since handling values have high dynamic range and should be controlled with high precision. More than, they are bi-directional and can change their signs. Internal construction of those trimmers mainly originated from design of placement of their scales.

Referred to FIG. 63 each trimmer, for example pitch-trimmer 454, has handler 490, which going through glass retaining ring 508 and also primary rotated can 491 on which the ring 508 fixed. The primary rotated can 491 can be rotated over its center axis altogether with retaining ring 508 and glass lid 530, see FIG. 66 also. The primary rotated can 491 can also be referenced as handling can. It has continuation inside as rotated fine scale 491a. The fine scale 491a has 5 degrees range on its full turn, tics distance of 0.1 degree and labeled tics distance 0.5 degree. Also all labels on the fine scale have negative sign, including zero value, which mean the scale used only for negative values of pitch. Positive direction of rotation for all trimmers is counter clockwise with origin on right, which is known as mathematical convention of angular reference. For this direction for positive values of pitch the rotated fine scale used only as arrow. Wedged frame around the “−0” value represents position of the arrow. It coincided with position of center of handler 490. Arrow of the rotated fine scale 491a points on neighbor steady fine scale 492, which placed inside of rotated fine scale 491a. The steady fine scale 492 equal to rotated fine scale 491a, but has only positive values and horizontal orientation for all labels. Also arrow sign near “0” value indicates arrow position, which user for read values from rotated fine scale 491a for case of negative pitch. Rotated fine scale 491a has center orientation for all labels, so each its label will be in horizontal orientation against of arrow of steady fine scale 492. Rotated intermediate scale 493 placed inside of steady fine scale 492. It has 60 degrees for its full turn and services negative pitch with positive arrow similarly as it does rotated fine scale 491a. Steady shield 494 placed inside of rotated intermediate scale 493. Steady intermediate scale 494b placed around outer side of the steady shield 494 and is equal to rotated intermediate scale 493, except sign of labels and their orientation, similarly to steady fine scale 492. Also its labels much bigger than for rotated intermediate scale 493 and are biggest from all scales. General scale 494a placed around inner side (hole) of the steady shield 494. It has dynamic range from −180 degrees to 180 degrees and occupies entire circle. And so this trimmer can be considered limitless, although practically it is not used and has meaning only for some taxi operations. Generic rotated arrow shield 495 placed inside of steady shield 494 and has painted arrow, which points on actual value of pitch on general scale 494a. This generic rotated arrow shield 495 is in use on all PGS trimmers and WST-trimmer 462. Steady shield 494 has identification of kind of trimmer as big letter “P”, placed between zero values of general scale 494a and steady intermediate scale 494b, which means: “Pitch”. And so this trimmer can be also referenced as P-trimmer. Also the steady shield 494 has designation of unit in which values of the pitch-trimmer 454 measures, as degree-sign “°” on center-up of it.

Skew-trimmer 456 is equal to pitch-trimmer 454, except of its steady shield 494′, which has identification as big letter “S”, which means: “Skew”. And so this trimmer can be also referenced as S-trimmer.

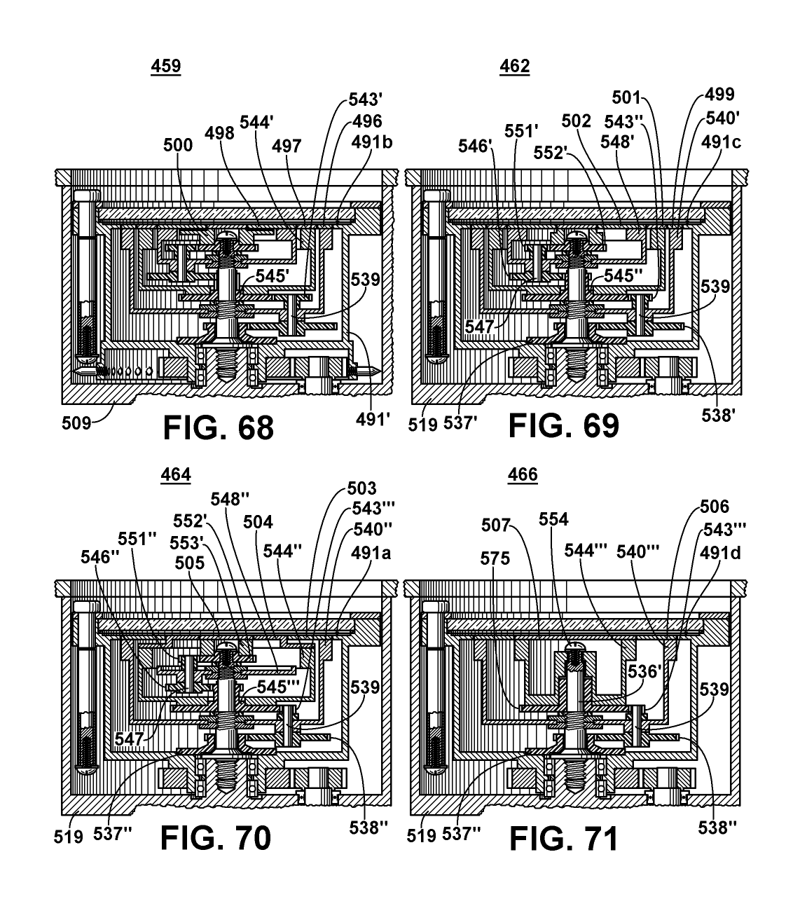

Gain-trimmer 459 generally has similar design as P-trimmer, but differed in particular scales and has additional features. Main difference in the trimmer is unit of values. Instead of degrees, which non-linearly mapped to linear rotation space, the trimmer used normalized linear gain, see FIG. 20, which magnitude has maximal value of 1.0. And so percent units used for the trimmer, which indicated by sign “%” on steady shield of gain 498. General scale of gain 498a has dynamic range from −100% to 100% and it occupies only about two thirds of half turn in each direction. Steady intermediate scale of gain 498b has full turn range of 50%, and so rotated intermediate scale of gain 497. Rotated fine scale of gain 491b has tics distance 0.1%, labeled tics distance 1%, range of full turn of 10%, and so steady fine scale of gain 496. Windows 498c and 498d on steady shield of gain 498 indicates values of pitch deviation in main and opposite directions respectively, see FIG. 19 also. Reading values from those windows is performed by thin arrows against their centers, which accompanied by degree-signs “°” and arrows to respected directions. Here degree-sign means: those windows perform non-linear mapping from linear rotation space to degrees-deviation-space, and entire gain can be calculated as difference between main and opposite values. This kind of windows, like as 498c and 498d, are known in cockpit's instrumentation as “Kollsman windows”. They used in altimeters for indicate atmospheric pressure. Main pitch deviation scale 500a, which shown inside of window 498c, and opposite pitch deviation scale 500b, which shown inside of window 498d placed on rotated flange 500, on which generic rotated arrow shield 495 mounted. This composed element shown on upper-right from scale placement of the gain trimmer 459, see also FIG. 68. Optionally, there can be a variant of gain-trimmer, where only one window exists for indicating entire gain. The steady shield of gain 498 has identification as big letter “G”, which means: “Gain”. And so this trimmer can be also referenced as G-trimmer.

WST-trimmer 462 has similar design as P-trimmer, but differed in particular scales. Main difference in the trimmer is unit of values. Instead of degrees it used “meters per second”, which indicated as “m/s” on steady shield of WST 502. Also it has identification as letters “WS” with letter “T” under them, which means: “Winding Speed Target”. General scale of WST 502a has dynamic range from −20 m/s to 40 m/s and it doesn't occupy full turn. Steady intermediate scale of WST 502b has full turn range of 20 m/s, and so rotated intermediate scale of WST 501. Rotated fine scale of WST 491c has tics distance 0.02 m/s, labeled tics distance 0.2 m/s and range of full turn of 2 m/s, and so has steady fine scale of WST 499.

SP-trimmer 464 has design significantly differed from P-trimmer. It has exactly same rotated fine scale 491a as for P-trimmer, and so steady fine scale 503b. But the steady fine scale 503b isn't isolated. It placed around outer side of steady shield of SP 503, which has much bigger diameter than steady shield of pitch 494. And so, intermediate scale missed on the SP-trimmer 464. General scale of SP 503a placed around inner side of steady shield of SP 503. It has dynamic range from −30° to 30° and it doesn't occupy full turn. Identification of the trimmer placed above left side of steady shield 503 as letters “SP”, which means: “Stabilator Pitch”. Rotated arrow shield of SP 504 placed inside of steady shield 503 and has painted arrow, which points on actual value of SP on general scale 503a. Rotated shield of stabilator's actual position 505 placed inside of rotated arrow shield of SP 504. It has image of airfoil painted on it, so this “airfoil” has exactly same natural angle relative to horizontal level of the indicator, as it has stabilator 102 relative to fuselage 101.

Lock-trimmer 466 looks as simplified version of SP-trimmer. Its rotated arrow shield 507 has same size as rotated arrow shield of SP 504, but doesn't have a hole inside. Also its rotated fine scale 491d has increased width than for other trimmers, consuming decreased width of steady shield of lock 506, which has on its left side trimmer's identification as letter “L”, which means: “Lock”. And so this trimmer can be also referenced as L-trimmer. Unit of values for the L-trimmer is percent, which reflected by “%” sign over identification letter “L”. Here zero value corresponds to state, when bands 314 of lockers 312 touch by their frictional linings 315 related drums 313, see FIG. 44E. General scale of lock 506a has dynamic range from −20% to 100% and it doesn't occupy full turn. Rotated fine scale of lock 491d has tics distance 1%, labeled tics distance 2%, range of full turn of 20%, and so steady fine scale of lock 506b.

Stream deviation indicator 468 is simple an airspeed indicator modified for having ability of bi-directional indication. Its arrow 627 repositioned on left side in zero state and its scale doesn't have unit of indication. Set of symmetrical tics placed from the zero state on 90 degrees to up and down. There upper direction means: “stream goes more from up of fuselage”. And for normal operation its arrow 627 should be near to zero state. It has identification “SDI” under axis of arrow 627.

Although scales of all trimmers and SDI where presented as black on white background, they should be actually luminous on black background, as it is usual for other instruments on cockpit.

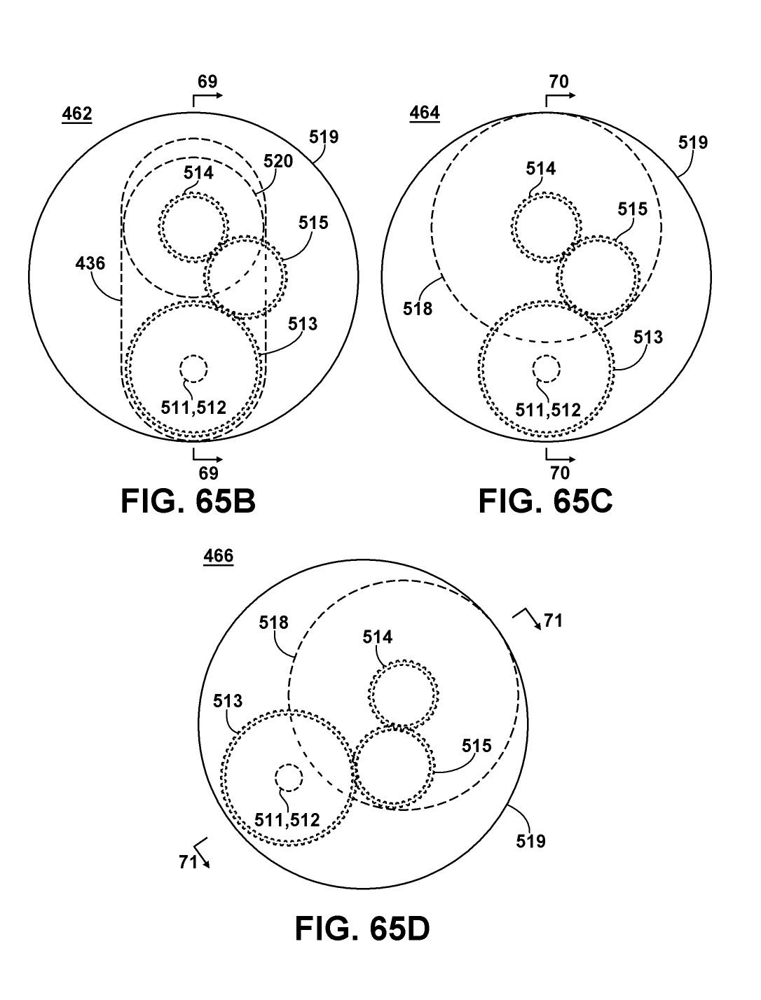

Before going to describing of internal construction of trimmers, let look on placement of their underneath transmissions, which have some common elements. Their placement views taken from face direction and represented on FIGS. 65A through 65D. PGS trimmers on each side combined to common PGS trimmer block 510 FIG. 65A. This combination permits more compact placement of trimmers on control panel 442. The PGS trimmer block 510 has case 509 from lightweight alloy and fixed to control panel 442 by non-shown screws, which placed about centers of bridged areas of each pair of adjusted trimmers toward to outside directions. Each trimmer has its own primary shaft 511, which enters to its interior. Each composition of trimmer with underneath transmission has related exit shaft 512, which exits to direction of trimmer's consumer. In current design for all trimmers, except S-trimmers 456 and 456′, primary shaft 511 is simultaneously exit shaft 512, but it can be changed under particular circumstances. Exit shaft 512 of any trimmer has exit gear 513, fixed on it, which accepts movement from intermediate gear 515, meshed with it. Servos 518 provide electromechanical movement for all trimmers, except WST-trimmer 462. Consumer of the trimmer is only WST encoder 436 FIG. 65B, mounted under the WST-trimmer 462 and needed only low power for movement. So mini-servo 520 used for the WST-trimmer 462. Servo 518 or mini-servo 520 for all trimmers, except S-trimmers 456 and 456′, has servo gear 514 fixed on its shaft and meshed with intermediate gear 515. Each S-trimmer 456 or 456′ has on shaft of its servo 518 much smaller servo pinion 517, instead of servo gear 514. External primary pinion 516 fixed on primary shaft 511 of each S-trimmer 456 or 456′ and meshed with exit gear 513. This difference in transmissions of S-trimmer 456 reflects necessity having equal angular speed of changing pitch and skew for both power-tiers of this movement: from servos or from manual handling of trimmers. Trimmer's locking brackets 556 FIG. 65A mounted on bottom outer sides of S-trimmers 456 and 456′ and G-trimmers 459 and 459′, see FIG. 67 also. Locking knob's brackets 564 mounted over trimmer's locking brackets 556 under control panel 442 and has handlers 566 over level of the control panel 442, which vicinity referenced for representing skew locking knobs 458 and 458′ and gain locking knobs 461 and 461′. Each separated trimmer represented on FIGS. 65B through 65D has case 519 from lightweight alloy and fixed to control panel 442 by non-shown screws, which placed over non-shown extensions over periphery the case 519.

Trimmers have some common elements in their construction. Let look on construction of P-trimmer 454 FIG. 66 as reference point for others trimmers. Servos 518 mounted on bottom 509a of case of PGS trimmers block 509 on some distance by using supports 522. Intermediate gear 515 supported by two flange-bearings 524, which placed on axel 523 and fixed altogether by screw 525 to bottom 509a of case of PGS trimmers block 509. Servo gear 514 fixed on shaft 521 of servo 518 and meshed with intermediate gear 515. Primary shaft 511 supported by two flange-bearings 535, inserted in bottom 509a of case of PGS trimmers block 509. Primary pinion 534 mounted on inside end of primary shaft 511 and provides one side axial support for it. Exit gear 513 fixed on primary shaft 511, meshes with intermediate gear 515 and completes axial support for the primary shaft 511. Upper universal joint 435 fixed on outer end of primary shaft 511, which acts there as exit shafts 512, and consumes correspondent hole in bottom and side cover 443, which manufactured from plastic. Other end of upper universal joint fixed on linking shaft 430. Glass lid 530 laid inside of correspondent socket of primary rotated can 491 over rubber ring 529 and secured by glass retaining ring 508. Handler 490 inserted through holes of glass retaining ring 508 and primary rotated can 491 to non-obstructed space between walls of case of PGS trimmers block 509 and primary rotated can 491. Tube 526 dressed on tail 490a of handler 490, can freely rotate on it and secured by washer 527 and screw 528 against fall out. When the handler 490 is pull out, the tube 526 retains it by some friction forces inside of correspondent hole of primary rotated can 491, providing also non-rotating ability for the handler 490 in fingers of pilot. Also the washer 527 prevents detaching the handler 490 from the trimmer.

Central axel 509b placed in center of bottom 509a as its integral part. Primary rotated can 491 supported by two bearings 531, dressed over central axel 509b and separated from each other on their insides by spacer ring 532. Also one of bearings 531 inserted from inside of the primary rotated can 491, and other inserted from its outside, so they separated on their outsides by a small inner ring area of rotated can 491, which has axial thickness equal to thickness of spacer ring 532. Two-stages central axel 536 screwed to central hole of central axel 509b and provides axial support for both bearings 531 and primary rotated can 491 in upper direction by using its flanged side laid over inner ring of upper bearing 531. Primary center gear 533, dressed outside of primary rotated can 491 from its bottom, fixed on it and meshed with primary pinion 534. So rotating of primary rotated can 491 will be transmitted to primary shaft 511 and vice versa.

Flanged primary central pinion 537 from plastic dressed over central axel 536 and fixed on bottom of primary rotated can 491, consuming its width flange for this fixation. Outer rim of its flange also provides its centering on bottom of primary rotated can 491, entering to a correspondent circular dip. This centering permits have some clearance between center hole of the flanged primary central pinion 537 and central axel 536, so they aren't in touch, preventing a friction and permitting manufacturing the flanged primary central pinion 537 also from non-plastic material, for increasing durability. Secondary gear 538 from plastic fixed on secondary shaft 539, which inserted in correspondent hole in bottom of primary steady can 540 from its outside. Secondary pinion 543 from plastic fixed on secondary shaft 539, securing it against fall out with secondary gear 538. Primary steady can 540 fixed on first stage of central axel 536 between two primary nuts 541. Each primary nut 541 has some low-height centering ring, which permits precision centering the primary steady can 540, which's center hole dressed over the ring. Positioning of secondary gear 538 below bottom primary nut 541 is problematic for setup of primary steady can 540, since bottom primary nut 541 desired be fixed in first order, before a primary steady can 540 will be laid on it. This operation limited by non-enough clearance between secondary gear 538 and primary rotated can 491 or between its center hole and central axel 536 for some other trimmers. So primary nuts 541 should have features resolving this problem. One feature for it can be standard hexagonal shape of bottom primary nut 541. So flat segment of the hex will provide increased clearance for positioning of secondary gear 538, and corners of the hex will provided enough abilities for clamping the primary steady can 540. Having only one flat or concave segment for bottom primary nut 541, instead of entire hex, can optimize this variant. Other feature can be used on primary nut 541 with round shape: there should be some keying holes around interior of its centering ring. These holes can be used together with a correspondent tubular setup key for screw the bottom primary nut 541 after its simultaneous setup with primary steady can 540. The secondary gear 538 meshed with flanged primary central pinion 537 after setup of primary steady can 540. Steady fine scale 492 fixed on top of primary steady can 540. Primary washer 542 from plastic is dressed over central axel 536 and laid over upper primary nut 541. Cluster 545 from plastic has secondary center gear and pinion and fixed outside on bottom of secondary rotated can 544 with centering on its hole by a corresponded centering ring, and having pinion component inside the secondary rotated can 544. The cluster 545 with secondary rotated can 544 dressed over central axel 536 and laid over primary washer 542, having possibility for freely rotating, utilizing low friction between plastic of its body and central axel 536. Tertiary gear 546 from plastic fixed on tertiary shaft 547, which inserted in correspondent hole in bottom of secondary steady can 548 from its outside. Tertiary pinion 551 from plastic fixed on tertiary shaft 547, securing it against fall out with tertiary gear 546. Secondary steady can 548 fixed on second stage of central axel 536 between two secondary nuts 549, which are similar to primary nuts 541, but have decreased size. Also problem of positioning tertiary gear 546 below bottom of secondary nut 549 can be resolved on similar way as for first stage. Additionally other possibility exists for it: secondary rotated can 544 can have some clearance window for tertiary gear 546, since the can 544 isn't sealed. Pinion component of cluster 545 has thin tubular continuation to up, which provides axial support in upper direction for the cluster 545. The tertiary gear 546 meshed with pinion component of cluster 545 after setup of secondary steady can 548. Secondary washer 550 from plastic is dressed over central axel 536 and laid over upper secondary nut 549. Tertiary center gear 552 from plastic fixed under bottom of rotated flange 553 with centering on its hole by a corresponded centering ring. The tertiary center gear 552 with rotated flange 553 dressed over central axel 536 and laid over secondary washer 550, having possibility for freely rotating, utilizing low friction between plastic of its body and central axel 536. Screw with washer 554 fix the tertiary center gear 552 in upper direction on two-stage central axel 536, entering in corresponding hole in rotated flange 553 and having a thin gap over flange of the tertiary center gear 552 for its free rotation. Rotated intermediate scale 493 fixed on top of secondary rotated can 544. Steady shield of pitch fixed on top of secondary steady can 548. Generic rotated arrow shield 495 is fixed on top of rotated flange 553.

Referred to FIG. 67 construction of S-trimmer 456 is almost same as for P-trimmer 454 and differed only by steady shield of skew 494′ and by having additional elements for locking. The S-trimmer 456 used lockable variant of primary rotated can 491′, which has on its bottom a skirt for locking 491z. Locking needles 555 screwed from outside the skirt 491z, using their threaded ends, and equidistantly distributed directed outward by their sharp ends. Number of those needles 555 is equal to number of ticks on rotated fine scale 491a FIG. 63, which corresponds to 0.1° of skew for locking precision. Locking wedge 557 performs actual locking, when it enters in window 509c upon force of spring 559, which dressed on its tail 557a and has its back support on flange of solenoid 558. The window 509c particularly continues on bottom 509a of case of PGS trimmers block 509. Solenoid 558 mounted inside of trimmer's locking bracket 556 and can attract ferromagnetic tail 557a of locking wedge 557 to its interior, upon powering. Rigid wire 560 mechanically connected with tail 557a inside of solenoid 558 and protrudes outward through some hole in mounting wall of locking bracket 556 for solenoid 558. The rigid wire 560 has hooked opposite end, on which soft string 561 knotted. Pulley 563 freely rotates on its axel 562, which fixed in locking bracket 556, and conducts the soft string 561 to direction of skew locking knob 458.

Bracket 564 of skew locking knob 458 mounted under control panel 442, to which it fixed by non-shown screws. Locking knob's shaft 565 enters from upper direction to correspondent hole of bracket 564, nesting in its bottom part, where it can freely rotate, having simultaneously axial support in bottom direction. Upper part of the mentioned hole has increased diameter, so there exists a clearance between shaft 565 and hole of bracket 564, enough for placing there soft string 561, which conducted to this direction through hole 564a by using pulley 571, which freely rotated on its axel 570, fixed in bracket 564. The pulley 571 and hole 564a in bracket 564 have position correspondent for entering the soft string 561 to shaft 565 tangentially. Also any sharp edges of the hole 564a removed against damaging the soft string 561. The shaft 565 has a threaded hole on its bottom to which screw 567 screwed from bottom hole of bracket 564. Spacer ring 568 dressed over the screw 567 and can freely rotate in bottom hole of bracket 564, so also screw 567 can freely rotated together with it and shaft 565, providing axial support for the shaft 565 in upper direction. Some free space remained over the screw 567 inside of shaft 565, in which soft string 561 enters through correspondent hole and has a knot inside, which fixed it. Spacer ring 569 dressed over shaft 565 and enters inside of bracket 564, consuming clearance over soft string 561 and laid over thin circular step inside of the clearance hole. Snapping ball 572 enters from correspondent hole in bracket 564 and continuously pushed by spring 573, which supported from its other end by screw 574 in bracket 564. Some hole exists in spacer ring 569, in which snapping ball 572 can enter, providing initial fixation for the spacer ring 569 against rotation. Also the spacer ring 569 has final fixation upon mounting entire skew locking knob 458 under control panel 442, which clamps it down over its flange. The shaft 565 has two coned nests 565a in which the snapping ball 572 enters in normal and locking position of skew locking knob 458. Locking knob's handler 566 fixed on shaft 565 after mounting entire skew locking knob 458.

When skew locking knob 458 is in normal position, the soft string 561 maximally winded on shaft 565 and locking wedge 557 is out of trimmer's space, permitting of free rotation of primary rotated can 491′. Shaft 565 is retained in the position by snapping ball 572 against increased force of spring 559. When skew locking knob 458 is in locking position, the soft string 561 maximally unwounded from shaft 565, so remained rotation moment on shaft 565 is zeroed. If solenoid 558 isn't powered for this case, the locking wedge 557 enters in trimmer's space between nearest pair of needles 555 and disables rotation of primary rotated can 491′. But if solenoid 558 will be powered for the last case, the locking wedge 557 will out of trimmer's space, permitting of free rotation of primary rotated can 491′, so free dangled loop of soft string 561′ will be created. Having the free dangled loop isn't a well-secured solution. More than, unwinding force to soft string 561 will be missed at all in case of actuating knob 458 to locking position under powered solenoid 558, which can jammed the soft string 561. So some intermediate pulley, which pulled by some low force spring should be placed between pulleys 563 and 571 for resolve the issue. This additional pulley isn't shown for simplicity. Solenoid 558 powered each time, when powered servo of its trimmer. Some times it can be performed with high frequency. So it is better using the knob 458 in normal position for non-manual handling, preventing wearing of the soft string 561.

Referred to FIG. 68 construction of G-trimmer 459 inside of case of PGS trimmers block 509 is almost same as for S-trimmer 459. It also uses the lockable variant of primary rotated can 491′, but it utilizes rotated fine scale of gain 491b. Gain exclusive secondary pinion 543′ with increased diameter used instead of basic 543 variant. Gain exclusive cluster 545′ used instead of basic 545 variant, having decreased diameter of its gear component. Gain exclusive secondary rotated can 544′ used instead of basic 544 variant, having decreased diameter of its flange interfaced with cluster 545′. Gain exclusive rotated flange 500 used instead of basic rotated flange 553, having additional scales 500a and 500b FIG. 63. Steady fine scale of gain 496 used instead of steady fine scale of pitch 492. Rotated intermediate scale of gain 497 is fixed on top of gain exclusive secondary rotated can 544′. Steady shield of gain 498 used instead of steady shield of skew 494′.

Referred to FIG. 69 construction of WST-trimmer 462 inside of trimmer's case 519 is almost same as for P-trimmer 454. It utilizes rotated fine scale of WST 491c. WST exclusive flanged primary central pinion 537′ used instead of basic 537 variant, having a bit decreased diameter. WST exclusive secondary gear 538′ used instead of basic 538 variant, having a bit decreased diameter. WST exclusive secondary pinion 543″ used instead of basic 543 variant, having a bit increased diameter. WST exclusive cluster 545″ used instead of basic 545 variant, having decreased diameter of its gear component and increased diameter of its pinion component. WST exclusive tertiary gear 546′ used instead of basic 546 variant, having decreased diameter. WST exclusive tertiary pinion 551′ used instead of basic 551 variant, having decreased diameter. WST-and-SP shared tertiary center gear 552′ used instead of basic 552 variant, having some decreased diameter. WST exclusive primary steady can 540′ used instead of basic 540 variant, having some decreased radial position of hole for secondary shaft 539. WST exclusive secondary steady can 548′ used instead of basic 548 variant, having some decreased radial position of hole for tertiary shaft 547. Steady fine scale of WST 499 is fixed on top of WST exclusive primary steady can 540′. Rotated intermediate scale of WST 501 used instead of rotated intermediate scale of pitch 493. Steady shield of WST 502 fixed on top of WST exclusive secondary steady can 548′.

Referred to FIG. 70 construction of SP-trimmer 464 inside of trimmer's case 519 retains some similarity with P-trimmer 454, including use of same rotated fine scale 491a. SP-and-Lock shared flanged primary central pinion 537″ used instead of basic 537 variant, having a bit decreased diameter. SP-and-Lock shared secondary gear 538″ used instead of basic 538 variant, having a bit decreased diameter. SP-and-Lock shared secondary pinion 543′″ used instead of basic 543 variant, having some decreased diameter. SP exclusive cluster 545′″ used instead of basic 545 variant, having a bit decreased diameter of its gear component and increased diameter of its pinion component. SP exclusive tertiary gear 546″ used instead of basic 546 variant, having decreased diameter. SP exclusive tertiary pinion 551″ used instead of basic 551 variant, having decreased diameter. WST-and-SP shared tertiary center gear 552′ used instead of basic 552 variant, having some decreased diameter. SP exclusive primary steady can 540″ used instead of basic 540 variant, having decreased radial position of hole for secondary shaft 539. SP exclusive secondary rotated can 544″ used instead of basic 544 variant, having increased diameter of central hole and decreased overall height. SP exclusive secondary steady can 548″ used instead of basic 548 variant, having decreased radial position of hole for tertiary shaft 547 and significantly reduced height, due missing of flange for mounting any scale. SP exclusive rotated flange 553′ used instead of basic 553 variant, becoming shape of ring with thickened wall and having rotated shield of stabilator's actual position 505 fixed on it. Rotated arrow shield of SP 504 has big lowered and directed to outside flange, which used for mounting it on top of SP exclusive secondary rotated can 544″. Steady shield of SP 503 fixed on top of SP exclusive primary steady can 540″ and hides mounting flange of rotated arrow shield of SP 504.

Referred to FIG. 71 construction of L-trimmer 466 inside of trimmer's case 519 also has some similarity with P-trimmer 454. It utilizes rotated fine scale of lock 491d. Main difference there is using one-stage central axel 536′ instead of basic two-stages central axel 536. SP-and-Lock shared flanged primary central pinion 537″ used instead of basic 537 variant, having a bit decreased diameter. SP-and-Lock shared secondary gear 538″ used instead of basic 538 variant, having a bit decreased diameter. SP-and-Lock shared secondary pinion 543′″ used instead of basic 543 variant, having some decreased diameter. Lock exclusive secondary center gear 575 used instead of basic cluster 545, having diameter equal to diameter of gear component of SP exclusive cluster 545′″. Lock exclusive primary steady can 540′″ used instead of basic 540 variant, having decreased radial position of hole for secondary shaft 539 and decreased diameter. Long hub of secondary center gear 575 enters in correspondent hole of inner hub of lock exclusive secondary rotated can 544′″ and fixed on its bottom flange. Screw with washer 554 fix the lock exclusive secondary rotated can 544′″ in upper direction on one-stage central axel 536′, having a thin gap over inner hub of the lock exclusive secondary rotated can 544′″ for its free rotation. Steady shield of lock 506 fixed on top of lock exclusive primary steady can 540′″. Rotated arrow shield of lock 507 fixed on top of lock exclusive secondary rotated can 544′″.

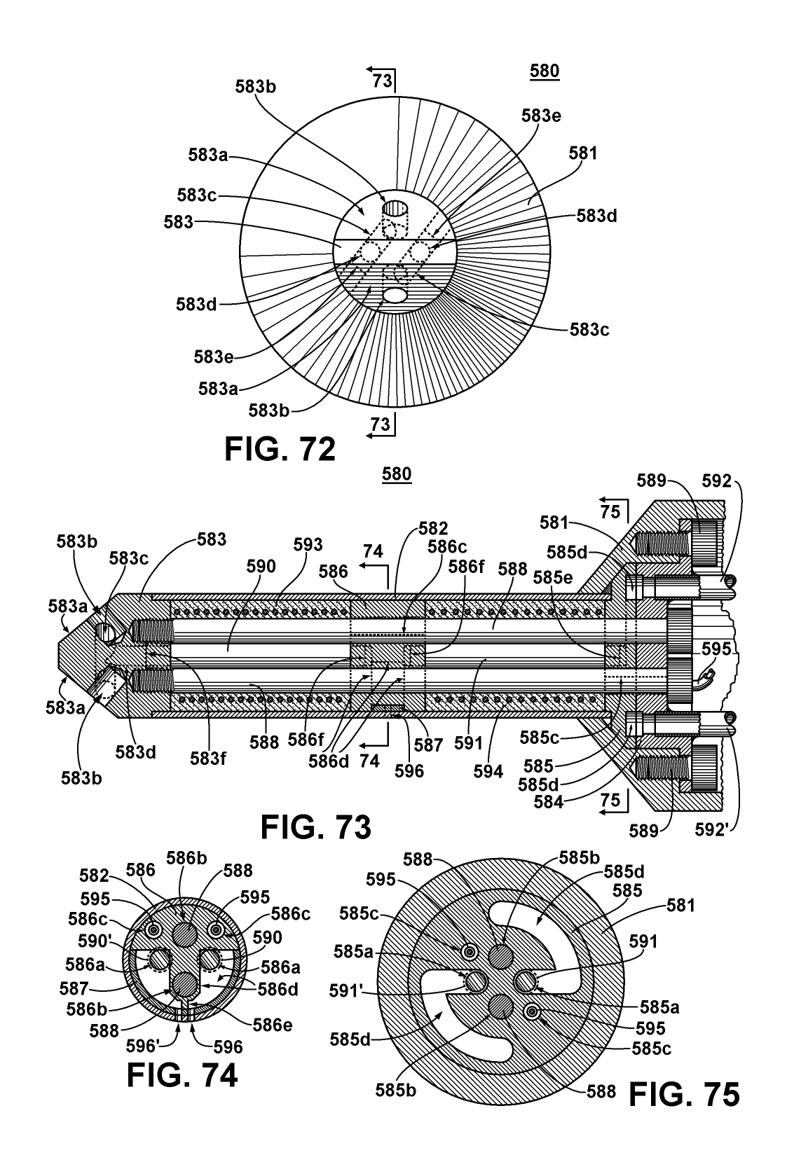

Referred to FIGS. 72 and 73 SDT has consoling base 581 as its support. This consoling base 581 is an elongated tube with conical transition on its forward end to decreased diameter. Tubular case 582 locked between forward flange 583 and back diverting flange 585 by two long bolts 588 going through holes 585b FIG. 75, which screwed to forward flange 583 and also go through correspondent holes of collector 584, placed over back diverting flange 585, having vertical alignment. The tubular case 582 protruded from inside of consoling base to outside through its hole on end of its conical transition, which diameter corresponds to outer diameter of the tubular case 582. Back diverting flange 585 also has a conical segment in its shape, which corresponds to inner conical segment of conical transition of consoled base 581. Collector 584 fixed to consoled base 581 inside its interior by screws 589. Moisture collector 586 with its sealing lid 587 placed inside of tubular case 582 on its center, having generally cylindrical shape with diameter correspondent to inside diameter of tubular case 582 and two holes 586b FIG. 74, used for conducting bolts 588.

Forward flange 583 has generally cylindrical shape with diameter equal to outside diameter of tubular case 582 and it inserted a bit into the tubular case 582, using some centering flange on its base. Also same kind of centering flange of back diverting flange 585 is used on other end of tubular case 582. Two equal slopes 583a milled on forward side of forward flange 583, where one looks to up and other looks to down, having about 40 degrees each from horizontal plan. Two equal entry channels 583b drilled on centers of slopes 583a, normally to their surfaces. Two equal horizontal channels 583d drilled from base of forward flange 583 with equal horizontal alignment. Two equal diverting channels 583c drilled from cylindrical surface of forward flange 583 to its interior, laying in its cross-section plan and connecting horizontal channels 583d with respective entry channels 583b. So upper entry channel 583b has connection with right (from direction of pilot) horizontal channel 583d, and lower entry channel 583b has connection with left horizontal channel 583d. Two seals 583e seal outer-ends of respective diverting channels 583c from environment, repairing original cylindrical shape of forward flange 583. Forward tube of upward pressure 590 and forward tube of downward pressure 590′ connect horizontal channels 583d of forward flange with forward entry holes 586a FIG. 74 of moisture collector 586, laying on right and left sides respectively and entering in output sockets 583f of forward flange 583 and forward entry sockets 586f of moisture collector 586 by their ends. Backward tube of upward pressure 591 and backward tube of downward pressure 591′ connect backward entry holes 586a of moisture collector 586 with entry holes 585a FIG. 75 of back diverting flange 585, laying on right and left sides respectively and entering in backward entry sockets 586f of moisture collector 586 and entry sockets 585e of back diverting flange 585 by their ends.

Forward heater 593 has generally tubular shape and placed inside of tubular case 582, wrapping bolts 588 and forward pressure tubes 590 and 590′. Backward heater 594 has generally tubular shape and placed inside of tubular case 582, wrapping bolts 588 and backward pressure tubes 591 and 591′. Electrical wires in isolation 595 connect forward heater 593 with backward heater 594 and exit from collector 584, going through holes 586c in moisture collector 586 and 585c in back diverting flange 585, see FIGS. 74 and 75. Those heaters 593 and 594 provide anti-icing ability of operation for SDT.

Referred to FIGS. 73 and 74 moisture collector 586 has two equal internal cavities 586d in horizontal alignment, which separated on their bottoms by thin wall 586e, in which vicinity moisture will be collected. Those internal cavities 586d manufactured by milling. Sealing lid 587 has shape of segment of a tube and seals both cavities, using some waterproof adhesive or sealant before inserting it with moisture collector 586 in tubular case 582. Also some small leakage is permissible, since pressures in both cavities 586d continuously pumped from big entry holes 586a. Small drain holes 596 drilled in sealing lid 587 and tubular case 582 on each side from separating wall 586e of moisture collector 586. Small leakage of pressures through drain holes 596 corresponds with equal environment pressure near their vicinity due symmetry in placement of drain holes 596 and cavities 586d. So symmetric sensitivity in vertical direction of entire SDT wouldn't be jeopardized by this implementation of moisture collecting.

Referred to FIGS. 73 and 75 back diverting flange 585 has two equal diverting channels 585d, which restore to original up-down position pressure exit sites and increase separation base between them. Collector 584 has two equal output tubes 592 and 592′, which brazed inside of vertically aligned holes in the collector 584, placed correspondingly with alignment of exit sites of diverting channels 585d, providing upward and downward output pressures respectively.

Referred to FIG. 76 in-flight management of the presented aircraft can be resumed and considered as follows.

Left rotor 110 and right rotor 110′ share common powering shaft 127, on which also placed left electrical engine 300 and right electrical engine 300′. Separated power circuits 438 and 438′ provides desired currents for coils of electrical engines 300 and 300′ respectively, having common management from engine controller 597 and consuming power from accumulators 437, placed on left and right accumulators racks 404 and 404′ respectively. Control panel of those racks 439 managed their longitudinal position, having feedback from left and right encoders of racks 418 and 418′ respectively, mechanically connected with them, and report theirs positional state to central computer 600. WST-trimmer 462 mechanically managed WST-encoder 436, which defines related target winding speed for engine controller 597. The engine controller 597 uses value of target winding speed for providing instant managing signals for power circuits 438 and 438′, having from them feedback of instant phase state and power consuming of engines 300 and 300′, which also propagated upon conversion to respective form to WSA indicator 449, MR indicator 451, RPM indicator 450 and to central computer 600.

Output pressures from SDT 580 propagated by pressure hoses 365 and 365′ to SDI 468 and to pressure electrical sensors 578 and 578′ for upward and downward pressures respectively. Stabilator controller 579 uses values of upward and downward pressures from electrical sensors 578 and 578′ as feedback to determine remained error in orientation of fuselage 101 of aircraft 100 and after application some low-pass filter generates respective command (if need) for actuating SP-trimmer 464 by its servo, which passes through control panel's logics 598. Movement of SP-trimmer 464 upon this actuating transmitted to stabilators 102, correcting position of fuselage 101. Also movement of SP-trimmer 464 transmits to SP-encoder 428, which reports its value to central computer 600. Bi-directional connection between stabilator controller 579 and central computer 600 permits apply more sophisticated management for stabilator controller 579 from side of central computer 600 upon reusing propagated values of pressures from electrical sensors 578 and 578′. Also this connection permits bypass for value of SP-encoder 428 to stabilator controller 579 as feedback against its operating outside of operational margins of stabilators 102. Additionally, movement of accumulator's rack 404 and 404′ can alter any operations over SP-trimmer 464, by using control panel of racks 439.

L-trimmer 466 mechanically managed lock state of both rotors 110 and 110′ simultaneously and mechanically connected with lock-encoder 427, which report its value to central computer 600, which can manage the L-trimmer by generating respective commands for actuating its servo, which pass through control panel's logics 598.

PGS-trimmers 454, 459 and 456 mechanically managed PGS state of left rotor 110 and mechanically connected with PGS-encoders 424, 425 and 426 respectively, which report their values to central computer 600. Also same task can be performed by right side PGS-trimmers 454′, 459′ and 456′ with PGS-encoders 424′, 425′ and 426′ respectively for right rotor 110′. Central computer 600 can manage both sides PGS-trimmers by generating respective commands for actuating their servos, which pass through control panel's logics 598.

Output pressures from PST 576 propagated by pressure hoses 364 and 364′ to pressure electrical sensors 577 and 577′ for pitot and static pressures respectively. Also static pressure propagated to ASI 485, VSI 489 and altimeter 486 and pitot pressure to ASI 485 only, as on conventional airplane.

Central computer 600 uses values from electrical sensors 577 and 577′ and value from non-shown sensor of outside air temperature for restoring horizontal and vertical components of TAS and flight altitude. Additionally it can use signal from GPS receiver 599 and output from Inertial Navigation System (INS) 601 for do it more correct. Corrected value of TAS vector can be used for calculate error of stream following state managed by stabilator controller for its sophisticated correction. TAS magnitude together with actual winding speed used for calculation correct PGS states for desired biangular values of each rotor 110 or 110′, see S36H4 on FIG. 36H and FIG. 22. Joystick 477 connected to central computer 600 and can moderate biangular values of each rotor 110 or 110′ on variational manner, performing actual handling of presented aircraft 100, and it can be handled by computer's buttons also. Actual biangular values of each rotor 110 or 110′ can be reflected on display 445 in numerical or graphical forms, also sharing their representation with other kind of information, such as navigation for example. Also RSI from FIG. 38 can be presented on display 445 for each rotor 110 or 110′ or for their average, having actual inflow vector calculated in accordance with data flow on FIG. 28. More than, after a small number of trying flights, corrected actual parameters of particular aircraft can be refactored, such as actual coefficients of drag for fuselage for some range of speeds. So by using such information, central computer can execute entire simulation for particular aircraft in accordance with FIG. 34 in real time, for prediction behavior of aircraft on advance. For this case, presented simulation should be completed by tier related to stabilators 102 and induced longitudinal moments. Also the simulation can be split on two components related to each rotor 110 and 110′ and linked by composed 3-d movement for prediction behavior of the aircraft upon turning operations too.

Control panel's switches 598 can disable management of trimmers by central computer 600 and (or) stabilator controller 579 in case of their malfunction or for any other circumstances. In this case trimmers can be managed by using control panel's buttons 598, and pilot can use standby instruments instead of malfunctioned computer.

Also in case of electricity outage all trimmers can be managed manually, by pilot's referencing to special tables for handling aircraft directly by PGS states of their rotors 110 and 110′ for particular flight operations.

In case of malfunction of one of power circuits 438 or 438′ or one of engines 300 or 300′ the aircraft can continue fly on related component from remained side, having limitation in power.

In case of malfunction of both of power circuits 438 and 438′ or both of engines 300 and 300′ or in case of limitation of remained energy in accumulators 437, the aircraft can glide, having rotors 110 and 110′ in locked state. When the case occurs instantaneously upon power outage, both rotors 110 and 110′ continue to rotate due inertial force, and so it is subject for pilot's error. Instinctively pilot wants to lock rotors, since moment induced by engines and linking external moment of rotors with composed sum of moments from center of gravity and stabilators 102 vanished, so aircraft begins promptly rotate down by its nose, which can significantly shift pitch of fuselage 101 from its stream following position, before rotor will be locked for gliding. But too prompted lock in this case will be dangerous too, since inertial moment has non-favorable direction additionally lowering nose of aircraft. So finally lock of rotors should be performed no faster than 0.3-0.5 second after power outage with instantaneous switching gain to zero and pitch to 5°, having P-mode of biangular handling. This time is enough for braking rotor by its external moment, before it begins rotate to back. Also for the time stabilator controller 579 moves stabilators 102 to position decreasing adverse nose rotation, and preset pitch of 5° will alleviate decreased lift from accumulated nose lowering angle. When the case occurred upon recuperative descent, the inertial moment of rotor is in favorable direction for braking. But also for this case locking of rotors should begin only after switching gain to −10° and pitch to 3°, having P-mode of biangular handling. This action will promptly switch sign of external moment of rotor, converting its kinetic energy to external energy of entire aircraft, braking rotors for time about 0.4 s. After it, gain should be set to zero upon stopping rotors for restoring normal external moment. Only after it rotors can be locked. Actuating locker before proximity rotors to low rotation can lead to application too high external moment on fuselage 101 and damage frictional lining 315 FIG. 44E. Doing this task upon total power outage, when also servos of trimmers are out of power, can be performed directly by using handlers of G-and-P-trimmers with additionally handling of SP-trimmer 464, trying to keep SDI 468 pointed to zero.

Additionally in-flight management can be extended upon including active VRS for depressing remained vibrations from variations of steering moment, see explanations for FIGS. 41A and 41B. The VRS applies compensating patterns of currents on coils of both engines 300 and 300′ by a pattern generator connected to both power circuits 438 and 438′. The pattern generator plays particular active pattern, which scaled in time using a minor phase signal. Particularly the minor phase signal can be synchronized with phase powering of this engines 300 an 300′ for particular number of poles in rotors of those engines. In other case a separated minor phase sensor extracts the minor phase signal from rotors 100 and 100′. The central computer 600 can manage the pattern generator upon reloading the active pattern from a pattern store, dependently from particular flight operation or load state. Also the pattern generator can be implement as part of engine controller 597, especially for case of synchronizing the minor phase signal with phase powering of engines.

Presented aircraft can be used with enlarged wingspan for having higher aspect ratio and so performance specified by LDR. But it cannot be performed straightforwardly, simply by installing more longer wings 111 on rotor 110, since they wouldn't possess enough rigidness against loads from aerodynamic and centripetal forces. So there need some intermediate ring for it.

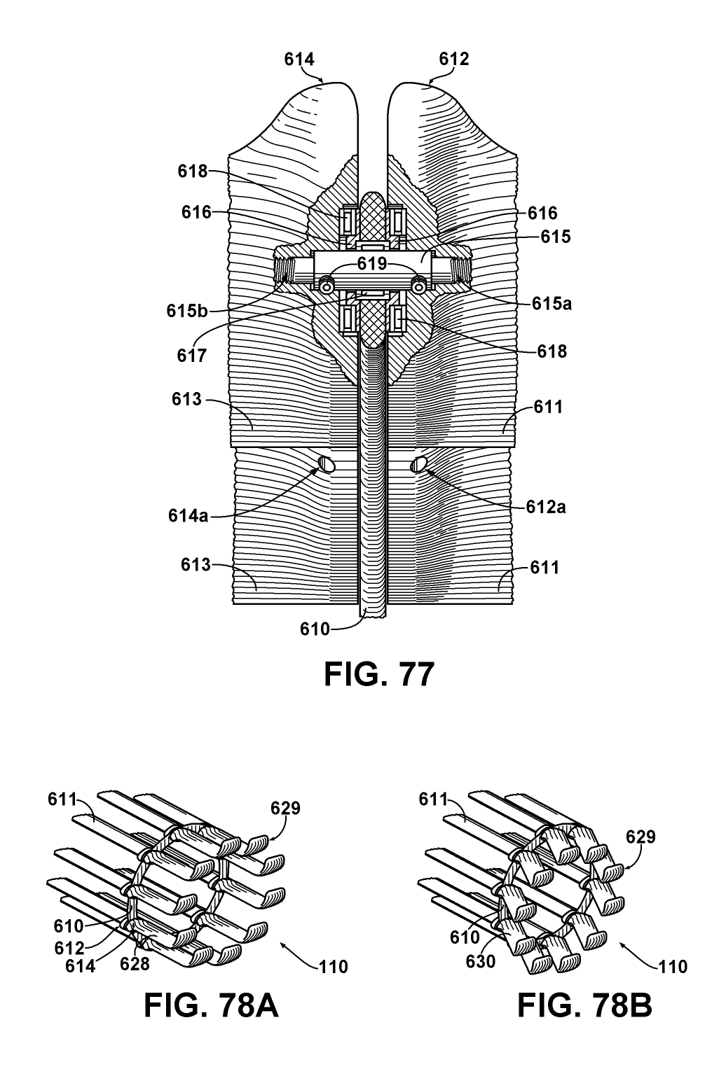

Option of using presented rotor 110 with an intermediate ring in its middle represented on FIG. 77. Two wings: inner wing 611 and outer wing 613 used in place of one wing 111 in this option. Those wings 611 and 613 have generally same length. Also inner end of inner wing 611 equal to inner end of original wing 111, and outer end of outer wing 613 equal to outer end of original wing 111. Outer end of inner wing 611 has intermediate fairing 612, which provides enough space for elements of its linking with inner end of outer wing 613 and has outer shape equal to outer shape of end wing fairing 170 for original wing 111. Inner end of outer wing 613 has intermediate fairing 614, which symmetrically equal to intermediate fairing 612 of inner wing 611. Intermediate ring 610 has flat surfaces from both sides. It manufactured from composite material and has equidistant holes related to correspondent wings. Wings′-link radial needle bearing 617 inserted in each such hole of intermediate ring 610. Wings′-link adapting flanges 616 dressed over each side of radial needle bearing 617. Intermediate fairings 612 and 614 of respective wings have flat end wing bases adjusted to respective sides of intermediate ring 610. And from this directions they have an interior spaces used for its rotational mating with adapting flanges 616, and wings'-link thrust bearings 618 laid over those adapting flanges 616. Shaft for linking wings 615 inserted in radial needle bearing 617, thrust bearings 618, adapting flanges 616 and in two respective intermediate fairings 612 and 614, where it screwed in correspondent threads by its threaded tails 615a and 615b respectively. Tail 615a has right-handed thread, and tail 615b has left-handed thread. Two setscrews 619 on each side from intermediate ring 610 fixed the shaft 615 against unscrewing, using setup holes 612a and 614a on both sides of intermediate fairings 612 and 614 respectively. Upon setup of intermediate ring 610 and outer wing 613 those setscrew 619 can be periodically screwed and unscrewed from respective sides for switch between screwing of shaft 615 or outer wing 613 relative to non-rotational inner wing 611. So for this operation outer wing 613 acts as some handler and only one setscrew 619 can be used for this kind switching And the operation will be completed, when overall bearings gap will be optimal, having free rotation without backlash with coinciding of trailing edges of inner wing 611 and outer wing 613. After it, all four setscrews should be fixed. High diameter of shaft 615 with using those setscrews 619 permit transmitting enough high rotational moment from inner wing 611 to outer wing 613. This kind of assembly of intermediate ring 610 on inner wings 611 permits its fast installation, and so for outer wings 613, after first setup. Indeed, for case of disassembling only one-side setscrews 619 can be unscrewed. So for next installation each outer wing 613 will be screwed together with its constantly assigned inner wing 611, simple by rotation it until their trailing edges will be coincided without visible backlash in their link. Also presented rotor 110 can be extended for using more than one intermediate ring 610.

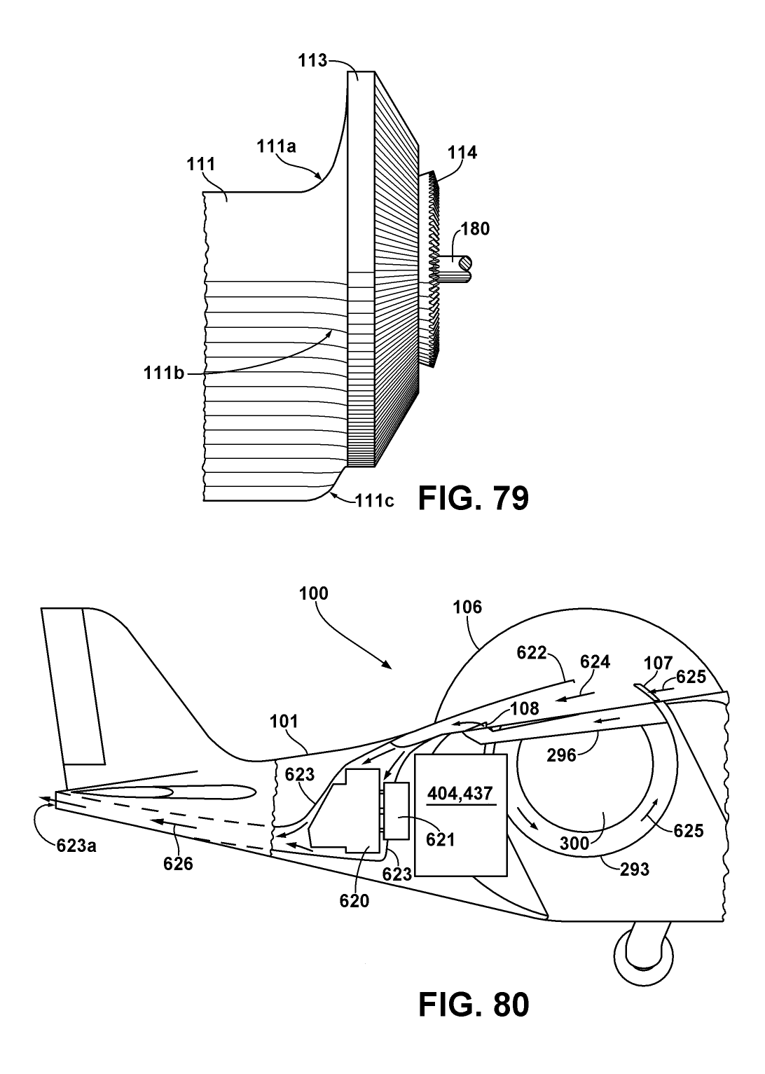

Using the intermediate ring 610 on end of rotor 110 permits install on it winglets, unsupported on their ends. These winglets can well withstand bending forces, having short length. Option of it represented on FIG. 78A. Here inner wings 611 connected to intermediate ring 610 from inside on its intermediate fairings 612 and can have full length or linked from components. Short winglets 628 connected to intermediate ring 610 from outside on its intermediate fairings 614 and have wing fences 629. Those wing fences 629 decrease induced drag upon postponing generation end-wing vortices, like wing fences on conventional airplane. FIG. 79B represents other example of this option. Here used swept winglet 630, which also has the wing fence 629. But it used sweeping to forward. Winglet whit this kind of sweeping has significantly shifted to forward center force relative its pivot, and so it induces significant positive moment. This moment provides advantage on cruise operation, where exist significant negative moment on entire wing. So the forward swept winglet 630 will particularly compensate the negative moment, leaving steering moments for wings below moderate level. Optimal level of this kind compensating is about 70 percents, since more high moments from winglets 630 will create too high positive steering moments for runway operations.

Presented aircraft can be used with wings 111, based on symmetrical airfoil such as NACA 0010, which have near to zero moment coefficient CM over width range of angles of attack, when it used with pivot position about 0.25 of its chord. Using this airfoil permits having low steering moments for all wings position for main operations, which is especially important for high speed cruise, where rotors 110 has greatest IMR, see FIG. 40H. Reducing steering moments leads to greatly reducing of possible wearing of steering gears and has additional advantage upon using option for having intermediate ring 610 on rotor 110, highly decreasing transmitted rotation moment from inner wing 611 to outer wing 613. Also additional advantage of using symmetric profile is: significantly decreased level of vibrations existing in other case, see FIG. 41B. Other advantage of using symmetric profile is having absolutely equal wings 111 for left and right rotors instead of only symmetrically equal.

Option of using presented rotor 110 with wings 111, based on symmetric airfoil, represented on FIG. 79, which pictured base portion of the wing 111 detached from rotor, having only bevel gear 114 and wing's shaft 180 on its base 113. Position of the shaft 180 corresponds to 0.25 of chord of wing 111, but base 113 stays unchanged. Straight part of wing 111 shifted toward its trailing edge for having desired pivot position. This shift some changed shape of leading edge transition 111a on wing's fillet 111b and introduced trailing edge transition 111c from base 113 to some protruded now trailing edge of wing 111.

Upon transition to higher-scale presented aircraft can reach subsonic speed on cruise. This ability permitted by low winding speed of wings 111 on rotor 110 relative to speed of cruise and speed of sound. For this variant, wings 111 can utilize a supercritical airfoil for increase cruise speed. Those wings 111 based on supercritical airfoil can be installed on rotor 110 with original alignment of wing's trailing edge relative to rim of wing's base 113 FIG. 44C, since this kind of airfoil has more aft shifted center of aerodynamic force. Also its pivot position can be optimized for cruise by decreasing diameter of wing's base 113, shifting leading edge of wings 111 to forward. Additionally wings with supercritical airfoil can be used with forward swept winglets 630 FIG. 78B for having low steering moments. Other advantage of wings with supercritical airfoil for using in rotor 110 is increased average thickness of wings in their section, which increases their rigidness.

Using of presented aircraft powered by accumulators only doesn't permit long-distance flights, due of limitation of contemporary accumulators. It can be enhanced in future, but in current days long-distance flights of an aircraft with moderate performance can be performed only by using combustion engines. Presented aircraft permits having hybrid power solution, when combustion engine used only for generating electricity for charging accumulators of aircraft and (or) for powering electrical engines of composed rotors, with keeping ability of recuperative descent and deceleration.

Modified variant of presented aircraft accommodated to use of combustion engine represented on FIG. 80. Combustion engine 620 with electrical generator 621 placed in aft compartment of fuselage 101 of aircraft 100 and enveloped by air-conducting envelope 623, which used for cooling the combustion engine 620, supplying it by oxygen from air and conducting exhaust of the combustion engine 620 toward air outlet 623a on tail edge of fuselage 101. Fairing with air inlet 622 used as lobby for air-conducting envelope 623 and spanned between both sides rotor's sockets 106, having in its interior air outlets 108 of cooling system of electrical engines 300. For this kind of airflow connectivity, a minor air cooling stream 625 enters in air inlets 107, goes around electrical engines 300 inside of electrical engine's socket 293 and continues moving through air conduction tubes 296 to air outlets 108, where it merges with air cooling mainstream 624, entered from forward to fairing with air inlet 622. Electrical generator 621 has generally cylindrical shape with low height, and air conducting envelope 623 sealed around it, permitting provide maintenance and service for the electrical generator 621 related to its powering connectivity to accumulators 437, placed in racks 404, and (or) to engines 300 without removing the air-conducting envelope 623. Maintenance and service of combustion engine 620 can be performed upon opening some hatches in fuselage 101 and air-conducting envelope 623 in direction over it. Fuel tanks aren't shown there and can be placed under area of accumulator's racks 404 and (or) in other free spaces.

What is claimed is:

1. A rotor for powered flight with managed PGS-state comprising:
a rotational domain with generally round shape and generally flat surface face side thereof;
a set of equal wings, equidistantly mounted on periphery of said rotational domain, longitudinally extended from face side thereof outside and parallel to central axis thereof on fixed distance from said axis with ability of rotation around respective axes parallel to said axis, having said respective axes in respective pivot positions relative respective chords of said wings;
an irrotational domain rotationally mount on said rotational domain in respect of said central axis thereof generally on back side thereof with particularly sharing overall volume space of said rotational domain, the irrotational domain used as irrotational tier of setup of said rotor and as reference base for steering said wings in accordance with managed PGS-state;
a central cluster, comprising placed coaxially a central gear and a circular grove, mounted on said irrotational domain toward direction of face side of rotational domain, having axis thereof parallel to central axis of said rotational domain with means for steering said central gear in angular, radial and asimuthal directions relative to said irrotational domain, where each freedom of said steering mapped to steering of pitch, gain and skew respectively, and have a continuation used as steering tier of setup of said rotor, comprising from separated PGS components or their combinations; and
a set of steering elements per each wing includes a pitch gear, having angular position of axis thereof generally directed to axis of respective wing from central axis of said rotational domain, a steering pinion meshed with said pitch gear, a entry gear shared common axis with said steering pinion, upon joining in respective steering cluster, and meshed with central gear of central cluster, having ratio teeth′ number thereof to number of teeth of said central gear equal to ratio of teeth′ number of said steering pinion to number of teeth of said pitch gear, a grove follower inserted to circular grove of central cluster and shared common axis with said entry gear upon joining to said steering cluster, a means for keeping fixed distance between axes of said steering cluster and said pitch gear, and a transmission between said pitch gear to respective wing, providing unitary angular relation between said pitch gear and said wing.

2. The rotor set forth in claim 1 wherein said rotor has features and elements comprising:
a central powering shaft, used as rotational tier of setup of said rotor and belonged to said rotational domain;
a flanged hub, fixed on said central powering shaft;
a round faceplate belonged to said rotational domain and represents face side thereof, providing mounting basement for said wings, the round faceplate fixedly connected on center of inside thereof to flanged side of said flanged hub, having coaxial relation with said central powering shaft;
a back-ring belonged to said rotational domain, coaxially mounted on inside of said faceplate on fixed distance there from, imposing axial position of said central cluster between axial position thereof and said faceplate;
a steady base with flange generally represents said irrotational domain, fixed on said central powering shaft on fixed distance from said back-ring with freedom of rotation in respect of said central powering shaft;
a round base of each said wing as integral element thereof, entered in respective correspondent hole of said faceplate, having face side thereof generally on same level with face level of said face plate, with fillet interface on each side of said wing and smooth transition of leading edge of said wing to rim thereof;
a shaft per each said pitch gear, on which said pitch gear fixed, the shaft rotationally mounted on ends thereof between said faceplate and said back-ring; and
a shell per each said pitch gear, which represents said means for keeping fixed distance between axes of said steering cluster and said pitch gear, the shell rotationally fixed on said shaft of respective pitch gear and provides full rotational support for respective steering cluster, becoming with all said elements of content thereof an earring assembly.

3. The rotor set forth in claim 2 wherein each transmission between related pitch gear and respective wing comprises:
a bevel gear with substantially high diameter, fixedly mounted on base of wing;
a bevel pinion meshed with said bevel gear;
a shaft-mounted cluster of a pinion, meshed with respective pitch gear, and a miter gear, where ratio of teeth′ number of said pitch gear to teeth′ number of said pinion equal to ratio of teeth number of said bevel gear to ratio of teeth number of said bevel pinion, and which shaft rotationally mounted on ends thereof between said faceplate and said back-ring;
a separated miter gear meshed with miter gear of shaft-mounted cluster; and
a transmission shaft, on which ends said separated miter gear and said bevel pinion fixed, and having support axis thereof in radial and axial directions in respect to said faceplate.

4. The rotor set forth in claim 3 wherein a set of equal ribs, which number equal to number of said rotor wings, used as distributed separation support of said back-ring on said faceplate, which members equidistantly placed around outer rim of said back-ring, providing rotational support for said transmission shafts from sides of said separated miter gears also.

5. The rotor set forth in claim 3 wherein a set of equal wing sockets of cup-like shape, which number equal to number of said wings, equidistantly mounted on periphery of said faceplate and used for rotational support of said wings and for rotational support for said transmission shafts from sides of said bevel pinions.

6. The rotor set forth in claim 3 wherein a set of screws used for fixing said bevel gear on base of wing, which placed around periphery of inside teeth area of said bevel gear, without protruding from level of the area.

7. The rotor set forth in claim 5 wherein a wing owned shaft of each said wing fixed inside said wing and protrudes from center of respective round base in direction opposite to said wing, servicing as pivot axis of said wing, and wherein each of wing sockets has a set of parts assigned thereto and related to support and installation of respective wing comprising:
a primary thrust bearing, placed between bottom of said wing socket and periphery of inside teeth area of bevel gear of said wing;
a radial needle bearing, placed inside of a central hole of said wing socket;
a tubular flange, dressed over shaft owned by said wing, having a tubular part thereof inside of said radial needle bearing and a flanged part outside of said wing socket;
a secondary thrust bearing, placed outside between bottom of said wing socket and the flanged part of said tubular flange; and
a nut screwed from outside on a threaded end of said shaft over the flange part of said tubular flange.

8. The rotor set forth in claim 5 wherein a set of bridges used for connect pairs of neighbored wing sockets, where each said bridge is a segment of plate, having mating rims thereof complementary to outer shape of said wing socket on mating interface, and oriented parallel to said faceplate upon mounting thereof on said wing sockets.

9. The rotor set forth in claim 2 wherein an irrotational shifting base mounted on said steady base as interface between said central cluster and means for steering thereof in radial and asimuthal directions relative to said steady base, and with thereof own means of angular steering of said central cluster, where said own means have continuation for pitch steering interface of said steering tier of setup.

10. The rotor set forth in claim 9 wherein steering tier of setup of rotor represents thereof components by mechanical means comprising:
a pitch outer shaft, which rotation used for change pitch of said rotor;
a gain outer shaft, which rotation used for change gain of said rotor in linear form; and
a skew outer shaft, which rotation used for change skew of said rotor or skew and gain simultaneously.

11. The rotor set forth in claim 10 wherein said central cluster includes a internal gear coaxially placed thereon, and said rotor further comprises:
a pitch flanged bracket, mounted on said shifting base on flange side thereof upon inserting through respective pitch hole of steady base of said rotor, and having a worm support bracket as other side thereof;
a pitch steering shaft, mounted inside said pitch flanged bracket with freedom of rotation;
a pitch pinion, fixed on inner end of said pitch steering shaft and meshed with said internal gear;
a pitch worm gear, fixed on outer end of said pitch steering shaft;
a telescopic universal joint, which outer shaft mounted on said steady base with freedom of rotation and used as pitch outer shaft of steering tier of setup, and which inner shaft mounted on said worm support bracket with freedom of rotation; and
a pitch worm, fixed on said inner shaft of telescopic universal joint and meshed with said pitch worm gear.

12. The rotor set forth in claim 9 wherein rotational support of said central cluster on said shifting base provides by a system comprising:
a radial bearing, placed between said shifting base and said central cluster;
a closing flange coaxially mounted on said shifting base from side of said faceplate; and
a thrust bearing, placed between said central cluster and said closing flange.

13. The rotor set forth in claim 9 wherein an irrotational fixation on fixed axial position for said shifting base relative to said steady base provides by a retaining system comprising:
a set of three radial rods, where each mounted by inner end thereof on said flange of steady base with radial and normal orientation relative to central axis of said rotor between said steady base and said shifting base and being fixed by outer end thereof on said steady base, where two of said radial rods oriented exactly in counter-direction, and third of said radial rods oriented by right angle to both others, becoming central radial rod;
a set of three tangential rods, where each mounted by ends thereof on said shifting base below of respective radial rod and with right angle orientation of axis thereof to axis of respective radial rod; and
a set of three cross-holes bearings, where in respective holes of each said bearing respective pair of said radial rod and said tangential rod inserted, having ability of free axial movement.

14. The rotor set forth in claim 13 wherein said tangential rods placed between said shifting base and said central cluster, and said shifting base has three side slots, which provide clearance for respective cross-holes bearings.

15. The rotor set forth in claim 13 wherein one of said cross-hole bearings has two crampons as symmetrical extensions along direction of respective tangential rod, and said crampons inserted in two respective saddles fixed on said shifting base, extending retaining base of tangential retaining component of said cross-hole bearing.

16. The rotor set forth in claim 10 wherein means of steering of shifting base are provided by a Gain-Skew-node (GS-node), which mounted on said steady base upon inserting kernel part thereof, referenced as GS-variator, in respective hole of said steady base, and said GS-variator provides direct steering interface to said shifting base and comprises:
a flange, which has generally round shape, providing desired space for other rotated elements in its interior, and used also for mounting said entire GS-node on said steady base by mounting base thereof, which axial direction relative to said steady base from said shifting base referenced as bottom direction;
a skew worm gear, mounted inside and below of said flange on fixed distance with freedom of rotation;
a toothed rack, mounted on said skew worm gear with tangential orientation of toothed side thereof on fixed distance from center of said skew worm gear with freedom of movement along teeth thereof;
a gain steering shaft, mounted on said flange coaxially with said flange with freedom of rotation;
a gain gear, fixed on said gain steering shaft and meshed with said toothed rack;
a steering lead, fixed on said toothed rack, having a round steering pin, inserted in correspondent hole of said shifting base with means of rotation, where said steering pin has coaxial relation with axis of said skew worm gear for neutral state of gain;
a gain worm gear fixed on said gain steering shaft in upper outside position from said flange;
a gain inner shaft, mounted on said flange with freedom of rotation, which can be used as gain outer shaft of steering tier of setup, when using of simultaneously change of skew and gain by corresponded skew outer shaft is permissible;
a gain worm fixed on said gain inner shaft and meshed with said gain worm gear;
a skew steering shaft, mounted on said flange with freedom of rotation, which can be used as skew outer shaft of steering tier of setup, when placement of axis of said skew outer shaft between said steady base and said shifting base in axial direction of said rotor is permissible; and
a skew worm fixed on said skew steering shaft and meshed with said skew worm gear.

17. The rotor set forth in claim 16 wherein said GS-variator has compact placement in axial direction by using features and elements comprising:
a rectangular dip on upper side of said skew worm gear in which said toothed rack placed moveable, slipping on bottom and toothed-opposite surfaces thereof;
a hole in said rectangular dip in which said steering lead inserted from bottom side and fixed on said toothed rack, having a slipping ledge, which slips over bottom surface of said skew worm gear, providing fixation for said toothed rack and for itself in axial direction;
a round dip on upper side of said skew worm gear in which said gain gear inserted keeping correct vertical alignment with said toothed rack;
a retaining ring, which coaxially and fixedly mounted on said skew worm gear, the retaining ring has a retaining rim on upper flange thereof;
a flanged bearing, which inserted coaxially in central hole of said skew worm gear from up, the flanged bearing provides radial and bottom axial supports for said gain steering shaft relative to said skew worm gear and laid under said gain gear;
a intermediate ring, which coaxially and fixedly mounted on said flange, the intermediate ring has two retaining rims on bottom flange thereof;
a outer bearing, which placed between said retaining ring and said intermediate ring, providing radial and bottom-axial supports for said skew worm gear, using said retaining rims of both said rings; and
a inner bearing, which placed between said intermediate ring and hub of said gain gear, completing radial and axial supports for said gain steering shaft and said skew worm gear.

18. The rotor set forth in claim 16 wherein said GS-variator permits simplified manufacturing and more convenient placement of said skew outer shaft of steering tier of setup by using elements comprising:
a skew outer shaft, which implements said skew outer shaft of steering tier of setup;
a skew bracket, which mounted over mounting base of flange of GS-variator, having flat-sector shape of mounting interface thereof with inner radius correspondent to related radius of said flange, the skew bracket used for support said skew steering shaft on ends thereof, so manufacturing of said flange without said support function can utilize turning operations, and additionally the skew bracket used for support said skew outer shaft on inner end and on other entry side thereof, placing axis thereof above said steady base and in parallel orientation to axis of said gain inner shaft and said skew steering shaft too; and
two meshed gears, where one of these gears fixed on said skew steering shaft outside of said skew bracket, and other gear fixed on said skew outer shaft near inner end thereof inside of said skew bracket.

19. The rotor set forth in claim 16 wherein said GS-node has a SG-compensator, which permits completely decompose gain and skew components of entire PGS-state, by providing rotation from said skew steering shaft to said gain inner shaft by a gear means and means of differential transmission, where rotation transmitted to said gain steering shaft provides movement of said toothed rack, compensating respective movement induced by rotation of said skew worm gear, and where other side of said means of differential transmission accepts rotation from said gain outer shaft of steering tier of setup.

20. The rotor set forth in claim 19 wherein said SG-compensator composed with a gain-handling reducer for aligning rotational speed of said gain outer shaft and pitch outer shaft of said steering tier of setup in relation to changing of correspondent components of PGS-state to ratios optimal for main flight operations, the reducer has two stages with coaxial placement of said gain outer shaft and said gain inner shaft, and said means of differential transmission placed between them, and with said composition said SG-compensator comprises:
a gain bracket, which mounted over mounting base of flange of GS-variator, having flat-sector shape of mounting interface thereof with inner radius correspondent to related radius of said flange, the gain bracket used for support all shafts of entire SG-compensator, except transverse shaft of said means of differential transmission, the gain bracket also supports end of said gain inner shaft and said skew steering shaft;
a gain outer shaft, which implements said gain outer shaft of steering tier of setup, the gain outer shaft supported by said gain bracket on inner end and other entry side thereof in coaxial relation with gain inner shaft;
an outer reduction pinion fixed on said gain outer shaft inside of said gain bracket;
an outer reduction gear meshed with said outer reduction pinion and has rotational support over hub thereof in radial and inner axial directions by a bearing inserted in said gain bracket from outside;
an outer miter gear fixed in hub of said outer reduction gear;
an inner miter gear;
an adapter has rotational support on tail thereof by said gain bracket and provides fixation for said inner miter gear, supporting it in coaxial relation to said outer miter gear;
an inner reduction pinion fixed on said tail of said adapter;
an inner reduction gear meshed with said inner reduction pinion and fixed on said gain inner shaft;
a transverse shaft has a rectangular section in center thereof with a cross-hole to axis thereof and a threaded hole in perpendicular direction;
two intermediate miter gears placed on ends of said transverse shaft with freedom of rotation and with support in outer axial directions, these miter gears meshed with said outer and inner miter gears in differential's relation;
a flanged bearing inserted in central hole of said outer reduction gear from outside;
a compensating shaft inserted to said flanged bearing up to limit of tail thereof, the compensating shaft has also rotational support on outer end thereof in said gain bracket, completing rotational support of said outer reduction gear, and tail thereof inserted in said cross-hole of transverse shaft and in central holes of said outer and inner miter gears;
a setscrew screwed into said threaded hole of transverse shaft and fixes said compensating shaft inside of said transverse shaft, creating a spider of the completed differential;
a compensating gear fixed on said compensating shaft;
a compensating pinion fixed on said skew steering shaft; and
a intermediate gear mounted on said gain bracket with freedom of rotation and meshed with said compensating gear and said compensating pinion.

21. The rotor set forth in claim 1 wherein an end rotor support ring mounted on ends of said wings with freedom of rotation of each said wing in connection thereof with the end rotor support ring by using features and elements comprising:
a convex shape of cross-section of said end rotor support ring in outside axial direction, which provides enough volume for place other elements inside of said end rotor support ring, having said shape of the cross-section airflow friendly;
a flat inner side in axial direction of said end rotor support ring;
a substantially big and flat end base of each said wing, which permits having tight interface with inner flat side of said end rotor support ring;
an end wing fairing of each said wing, which provides enough volume for place other elements inside of thereof and keeps airflow friendly cross-section between transition thereof from airfoil of said wing to said flat end base, having additional protruding in direction of leading edge thereof and said wing;
a set of equal step-holes equidistantly spaced around center-line of said end rotor support ring with number equal to number of said wings, having generally three stages of said stepping, where stage with highest diameter of said step-hole placed on inner flat side of said end rotor support ring;
an end wing tubular flange inserted by flanged side thereof to middle stage of each said step-hole;
an end wing secondary thrust bearing laid on wing's side of each said end wing tubular flange;
an end wing radial needle bearing, dressed over tubular part of each said end wing tubular flange after said end wing secondary thrust bearing;
an end wing adapting flange laid over each said end wing secondary thrust bearing, entering by centering ring thereof in outer stage of said step-hole and fixed around perimeter thereof to said end rotor support ring by screws, having said end wing radial needle bearing inside of center hole thereof without possibility of fall out, upon closing it by under-flanged part thereof;
a step-hole exists in said flat end base of each wing, centered around pivot axis of said wing, having generally three stages of said stepping, where stage with smallest diameter has on continuation thereof a threaded finalizing inside of said wing;
an end wing primary thrust bearing with diameter higher than said end wing secondary thrust bearing laid in middle stage of said step-hole of each wing after said correspondent end wing adapting flange, where last enters in outer stage of said step-hole of wing by area of said screws of fixation thereof and provides additional radial aligning of the bearing by under-flanged part thereof;
an end wing bolt enters from outside of each step-hole of end rotor support ring to said end wing tubular flange and screwed in said threaded finalizing inside of respective wing, having head thereof inside of said step-hole with smallest diameter, the end wing bolt has freedom of rotation inside of said end rotor support ring with said end wing tubular flange altogether;
two setscrews fix each said end wing bolt against unscrewing, using respective setup holes on both sides of said respective end wing fairing; and
an end wing seal enters in outer remainder of each said step-hole and seals its content from environment, having airflow friendly outer surface.

22. The rotor set forth in claim 1 wherein at least one intermediate support ring mounted in midst of said wings with freedom of rotation of each said wing in intersection thereof with said intermediate rotor support ring in respect the ring, and with ability transmit rotational moment from inward to outward linked components of each said wing relative said intermediate support ring by using features and elements comprising:
two flat sides in axial direction of said intermediate rotor support ring;
a substantially big and flat intermediate base of each linked component of each said intersected wing, which permits having tight interface with flat sides of said intermediate rotor support ring;
an intermediate wing fairing of each linked component of each said intersected wing, which provides enough volume for place other elements inside of thereof and keeps airflow friendly cross-section between transition thereof from airfoil of said linked component to said flat intermediate base, having additional protruding in direction of leading edge thereof and said linked component;
a set of equal holes equidistantly spaced around said intermediate rotor support ring with number equal to number of said wings;
a wings'-link radial needle bearing inserted in each said hole of intermediate rotor support ring and some protruded from both sides of said intermediate rotor support ring;
a wings'-link adapting flange placed on each side of each hole of said intermediate rotor support ring and centered by said correspondent protruded end of respective wings′-link radial needle bearing, the wings'-link adapting flange has a under-flanged part, which closes said wings'-link radial needle bearing from going out;
a step-hole exists in said flat intermediate base of each linked component of each intersected wing, centered around pivot axis of said linked component, having generally three stages of said stepping, where stage with smallest diameter has on continuation thereof a threaded finalizing inside of said linked component;
a wings'-link thrust bearing laid in outer stage of said step-hole of each linked component of each intersected wing after respective wings'-link adapting flange, where last provides additional radial aligning to said bearing by under-flanged part thereof;
a wings'-link shaft has central part with substantially high diameter, which enters in each said wings'-link radial needle bearing and in middle stages of step-holes of intermediate bases of correspondent linked components, and has two symmetrical tails of lower diameter with threaded ends, which screwed into said threaded finalizing inside of linked components, having complementary right-left handing of said threaded ends thereof for fine regulation backlash between said intermediate rotor support ring and both components of said intersected wing; and
two setscrews fix each side of each said wings'-link shaft for transmitting rotation moment, using respective setup holes on both sides of said correspondent intermediate wing fairings, these setscrews also permit using one of linked component as handle for setup and fine regulation of said backlash upon alternated screwing-unscrewing of said setscrews from respective sides of said wings'-link shaft.

23. The rotor set forth in claim 22 wherein winglets installed as most outer linked components of said wings intersected with said intermediate rotor support rings, having wing fences on ends thereof.

24. The rotor set forth in claim 22 wherein winglets installed as most outer linked components of said wings intersected with said intermediate rotor support rings, having longitudinal sweeping toward leading edges thereof for particular compensating overall negative rotational moments of said wings in high speed flight operations performed with said rotor.

25. The rotor set forth in claim 2 wherein a cross-section of each said wing utilizes a symmetrical airfoil, having substantially low moment coefficient on 0.25 of chord thereof, which used as pivot position, and said wings has trailing edge thereof substantially protruded from rim of said round base of said wing, against having said round base too big.

26. The rotor set forth in claim 1 wherein a cross-section of each said wing utilizes a supercritical airfoil.

27. A rotary wing aircraft generally based on conception for performing powered flight of aircraft by performing work against gravity force, using gliding wing as steady support, namely “flying elevator” conception, comprising:
a fuselage, having generally streamlined elongated shape;
handling means installed on said fuselage and used for handling and control of said aircraft;
two stabilators pivotally mounted apart on left and right sides of aft of said fuselage, with ability of control of pitch thereof and connected to respective tier of said handling means;
engine means installed on said fuselage and connected to said handling means on respective tier of said handling means;
energy supply means installed on said fuselage and connected to said engine means and to respective tier of said handling means;
two rotors with managed PGS-state of axially oriented wings thereof and construed in accordance with four gears pitch steering scheme, mounted apart on left and right sides of said fuselage, where each has setup tiers including: a rotational tier drivable connected to said engine means, an irrotational tier fixedly mounted on respective irrotational element of said aircraft and represented by a steady base of said rotor and a steering tier, which represented by means of managed separated PGS-components or their combinations and connected to respective tier of said handling means; and
locking means used for locking against rotation of said rotational tiers of setup of said rotors upon gliding of said aircraft, these locking means have an irrotational tier thereof mounted on respective irrotational elements of said aircraft, a rotational tier thereof mounted with drivable connectivity to said rotational tiers of setup and a handling tier, which represented by means of switching between locked and non-locked state thereof for said both rotors simultaneously and connected to respective tier of said handling means.

28. The aircraft set forth in claim 27 wherein said steering tier of setup of each said rotor represents thereof components by mechanical means comprising:
a pitch outer shaft, which rotation used for change pitch of said rotor;
a gain outer shaft, which rotation used for change gain of said rotor in linear form; and
a skew outer shaft, which rotation used for change skew of said rotor or skew and gain simultaneously;
and wherein said handling means has pair from servo and encoder per each said outer shaft rotationally connected with respective outer shaft, and used for management thereof.

29. The aircraft set forth in claim 28 wherein tiers of said handling means related to said two stabilators and to said locking means connected to them by respective shafts, having pair from servo and encoder rotationally connected with each said shaft, and wherein said handling means have also an attitude control system, an airstream control system and a stabilator controller, where last can manage pitch of said stabilators upon actuating servo related to said stabilators for keeping desired pitch of said fuselage relative to ground using the attitude control system, or for keeping said fuselage pointed to direction of airstream using the airstream control system (stream following feature), dependently from particular flight operations.

30. The aircraft set forth in claim 29 wherein said engine means comprise two electrical engines respective and drivable connected to said rotational tiers of setup of respective rotors, and wherein energy supply means include set of electrical sources connected to two power circuits respectively and correspondently to these two electrical engines and managed by respective tier of said handling means.

31. The aircraft set forth in claim 30 wherein said power circuit can conduct power for recuperation mechanical energy of said rotors to said electrical sources, said electrical engines can operate for the recuperation, and said electrical sources can receive and store electrical energy in any form.

32. The aircraft set forth in claim 30 wherein said rotational tier of setup of each rotor represented by a central powering shaft placed coaxially with said rotor.

33. The aircraft set forth in claim 32 wherein said central powering shafts of both rotors fixedly connected with each other and said two power circuits have common control.

34. The aircraft set forth in claim 33 wherein tier of said handling means related to electrical engines has a pair from servo and encoder, where said encoder used as primary source for defining target winding speed for said both rotors, and wherein said handling means have also an engine controller, which accept values from said encoder and manages said both power circuits for reflect desired target winding speed of said rotors, having feedback about actual winding speed and keeping rotational moment induced by acceleration of said rotors inside of limits of prescribed constrains.

35. The aircraft set forth in claim 32 wherein said electrical engines have generally disk-like shape with high diameter about of half of said rotor's diameter, which permits having high torque, and small thickness, which permits having low weight, and rotational tiers thereof directly coupled with said powering shafts of respective rotors.

36. The aircraft set forth in claim 35 wherein said fuselage has two rotors' sockets with generally conical shape and with diameter generally about 40 percents higher than height of said fuselage in vicinity thereof and with aligning of outer bases thereof with neighbored levels of said fuselage, in which said two respective rotors inserted from outside of said fuselage up to beginning of wings of said rotors, these rotors' sockets used as fairings for said rotors, and provide additional rigidness for said fuselage also, and wherein said fuselage has in shape thereof intermediate interfaces along common section borders of said rotors' sockets and streamlined part of said fuselage for smoothing over said section borders.

37. The aircraft set forth in claim 36 wherein said fuselage has inside thereof on each lateral side a force plate, continuing from fuselage floor in vertical direction up to upper limits of said fuselage and having a big hole coaxial with respective rotor, and vicinity of said hole integrally connected with inner base of conical surface of respective rotor's socket, providing additional rigidness for said fuselage, and wherein said electrical engines inserted to said holes from outside of said fuselage and fixed over perimeter of said holes, having a setup flanges over bodies thereof for said fixation, and which bodies used for mounting of said steady bases of rotors.

38. The aircraft set forth in claim 37 wherein said fuselage has sockets for said electrical engines, and each said engine's socket comprises:
a socket's drum, which is a ring integrally connected to inner side of said force plate of fuselage in coaxial placement to hole of said force plate, having diameter thereof moderate higher than diameter of said respective electrical engine, small thickness and axial length about axial length of protruded part of said engine over said force plate;
a socket's back-ring, which has outer diameter equal to outer diameter of said socket's drum, small thickness and inner diameter some small than diameter of said electrical engine, the socket's back-ring integrally connected to said socket's drum over entire perimeter thereof and seals entire air volume between said socket's drum and said electrical engine upon additional fixation of inner flange of said electrical engine thereto; and
a remainder of said force plate, created upon integration of said socket's drum to said force plate;
and wherein said fuselage has a cooling system per each electrical engine, based on said engine's socket, comprising:
an entry airflow window of said engine's socket created in upper-forward quadrant of said socket's drum;
an air inlet placed over forward streamlined part of said fuselage in interface thereof with said rotor's socket after joining thereof with said force plate, and generally has shape of horizontal projection of said entry airflow window to said fuselage;
an air separating plate placed generally horizontal from bottom of said entry airflow window to cylindrical surface of said electrical engine with generally near to tangential relation thereto, having also continuation to forward direction up to bottom of said air inlet, the air separating plate has width equal to distance between said force plate of fuselage and said socket's back-ring, disabling to air going underneath;
an air sealing plate placed generally horizontal from top of said air inlet to top of said entry airflow window, having same width as said air separating plate, disabling to air going outside of volume space of said cooling system;
an exit airflow window of said engine's socket created in upper-forward quadrant of said socket's back-ring under said air separating plate, permitting for warm air go out said engine's socket after its turn around said electrical engine;
an air outlet placed over backward streamlined part of said fuselage in interface thereof with said rotor's socket after aft limit of said force plate, but more inner in axial direction of said rotor then said air inlet;
an air conduction tube placed inside of said fuselage in direction generally parallel to ceil of said fuselage and to closed vicinity to said ceil toward aft of said fuselage, the air conduction tube has generally rectangular shape in each cross-section thereof, fixed on two opposed segments of said socket's back-ring and fixedly connected to said fuselage along perimeter of said air outlet, bypassing warm air and increasing rigidness to said fuselage also.

39. The aircraft set forth in claim 35 wherein said central powering shaft of each said rotor going through center of rotor of respective electrical engine and fixed therein with ability of detaching.

40. The aircraft set forth in claim 39 wherein each electrical engine has a hollow shaft mounted on center of its rotor after insertion tubular part thereof to a correspondent hole in rotor of said electrical engine from inside direction of fuselage, having flanged part thereof referenced as setup flange and fixed to correspondent side of rotor of electrical engine from inside direction also, the hollow shaft has a continuation of tubular part thereof from other side of said setup flange, providing fixation for said central powering shaft inserted in central hole thereof, and the hollow shaft manufactured from high module alloy, permitting using lightweight alloy for remained part of rotor of electrical engine.

41. The aircraft set forth in claim 40 wherein each said hollow shaft has a collet clamp used for fixation said central powering shaft of rotor comprising:
a fine tolerance clamping area with thread on said continuation of tubular part, with a number of end-beginning slots around thereof and with outer end-cone; and
a clamping nut, which screwed over thread of said fine tolerance clamping area and has inner cone correspondent to said outer end-cone of said fine tolerance clamping area.

42. The aircraft set forth in claim 40 wherein each electrical engine has elements related to force accepting interior thereof comprising:
a high load needle bearing, which placed inside of body of said electrical engine and provides radial support to end of said hollow shaft from side of entering said central powering shaft of rotor;
a lid, which closed interior of said electrical engine from inside direction of said fuselage and has a central hole with diameter a bit higher then outer diameter of setup flange of hollow shaft;
a middle load bearing, which placed inside of said lid, having inside diameter thereof generally equal to diameter of central hole of said lid, the middle load bearing provides radial and inner axial support for remained part of rotor of electrical engine; and
a low load bearing, which placed inside of body of said electrical engine, overlapping said high load needle bearing, the low load bearing provides radial and outer axial support to remainder of rotor of electrical engine.

43. The aircraft set forth in claim 40 wherein said locking means on side of each said rotor have a locker comprising:
a drum, which fixed on setup flange of hollow shaft of electrical engine and used as rotational tier of said locking means;
a band brake, including band with frictional lining inside, correspondent to said drum and pivotally fixed by one end thereof on said electrical engine, and pulling lever, which pivotally connected to other end of said band by one end thereof, having a grove follower on other end thereof, and pivotally mounted on said electrical engine, the band brake used as irrotational tier of said locking means;
a main bracket fixed on said electrical engine;
an outer locking shaft, which has rotational support on said main bracket and used as handling tier of said locking means;
a screw, which fixed on said outer locking shaft in limits of said main bracket;
a conducting rod, which fixed on said main bracket, having axis thereof parallel to axis of said screw; and
a threaded lead, in which said screw screwed and which has an additional hole, which can move over said conducting rod, the threaded lead has an open grove in direction perpendicular of axis of said screw, in which said grove follower of pulling lever of band brake inserted, providing ability for precision control of said band brake.

44. The aircraft set forth in claim 43 wherein one side said locker selected as main, having outer locking shaft thereof connected to related tier of said handling means, and other side said locker selected as dependent, having outer shaft thereof connected to same of said main locker by gear means, using two pairs of meshed miter gears.

45. The aircraft set forth in claim 37 wherein a PGS gearbox placed for each said rotor near of floor of said fuselage, between said rotor's socket and said force plate, comprising:
a body, which fixed to said force plate,
a set of three coupled shafts for all said PGS-components, which members have rotational support and oriented vertically;
a set of three primary shafts for all said PGS-components, which members have rotational support and oriented horizontally; and
a set of three pairs of meshed miter gears, which fixed on said respective coupled and primary shafts;
and wherein elements exist, accompanied to said PGS gearbox, comprising:
a set of three PGS couplings, which connect all outer shafts of said steering tier of setup of rotor with respective coupled shafts of PGS gearbox;
three windows in said rotor's socket for all said outer shafts, in which said outer shafts can freely entered upon axial movement of said rotor in time of setup, and in which said PGS couplings can be rotated freely; and
three windows in said force plate, which placed against said respective socket's-windows, these windows used for assisting in mounting of said PGS couplings upon setup of said rotor.

46. The aircraft set forth in claim 27 wherein pitch control of said stabilators has elements comprising:
a common pivot shaft, which connects said two side stabilators altogether;
a worm gear fixed on said common pivot shaft;
a worm bracket, which fixed on said fuselage by means ensuring fixed distance thereof from said common pivot shaft;
a steering shaft, which has rotational support in said worm bracket;
a worm fixed on said steering shaft and meshed with said worm gear;
a primary stabilator pitch shaft, which represents respective tier of said handling means; and
a universal joint, which connects said steering shaft with said primary stabilator pitch shaft.

47. The aircraft set forth in claim 29 wherein said airstream control system comprises:
a Stream Deviation Tube (SDT), placed on nose of said fuselage, which reflects deviation of airstream relative horizontal plane thereof to pair of pressures on respective pneumatic outputs thereof, where one of them outputs represents upward pressure, and other downward pressure; and
a pair of electrical sensors respectively connected to said pair of pneumatic outputs of said SDT, which convert respective pressures to electrical signals used as output of said airstream control system.

48. The aircraft set forth in claim 34 wherein a central computer can manage all tiers of said handling means.

49. The aircraft set forth in claim 34 wherein two racks placed inside of said fuselage near to respective electrical engines, these racks have said electrical sources fixed on shelves thereof and are movable along said fuselage by mechanical means as part of said handling means, including respective servos and encoders, for tune center of gravity of said aircraft dependently from load variation and for additional assisting to said stabilator controller.

50. The aircraft set forth in claim 48 wherein said airstream control system possess abilities to measure true aerodynamic speed (TAS) at least for said stream following feature, and said central computer can interpret handling commands, expressed in form of biangular values for respective rotors, to respective PGS-states, using said value of TAS and actual winding speed of said rotors from said engine controller.

51. The aircraft set forth in claim 38 wherein said electrical sources can receive and store electrical energy in any form, and energy supply means include power plant based on combustion engine with electricity generator installed inside of aft compartment of said fuselage, with related elements of interface thereof comprising:
a fairing with air inlet, which spanned between said both side rotor's sockets over ceil of said fuselage, continues to aft and closes inside of interior thereof said air outlets of cooling systems of both electrical engines, so air from said cooling systems mixed with mainstream air of the air inlet;
an air-conducting envelope accepts air by its entry hole, placed inside of said fairing, directs it toward said combustion engine for cooling and breathing, and conducts exhaust of said combustion engine and hot air toward trailing edge of said fuselage, the air-conducting envelope wraps said combusting engine, generally having said electricity generator outside thereof, and has an air outlet on trailing edge of said fuselage; and
a power management circuit, which connected to said electricity generator, said electrical sources and to related tier of said handling means.

52. The aircraft set forth in claim 50 wherein said fuselage has a cabin with cockpit, which has handling elements comprising:
a display of said central computer;
a joystick connected to said central computer, which used as primary handler from side of pilot, providing commands based on variation of biangular values for respective rotors upon interpretation movements thereof by said central computer, presuming intuitive and pilot friendly intention of such movements;
a lock command button, which send command to said central computer for actuating said encoder of engine controller to position correspondent to zero target winding speed of said rotors;
a pair of buttons for increase-decrease target winding speed of said rotors by actuating said encoder of engine controller to respective directions; and
a versatile command pad from buttons, which used for customization handling of said aircraft and for management of said central computer;
and wherein said central computer can perform automatic lock of said rotors with zero target winding speed of rotors in case of magnitude of actual winding speed dropped below constrained threshold.

53. The aircraft set forth in claim 52 wherein said cockpit further has handling elements reflected in commands of said central computer comprising:
a handling control capturing button on said joystick, which used for enabling movements commands from said joystick with initial remembering absolute position of said joystick and biangular state of both rotors;
a pad of common handling for skew, opposite angle, biangular gain and main angle of both rotors simultaneously, having pair of increase-decrease buttons per each said handled parameter; and
a pad of in turn handling, which based on differential handling of biangular gain and on mixed handling of collective angle of said both rotors, the pad has buttons related to biangular gain in corners of quad thereof, and buttons related to collective angle on sides of quad thereof, here bottom corners buttons will decrease biangular gain for same side rotor with increasing on opposite side, and upper corners buttons perform opposite action, also here center side buttons will decrease collective angle for same side rotor with increasing on opposite side, and vertical center buttons act as complement for buttons of said pad of common handling on base of collective angles.

54. The aircraft set forth in claim 53 wherein said skew outer shaft of each said rotor used only for change skew, and wherein a set of trimmers rotationally connected to said respective servos and encoders of handling components for permitting manual handling of respective components by mechanical means in interior of each with high precision included, comprising:
two P-trimmers, which managed pitches of PGS-states of respective rotors, the each P-trimmer has a general scale with range from −180° to 180°, which occupies full circle, and has tics distance on highest precision scale in order of 0.1′;
two G-trimmers, which managed gains of PGS-states of respective rotors, the each G-trimmer operates over linear normalized gain, having a general scale with range from −100% to 100%, and has tics distance on highest precision scale in order of 0.1%, also the G-trimmer has overall indication of gain or indication of pitch deviations in main and opposite points on skew direction;
two S-trimmers, which managed skews of PGS-states of respective rotors, the each S-trimmer has placement of scales thereof equal to placement to said P-trimmer;
a WST-trimmer, which manages target winding speed of said engine controller, the WST-trimmer has a positive segment of a general scale thereof about two times longer than negative segment, and has tics distance on highest precision scale no worse than 0.1 m/s in order thereof;
a SP-trimmer, which manages pitch of said stabilators, the SP-trimmer has a general scale with range about from −30° to 30°, and has tics distance on highest precision scale in order of 0.1°, also the SP-trimmer can indicate actual position of said stabilators by a pictogram of section of said stabilator; and
a L-trimmer, which manages locking state of said locking means, the L-trimmer has a general scale with range from about −20% to 100%, where 0% reflects state when said irrotational tier of locking means touches said rotational tier of locking means, and full range thereof reflects full excursion of elements of said handling tier of locking means.

55. The aircraft set forth in claim 54 wherein said trimmers placed on said cockpit together with accompanied elements comprising:
a pair of increase-decrease buttons per each said trimmer, which used for changing value of respective component electromechanically by actuating respective servo, these buttons placed near respective trimmer (trimmer-buttons);
four locking knobs (L-knobs), which placed only near S-trimmers and G-trimmers as outer interface of their internal locking system and used for locking respective trimmers upon manual handling against possible mutually induced rotation of said outer shafts of rotors for skew and gain components, these locking knobs are handled by rotation between locking and non-locking position and have possibility of automatic unlocking for case of non-manual handling;
three pairs of increase-decrease buttons for changing pitch, gain and skew respectively and simultaneously for said both rotors electromechanically by actuating respective servos (common P-G-S-buttons);
a high speed button (HS-button) used for enabling high speed actuation for servos of pitch and skew, which action is applicable upon runway operations;
a pitch follows skew switch (S->P-switch) used for enabling said P-trimmers follow with same speed and direction after respective changes of said S-trimmers upon pressing said common S-button, which action is applicable upon runway operations;
two sets of differential P-G-S-buttons, which placed apart on respective sides related to said rotors and will decrease pitch, gain or skew respectively for same side rotor with increasing on opposite side electromechanically by actuating respective servos;
a Stream Deviation Indicator (SDI) is a pneumatic indicator respectively connected to pneumatic outputs of said SDT and reflects pressure difference by position of arrow thereof, the SDI used upon manual handling of said SP-trimmer and for indication efficiency of the automatic controlled loop of said stabilator controller;
a WSA-indicator, which connected to said engine controller and reports actual winding speed of said rotors;
a RPM-indicator, which connected to said engine controller and reports actual RPM of said rotors;
a MR-indicator, which connected to said engine controller and reports actual external moment ratio on common central powering shaft of said rotors, which value is normalized to particular total weight of said aircraft;
a SF-switch, which used for enabling said “Stream Following” featured action of said stabilator controller;
a EC-switch, which used for managing power state of said engine controller; and
a CM-switch, which used for enabling computer management for said central computer over all trimmers.

56. The aircraft set forth in claim 55 wherein, said cockpit has an indicator panel, oriented generally vertically, which used for placement standard standby instruments of an airplane with following said elements of cockpit: display, EC-switch, WSA-indicator, RPM-indicator and MR-indicator, and wherein said cockpit has also a control panel, sloped generally on 45 degrees and placed under said indicator panel as continuation thereof, having all said remained elements of said cockpit with placement, shaping and features comprising:
all elements of computer management placed in near under bottom of said display, having said pad of common handling on center of said display and of center from pilot;
said joystick placed on a pad, which hanged on a concave support from center of said control panel just below said pad of common handling;
said two sets of differential P-G-S-buttons placed on said control panel on respective sides from said concave support, having P-buttons thereof in inner-most position and G-buttons in outer-bottom position, and all these buttons have bottom arrowed shape for hint on decreasing nature thereof, where P- and G-buttons additionally have outward offset in shape of bottom-arrowed ends thereof for hint for turning impact thereof;
said common P-G-S-buttons and said HS-button placed on said pad of joystick from forward of said joystick, having P-buttons thereof on center of said pad and HS-button between pair of P- and S-buttons for hint on impact destination of said HS-button;
said S->P-switch placed on rim of said pad of joystick near said pair of S-buttons for hint on accompanied control used with this activated S->P-switch;
said two sets of P-G-S-trimmers placed on said control panel on respective sides from position of said display on corners of triangles, having P-trimmers in inner-bottom positions and G-trimmer in outer-middle positions for hint on maximal impact the last on turning operations;
said trimmer-buttons of P-G-S-trimmers placed generally in inner-bottom positions from respective trimmers, having different inclination from vertical with bottom-buttons on outside, which hint on different impact of respective components on turning operation and on side of normal turning, so trimmer-buttons for G-trimmers have maximal inclination and same buttons for S-trimmers are vertical;
said L-knobs placed generally in upper-outer positions from respective trimmers, minimizing effect of possible obstruction there from;
said WST-trimmer placed in upper-outer position on inner-most side of said control panel under WSA-indicator from said indicator panel, having trimmer-buttons thereof in upper-inner position;
said SP-trimmer placed under WST-trimmer, having trimmer-buttons thereof in bottom-inner position;
said SDI placed under said SP-trimmer, hinting on managing control thereof;
said SF-switch placed in upper-inner position from said SDI, hinting on enabling ability thereof in linking stabilator pitch managed by said stabilator controller with deviation remainder on SDI;
said L-trimmer placed on bottom of inner-most side of said control panel under G-trimmer, having trimmer-buttons thereof in upper-inner position; and
said CM-switch placed on top of inner-most side of said control panel over G-trimmer and oriented horizontal, having enabling articulation thereof pointed to said display for friendly hint on enabling state of computer management.

57. The aircraft set forth in claim 54 wherein, each set of said P-G-S-trimmers shared a common case with equilateral triangle placement for compactness.

58. The aircraft set forth in claim 52 wherein, said fuselage has vertical stabilizer with rudder, and said cockpit has two pedals for steering said rudder, connected with them by elements of respective tier of handling means.

59. The aircraft set forth in claim 38 wherein, said fuselage has two parking wheels, which rotationally mounted on two respective retractable parking support resided on lateral sides of said fuselage and occupies interior space near aft vicinity of said rotor's sockets outside inner levels in axial direction of respective electrical engines, these parking support oriented and retracted generally in vertical direction, manufactured from lightweight alloy tube and each has accompanied features and elements comprising:
a slotted end has a slot for said parking wheel in center-plan of tubular end of said parking support and rounded with radius generally equal to half of cross-length thereof;
a axel for said parking wheel fixed on said slotted end, connecting sides thereof;
a conductor has shape of segment of tube, fixed on said fuselage and has inside interior thereof said parking support, providing transverse support thereto with possibility of vertical slipping;
a keying rib mounted along backward side of said parking support and enters in corresponding hole of said conductor, preventing rotation of said parking support;
a retracting screw aligned with axis of said parking support;
a threaded complement mounted inside of said parking support, wherein said retracting screw screwed inside thereof;
a heel fixed on upper side of fuselage and provides rotational support for said retracting screw;
a servo with gear means can rotate said retracting screw; and
a parking hatch placed on fuselage, can be opened outside upon pushing force of said parking wheel, can be retracting by using spring means and secured by electromechanical latch, having ability for pressurizing level of sealing.

60. The aircraft set forth in claim 35 wherein, active vibration reduction system (VRS) included for partially decreasing vibrations induced by remained variations of overall steering moment of said rotors over changing minor rotational phase thereof, comprising:
a minor phase sensor, which provides synchronization signal of minor phase of said rotors upon detecting occurring of crossing zero-phase point of said rotors by any wing thereof, including possibility perform this task by analyzing original current patterns from said power circuits in case of respective correlation exists;
a pattern store, which stores set of compensating patterns related to respective flight operations and respective load states, the pattern store connected to respective tier of said handling means for selecting any of stored pattern as an active pattern for use; and
a pattern generator, which connected to said minor phase sensor and said pattern store, and can play said active pattern, synchronized and scaled in time with said synchronization signal of minor phase from said minor phase sensor, the pattern generator passes output pattern signal thereof to said two power circuits for obtain desired level representation in currents of coils of said electrical engines.

61. A trimmer for high precision control and indication of bi-directional values of steering of a handled element over rotational transmission, comprising:
a case has generally cylindrical shape, closed from bottom only and has outside other end thereof fixtures for mounting said trimmer under corresponding hole of control panel of cockpit;
a primary shaft has rotational support in bottom of said case upon entering from outside and used to transmit rotational state to consumer of said trimmer or receive it back;
a primary rotated can mounted coaxially inside of said case with rotational support on bottom thereof, the primary rotated can has a handling ring around face side thereof;
a primary rotated scale with shape of ring, mounted coaxially inside of said handling ring of primary rotated can or can be integral part thereof, the primary rotated scale has tics and oriented to center thereof labels around ring thereof with highest precision, which service negative values of handled steering, and zero label thereof used as arrow for positive values, having an arrow like frame around there;
a handler mounted on said handling ring of primary rotated can, having face level thereof below face level of said case, and can be retracted up over level of said control panel, having rotational support in this retracted state, the handler used for manual handling of said trimmer by fingers;
at least one steady scale or shield with shape of ring, mounted coaxially on said case, having face level of each same as for said primary rotated scale, where inner most steady shield has a scale around outer perimeter thereof and a general scale around inner perimeter thereof, which exposes full range of values of said trimmer, and where each steady scale or said outer scale of shield services positive values of handled steering, and the scale for outer most case has same placement tics and horizontal oriented labels as for said primary rotated scale, being read against said arrow from primary rotated scale, and in other case an intermediate rotated scale presumed in outer neighborhood with similar placement rules as for said primary rotated scale, and zero value of said steady scale or outer scale of shield services as an arrow for said respective rotated scale for negative values of handled steering;
at least one rotated scale or shield with shape of ring or circle, mounted coaxially on said case with rotational support, having face level of each same as for said primary rotated scale, where any rotated scale services as said presumed respective intermediate rotated scale for negative values, and where outer most rotated shield placed inside of said inner most steady shield and pictures an arrow, which points to respective value on said general scale;
a set of gear means, where each member thereof used for transmitting rotation from said respective outer rotated scale or shield, including said primary rotated scale, to respective inner rotated next scale or shield with desired reducing, servicing all said rotated elements; and
primary stage gear means used for transmitting rotation of said primary rotated can to said primary shaft and vice versa.

62. A trimmer set forth in claim 61 wherein said steady and rotated scale or shields and respective set of gear means accommodated to intermediate level of indication upon including elements comprising:
a primary steady scale, placed inside of said primary rotated scale;
a intermediate rotated scale, placed inside of said primary steady scale;
a steady shield, placed inside of said intermediate rotated scale, having a intermediate steady scale around outer perimeter thereof;
a central rotated arrow shield placed inside of said steady shield;
a secondary stage gear means placed between said primary rotated can and said intermediate rotated scale; and
a tertiary stage gear means placed between said intermediate rotated scale and said central rotated arrow shield.

63. A trimmer set forth in claim 61 wherein, a functionality for mapping alternative values with low precision exists with features and elements comprising:
a window in said steady shield with thin arrow or line outside thereof for reading indication inside thereof; and
a mapping shield with shape of ring, coaxially clustered with said outer most rotated shield, having face level thereof below said steady shield and having an alternative scale around a sector thereof partially under said window of steady shield.

64. A trimmer set forth in claim 63 wherein, two windows for two variants of alternative values exist on said steady shield, instead of said one window, with different radial positions and non-overlapped angular segments thereof, and two alternative scales placed on said mapping shield respectively.

65. A trimmer set forth in claim 61 wherein said steady and rotated scale or shields and respective set of gear means accommodated to indication of actual position of a handled element upon including elements comprising:
a steady shield, placed inside of said primary rotated scale, having a primary steady scale around outer perimeter thereof;
a rotated arrow shield placed inside of said steady shield;
a central rotated shield of actual position placed inside of said rotated arrow shield, the central rotated shield of actual position has a pictogram of handled element, which angular position is equal to angular position of the handled element relative to a common base;
a secondary stage gear means placed between said primary rotated can and said rotated arrow shield; and
a tertiary stage gear means placed between said rotated arrow shield and said central rotated shield of actual position.

66. A trimmer set forth in claim 61 wherein said rotational support of said primary rotated can has elements and features comprising:
a central axel of case is integral part of said case and protrudes from said bottom thereof to interior thereof in coaxial position, the central axel of case has a threaded hole on axis thereof;
a spacer ring;
two bearings dressed over said central axel of case, separated by said spacer ring, dressed on said central axel of case too, the bottom bearing has axial support over inner ring thereof on said bottom of case, and the upper bearing has upper level thereof equal to upper level of said central axel of case;
a tail of primary rotated can is integral part of said primary rotated can as continuation from bottom thereof to down, the tail has a center hole with a small inner ring area inside, which separates outer rings of said two bearings inserted to this hole; and
a long central axel screwed to said threaded hole of central axel of case and has a flange, which laid on top of said central axel of case, providing axial support for inner ring of said upper bearing;
and wherein said primary stage gear means comprises:
a primary center gear fixed on said tail of primary rotated can; and
a primary pinion fixed on said primary shaft and meshed with said primary center gear.

67. A trimmer set forth in claim 61 wherein a rotated arrow shield placed inside of said steady shield with a secondary stage gear means placed between said primary rotated can and said rotated arrow shield, and all shields, inside of said primary rotated can, have support elements comprising:
a long central axel mounted coaxially on said case and protruded in interior of said primary rotated can, the axel has a threaded segment in middle thereof, a tail over the threaded segment and a threaded hole on axis thereof from top;
a primary steady can mounted coaxially on said threaded segment of long central axel between two nuts, which clamped a bottom thereof, the primary steady can has a thickened area on rim thereof, which used for mounting said steady shield;
a secondary rotated can mounted coaxially on said tail of long central axel with rotational support, the secondary rotated can has a thickened area on rim thereof, which used for mounting said central rotated arrow shield; and
a screw with washer fixed in said threaded hole of long center axel, providing upper axial support for said secondary rotated can;
and wherein said secondary stage gear means have elements comprising:
a flanged primary central pinion dressed over said long central axel and fixed on bottom of said primary rotated can, consuming own width flange for this fixation, the flanged primary central pinion isn't touch said long central axel by central hole thereof;
a secondary shaft crossed bottom of said primary steady can with rotational support therein;
a secondary gear fixed on bottom end of said secondary shaft and meshed with said flanged primary central pinion;
a secondary pinion fixed on upper end of said secondary shaft; and
a secondary center gear mounted coaxially on bottom of said secondary rotated can and meshed with said secondary pinion.

68. A trimmer set forth in claim 67 wherein all gears of said secondary stage gear means manufactured from plastic, having features and elements comprising:
axial support of said secondary shaft provided by low friction hubs of said secondary gear and said secondary pinion;
radial support for said secondary rotated can provided by low friction central hole of said secondary center gear;
a low friction plastic washer placed between said upper nut and said secondary center gear for bottom axial support of said secondary rotated can, the plastic washer can be manufactured as integral part of said secondary center gear.

69. A trimmer set forth in claim 62 wherein said scales and shields, inside of said primary rotated can, have support elements comprising:
a long central axel mounted coaxially on said case and protruded in interior of said primary rotated can, the axel has a primary threaded segment in middle thereof, a tail over the primary threaded segment, a secondary threaded segment in middle of the tail, a short tile after the secondary threaded segment and a threaded hole on axis thereof from top;
a primary steady can mounted coaxially on said primary threaded segment of long central axel between two primary nuts, which clamped a bottom thereof, the primary steady can has a thickened area on rim thereof, which used for mounting said primary steady scale;
a secondary rotated can mounted coaxially on said tail of long central axel with rotational support, the secondary rotated can has a thickened area on rim thereof, which used for mounting said intermediate rotated scale;
a secondary steady can mounted coaxially on said secondary threaded segment of long central axel between two secondary nuts, which clamped a bottom thereof, the secondary steady can has a thickened area on rim thereof, which used for mounting said steady shield;
a rotated flange mounted coaxially on said short tail of long central axel with rotational support, the rotated flange used for mounting said rotated arrow shield; and
a screw with washer fixed in said threaded hole of long center axel, providing upper axial support for said rotated flange, these screw with washer placed inside of correspondent hole of said rotated flange;
and wherein said secondary and tertiary stages gear means have respective elements comprising:
a flanged primary central pinion dressed over said long central axel and fixed on bottom of said primary rotated can, consuming own width flange for this fixation, the flanged primary central pinion isn't touch said long central axel by central hole thereof;
a secondary shaft crossed bottom of said primary steady can with rotational support therein;
a secondary gear fixed on bottom end of said secondary shaft and meshed with said flanged primary central pinion;
a secondary pinion fixed on upper end of said secondary shaft;
a cluster of secondary center gear and pinion mounted coaxially on bottom of said secondary rotated can, having pinion thereof inside of interior of said secondary rotated can, and center gear thereof meshed with said secondary pinion;
a tertiary shaft crossed bottom of said secondary steady can with rotational support therein;
a tertiary gear fixed on bottom end of said tertiary shaft and meshed with pinion element of said cluster of secondary center gear and pinion;
a tertiary pinion fixed on upper end of said tertiary shaft; and
a tertiary center gear mounted coaxially on bottom of said rotated flange and meshed with said tertiary pinion.

70. A trimmer set forth in claim 69 wherein all gears of said secondary and tertiary stages gear means manufactured from plastic, having features and elements comprising:
axial support of said secondary shaft provided by low friction hubs of said secondary gear and said secondary pinion;
radial support for said secondary rotated can provided by low friction central hole of said cluster of secondary center gear and pinion;
a low friction plastic washer placed between said upper primary nut and said cluster of secondary center gear and pinion for bottom axial support of said secondary rotated can, the plastic washer can be manufactured as integral part of said cluster of secondary center gear and pinion;
axial support of said tertiary shaft provided by low friction hubs of said tertiary gear and said tertiary pinion;
radial support for said rotated flange provided by low friction central hole of said tertiary center gear;
a low friction plastic washer placed between said upper secondary nut and said tertiary center gear for bottom axial support of said rotated flange, the plastic washer can be manufactured as integral part of said tertiary center gear.

71. A trimmer set forth in claim 61 wherein said primary rotated can has features and elements, related to sealing interior thereof, comprising:
a nest inside handling rim of said primary rotated can over face level of said primary rotated scale;
a rubber ring placed on bottom of said nest around periphery thereof;
a glass lid inserted in said nest and lays on said rubber ring; and
a glass retaining ring fixed on top of handling rim of said primary rotated can and retains said glass lid, the glass retaining ring has a hole correspondent to said handler.

72. A trimmer set forth in claim 61 were said handler and said primary rotated can have features and elements comprising:
a head exist on top of said handler with shape of ring of substantially increased diameter;
a hole exists in handling rim of said primary rotated can, therein said handler inserted from up and lays on said head with ability retracting by fingers;
a tail exist as continuation of said handler below bottom level of said handling rim;
a threaded hole exists on axis of said tail from bottom;
a tube dressed on said tail with possibility of free rotation thereon, the tube has outside diameter matched to diameter of said hole of handling rim for retaining against rotation and fall-down in retracted state of said handler by some friction; and
a screw with washer fixed in said threaded hole of tail, where outer diameter of the washer is substantially higher then diameter of said hole of handling rim, retaining said handler inside of trimmer and supporting said tube against fall-down.

73. A trimmer set forth in claim 61 wherein a locking system included with said trimmer, having a locking knob on said control panel, with features and elements of said system comprising:
locking needles equidistantly mounted on said primary rotated can or on continuation thereof, around perimeter thereof and outward from center thereof in non-obstructed area of said case;
a window exists on periphery of said case against area of said locking needles;
a locking bracket mounted on periphery of said case, having an interface of interior thereof with said window;
a solenoid mounted inside of said locking bracket with axis thereof directed toward said window;
a locking wedge, has magnetic tail inserted in said solenoid, the locking wedge can enter in said window with positioning between pair of neighbored locking needles, performing actual locking;
a spring dressed on tail of said locking edge, having back support on flange of said solenoid, the spring pushes said locking edge toward locking position thereof;
a rigid wire connected to end of tail of said locking wedge, going from a hole of mounting place of said solenoid in said locking bracket;
a soft string fixed to end of said rigid wire, the soft string can unlock said trimmer upon pulling other end of the string;
a pulley mounted on said locking bracket with possibility of free rotation, the pulley conduct said soft string to direction of said locking knob;
a bracket of locking knob mounted under said control panel near said trimmer;
a pulley of said locking knob mounted on said bracket of locking knob with possibility of free rotation, the pulley receive other end of said soft string from direction of said locking bracket;
a shaft of locking knob mounted inside of said bracket of locking knob with rotational support and has a tail protruded over face level of said control panel through correspondent hole thereon, the shaft has other end of said soft string fixed on middle segment thereof and can pull said soft string upon own rotation, having grove like envelope of clearance around of mating segment thereof with said soft string;
a shaft snapping system placed inside said bracket of locking knob and provides snapping with some force of said shaft in two angular positions related to locking and non-locking states of said locking knob; and
a handler of locking knob fixed on tail of said shaft and has a pointer, which indicates actual locking state of said locking knob.

74. A trimmer set forth in claim 61 wherein a servo mounted outside on bottom of said case, the servo provides rotation to said primary shaft and to consumer of said trimmer by using gear means mounted on bottom of said case.

75. A Stream Deviation Tube (SDT) for detecting deviation of airstream from plan of symmetry thereof in pitch direction generally and in form of two pressures, the SDT presumes use thereof by installation on forward of fuselage of an aircraft for detect deviation of said fuselage from stream following position, and the SDT comprising:
a consoling base, which used to positioning a forward end of said SDT on desired distance from said fuselage, the consoling base has generally tubular shape with conical narrowing to low diameter on forward end thereof;
a tubular case mounted on forward end of said consoling base and has outside diameter correspondent to said conical narrowing of consoling base;
a forward flange mounted on forward end of said tubular case and has outside diameter equal to outside diameter of said tubular case, the forward flange has symmetrical shape, looking from lateral direction, with two equal slopes on angle about 40 degrees from pitch plan symmetry thereof, having a entry channel on center of each said slope with continuation to respective output socket on mounting flange thereof;
two pressure output tubes, which mounted inside of said consoling base and provide upward and downward pressures to consumer; and
a system of pressure conduction, which conducts pressures from said output sockets of said forward flange to respective pressure output tubes.

76. A SDT set forth in claim 75 wherein said tubular case has transverse support upon inserting in correspondent hole in said conical narrowing of consoling base, and said system of pressure conduction and mechanical connectivity have features and elements comprising:
a collector has round flanged shape and mounted inside of said consoling base in rearward vicinity of said conical narrowing thereof, the collector has two said pressure output tubes brazed inside two respective holes thereof, and the collector has two other holes for fixing thereto other elements of said SDT;
a backward flange mounted inside of said consoling base in middle vicinity of said conical narrowing thereof, between said collector and said tubular case, inserting in said tubular case by a thin own centered area, the backward flange has two holes, which forward sides have entry sockets, and which backward sides have respective connectivity to said holes of collector for pressure output tubes, providing transition of pressure from short base between said entry sockets to increased base between said pressure output tubes, and also has two other holes, which coincide with said respective fixation holes of collector;
a centered area created on said forward flange, which inserted in forward end of said tubular case, providing transverse support for said forward flange;
two threaded holes exists on said centered area of said forward flange, correspondent to said two respective fixation holes of collector;
two tubes for upward pressure and backward pressure inserted in said respective output and entry sockets between said forward flange and said backward flange; and
two long bolts inserted from backward of said collector to said respective fixation holes in collector and backward flange, these bolts screwed in said respective threaded holes in forward flange, providing fixation for said forward flange, said tubular case, said backward flange and said two tubes for pressures.

77. A SDT set forth in claim 76 wherein said two bolts and said respective holes placed in vertical position, said output sockets of forward flange and said entry sockets of backward flange placed in horizontal position, each said of two tubes for pressures broken in two parts with a gap between them in middle, and a anti-icing and moisture eliminating system with features and elements included, comprising:
a moisture collector placed in said gap between said forward and backward pairs of pressure tubes, which entered in corresponding entry sockets thereof, the moisture collector has generally cylindrical shape with diameter equal to inner diameter of said tubular case with two mounting holes for said long bolts, and has two internal cavities in middle thereof symmetrically equal in lateral relation, which are opened to bottom and lateral directions, having separation by thick wall with said bottom mounting hole inside and by thin wall on bottom thereof, where moisture collected, and said cavities are connected by respective holes to said both sides entry sockets of said moisture collector;
a sealing lid has shape of segment of a tube, complementing perimeter of middle section of said moisture collector to completed circle, and seals said both cavities of said moisture collector by using a sealant, having a interface with said thin wall on bottom thereof, in which vicinity created two drain holes for said both respective cavities with symmetric placement;
two drain holes created on bottom of said tubular case, aligned in placement thereof with said two drain holes of sealing lid; and
two electrical heaters placed inside of said tubular case from each side of said moisture collector, having said forward and backward pressure tubes and said long bolts wrapped by tubular bodies thereof, these two heaters complemented with two electrical wires exited from said collector and have desired electrical connectivity between them and said two electrical wires by using correspondent holes created in said moisture collector, said backward flange and said collector for isolated electrical wires.

78. A SDT set forth in claim 77 wherein pressure connectivity in said forward flange and said backward flange have features and elements comprising:
two horizontal channels of forward flange, going from said respective output sockets inside of body of said forward flange on about middle of thickness of the body;
two diverting channels of forward flange drilled from cylindrical surface of said forward flange to interior thereof, laying in cross-section plan thereof and connecting said horizontal channels with respective entry channels, having inclination to horizontal plan about 45 degrees;
two seals of diverting channels seal outer-ends of said respective diverting channels from environment, repairing original cylindrical shape of said forward flange; and
two diverting channels of backward flange created on back side of said backward flange, have 90-degrees sectors for restore to original up-down position exit sites of pressure, providing vertical alignment for said two pressure output tubes with friendly direct geometrical relation between said two entry channels of forward flange and said two pressure output tubes.

79. A system of methods of operating and handling an aircraft, having two sets of wings placed apart of fuselage of said aircraft and involved in collective movement along a fixed loop relative to center plan of said aircraft with common and changeable winding speed of said wings along said loop with variable pitch steering of said wings for different phases along said loop, and where, for ground based reference frame, magnitude of variations of said pitch steering isn't exceed 90 degrees, but collective steered pitch of said all wings can have any arbitrary value in range from −180 degrees to 180 degrees, and where said aircraft accommodated by respective means for normal operations, keeping controlled pitch, with value of overall driving force, used for said collective movement of said wings, laid in range between 15 and 85 percents of entire weight of said aircraft generally, the system comprises methods of:
on runway acceleration, comprising steps of:
set distribution of pitches of said wings along said loop, having high angle of attack relative to sum of said winding speed, anticipated ground speed and anticipated inflow, related to anticipated thrust about 40 percents of entire weight of said aircraft, for phase of forward wings, at least moderate negative angle of attack for phase of backward wings, and intermediate pitches between these phase points;
establish high positive winding speed, where positive direction defined as having upper wings going to forward, and keep said distribution of pitches in accordance with changed ground speed, having acceleration about 0.3 g with desired margin; and
progressively decrease said positive winding speed upon increasing ground speed with correspondent change of said distribution of pitches with progressively increasing vertical component of thrust, having high acceleration and having consumed power near to maximal value designed for said aircraft;
flight handling, comprising steps of:
establish said fuselage in direction of flight path of said aircraft or with some other controlled angle in vicinity of ground case, and continue retain the state of said fuselage against changing pitch moment of said aircraft induced by said variable driving force, using said respective means;
set distribution of pitches of said wings along said loop generally in accordance with “flying elevator” conception and forward dominating wings i.e., having angles of attack inducing high load on loop's segment tied to wings with high vertical moving component and placed more forward, and correspondingly having angles of attack inducing low load on loop's segment tied to wings with high vertical moving component and placed more backward;
adjust distribution of pitches of said wings to desired horizontal acceleration of said aircraft induced by sum of gravitic propulsions of said all wings, gliding relative of respective local airstreams; and
adjust value and direction of said winding speed for having desired vertical movement of said aircraft, keeping said distribution of pitches of said wings for desired state of acceleration of said aircraft;
differentially adjust distribution of pitches of said wings between said two sets to control roll and yaw of said aircraft;
on runway deceleration, comprising steps of:
progressively increase collective pitch of all wings, keeping vertical component of thrust below entire weight of said aircraft, providing deceleration about 0.4 g with desired margin; and
maintain positive winding speed for having maximized deceleration after crossing of collective pitch of all wings value of 90 degrees and significantly dropped speed of said aircraft.

80. A system of methods as recited in claim 79 wherein said respective means for accommodating said aircraft to said variable driving force included two stabilators placed apart on aft of said fuselage of said aircraft, which used for compensation increasing from equilibrium pitch moment by increasing pitch thereon, and they used for compensation decreasing from equilibrium pitch moment by decreasing pitch thereon.

81. A system of methods as recited in claim 79 wherein said respective means for accommodating said aircraft to said variable driving force included means for moving parts of content of said fuselage, providing desired offset of center gravity of said aircraft, which used for compensation increasing from equilibrium pitch moment by shifting center gravity forward, and they used for compensation decreasing from equilibrium pitch moment by shifting center gravity backward.

82. A system of methods as recited in claim 79 wherein said loop has circular form by using two rotors with managed PGS-state and construed in accordance with four gears pitch steering scheme, and said variable ratio of driving force mapped to external moment ratio (EMR) with same range, and wherein common handling of said rotors for said on runway acceleration method comprises steps of:
set high negative gain about −65 degrees;
set pitch and skew almost same and some below zero and stay use skew control for control pitch; and
progressively decrease magnitude of said negative gain upon increasing ground speed and decreasing said winding speed, and do it with simultaneously and progressively approaching said small negative values of skew and pitch toward zero for increasing vertical component of thrust;
and also wherein common handling of said rotors for said on runway deceleration method comprises steps of:
permit for rotors enter in deceleration of rotation thereof, but without dropping said winding speed below level about one third of specific stagnation speed of said aircraft, where said specific stagnation speed defined as speed, which stagnation on pitot-tube creates pressure equal to specific load of said wings of said rotors;
drop magnitude of high negative gain to moderate value about −40 degrees;
set skew equal to current value of pitch and stay use skew control for control pitch with common value;
progressively increase skew and pitch up to value 90 degrees; and
increase skew and pitch up to value about 120 degrees for maximize remained deceleration after significant dropping of ground speed.

83. A system of methods as recited in claim 82 wherein said aircraft has a pitch-based biangular handling (P-mode) for said rotors of said aircraft, and wherein said P-mode biangular handling related to respective PGS-state by rules comprising:
handling skew in the handling mode is transparent to normal skew handling;
the handling consists from handling two formal pitch values placed apart on line of skew direction and belonged to idealized PGS-control, which has linear distribution of pitches between points laid on skew direction, and where value related to direction on skew referenced as main and other as opposite;
actual PGS-state mapped from set of selected skew and two biangular values by refactoring PGS-state for a pair of match-points, where the each match-point is some known value of entire pitch distribution exists in some known angular position in phase space;
the known angular positions of said match-points are simple two opposite directions on said line of skew shifted on some known phase shift;
the known values of said match-points are simple linear interpolations between said biangular values for respective known angular positions; and
the value of said known phase shift is product of some fixed empirical value and square root of normalized magnitude of gain with sign inverted to sign of gain, where maximal constructive limited value of gain used for said normalization.

84. A system of methods as recited in claim 83 wherein said fixed empirical value for said phase shift is about 24 degrees.

85. A system of methods as recited in claim 83 wherein said aircraft has an angle-of-attack-based biangular handling (A-mode) for said rotors of said aircraft, which used with conjunction with establishing of said fuselage in direction of flight path of said aircraft with some remained error, and wherein said angle of attack referenced as alpha, and said A-mode biangular handling related to respective PGS-state by rules comprising:
an error angle value considered and calculated as difference between orientation of said fuselage and direction of true airspeed (TAS) vector;
PGS-skew value equal to handling skew value minus said error angle value;
the handling consists from handling two formal alpha values placed apart on line of skew direction and belonged to idealized distribution of alphas, which has linear distribution of alphas between points laid on PGS-skew direction, and where value related to direction on skew referenced as main and other as opposite;
actual PGS-state mapped from set of corrected skew and two biangular values by refactoring PGS-state for a pair of match-points, where the each match-point is some known value of entire pitch distribution exists in some known angular position in phase space;
the known angular positions of said match-points calculated exactly by same rules as for said match-points of said P-mode of biangular handling; and
the known value of said each match-point is sum of related alpha from function of said linear distribution for known angular position of the match-point, with direction of TAS of a wing in the known angular position, where the TAS calculated as vectorial sum of tangential rotational component of the wing and TAS speed-vector of said entire aircraft, mapped to reference frame of said fuselage.

86. A system of methods as recited in claim 85 wherein common handling of said rotors for said flight handling method comprises steps of:
enable said A-mode of biangular handling;
ensure said main value of biangular handling higher then said opposite value of biangular handling;
set skew value near to zero;
adjust said main value of biangular handling to desired airspeed and horizontal acceleration, upon particular vertical speed;
adjust said opposite value of biangular handling to desired airspeed, performance and EMR;
adjust skew value for optimize performance, said EMR and flight path angle of said aircraft.

87. A system of methods as recited in claim 86 wherein differential handling of said rotors for said flight handling method for case of entering in turn upon A-mode of biangular handling has three categories including and comprising:
for ascending flight and cruise: set a positive difference of out-turn relative in-turn main values of biangular handling of respective rotors, and set about half of it negative difference of out-turn relative in-turn opposite values of biangular handling of respective rotors;
for gliding with optimal speed: set a positive difference of out-turn relative in-turn main values of biangular handling of respective rotors; and
for descending flight: set a negative difference of out-turn relative in-turn main values of biangular handling of respective rotors, and set about same positive difference of out-turn relative in-turn opposite values of biangular handling of respective rotors, where the last value should be decreased in two times upon approaching to very high common main value of biangular handling.

88. A system of methods as recited in claim 86 wherein said flight handling method for case of high powering recuperative descent with high speed comprises steps of:
set skew about −5 degrees for said both rotors;
progressively increase common main value of biangular handling to about 10 degrees higher then zero-lift alpha for airfoil used on said wings of rotors;
progressively decrease common opposite value of biangular handling to about 3 degrees higher then said zero-lift alpha upon said increasing of common main value; and
progressively and simultaneously with said changing of biangular values change said winding speed to high negative value about −40 percents of said specific stagnation speed, having recuperating power about two thirds from maximal consuming power and flight-path angle about −13 degrees in final state.

89. A system of methods as recited in claim 86 wherein said flight handling method for case of middle powering recuperative deceleration in descent with middle speed comprises steps of:
set skew about −15 degrees for said both rotors;
progressively increase common main value of biangular handling to about 14 degrees higher then zero-lift alpha for airfoil used on said wings of rotors;
progressively decrease common opposite value of biangular handling to about 6 degrees higher then said zero-lift alpha upon said increasing of common main value; and
progressively and simultaneously with said changing of biangular values change said winding speed to high negative value about −25 percents of said specific stagnation speed, having recuperating power about 40 percents from maximal consuming power, horizontal deceleration about 0.1 g and flight path angle about −6 degrees in final state.

90. A computer memory based method for modeling flight an aircraft, having two sets of wings, belonged to two respective actuators placed apart of fuselage of said aircraft and involved in collective movement along a fixed loop relative to center plan of said aircraft with common and changeable winding speed of said wings along said loop with variable pitch steering of said wings for different phases along said loop, and where said actuators can be locked against moving said wings along said loop, and also said actuators considered by the method as one actuator with a common state, the method composed from operational tiers, memory state and processing, executed as sequence of cycles with some time-step on background of arbitrary handling and supervising, performing modification of said memory state for reflect actual modeling the flight in order of sequential rules of the method, doing calls to said tiers by demand of these rules, wherein said tiers used for modeling particular aspects of relation of said aircraft to flight for respective particular conditions comprising:
a tier of medium aspect, which used for modeling a medium enveloped said aircraft, particularly air and gravity acceleration, dependently from flying altitude;
a tier of wings placement aspect, which used for modeling distribution of position, speed directions and pitches for particular wings on said actuator, having relative reference frame placed in common origin of said actuators in center plan of said aircraft and oriented along ground and along said fuselage for said pitches only, the tier depends from said phase, from particular steering state of said actuators and from direction of said winding speed, where positive direction defined as having upper wings going to forward;
a tier of airfoil aspect, which provides access to respective datum of section coefficients and aggregations for broad range of Reynolds numbers and full 360 degrees range of angles of attack of airfoil used in said wings;
a tier of inflow aspect, which used for modeling end use inflow, dependently from thrust vector, overall true airspeed (TAS) vector, air density and outdated local airspeed (LAS) vector;
a tier of wings interference aspect, which used for modeling state of airspeeds for said all wings induced by vorticity distribution between said wings, dependently from provided state of cinematic viscosity, base flow LAS vectors, absolute pitches and origin referenced position of said wings, the tier provides end use state of LAS vectors;
a tier of a ground interaction aspect, which used for modeling a force induced from a undercarriage of said fuselage, dependently from position and speed of excursion of the undercarriage;
and wherein said sequential rules grouped in set of updates and queries, for friendly management and referencing over said rules, comprising:
a query altitude conditions for air density, cinematic viscosity and magnitude of gravity acceleration for aircraft position from said medium aspect tier;
an update predicted state comprising steps of:
updating predicted speed, location and winding speed of aircraft performed by numerical integration of respective current values on half of time-step, using an acceleration vector, the predicted speed vector and a winding acceleration of aircraft as respective derivatives; and
updating predicted speed and location of each wing performed by numerical integration of respective current values on half of time-step, using an acceleration vector and the predicted speed vector of the wing as respective derivatives;
an update airflow state comprising steps of:
updating magnitude of airspeed of aircraft from magnitude of respective predicted speed vector;
updating angle of attack of each wing as difference between pitch and LAS vector, where pitch provided from said tier of wings placement aspect with additional correction on a fuselage pitch angle, and LAS vector calculated as correction said current speed vector of the wing on an inflow vector;
simulating interference performs call to said tier of a wings interference aspect with providing all required information for it, restoring said absolute pitches from respective angles of attack; and
updating airflow state of each wing from result of interference simulation, including angle of attack, airspeed magnitude, Reynolds number, coefficients of lift, drag and moment and steering variation of angle of attack by steering stream by interference and inflow;
an update winding state comprising steps of:
checking locked state as a locking flag, and for case if it set and a target winding speed isn't zero, going out from said updating winding state, and in other case resetting the locking flag and continue;
checking of predefined lockspeed threshold, and for case if an actual winding speed value below the threshold, setting said locking flag, setting a directed powering force to zero and going out from said updating winding state, and in other case continue;
obtaining a needed delta acceleration dependently from difference between said target winding speed and said actual winding speed and value of said winding acceleration, and with applying limitation based on reciprocated footprint of mass of all wings in total mass of aircraft; and
updating power force, by setting said directed powering force value to sum of an directed internal force with difference based on said calculated delta acceleration and mass of all wings, with applying a predefined maximal magnitude of the force for slipping over crossing thereof;
an update dynamic state comprising steps of:
updating fuselage drag force by building an aerodynamic force vector oriented against said predicted speed vector with magnitude based on a front area and a wet area of said fuselage, said magnitude of airspeed and said air density;
updating damper force, by building the damper force vector oriented generally in upper direction and with magnitude based on excursion of undercarriage under load of said aircraft and on predicted vertical speed of said aircraft, and obtained upon passing said two parameters to said tier of a ground interaction aspect;
updating gravity and total forces by building the gravity force vector with magnitude based on a glide mass of aircraft and said magnitude of gravity acceleration, and by building the preliminary total force vector from said vectors of aerodynamic, damper and gravity forces;
preparing intermediate accumulators for forces and moments, by assigning and resetting variables for accumulations aerodynamic forces, non-conservative forces, along-loop directed aerodynamic forces, external moments and internal moments from particular wings;
entering in walkthrough on all wings;
updating forces and pitch moment of current wing by building an aerodynamic force vector with drag footprint aligned in LAS direction based on predicted TAS angle and said steering variation of angle of attack, and with values of drag and lift derived from said respective coefficients, airspeed magnitude and wing's area, by calculating the pitch moment from said respective coefficient of moment, airspeed magnitude, wing's area and wing's chord, by building a gravity force vector from values of a glide mass of wing and said magnitude of gravity acceleration, and by building a total force vector from said vectors of aerodynamic and gravity forces;
accumulating forces and moments of current wing by accumulating said aerodynamic force vector, by querying speed direction and position of current wing from said tier of wings placement aspect, by accumulating loop directed force obtained as scalar projection of said aerodynamic force vector on the speed direction, by accumulating external moment obtained as cross-product of the wing's position with said total force vector, by accumulating said pitch moment on said internal moment accumulator, by rebuilding drag-only version of said aerodynamic force vector, and by accumulating the drag-only vector on said non-conservative forces accumulator;
exiting from said walkthrough on all wings;
totalizing forces by accumulating said preliminary aerodynamic force of aircraft to said non-conservative forces accumulator, and by accumulating said aerodynamic forces accumulator to said aerodynamic force vector and to said total force vector of aircraft;
updating thrust reporting by calculating a LAS vector from sum of said predicted airspeed vector and said inflow vector, by refactoring consumed thrust force from said loop directed forces accumulator, said actual winding speed and magnitude of the LAS vector, by normalizing the consumed thrust force on magnitude of said gravity force with obtaining a consumed thrust ratio (CTR) value, by calculating a true thrust force from said aerodynamic force vector upon subtracting vector in said non-conservative forces accumulator, by normalizing magnitude of the true thrust force on magnitude of said gravity force with obtaining a true thrust ratio (TR) value, and by obtaining a thrust angle (TA) as angle of said true thrust force;
updating directed internal force in case of set said locking flag by assigning inverted value of said loop directed aerodynamic forces accumulator to said directed internal force, and in other case the last acquired value of said directed powering force;
calculating components of total force per each wing by calculating a translation component as mass-proportional part of said entire total force vector, and by calculating an along-loop component as member-proportional part of sum of value of said loop directed aerodynamic forces accumulator with said directed internal force;
updating inflow by calling said tier of inflow aspect with passing thereto said air density value, said predicted speed vector, said LAS vector and said true thrust force vector;
entering in walkthrough on all wings;
correcting states for impact of current wing by querying speed direction and position of current wing from said tier of wings placement aspect, by calculating said total force of the wing as superposition of said translation component and projection of said along-loop component on said wing's speed direction, and by discarding cross-product of said wing's position with said total force from said external moments accumulator;
exiting from said walkthrough on all wings; and
totalizing moments by storing sum of values of said external moments accumulator and said internal moments accumulator as pitch moment of aircraft, and by storing said value of said internal moments accumulator as internal pitch moment of aircraft;
an update cinematic state comprising steps of:
updating states of a previous location and a previous kinetic energy from respective values of said current location and a kinetic energy of current state;
updating acceleration, location and speed by calculating said acceleration vector from ratio of value of said total force vector to value of said gliding mass, and by time-step integration of said location and current speed vectors over base cinematic equations;
calculating kinetic energy for fuselage by using said updated current speed and mass of fuselage;
entering in walkthrough on all wings;
updating previous location of current wing from said current location;
updating acceleration, location and speed of current wing by calculating acceleration vector from ratio of value of said total force vector to value of said gliding mass of wing, and by time-step integration of said location and current speed vectors over base cinematic equations;
calculating kinetic energy of current wing by using said updated current speed and said gliding mass;
exiting from said walkthrough on all wings; and
updating time of said processing by incrementing it on time-step;
an update power state comprising steps of:
checking locked state of said locking flag, and for case if it set ensuring locking is finalized by resetting values of said actual winding speed, said winding acceleration and a consumed power value with going out from said updating power state, and in other case continue;
calculating a power speed by building localized vector of changing position of any one wing upon subtracting localized previous position from localized current position, by querying speed direction of the wing from said tier of wings placement aspect, and by dividing projection of said localized vector on said speed direction on time-step;
updating winding acceleration, winding speed and consumed power by assigning to said winding acceleration result from dividing changing of said actual winding speed on time-step, by assigning said power speed to said actual winding speed, and by setting said consumed power to product of said directed powering force and said actual winding speed; and
updating gliding mass of aircraft, related to rate of consuming fuel, if it applicable;
an update actuator's phase comprising steps of:
updating phase and checking its range by addition to current phase a ratio of product of said actual winding speed with time-step to length of said loop, and by normalizing this result in case of over-ranging; and
doing hard sync for each wing by querying speed direction and position of the wing from said tier of wings placement aspect, by setting to said current location superposition of said wing's position and current location of entire aircraft, by setting to said current speed vector superposition of said wing's speed direction scaled on said actual winding speed and current speed vector of entire aircraft, and by setting to said acceleration vector superposition of said wing's speed direction scaled on said winding acceleration and acceleration vector of entire aircraft;
and an update report state comprising steps of:
calculating cruise power by calculating a gravitic power, using change of vertical component of said current location relative to same of previous location, by calculating a kinetic power, using change of said kinetic energy from said previous kinetic energy, by calculating an acceleration power, using change square of said current speed from square of said previous speed, by calculating an internal kinetic power as difference between said kinetic power and the acceleration power, by calculating an external consumer power as difference between said consumer power and said internal kinetic power, and by obtaining the cruise power as losses remained after subtraction said gravitic power and said acceleration power from said external consumed power;
updating cruise ratio by dividing said consumed power on said cruise power;
updating equivalent lift to drag ratio (LDR) and lift coefficient (CL) by calculating an average speed vector between said current speed vector and a previous speed vector, by calculating an equivalent drag as ratio of said cruise power to magnitude of the average speed, by calculating an equivalent lift as scalar projection of said aerodynamic force to direction orthogonal to said average speed, by obtaining the equivalent LDR as ratio of the equivalent lift and said equivalent drag, by calculating a stagnation pressure based on said average speed and said air density, and by obtaining the CL as ratio of said equivalent lift to product of the stagnation pressure and total area of wings;
updating previous speed vector from current speed vector;
updating winding ratio (WR), normalized acceleration and flight path angle (FPA) by calculating a LAS vector from said current speed vector and said inflow vector, by obtaining the WR as ratio of said actual winding speed to magnitude of the LAS, by obtaining the normalized acceleration vector from said acceleration vector and said gravity acceleration, and by obtaining the FPA as angle of said current speed vector; and
updating propulsion efficiency (PrE), power lifting speed (PLS) and true gliding lift to drag ratio (TGLDR) by calculating a propulsion inflow as scalar projection of said inflow vector on direction of said current speed vector, by obtaining the PrE as ratio of magnitude of said current speed vector and its sum with the propulsion inflow, by obtaining the PLS as ratio of said external consumed power, scaled on the PrE, to magnitude of said aerodynamic force, and by obtaining the TGLDR as ratio of said LDR to said PrE.

91. A method as recited in claim 90 wherein said update report state of said sequential rules further includes an obtaining of local glide angle of embedded virtual glider (LGA) comprising steps of:
preparing calculation of said LGA by obtaining a common direction of inertial vertical of said entire aircraft as normalized vector in inverted direction of said aerodynamic force, and by initializing an accumulating vector of LGA direction to zero value;
entering in walkthrough for all wings;
obtaining LAS vector of current wing by rotating said predicted speed vector of the wing to its said steering variation of angle of attack;
obtaining LAS direction vector of current wing as normalized vector of said LAS vector of the wing;
obtaining a weighting value for said LAS direction as inverted dot-product of said common direction on said aerodynamic force vector of current wing;
accumulating said LAS direction vector scaled on said weighting value to said accumulating vector of LGA direction;
exiting from said walkthrough for all wings; and
updating a LGA value as angle of said accumulating vector of LGA direction.

92. A method as recited in claim 90 wherein said tier of wings interference aspect uses set of general rules for modeling said interference upon entire processing thereof comprising:
said processing uses only one said actuator for considerations;
said processing has generally sequence of equal main cycles with number for said N wings on said actuator about 2N;
said processing considers cross-section of each wing of said actuator being split on M segments along chord of airfoil thereof, having known area and center for each said segment of said cross-section, where said center calculated as center of gravity of the segment;
said processing builds on said each main cycle a draft distribution of LAS vectors over said wings, by merging a draft distribution of modeled induced speed vectors with known base distribution of LAS vectors;
said processing sequentially accesses in each said main cycle each destination wing for calculate its own induced speed vector upon a destination cycle;
said processing sequentially accesses in said destination cycle each said segment of said wing for calculate its own induced speed vector upon a segment cycle;
said processing sequentially accesses in said segment cycle each other wing for calculating and accumulating a partial induced speed vector from the source wing upon a source cycle;
said processing considers for calculation said partial induced speed vector a vorticity source placed in some center of vorticity (CV) as approximation entire vorticity distribution around said source wing, dependently from angle of attack of said wing;
said processing considers for calculation said partial induced speed vector a vorticity destination placed on said center of segment;
said processing calculates said partial induced speed vector basically in accordance with Biot-Savart law, having signed magnitude equal to scalar projection of a circulation to direction of a z-axis, divided on length of circle with radius equal to length of radius-vector between said vorticity source to said vorticity destination and directed along cross-product of normalized vector on the z-axis and normalized vector on said radius-vector, having the z-axis oriented along any wing from said fuselage to outward, and having the circulation calculated in accordance with Joukowski theorem as cross-product of aerodynamic force vector of source wing on normalized vector of direction LAS of the wing and divided on air density, length of the wing and magnitude of the LAS;
said processing additionally corrects said partial induced speed vector by scaling on a 3-d factor coefficient, which calculated by subtracting from square root of sum one with square of a 3-d aspect coefficient at the 3-d aspect coefficient, where the 3-d aspect coefficient is ratio of said length of radius-vector between said vorticity source to said vorticity destination to length of wings;
said processing calculates said wing own induced speed vector upon a consolidation algorithm, which is a weighted average over all segments of the wing, having weighting coefficient equal to ratio of said area of current segment on sum of chord length with distance from said center of current segment to some focusing point on said airfoil or on vicinity thereof;
said processing uses center of aerodynamic force (CF) as said focusing point, dependently from angle of attack and Reynolds number of said wing, in form of pair of coordinates (CFx and CFy) relative leading edge of said airfoil;
said processing calculates for each main cycle respective angles of attack and Reynolds numbers for each wing and queries said tier of airfoil aspect for getting respective coefficients of lift and drag and said CFx and CFy as aggregations; and
said processing uses known pivot position of wings relative leading edge of said airfoil, pitches of respective wings and their positions as pivot coordinates for doing all desired transformation of position for all geometrical features used for said modeling.

93. A method as recited in claim 92 wherein said center of vorticity (CV) approximated by a empirical sequential rules comprising:
scale geometry of said airfoil for having chord length equal to one, if the length differed from one;
for given angle of attack (AoA) obtain magnitude of said angle of attack |AoA|;
assign a main angle of attack AoA′ with value of said AoA for case if the |AoA| isn't higher than 90°, and in other case assign the AoA′ to value of 180°−|AoA|;
calculate main x-component of said CV relative leading edge of said airfoil along its chord CVx′ as half of (1-sin(|AoA|)) in power 0.07;
assign x-component of said CV relative leading edge of said airfoil along its chord CVx equal to said CVx′ for case if the |AoA| isn't higher than 90°, and in other case assign the CVx to value of 1-CVx′;
calculate y-component of said CV relative to chord of said airfoil in upper direction CVy as camber-line of said airfoil for said particular CVx; and
rescale CVx and CVy back to original scaling of said airfoil geometry, if it applicable.

94. A method as recited in claim 92 wherein said tier of wings interference aspect uses a particularly dimensionless scaling for simplify and speed up entire processing of said tier with definition rules comprising:
use said LAS vector in original form;
use a scaled chord length of said airfoil c′ equal to one instead original chord c;
use any geometrical one-dimension feature of entire process divided on length of original chord instead the original feature;
use any geometrical two-dimension feature of entire process divided on square of length of original chord instead the original feature;
use a scaled aerodynamic force vector AF′ instead said original aerodynamic force vector AF and defined as vector build on respective lift and drag coefficients in accordance to original transform relative to direction of said LAS of wing, and multiplied on half of square of said LAS; and
use a scaled circulation value instead said original circulation value and defined as cross-product of said scaled aerodynamic force vector AF′ with normalized vector along direction of the LAS, divided on magnitude of said LAS, using two-dimensional scalar version of said cross-product.

95. A method as recited in claim 94 wherein said entire processing of tier of wings interference aspect comprises from steps of:
enter in basic initialization;
acquire actual chord length of wings;
acquire said pivot position on said airfoil of wings scaled in said chord length;
acquire actual length of wings and scale it in said chord length;
do split said airfoil on said M segments and calculate area of each segment AS and center of each segment CSm as center of gravity;
acquire actual number of said wings N and establish storage of per wing states;
exit from said basic initialization;
receive call for demand of simulation and acquire cinematic viscosity, distribution of pivot positions, pitches and base LAS vectors over said wings;
normalize distribution of pivot position by scaling each position in said chord length;
calculate actual positions of centers of segments CSim per each wing dependently from respective position and pitch of the wing;
initialize resulted distribution of said LAS vectors by respective values of said base LAS vectors distribution;
enter in said main cycle of said processing, resetting a counter of main cycles;
enter in walkthrough over all wings;
calculate LAS magnitude and Reynolds number of current wing, using said cinematic viscosity and said actual chord length;
calculate angle of attack of current wing by subtracting respective LAS direction from pitch of the wing;
query said tier of airfoil aspect for respective coefficients and aggregations for current wing, passing to the tier said angle of attack and Reynolds number;
calculate said scaled aerodynamic force vector for current wing, using related lift and drag coefficients and said LAS vector;
calculate said scaled circulation value for current wing, using said scaled aerodynamic force vector and said LAS vector;
calculate said center of vorticity of current wing in airfoil's reference frame, using said angle of attack of the wing;
calculate said actual position of said center of force of current wing by reposition center force coordinates from said obtained aggregations, using actual pivot position and pitch of the wing and said pivot position on said airfoil;
calculate said actual position of said center of vorticity of current wing by reposition said center of vorticity of current wing in airfoil's reference frame, using actual pivot position and pitch of the wing and said pivot position on said airfoil;
exit from said walkthrough over all wings;
update said counter of main cycles and exit from said processing for case of reaching desired number of said main cycles, in other case continue;
enter in walkthrough over all destination wings;
enter in walkthrough over all segments of current destination wing;
reset value of induced speed vector of current segment of current destination wing;
enter in walkthrough over all source wings, excluding current destination wing;
calculate said radius-vector from said center of vorticity of current source wing to said center of current segment of current destination wing;
calculate direction of said partial induced speed vector from direction of said radius-vector;
calculate said 3-d aspect using magnitude of said radius-vector and said scaled length of wings;
calculate said 3-d factor, using said 3-d aspect;
calculate said signed magnitude of said partial induced speed vector, using said scaled circulation value of current source wing and magnitude of said radius-vector;
build said partial induced speed vector, using said signed magnitude, said 3-d factor and said direction thereof;
accumulate said partial induced speed vector on said induced speed vector of current segment of current destination wing;
exit from said walkthrough over source wings;
exit from said walkthrough over all segments of current destination wing;
calculate respective array of weighting coefficients for all segments of current destination wing, using respective distances of said centers of segments from said center of force of current destination wing and said respective areas of segments;
calculate consolidated induced speed vector of current destination wing from induced speed vectors of all segments of the wing, using said array of weighting coefficients;
accumulate said consolidated induced speed vector on said resulted LAS vector of current destination wing;
exit from said walkthrough over all destination wings; and
enter in next main cycle of said processing.

96. A method as recited in claim 90 wherein said loop has circular form by using two rotors with radius R from center axis of each said rotor to pivot axis of any wing thereof as said respective actuators, and wherein said tier of inflow aspect uses set of general rules for modeling said inflow upon entire processing thereof comprising:
said processing considers said inflow vector in result thereof oriented in opposite direction to said known true thrust;
said processing considers magnitude of said true thrust on other side equal to product of duplicated air density, a thrust specific area (TSA) of said aircraft, a magnitude of LAS vector and magnitude of said inflow vector, where said LAS vector should be equal to sum of said TAS vector and said inflow vector, implying a non-linear equation for resolving;
said processing uses Newton method (tangent method) for resolving said non-linear equation under low number of iterations;
said processing considers said TSA depends from a downwash specific area (DSA), propulsion specific area (PSA) and a thrust specific angle 13 between said true thrust vector and said LAS vector by a quadrature formulae implying said TSA equal to square root from sum o squares of DSA*sin(β) and PSA*cos(β);
said processing considers said DSA generally equal to area of circle with diameter based on total wingspan of said aircraft;
said processing considers said PSA generally equal to 4*L*R, where L is a common length of any wing of any said rotor; and
said processing uses said outdated known LAS vector for calculate said thrust specific angle β.

97. A method as recited in claim 96 wherein each of said two rotors construed in accordance with four gears pitch steering scheme, having a central gear with omni-directional controlled offset from center of rotor, a one pitch gear per each said wing synchronized with the wing by angular position, and a one cluster per each said pitch gear, having a steering pinion meshed with said pitch gear and a entry gear meshed with said central gear, and wherein said tier of wings placement aspect uses managed PGS-state as said particular steering state, and uses set of general rules, for modeling distribution of pitches of particular wings upon entire processing thereof, comprising:
said processing considers axes of said pitch gears placed on a common circle around central axis of said rotor with radius R0;
said processing considers said pitch gear has radius r1, said center gear has radius r2, said entry gear has radius r3 and said steering pinion has radius r4;
said processing considers gear ratio of r1 to r4 equal to ratio of r2 to r3 and equal some constant K;
said processing considers a triangle build on axis of said pitch gear, axis of said central gear and axis of said cluster has two short sides with lengths r14=r1+r4 and r23=r2+r3 from sides of pitch gear and center gear respectively;
said processing considers a constant S1 equal to duplicated product of r14 and r23;
said processing considers a constant S2 equal to sum of squares of r14 and r23;
said processing considers, by using cosine theorem, a constant angle ω0 equal to arccosine of ratio of difference of S2 and square of R0 to S1;
said processing considers distance between axis of said pitch gear and axis of said central gear as a variable r;
said processing considers, by using cosine theorem, a variable angle ω1 equal to arccosine of ratio of difference of S2 and square of r to S1;
said processing considers a variable ω=ω1−ω0;
said processing considers a pitch deviation of said particular wing to which belongs said particular pitch gear, having particular r, as variable δ=−ω*(1+1/K);
said processing considers angular direction from center of said rotor toward any particular wing is equal to same kind direction toward respective pitch gear of said wing, if other not specified;
said processing considers a direction of skew reflects skew-angle specified by S-component of said PGS-state in counter positive direction of said winding speed, beginning from forward-most position relative said fuselage;
said processing considers value of said r in said direction of skew has extremity with value r′;
said processing considers a variable Δr equal to R0-r′ for case of normal assembling of said four gears pitch steering scheme, and considers equal to r′-R0 for other case of inverted assembling, where inverted assembling defined as having said cluster in upper elongation, relative said pitch gear for zero-value direction of skew;
said processing considers a maximal magnitude of said Δr as a constant Δrmax;
said processing considers a difference between said pitch deviation in direction of skew and opposite direction as G-component or gain of said managed PGS-state and can pass it back by demand of this tier callers;
said processing considers an angular position of particular wing in counter positive direction of said winding speed, beginning from forward-most position relative said fuselage;
said processing considers a ratio of said Δr to said Δrmax as a linear normalized gain Gn and accompanied with said managed PGS-state for direct changing said gain; and
said processing considers said pitch of particular wing is equal to said pitch deviation 6 summed with P-component of said managed PGS-state.

98. A method as recited in claim 97 wherein said entire processing of said tier of wings placement aspect for case of querying pitch for given angular position comprises from steps of:
calculate a relative angular position by subtracting said S-component of said managed PGS-state from said given angular position;
build a vector of position of axis of said center gear, using said Gn accompanied said managed PGS-state, said Δrmax and skew;
invert sign of said vector of position of axis of said center gear for case is said inverted assembling specified;
build a vector of position of axis of said pitch gear, using said constant R0 and said given angular position;
build a distance vector by subtraction said vector of position of axis of said center gear from said vector of position of axis of said pitch gear;
obtain a distance as magnitude of said distance vector;
calculate said ω1, using said distance and said constants of S1 and S2;
calculate said co, using said constant ω0;
calculate said pitch deviation, using said ω value and constant K;
invert sign of said pitch deviation for case is said inverted assembling specified; and
provide result as sum of said pitch deviation and said P-component of said managed PGS-state.

99. A method as recited in claim 96 wherein said updating speed and location of all wings step of update predicted state of sequential rules implements an advanced prediction updating comprising steps of:
calculating angular shift and centripetal acceleration by obtaining the angular shift upon dividing product of inverted half of time-step on said actual winding speed on said radius of rotor R, by obtaining a sign of centripetal acceleration as sign of said actual winding speed, and by obtaining magnitude of said centripetal acceleration as square said winding speed divided on said R;
entering in walkthrough of all wings;
obtaining current speed direction vector of current wing from said tier of wings placement aspect;
obtaining predicted speed direction vector of current wing by rotating said current speed direction vector on said angular shift;
obtaining current angular acceleration direction vector by rotating said current speed direction vector on product of 90 degrees with said sign of centripetal acceleration;
obtaining predicted angular acceleration direction vector by rotating said predicted speed direction vector on product of 90 degrees with said sign of centripetal acceleration;
obtaining predicted rotation impact acceleration vector by subtraction said current angular acceleration direction vector from said predicted angular acceleration direction vector with scaling on said magnitude of said centripetal acceleration;
updating a predicted acceleration vector of current wing by addition said predicted rotation impact acceleration vector to said acceleration vector of the wing;
updating said predicted speed vector of current wing by addition said predicted acceleration vector scaled on half of time-step to said current speed vector of the wing;
updating said predicted location vector of current wing by addition said predicted speed vector scaled on half of time-step to said current location vector of the wing;
exiting from said walkthrough of all wings.

100. A method as recited in claim 96 wherein said update dynamic state of said sequential rules further includes an updating on end thereof comprising steps of:
calculating a moment normalizing value by multiplying said gliding mass of said aircraft, said gravity acceleration and said radius of rotor R;
updating a moment ratio by dividing said pitch moment of aircraft on said moment normalizing value; and
updating an internal moment ratio by dividing said internal pitch moment of aircraft on said moment normalizing value.

101. A method as recited in claim 90 wherein said arbitrary handling provides for demand thereof a set of two handling angles of attack in two generally opposite and specified directions for reflect said kind of handling based on the set, namely biangular handling, in said modeling, and wherein a tier of handling interpretation included and provides mapping of said parameters of said biangular handling to particular steering state of said actuators, using said current speed vector of aircraft and said actual winding speed for match said two prescribed angles of attack upon call of said handling interpretation tier from a step placed on end of said update power state of sequential rules.

102. A system for cruise flight generally based on conception for performing powered flight of aircraft by performing work against gravity force, using gliding wing as steady support, namely “flying elevator” conception, comprising:
a fuselage, having generally streamlined elongated shape;
at least one laterally symmetrical wing or lightweight glider with control elements, having abilities for remote control of pitch, roll and yaw thereof in glide with payload hanged there under with generally width range of load force provided from said payload, the wing has mass generally on significant order less than said fuselage;
a wire per each said wing connected the wing with said fuselage, having a connection position to the wing on center chord thereof generally;
a wire winding system per each said wire, having the wire wound on a drum thereof and means for powering the drum for rotation with controlled winding speed in both directions, the wire winding system installed on said fuselage generally near of center gravity of said fuselage;
means for attitude control of said fuselage at least for pitch and yaw thereof for directing said fuselage in airstream direction, these means placed on said fuselage;
means for acquire remote control of each said wing installed on the wing in respective connectivity with said control elements;
means for remote control of each said wing from side of said fuselage, these means placed on said fuselage with respective connectivity with said means for acquire remote control of each said wing; and
a cruise control system with ability for manage at least said winding systems and said means for remote control of each said wing upon applying periodically and adaptive patterns of actuation said systems and means, generally in accordance with handling rules comprising:
any wing involved in winding-in movement relative to fuselage should have a pitch implying with true airspeed (TAS) vector thereof generally high load from side of wire thereof, if other handling rules don't override it;
any wing involved in winding-out movement relative to fuselage should have a pitch implying with TAS vector thereof generally low load from side of wire thereof, if other handling rules don't override it;
any winding system should switch direction of actuation thereof upon encountering respective limit of prescribed range of lengths of free wire outside of said respective drum, if other handling rules don't override it;
any winding system should provide force on respective wire below prescribed operation limit;
any winding system should prevent forceless state of respective wire by respective winding-in actuation;
any winding system should operate in prescribed range of lengths of free wire outside of said respective drum, if other handling rules don't override it;
any elongation of any said wing relative other said wing should reflect in a respective policy of proximity of said members of said elongation;
any elongation of any said wing relative fuselage should reflect in a respective policy of proximity of said members of said elongation;
any winding system shouldn't imply force of respective wire for accelerate or decelerate respective wing outside prescribed limits of TAS of the wing;
overall force from all said wings and gravity force shouldn't imply vertical and horizontal accelerations of said fuselage outside prescribed limits;
said system for cruise flight should have TAS magnitude of center gravity thereof between prescribed limits; and
said system for cruise flight should have TAS magnitude of center gravity near to desired handled value, if other handling rules don't override it.

103. A system as recited in claim 102 wherein each said wing handling upon variation position of connection point thereon for said respective wire, and wherein said control elements reflected in a center node of the wing, which used simultaneously for connect said wire, having elements comprising:
two longitudinal pathways fixed on said wing along central chord of the wing on some equal distance from the chord each, having some window between them;
a caret mounted between said two longitudinal pathways and can be moved on said pathways in longitudinal direction;
two transverse pathways placed on forward and rearward sides of said caret or comprising said sides thereof, having some window between them;
two movable supports mounted on said two transverse pathways respectively and can be moved on said pathways in transverse direction;
a common frame pivotally fixed on said two movable supports, having common pivot axis thereof oriented in longitudinal direction and constraining fixed distance between said two movable supports;
a central shaft mounted between two sides of said common frame in transverse direction, having axis thereof crossed with said common pivot axis of said common frame;
a link pivotally mounted on said central shaft by upper end thereof inside said common frame;
a C-shape earring pivotally mounted on bottom end of said link and connected with end of said respective wire of said wing;
a transverse screw goes through a respective threaded hole in said one of two movable supports along said respective transverse pathway;
a transverse servo rotationally connected to said transverse screw and placed on one side of said caret;
a longitudinal screw goes through a threaded hole in respective element on side of said caret, along said respective longitudinal pathway; and
a longitudinal servo rotationally connected to said longitudinal screw and placed on said wing.

104. A system as recited in claim 103 wherein said system has two said wings, and wherein one of said two wings always placed over other said wing, having said wire thereof going freely through said central node of said other wing, using a pulley assembly inside of said common frame of said central node as substitution of said link for conduct said wire comprising:
two equal cheeks, where each has three holes in vertical direction with symmetrical placement relative of a central hole thereof, and said central hole used for pivotal connection thereof and said pulley assembly with said central shaft, having additional longitudinal offset for better securing of said wire of upper wing in direction opposite to direction of entering thereof to said pulley;
a upper shaft, which mounted between upper ends of said two cheeks;
a bottom shaft, which mounted between bottom ends of said two cheeks and used for mounting said C-shape earring;
three pulley respectively dressed on said upper, central and bottom shafts with possibility of free rotation, and having said wire of upper wing conducted between them with order based on known offset in longitudinal direction of said wire relative of other wire, so said wire of upper wing enters from bottom to said pulley assembly over the bottom pulley from direction of the known offset thereof, and also exits in same direction.

105. A system as recited in claim 102 wherein said system has one said wing, and wherein said fuselage includes two symmetrical wings mounted apart symmetrically with respective roll control and either with possibility of shared pitch control of said wing with fuselage or with possibility having independent said pitch control, and in any case said pitch control reflected in further handling rules of said cruise control system, referencing said one wing with wire as wired wing, comprising:
for case if said wired wing involved in winding-in movement relative to fuselage, said fuselage wings should have a pitch implying with TAS vector thereof generally low sustain support, if other handling rules don't override it; and
for case if said wired wing involved in winding-out movement relative to fuselage, said fuselage wings should have a pitch implying with TAS vector thereof generally high sustain support, if other handling rules don't override it.
